(19) United States
(12) Patent Application Publication
(10) Pub. No.: US 2005/0139363 A1
(43) Pub. Date: Jun. 30, 2005

(54) Fire suppression delivery system

(76) Inventor: Michael Steven Thomas, Bellerose, NY (US)

Correspondence Address: Albert Wai-Kit Chan;World Plaza, Suite 604, 141-07 20th Avenue, Whitestone, NY, 11357, US

(21) Appl. No.: 10/902,598

(22) Filed: Jul. 29, 2004

Related U.S. Application Data
(60) Provisional application No. 60/491,816, filed on Jul. 31, 2003.

(51) Int. Cl. A62C 11/00; A62C 13/62; A62C 13/66; A62C 2/00

(52) U.S. Cl. 169/30; 169/71; 169/72

(57) ABSTRACT

This is a fire suppression delivery system for the delivery of compressed powdered fire suppressant materials to extinguish fires in, but not limited to high rise, commercial, industrial buildings; tunnel structures; offshore structures; oil and gas platforms; marine vessels; and environmental areas. The system and methods employ basic platforms, to the use of advanced methods currently not employed for this purpose, including electronic programming, heat seeking, propulsion, microprocessor discharge; the use of carriers, launching devices; modification of fire fighting aircraft, ground vehicles, and unmanned aircraft or drones.

This application claims benefit of U.S. Ser. No. 60/491,816, filed Jul. 31, 2003, the content of which is incorporated in its entirety into this Application by reference.

All literature cited herein are incorporated entirety by reference into this Application.

### BACKGROUND OF THE INVENTION

High rise, industrial and major forest (grassland, bog and similar environmental) fires are often battled by the use of manual fire hoses, aerial hoses, building fire houses, fire extinguishers, sprinkler systems, ground and aerial-based firefighting vehicles, including helicopters to project or drop water, foam, formulated liquids, or granular solid materials directly into the fire situation or proximate to same. Additionally, firefighters combating major forest fires have employed heavy ground equipment more familiar to construction sites, or modified fixed wing or rotary wing aircraft.

Firefighters combating fires deal not only with problems regarding access to the fire but access time, the reach and extent of the fire, heat, smoke, gases, and whether sufficient water supply and pressure will exist to safely take down the fire. Typically, where a fully evolved fire in a 20,000 square foot office tower is not put down within two hours efforts must then shift to containment, to prevent spread to other floors and areas, along with extinguishment and requiring additional forces.

In light of an ever increasing terrorist threat, the ability to effectively access and extinguish a fire situation demands a new and different approach against a conflagration, but will compromise or destroy standard building installed fire systems in their process, and the ability of firefighters to reach same. The 2003 fires that swept through California represent a small portion of major forest fires that have scorched North America, and have wreaked havoc globally: i.e., an area greater than one-third the land masse of the United States.

U.S. Pat. No. 6,029,751, “Automatic fire suppression apparatus and method,” Ford, et al., Feb. 29, 2000, utilizes a tank containing a suitable fire extinguishing agent, that is equipped with a temperature activated valve to discharge the extinguishing agent. This is a fixed position—stationary system that resets the valve to stop the flow of suppressants when the fire is suppressed. It is not suited for outdoor application over a large outdoor area or ecosystem. If the fire is not suppressed, additional assistance is necessary. Although U.S. Pat. No. 6,523,616, “Building fire extinguishing system,” Wallace, Gary B., Feb. 25, 2003, utilizes a fixed position sprinkler system placed at the apex of an A-frame structure to disperse a fire retardant to prevent a building from burning and for extinguishing a building already on fire. Although it can be affixed externally to a remote position of the building and surrounding area, outfitting a high-rise building, large outdoor or wilderness area, would prove to be highly expensive and not very effective.

High-rise structures are surrounded by and create thermal, wind and environmental patterns different from low profile structures, demanding greater speed and pressure of the retardant substance to have any impact to the external upper levels of a structure. As with any fixed position tank supply system, it is dependent upon the tank's capacity and the ability to prevent flow disruption from the tank to the dispersal system. This concern is not eliminated, even with the development of Bromfield R. Greer's “Fire extinguishing device,” U.S. Pat. No. 6,244,353, Jun. 12, 2001; U.S. Pat. No. 6,533,041 “Fire sprinkler apparatus and method,” Jensen, Raymond H., Mar. 18, 2003; U.S. Pat. No. 5,188,184, “Fire suppression system,” Northill, Barry, W., Feb. 23, 1993, which is primarily designed for use in underground structures; and, U.S. Pat. No. 6,557,374 “Tunnel fire suppression system and methods for selective delivery of breathable fire suppressant directly to a fire site,” Kotliar, Igor K., May 6, 2003.

Built-in fire extinguisher systems within a building as noted at U.S. Pat. No. 5,771,977, Schmidt, Robert A., Jun. 30, 1998, present a number concerns. These systems are expensive to install, and can be difficult and expensive to later modify to provide fire suppression protection in a new areas.” Hand-held and conventional fire extinguishers are limited not only by capacity but the ability of its intended user to timely access the extinguisher at the time of an emergency.

U.S. Pat. No. 5,778,984, “Fluid fire extinguishing agent shell for throwing,” Suma, Tomisabura, Jul. 14, 1998, utilizes a fluid fire extinguishing shell that comparatively is limited in application to being thrown. Although U.S. Pat. No. 5,778,984 seeks to overcome the limitations it eschews regarding hand-held fire extinguishers, it faces the same limitation, the same challenge, and may be plagued by the same concern of timely access: fire origins beyond the throwing range of its handler, large and growing fires, and fires that stand between the intended user and this fluid fire extinguishing agent shell.

Smaller systems have limited reach and application. U.S. Pat. No. 6,548,753 “Flame suppression cabinet,” Blackmon, Jr., et al., Apr. 15, 2003, is a stationary system of passive fire suppression—using fire plates to prevent the spread of fire from within a telecommunication network cabinet.

U.S. Pat. No. 5,018,586 “Fire suppression system for a decorative tree,” Cawley, Dennis, May 28, 1991, utilizes Halon, which is an environmentally unacceptable substance and highly regulated. If the fire originates away from the tree the fire or smoke must reach the area immediate to the tree before the system is activated.

U.S. Pat. No. 4,328,868 “Fire suppressant impact diffuser,” Monte, et al., May 11, 1982, a stationary system. It is limited in reach and containment tanks capacity, but suited for small or tightly enclosed areas. Perhaps an excellent method to prevent a flash explosion within a small, defined area, though expensive for a larger structure such as a building, and untenable for an open area such as a forest, and it uses Halon.

U.S. Pat. No. 6,549,422, “Electronic system fire containment and suppression,” Mendoza, et al., Apr. 15, 2003, which pertains to a printed circuit board for fire containment and suppression, where the housing system must be able to withstand extreme temperatures.

The inventiveness of U.S. Pat. No. 6,340,058 “Heat triggering fire suppressant device,” Dominick, Stephen M., et al., Jan. 22, 2002, may prove to be an effective technique for small areas. It is a fire suppressant device type that may be mounted in a kitchen range hood or industrial locations. Similarly, U.S. Pat. No. 4,691,783 “Automatic modular fire extinguisher system for computer rooms,” Stern et al., Sep. 8, 1987, is limited in reach and expensive to outfit larger, common areas.

Alton J. Doud, U.S. Pat. No. 6,732,725 “Fire out canister launcher,” May 11, 2004, proposed the use of a hand held launching device to project an encasement into a fire situation. However, it is quite limited in range and application, to that what is proposed herein, which just as U.S. Pat. No. 6,725,941 “Fire retardant delivery system,” Edwards, Paul, et al., Apr. 27, 2004. What is proposed herein utilizes electronic programming and smart technology to target a fire with greater accuracy and suppression power.

A fixed position tank supply system depends upon volume and the ability to prevent flow disruption from the tank to the dispersal system: typically, water sprinkler heads or gas jets. This is one problem highlighted with the terrorism attacks of Sep. 11, 2001, where destruction of or severe damage to the standpipes and water lines normally feeding the building's sprinkler system resulted in a misting at best or no water at all. This concern is not eliminated even with the development of Bromfield R. Greer's “Fire extinguishing device,” U.S. Pat. No. 6,244,353, Jun. 12, 2001; or, U.S. Pat. No. 6,533,041 “Fire sprinkler apparatus and method,” Jensen, Raymond H., Mar. 18, 2003.

In combating building fires, U.S. Pat. No. 4,488,603 “A compact and highly mobile fire-fighting vehicle,” Schittmann, et al., Dec. 12, 1984, was developed as a manual or remote controlled, self-propelled fire fighting vehicle, that could travel through the corridors and door openings of a building, transportable in a freight or regular elevator to the fire zone, while carrying personnel and various fire extinguishing materials. Among its drawbacks is that absent a ramp to access each floor or placing such a vehicle on each level of a multi-storied building, the loss of elevator access could render this system useless. See, also, U.S. Pat. No. 4,550,931 “Wheeled container, especially for use by fire-fighting and rescue squads,” Ziaylek, Jr., Theodore, Nov. 5, 1985; and, a recent development, U.S. Pat. No. 6,502,421 “Mobile firefighting systems with breathable hypoxic fire extinguishing compositions for human occupied environments,” Kotlian, Igor K., Jan. 7, 2003.

With all of the above methods described the concern here is what happens when firefighters are called upon to put down a fire these systems and methods could not contain. U.S. Pat. No. 6,134,423 “Fire fighting apparatus,” Fitzpatrick, Peter J., Oct. 24, 2000, utilizes a high temperature-sensitive shell containing a fire suppressant that is embedded as or fashioned as a ceiling tile.

The devastation of forest fires witnessed in the Western United States and Australia in 2002, and those face in South America, Europe and elsewhere, continue to illustrate the difficulty of fighting such fire situations. Current fire suppression methods include ground crews or firejumpers, heavy construction type machinery. Advancements in ground control of forest (and other environmental) fires includes U.S. Pat. No. 5,641,024 “Bush fire fighting machine,” Lopez, Alvarez, Jun. 24, 1997, which was developed to primarily to create fire lanes to prevent the advancement of a fire by clearing materials in its advancing front. However, one spark that travels from an advancing fire front to a position beyond the fire lane is all that is needed to ignite the next major forest fire.

Aerial fire fighting has seen many innovations, whether directed at a high-rise building or a forest fire. A more recent development is U.S. Pat. No. 6,364,026 “Robotic fire protection system,” Doshay, Irving, Apr. 2, 2002. U.S. Pat. No. 4,936,389 “Fluid dispenser for an aircraft,” MacDonald, et al., Jun. 26, 1990; also, U.S. Pat. No. 5,320,185 “Aircraft fluid drop system,” Foy, et al., Jun. 14, 1994; U.S. Pat. No. 5,794,889 “Foam generating device for fire-fighting helicopter,” Rey, Claude, Dec. 23, 1997; U.S. Pat. No. 5,878,819 “Device for assisting with the extinguishing of fires by water-bombing aircraft,” Denoize, et al., Mar. 9, 1999; U.S. Pat. No. 5,549,259 “Innovative airtankers and innovative methods for aerial fire fighting,” Herlik, Edward C., Feb. 17, 1994; U.S. Pat. No. 6,474,564 “Targeting, small wildland fire extinguisher dropping system,” Doshay, et al., Nov. 5, 2002; and, U.S. Pat. No. 6,125,942 “Aircraft-based fire fighting bucket,” Kaufman, et al., Oct. 3, 2000. However, these gravity-based aerial drop systems are limited in application. Operators aboard the aircraft must not only identify the intended target zone but hopefully place the fire retardant on point. How close an aircraft can fly over the intended target zone, and the reduction of extinguishment lost to drifting, thermal updrafts, and dissipation prior to reaching the fire, is a constant concern plaguing firefighters.

U.S. Pat. No. 4,881,601 “Apparatus for deployment of aerial-drop units,” Smith, Wayne D., Nov. 11, 1989, brought about the development of a containerized system to overcome the problem by those skilled in the art known as the protective effect of the fire updraft” referred to as the shielding effect. The shield effect undoubtedly had a negative impact upon older systems such as U.S. Pat. No. 4,195,693 “Device for extinguishing fires from the air,” Busch, et al., Apr. 1, 1980. The latter utilized a tank of water rear-loaded into an aircraft for discharge from the rear-loading door to the fire zone.

Fire fighters and fire jumpers can be plagued by extremely high temperatures, superheated air, low oxygen levels, and fires that can stretch more than several hundred feet high, and at times miles long, when combating major forest or grassland fires. The thermal patterns created by major forest fires can create a different environment reaching as high as 300′, or more, above the fire. Aircraft used to combat such fires are constantly buffeted by these weather patterns. Helicopters deployed to combat a (building) fire are limited in the amount of water that can be carried (2,000 to 3,000 gallons) and the ability of its water cannon to effectively project enough water or foam deep within a structure: while contending with cross currents and updrafts that can whip between buildings—similar to winds channeling through a canyon. U.S. Pat. No. 5,377,934 “Helicopter conversion,” Hill, Jamie, R., Jan. 3, 1995, discussed the adaptation of a UH-1H/V or UH-1D airframe as a fire fighter. It is unfortunate, however, that U.S. Pat. No. 5,377,934's references do not discuss the process of adaptation to contain and deploy concentrated, encapsulated fire suppressant material, pinpoint deployment, closer operation to and within the fire environment, or impact of prop wash and aircraft velocity on deployment.

U.S. Pat. No. 5,135,055 “Ground and airborne fire fighting system and method of fighting high rise building fires,” Bisson, Theodore, J., Aug. 4, 1992, discussed the use of a mobile ground pump vehicle connected via an inlet to the pump of one or two extendable booms with nozzles onboard a helicopter. The latter, when maneuvered to the high rise floor where the fire is directs a stream of water into the building to extinguish the fire. Building height, prop wash, down drafts, updrafts, sufficient fire hose and other dynamics factor into one's ability to maintain an aircraft to achieve this method of operation. However, U.S. Pat. No. 5,135,055 does not discuss the limitation of fire access where the fire cannot be accessed from the exterior because of barriers of obstructions that prevent ones ability to train a line of water directly upon or proximate to the fire itself.

Rapid water replenishment has been improved by such efforts as U.S. Pat. No. 4,474,350 “Probe for water bomber,” Hawkshaw, John K., Oct. 2, 1984. Here, the improvement is a mechanism for loading water into a water storage tank of a bomber aircraft, and refueling at flying speed during a landing touchdown on a body of water. See, also, U.S. Pat. No. 4,671,472 “Fire bombing and fire bombers,” Hawkshaw, John K., Jun. 9, 1987.

Other methods of replenishment and deployment include U.S. Pat. No. 4,993,665 “Device for attachment to a helicopter” Sparling, Fred, Feb. 19, 1991, U.S. Pat. No. 4,930,826 “Cargo apparatus for attaching a cargo container to an aircraft,” Perren, et al., Jun. 5, 1990; U.S. Pat. No. 4,090,567 “Fire fighting helicopter,” Tomlinson, Francis E., May 23, 1978; and, U.S. Pat. No. 5,385,208 “Airborne fire suppressant foam delivery apparatus,” Baker, et al., Jan. 31, 1995, which discusses the use of foam to fight forest fires. At U.S. Pat. No. 4,576,237 “Fire fighting basket assembly for aircraft,” Arney, Donald B., Mar. 18, 1986, a basket suspended from a helicopter that can be lowered into a body of water. Subsequently the water is released to or above the fire zone. U.S. Pat. No. 4,576,237 “Fire fighting basket assembly for aircraft,” Arney, Donald B., Mar. 18, 1986, illustrates a collapsible fire fighting basket suspended from a helicopter that can be filled from an open body of water.

U.S. Pat. No. 6,474,564 “Targeting, small wildland fire extinguisher dropping system,” Doshay, et al., Nov. 5, 2002, was developed primarily as an aerial drop/aerial suspended system using a bag, 55 gallon drum or similar mechanism, and a fluid fire suppressant. The targeting mechanism relates to valve ports threaded to a bag containing an aqueous fire suppressant (e.g., water) that can be suspended from a helicopter to perform an aerial drop. It is limited as to capacity, how close the helicopter can hover over the immediate area, and is suitable only for dropping fire suppressant materials from an overhead position, and is unsuitable for an enclosed structure. Similarly, U.S. Pat. No. 6,125,942 “Aircraft-based fire fighting bucket,” Kaufman, et al., Oct. 3, 2000, uses a bucket with a flow controller suspended from a helicopter, comprising a flow controller to release its materials at the desired volume flow rate. However, both systems are limited, yet an advance to older methods such as U.S. Pat. No. 4,601,345 “Mixing and drop systems for fire retardants,” Makrt, David M., Jul. 22, 1986 and U.S. Pat. No. 4,172,499 “Powder and water mixing and dropping system onboard an aircraft,” Richardson, et al., Oct. 30, 1979.

An overwhelming part of the prior art focuses upon reaching a fire at its point of origin or its base. U.S. Pat. No. 5,211,246 “Scouring method and system for suppressing fire in an enclosed area,” Miller, et al., May 18, 1993, may represent the dearth of systems developed to combat a fire in the upper, middle, and lower regions of an enclosed area. Unfortunately, U.S. Pat. No. 5,211,246 may not be applicable beyond its target, i.e., an airplane or similar structure or similar enclosed area. The proposed system herein does in fact address the methods and mechanisms of combating the different levels of a fire's vertical column, as a comprehensive, effective method to knock down a fire.

A more recent development is U.S. Pat. No. 6,364,026 “Robotic fire protection system,” Doshay, Irving, Apr. 2, 2002, which proposed the use of a dual unmanned aircraft system. The first aircraft serves as a surveillance vehicle to pinpoint a fire's origin and relay that information to a remote command center. The second aircraft is then dispatched to drop a quantity of fire suppressant material to the target fire zone. Whereas the second aircraft of U.S. Pat. No. 6,364,026 is used as a drop vehicle, the proposed system here is capable of drop dispersal, drop and pinpoint projection of an array of fire suppression mechanisms.

Several systems that encapsulate or containerize fire suppressant materials propose the use of an explosive agent as the discharge mechanism. U.S. Pat. No. 5,507,350 “Fire extinguishing with dry ice,” Primlani, Indu J., Apr. 16, 1996, discusses the use of a solid carbon dioxide capsule, as a projectile, to chill a fire zone and to deplete same of oxygen required for combustion. This system requires constant refrigeration and special handling. Primlani proposes strategically storing capsules until needed: an expensive proposition, particularly for large ecosystems fire control.

U.S. Pat. No. 5,232,053 “Explosion suppression system,” Gillis, et al., Aug. 3, 1993, is a containerized system where its pressurized fire suppressant material is discharged by an explosive agent. Similarly, U.S. Pat. No. 4,964,469 “Device for broadcasting dry material by explosive force,” Smith, Wayne, D., Oct. 23, 1990, is comprised of a frangible container with an impact activated detonator, fuse cord, and explosive device. On impact, the detonator ignites a fuse, which in turn sets off the explosive device to scatter its fire suppressant load.

U.S. Pat. No. 4,285,403 “Explosive fire extinguisher,” Poland, Cedric M., Aug. 25, 1981, is comprised of a frangible shell containing a fire suppressant solution, and armed with an explosive charge. When dropped from an aircraft to a fire zone and detonated, detonation would atomize the solution into a vapor-like fog. This vapor-like fog, when coupled with the concussive force of detonation, would put out the fire. Also, see, U.S. Pat. No. 4,195,572 “Pressurized projectile for delivering and dispensing liquids or particulates,” Knapp, John S., Apr. 1, 1980, which does not require the use of an explosive device.

U.S. Pat. No. 4,627,354 “Launchable aerosol grenade,” Diamond, et al., Dec. 8, 1986, is a non-flammable and non-explosive projectile containing pressurized materials. This projectile can be fired from a gun or similar device, to a targeted area. When fired, the projectile impacts against a piercing pin, which later releases the can and its contents upon impact with its target. U.S. Pat No. 4,527, 354 is primarily designed for use as a tear gas grenade.

The above cited inventions represent a small portion but wide area of the technology currently employed in fire fighting. The invention proposed herein is developed to address the concern of what happens when firefighters are called upon to put down a fire these systems and methods could not contain.

### SUMMARY OF THE INVENTION

When the above systems and their predecessors effectively 5 take down a fire, the work of the firefighter is may be reduced. However, when these systems are overwhelmed by the sheer magnitude of a fire fail, additional systems, as proposed here, that are adaptable to multiple situations/usage, is intended to provide another method available to fire fighters, in the art of combating fires.

The general purpose of the present invention is to provide a new fire extinguishing system for professionals. This fire suppression delivery system will augment the fire fighting technology that currently exists. This includes the use of novel features that result in a new fire extinguishing system: readily recognized by those skilled in the art as not anticipated, rendered obvious, suggested, or even implied by any of the prior art of fire fighting technology, either alone or in any combination thereof.

Still yet another object of the present invention is to provide a new fire extinguishing delivery system which augments the apparatus and methods of the prior art, while simultaneously overcoming some of the disadvantages normally associated with same.

The present invention will provide a new fire extinguishing system for combating high-rise building, commercial and industrial structure, and underground fires, as well as forest, brush and other environmental fires, with a higher degree of precision and concentration.

Even still another object of the present invention is to provide a new fire extinguishing system that applies fire-extinguishing agents throughout vertical column of the fire. The intent is to minimize the loss due to evaporation and updraft flow unlike the conventional aerial drops using water, foam and/or chemical.

The present invention ranges in descriptions from basic to advanced designs systems. This system also provides new methods of containment and the deployment of fire suppression material to a fire zone.

Frangible impact agents and launchable agents have been developed, where impact or timing mechanism triggers dispersal. The current system improves upon the current technology and goes beyond same in, in both the current technology and application. It incorporates technology from other civilian and military applications, and does so in a novel and non-obvious way. For example, the use of electronic programming of fire suppression delivery systems gives greater versatility, in addition to its use of smart technology not heretofore utilized in fire fighting.

The programmable launchers cited, including the hand-held launcher with its rear loading magazine are non-obvious, novel and would not have otherwise been construed as a natural progression in the development of fire suppression systems. The containment system and its adaptation to launchers, vehicle mount systems, fire fighting aircraft, including the drone, emergency vehicles, along with other aircraft modifications, have not been undertaken previously, as an individual design or as a system.

Other features of the invention have thus been outlined, rather broadly. This is intentional so that the detailed description that follows may be better understood and in order that the present contribution to the art may be appreciated.

This invention is not limited in its application to the details of construction or the arrangements of the components set forth in the description, or illustrated in the drawings. The invention is capable of being practiced and carried out in various ways. For example, the application of a substantial number of the components of this invention that are cited for high rise or forest fire environments are interchangeable, i.e., can be adapted for use in both environments. The phraseology and terminology employed herein are for the purpose of description and should not be regarded as limiting.

As such, those skilled in the art will appreciate that the concepts discussed herein, may be readily be adapted to the design of other structures, methods and systems for carrying out the purposes of the present invention. Therefore, it is important, that the claims be regarded as including such equivalent constructions insofar as they do not depart from the scope and spirit of the present invention here.

The abstract is not intended to define the invention of the application, nor is it intended to be limiting as to the scope of the invention in any way.

The purpose of the abstract is to enable the U.S. Patent and Trademark Office, practitioners, and others, who are skilled or unskilled in the art, to determine quickly the nature and essence of the disclosure of the application.

### DETAILED DESCRIPTION OF THE FIGURES

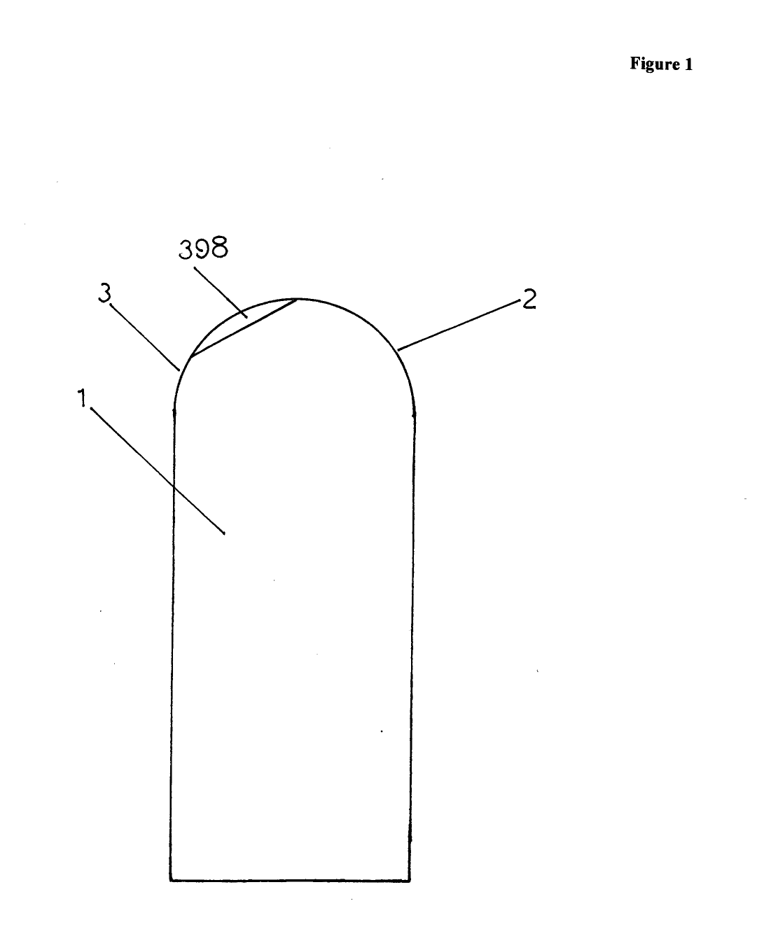

FIG. 1 is a two dimensional exterior view of a thin-walled general spherical/cylindrical capsule or canister constructed from cellulose, gelatin, hardened fire suppressant materials, plastics, composite materials or other suitable mediums, to form a thin-walled double thin-walled or hybrid capsule for the delivery of highly compressed fire suppressant or fire retardant materials to a fire situation.

Delivery of the fire suppressant capsule can be achieved by throwing, dropping, aerial dropping or projection from a launcher, or other suitable methods of presentation into (and activation within) into the fire zone itself. The size of a capsule or canister range from something as small as a tennis ball or an eight-ounce aluminum can, to several hundred pounds.

As a safety feature, each capsule, capsule-type, and canister contains a non-phosphorous or non-combustible tracer that will act in the same capacity as munitions packed with a tracer round: to determine the path of a capsule, particularly under low light, night, or heavy smoke conditions, the tracer will provide a visual cue.

Fire suppression capsule's or canisters developed for electronic programming would be fitted with electronic contact strips and/or microchips.

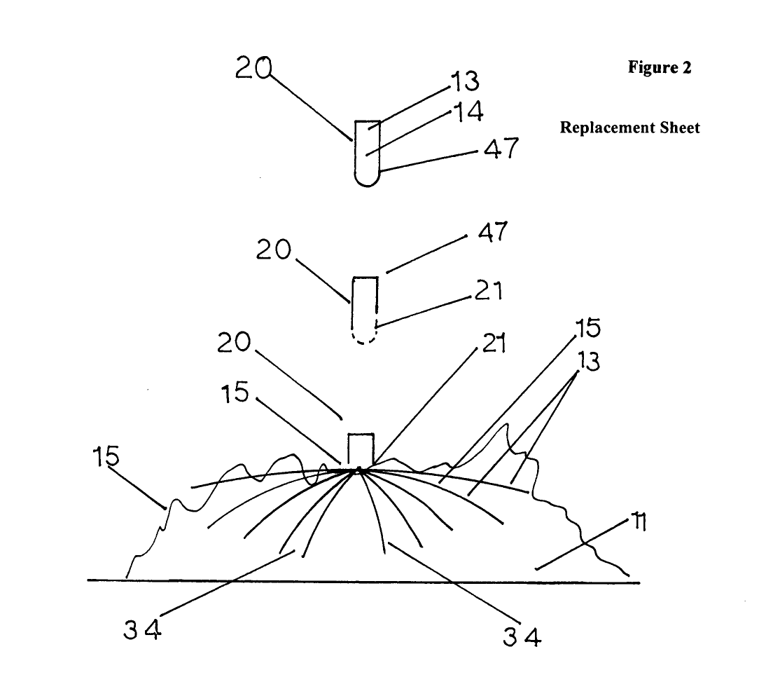

FIG. 2 illustrates a heat/temperature activated fire suppressant capsule projected into a fire zone. Here, the capsule's containment wall is designed to disintegrate at a minimum or pre-determined temperature threshold (e.g., 350° F.).

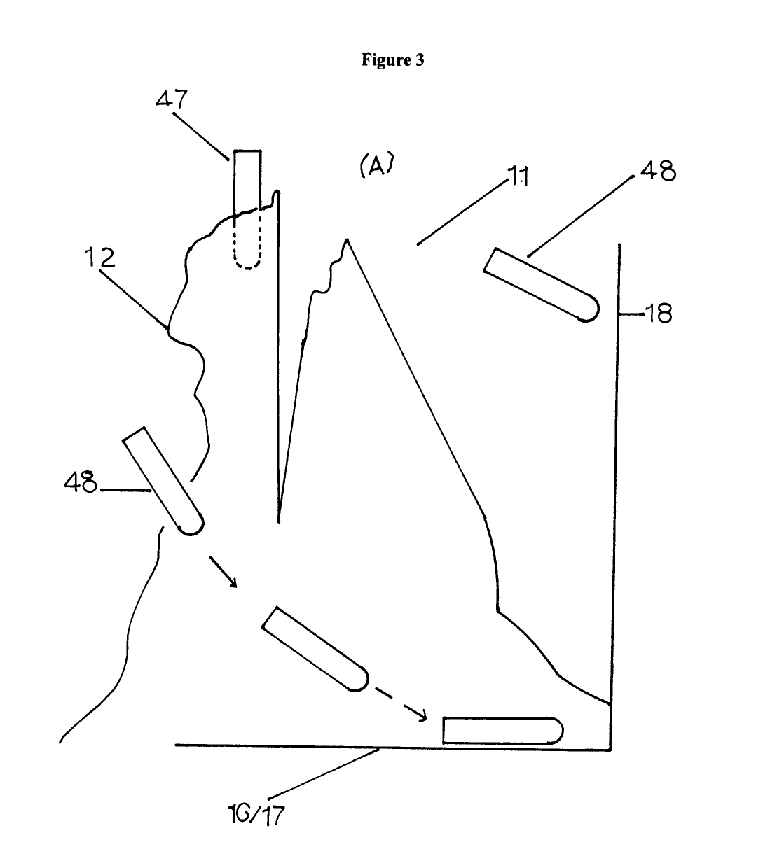

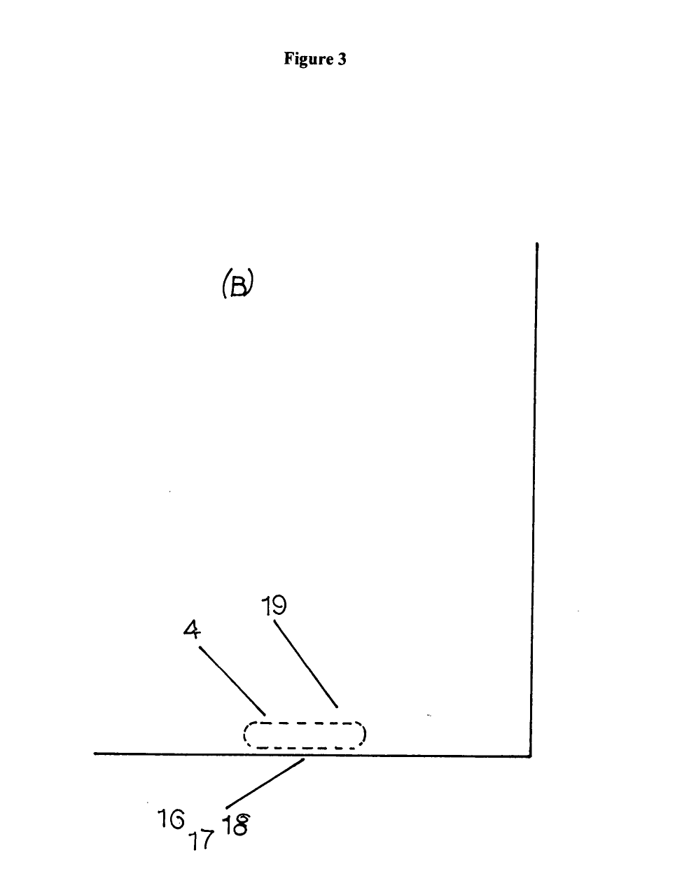

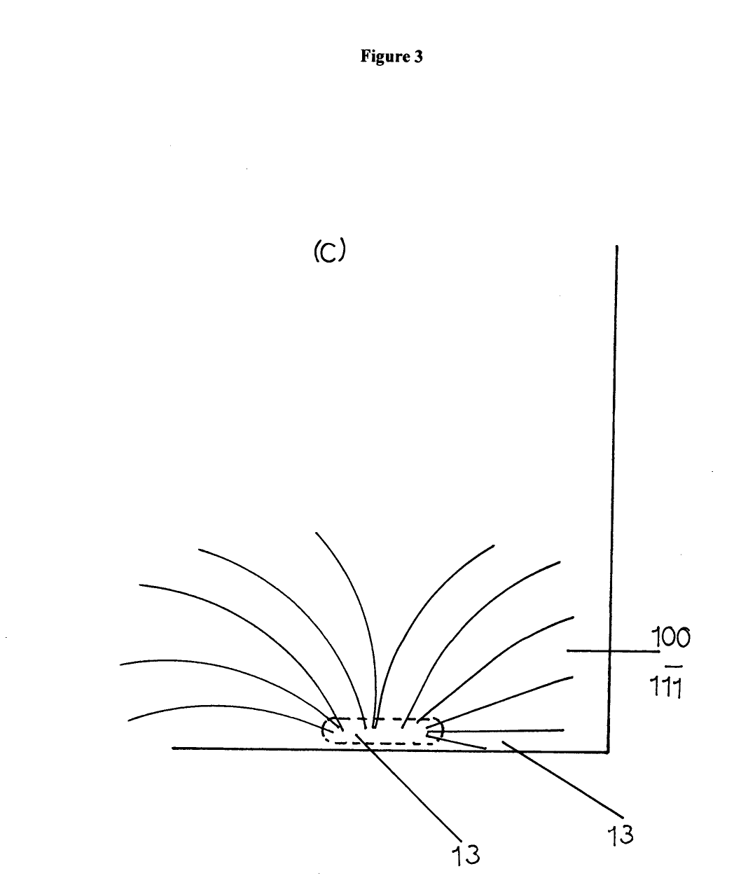

FIG. 3 illustrates a heat/temperature activated shatter fire suppressant capsule (or, “shatter capsule”) projected into a fire zone. When in contact with the flame and upon impact with a second structure, e.g., the floor ground or any structure/surface that will cause the capsule to shatter upon impact, the capsule shatters forcibly ejecting its fire suppressant load to the fire zone).

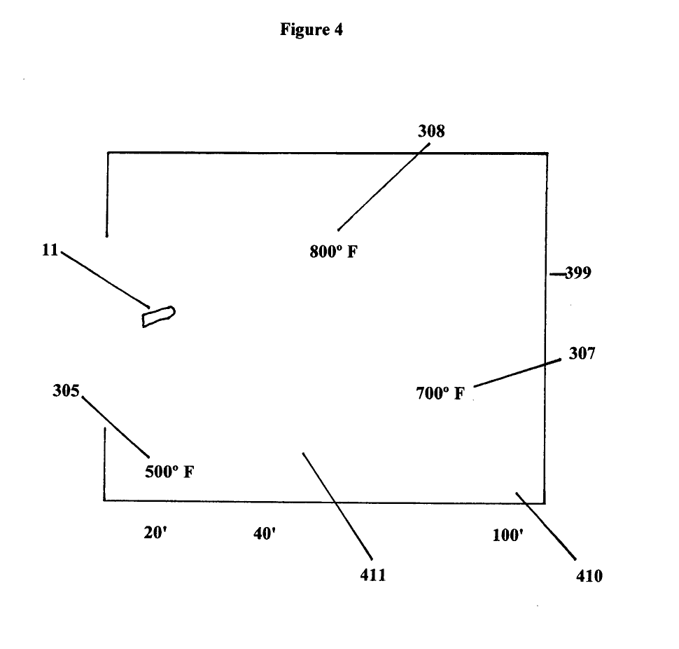

FIG. 4 illustrates a structural fire zone where the intensity of the fire's temperature various throughout the structure.

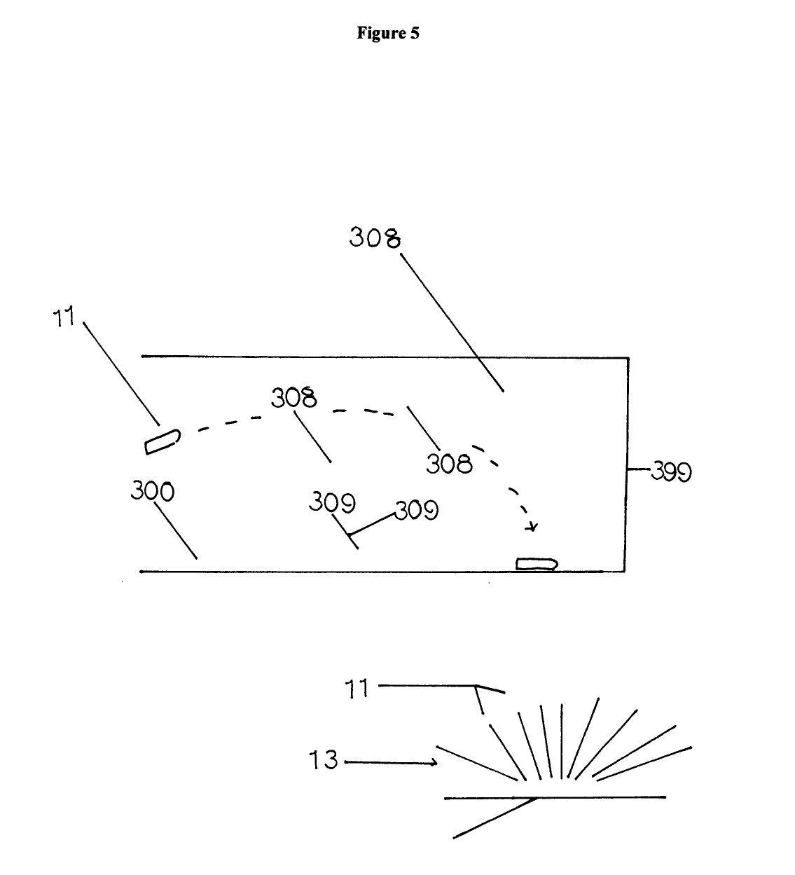

FIG. 5 demonstrates this principle where a fire suppressant capsule that requires, e.g. 900° F. temperatures to initiate disintegration of the capsule, so as to release the suppressant, the capsule disintegrates 30 seconds after projection from the launcher or 30 seconds into the fire zone.

Where a capsule lands in a fire zone that is below the minimum temperature threshold (e.g., the capsule is specifically set to disintegrate at the 900° F.), time sensitive feature acts as a safety feature to release the fire suppressant load instead of waiting for the temperature to achieve 900° F. or greater (which would otherwise result in more damage before the suppressant is released).

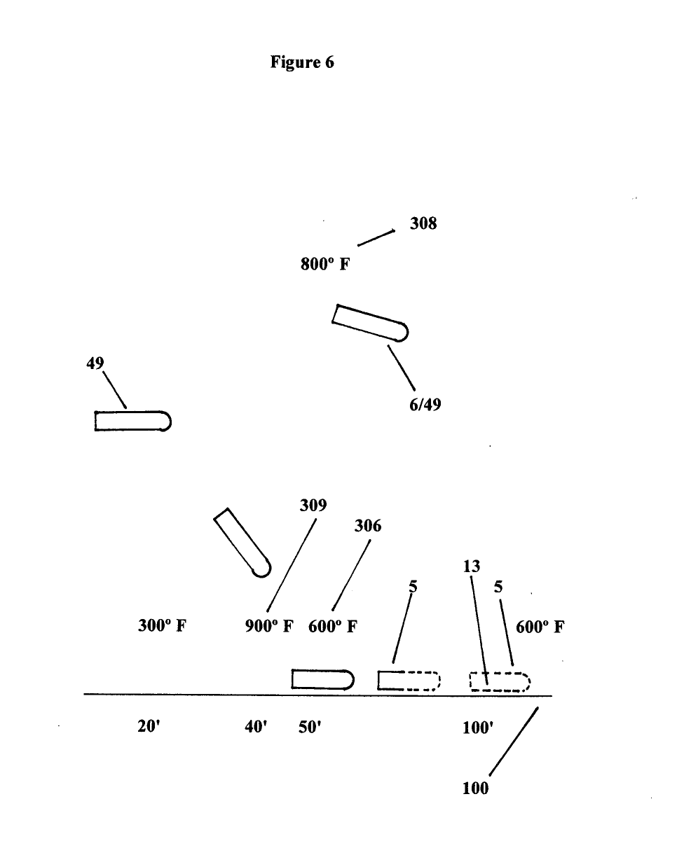

FIG. 6 utilizes the same fire zone pattern discussed at FIG. 5. Here, the intended mark is the 700° F. demarcation, using a time activated capsule to suppress the fire.

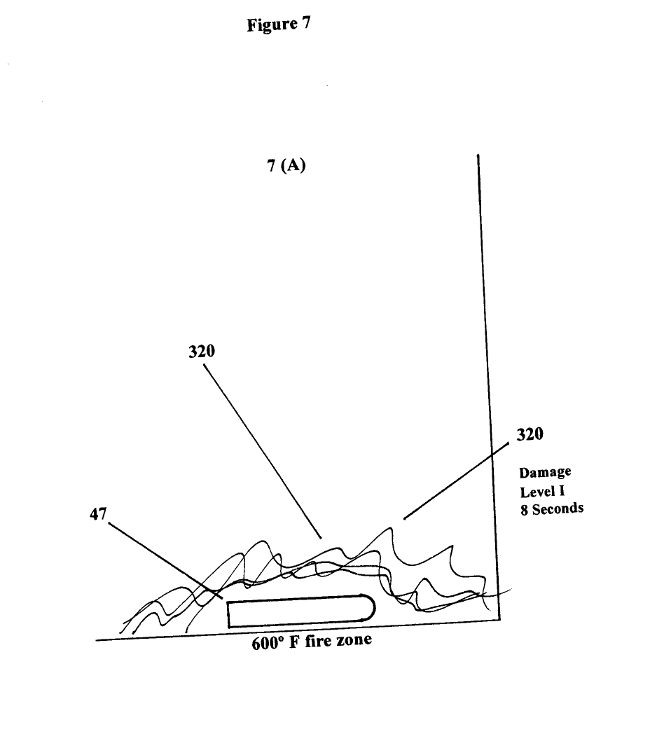

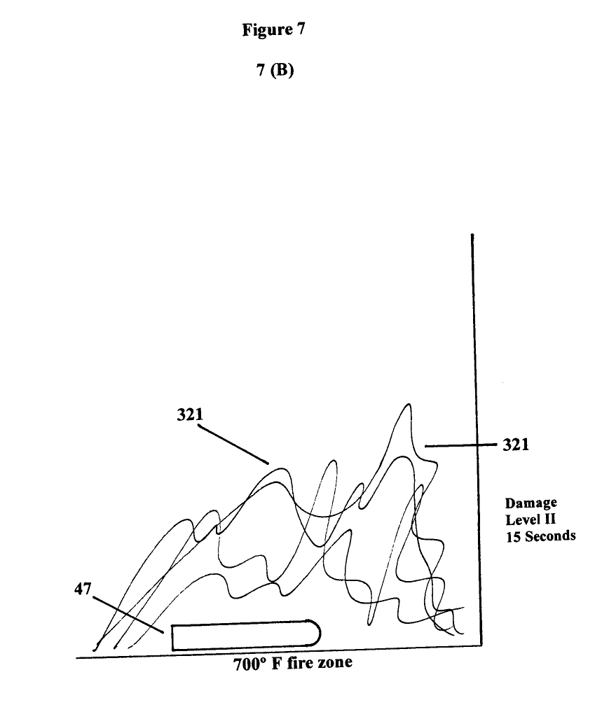

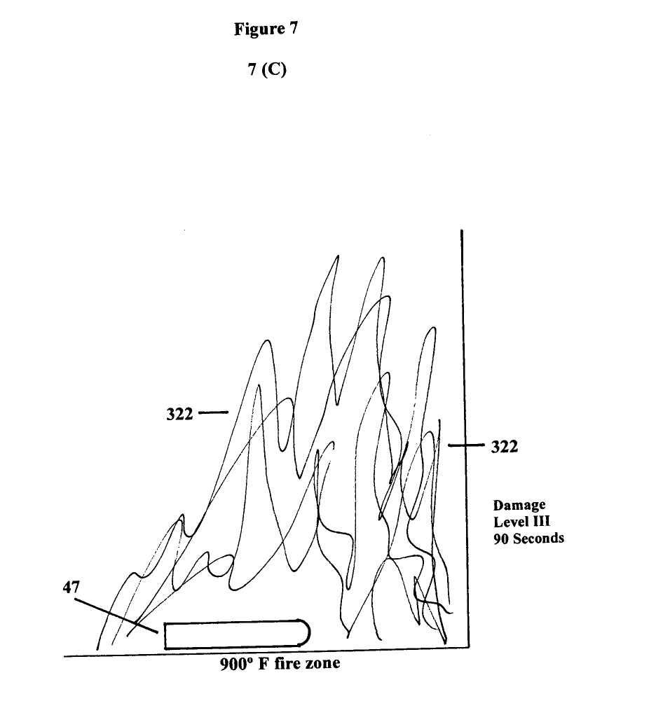

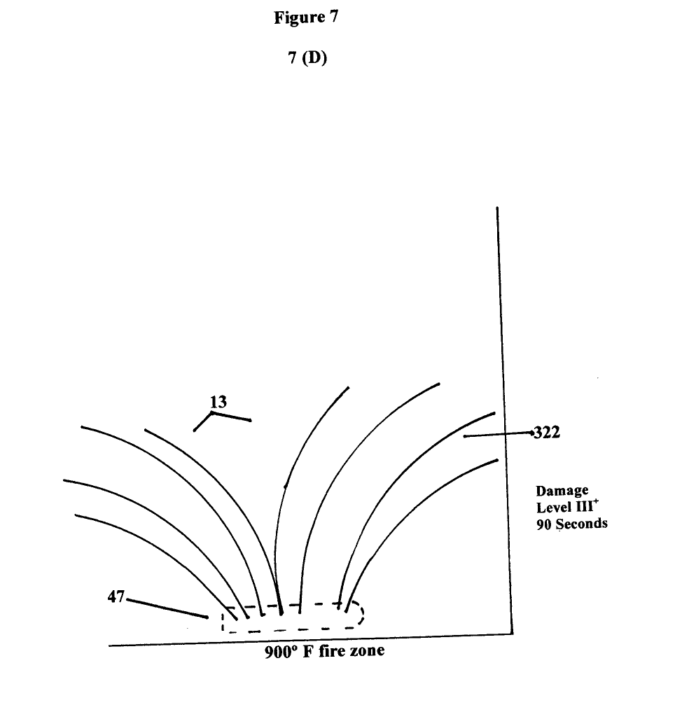

FIG. 7 further illustrates the intent of FIG. 6.

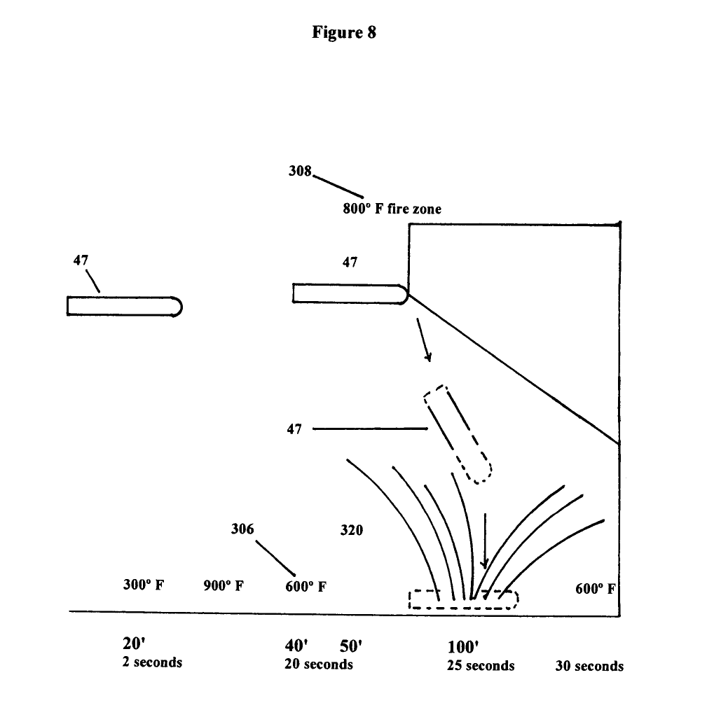

FIG. 8 illustrates FIG. 5, as a heat/temperature activated fire suppressant capsule encounters a hard surface along its trajectory path, and on impact releases its fire suppressant load at ground or floor.

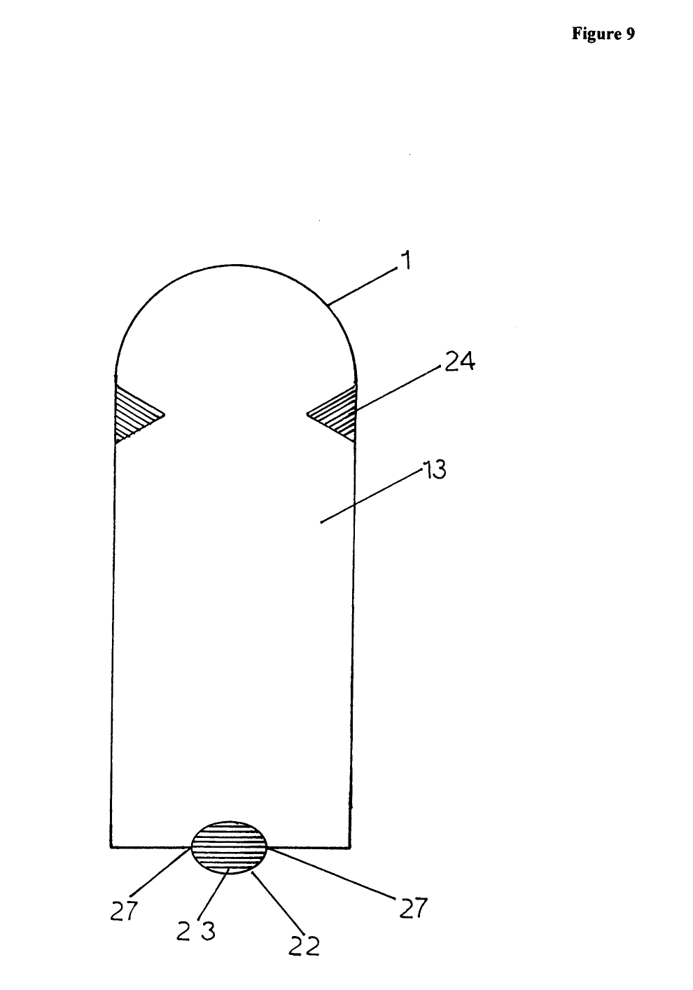

FIG. 9 is a two dimensional view of FIG. 1 with a protruding posterior soft spot containing a propellant and two dispersal ports. When the soft spot is ruptured, it will propel the fire suppressant capsule by forcing the propellant through a restricted aperture, while at the same time discharging the fire suppressant.

FIG. 10 illustrates FIG. 9 during the fire suppressant capsule's ascent, ejecting fire suppressant through a thin-walled port and the soft-spot region.

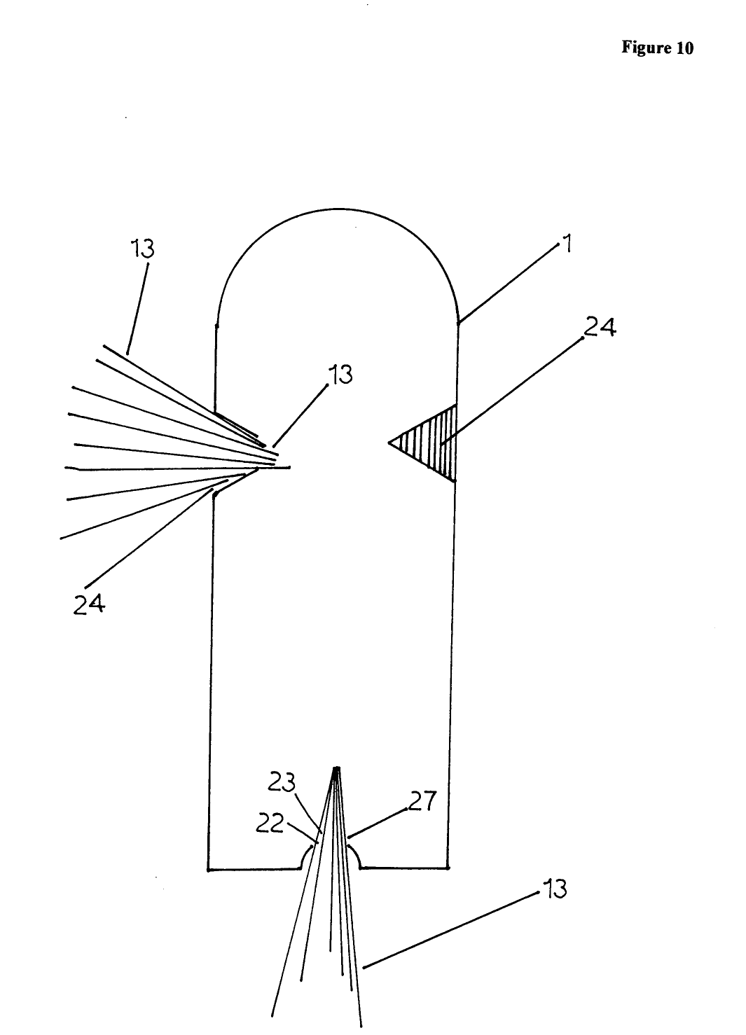

FIG. 11 illustrates a fire suppressant capsule with intact multiple thin-walled ports, and a separate propellant containment area at the base of the capsule.

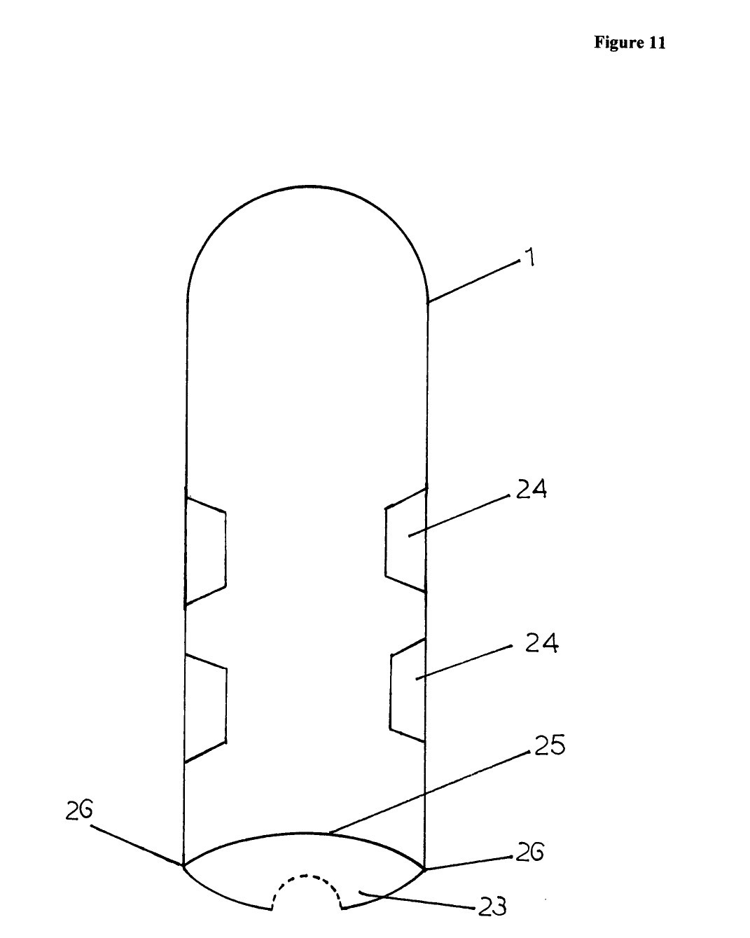

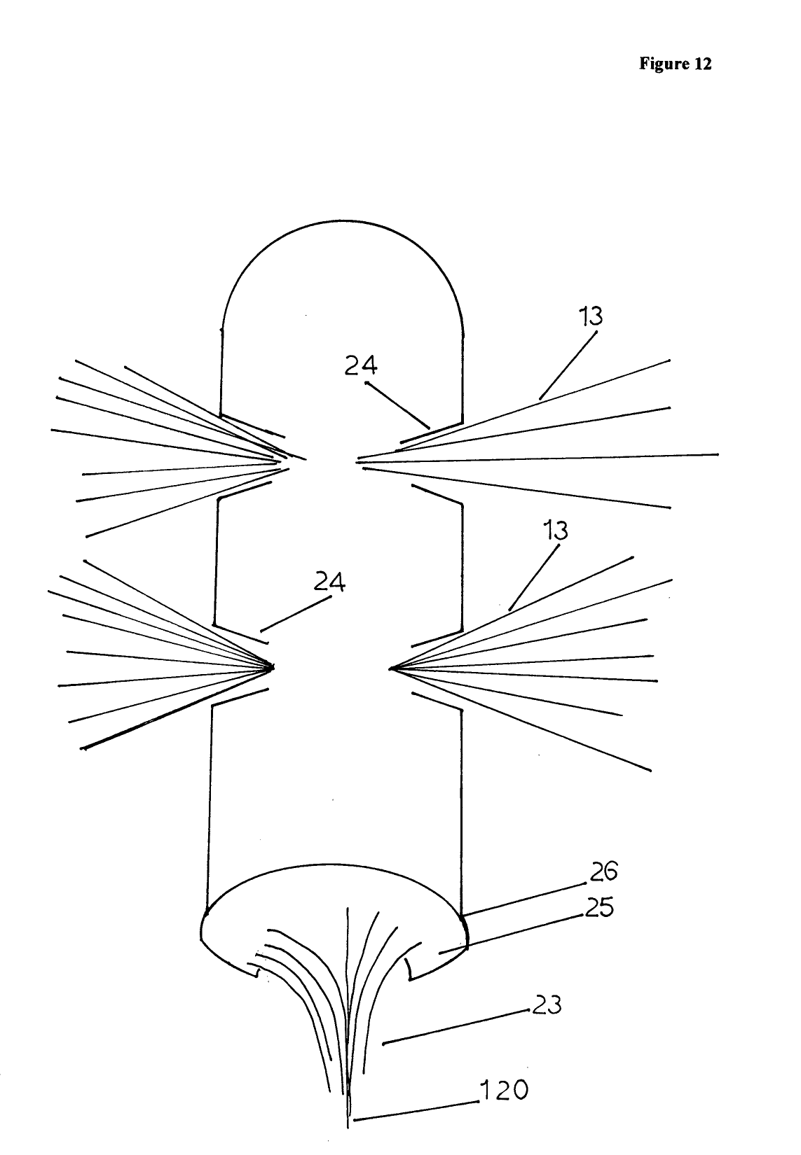

FIG. 12 illustrates FIG. 11 where all four thin-wall ports have been breached, expelling its fire suppressant load.

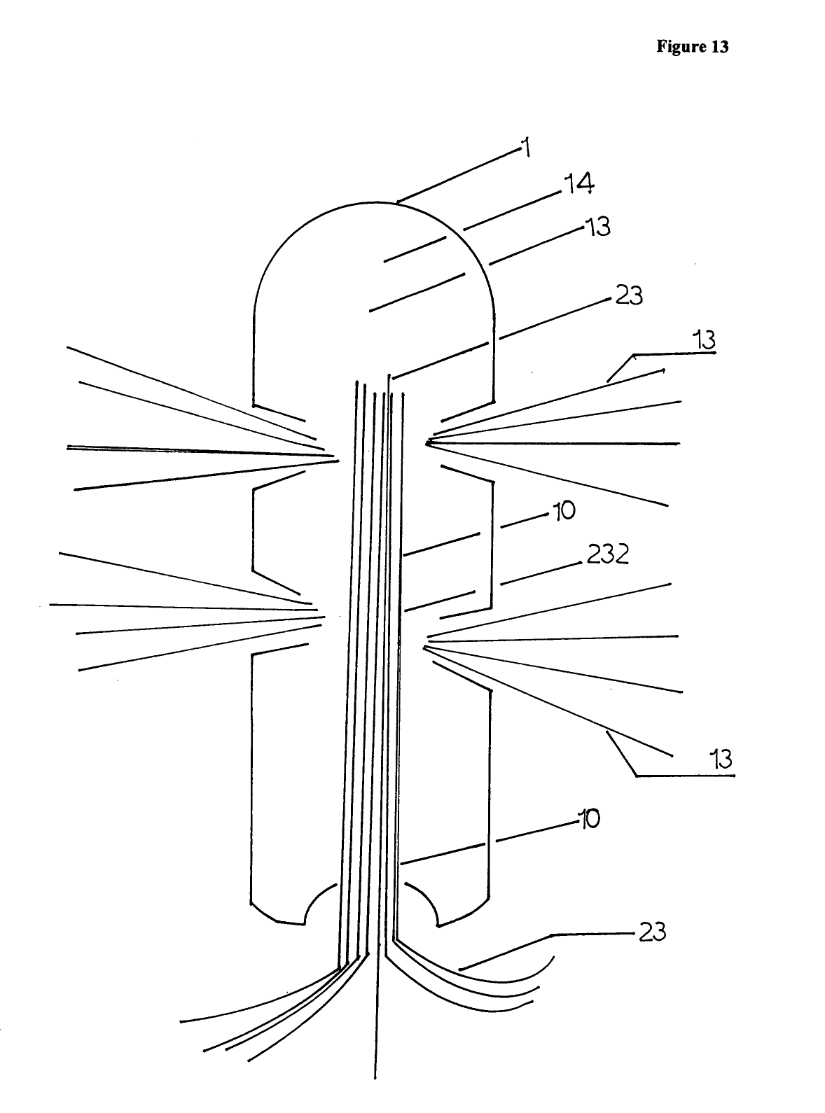

FIG. 13 illustrates a view of FIG. 11 and 12, where the propellant core occupies a central core region of the capsule.

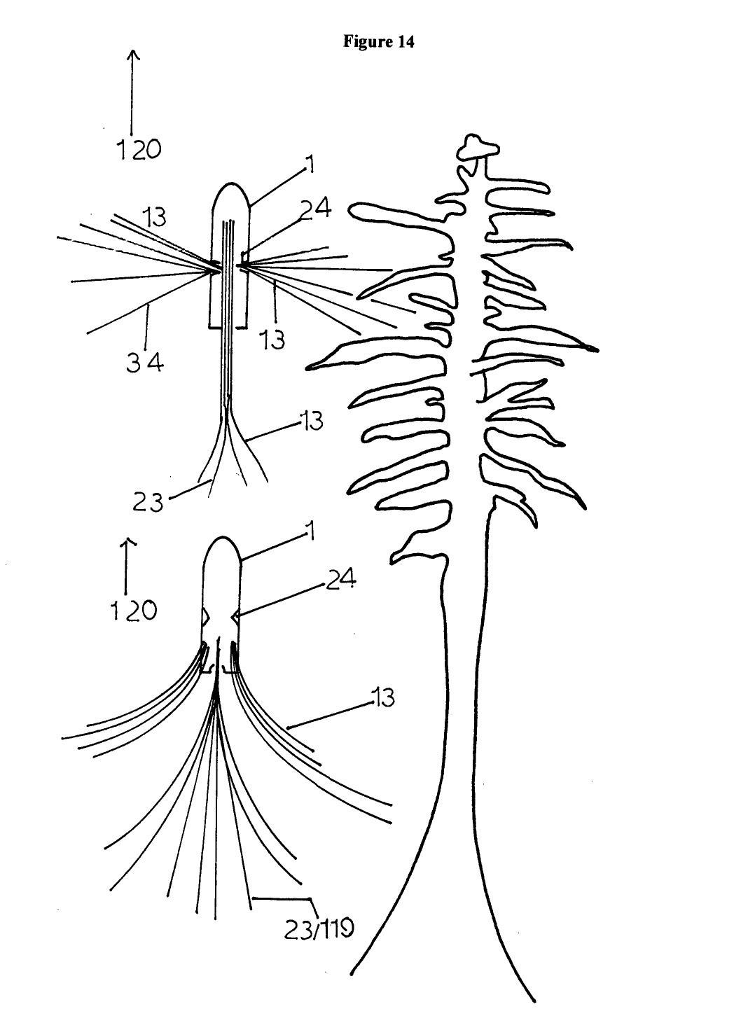

FIG. 14 illustrates FIG. 11 and FIG. 12. Here, the fire suppressant capsule is projected into a fire zone, self rights, and the soft spot is superheated to 550° F. by the fire. The self-righting mechanism is a physical (plant) design where the capsule will self orient itself into an upright position.

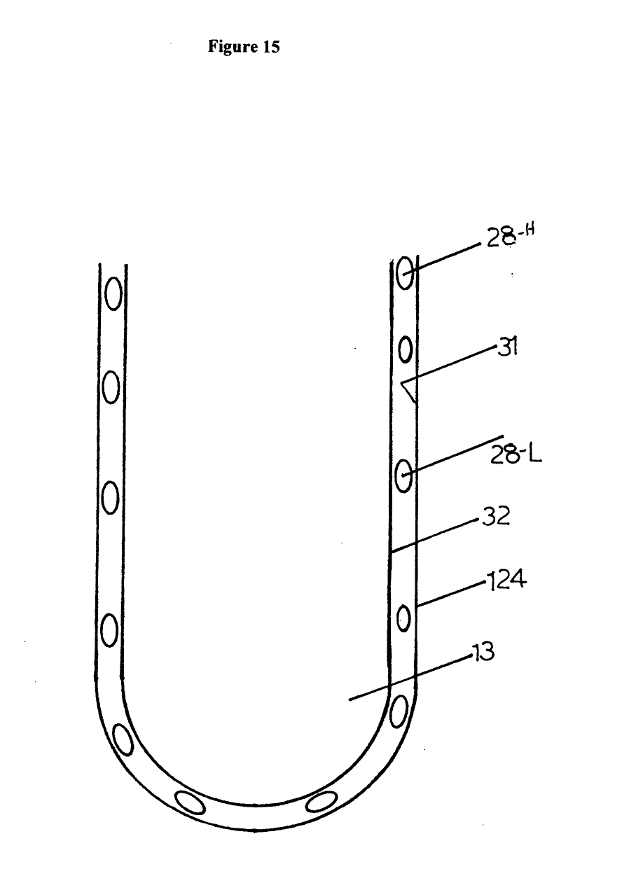

FIG. 15 is a partial cross-sectional view of a thin walled fire suppressant capsule, illustrating low (vacuum) or high pressure nodules.

A second method to creating a pressure-sensitive fire suppressant capsule is to load the fire suppressant under high or negative (vacuum) pressure.

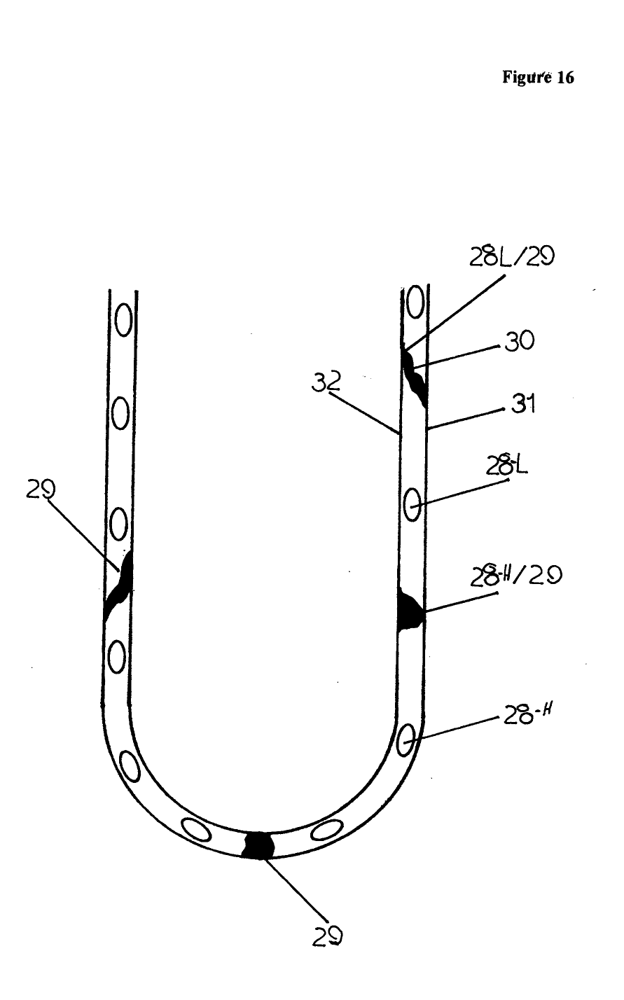

FIG. 16 is a partial cross-sectional view of FIG. 15, where several low (vacuum) or high pressure nodules have been breached or ruptured, forming a channel between the exterior and interior of the thin-walled capsule, which will result in the releasing of its fire suppressant load to the fire environment.

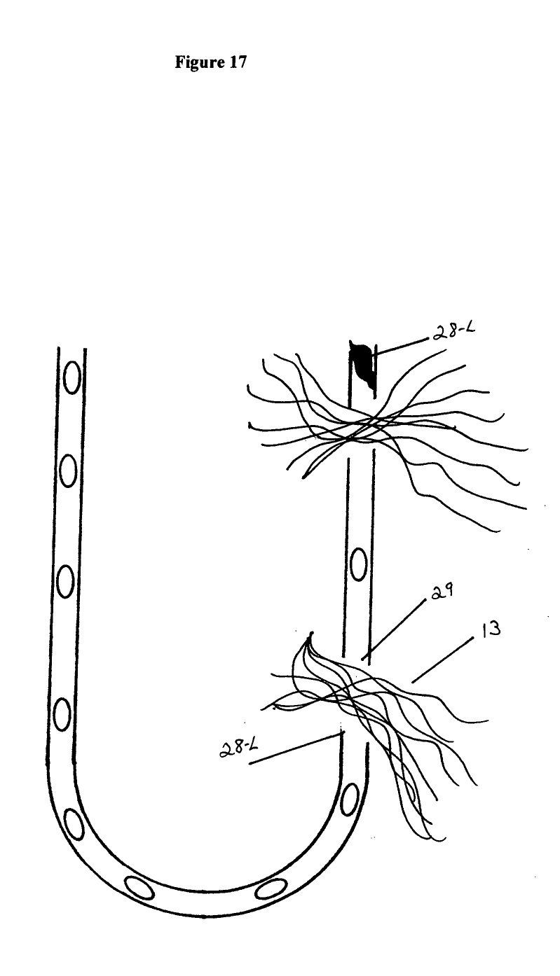

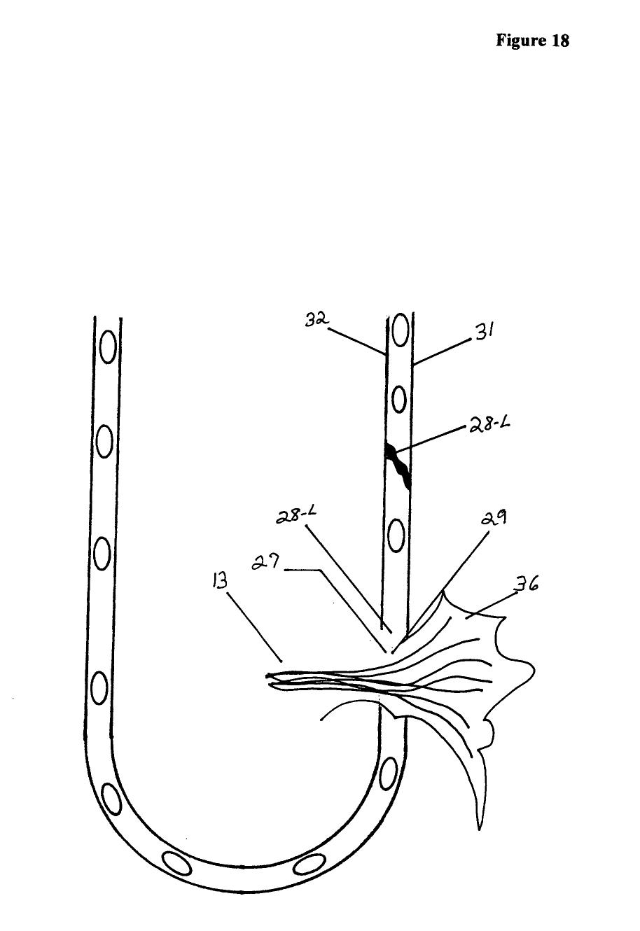

FIG. 17 is a partial cross-sectional view of FIG. 15 and FIG. 16, where two of the low (vacuum) that have been breached and formed a channel between the exterior and interior of the thin-walled capsule.

FIG. 18 is a partial cross-sectional view of FIGS. 10 and 11.

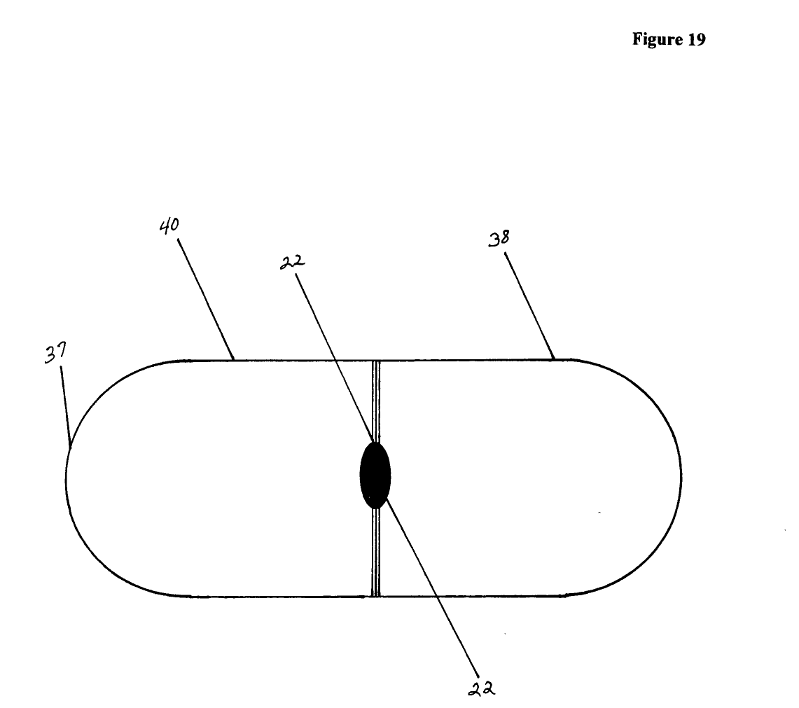

FIG. 19 is a lateral view of a Two-stage pop-up thin-walled fire suppressant capsule that can be thrown, projected or dropped into a fire zone.

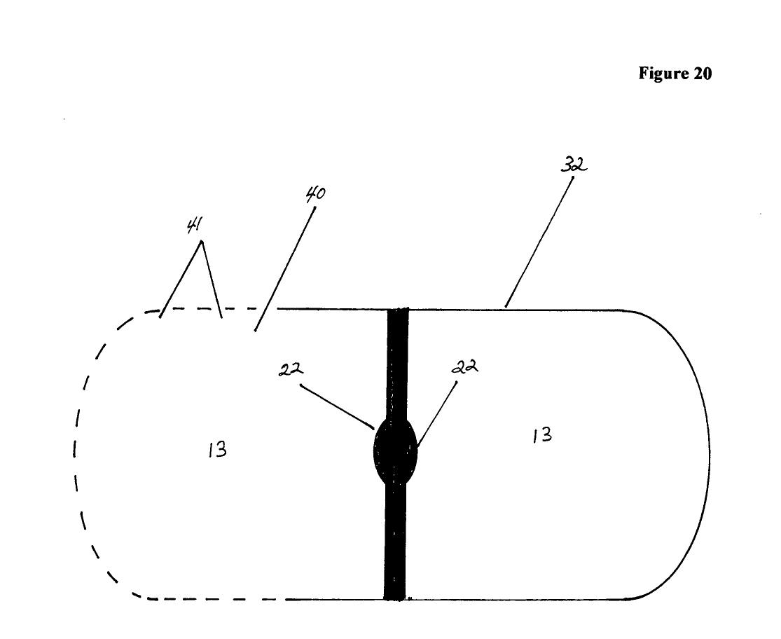

FIG. 20 is lateral view of a Two-stage pop-up thin-walled fire suppressant capsule where the wall of Stage-one has disintegrated and discharged its fire suppressant load.

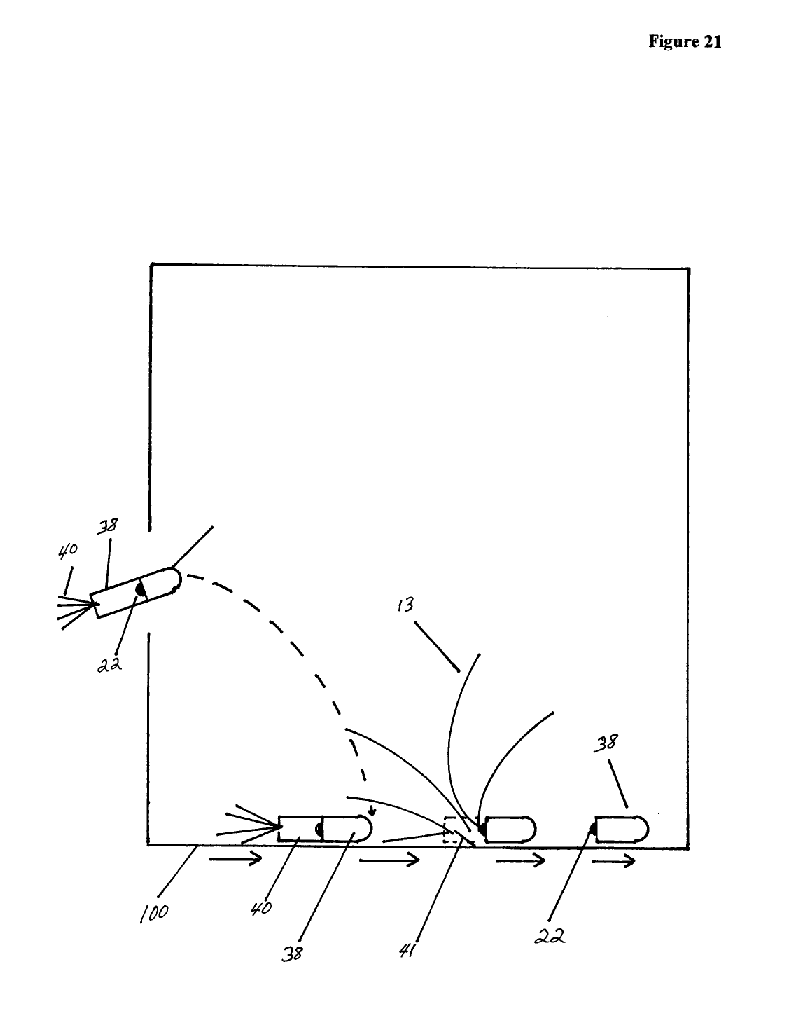

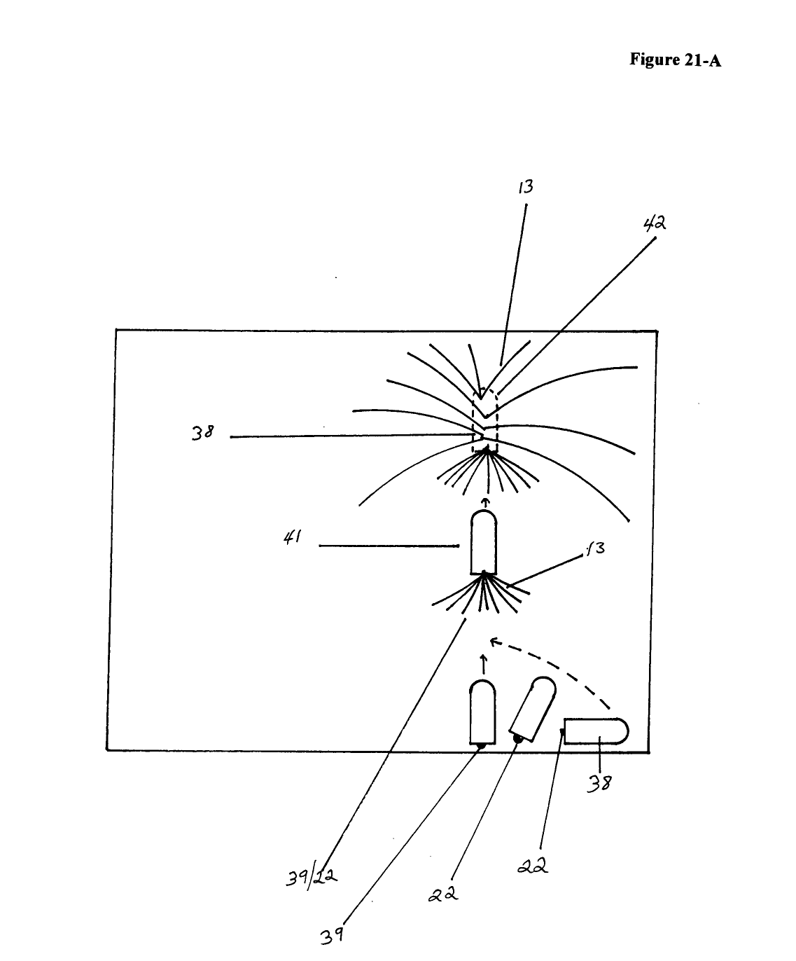

FIG. 21 illustrates a Two-stage pop-up thin-walled fire suppressant capsule landing within a structural fire zone, where Stage-one disintegrates, discharges its fire suppressant load.

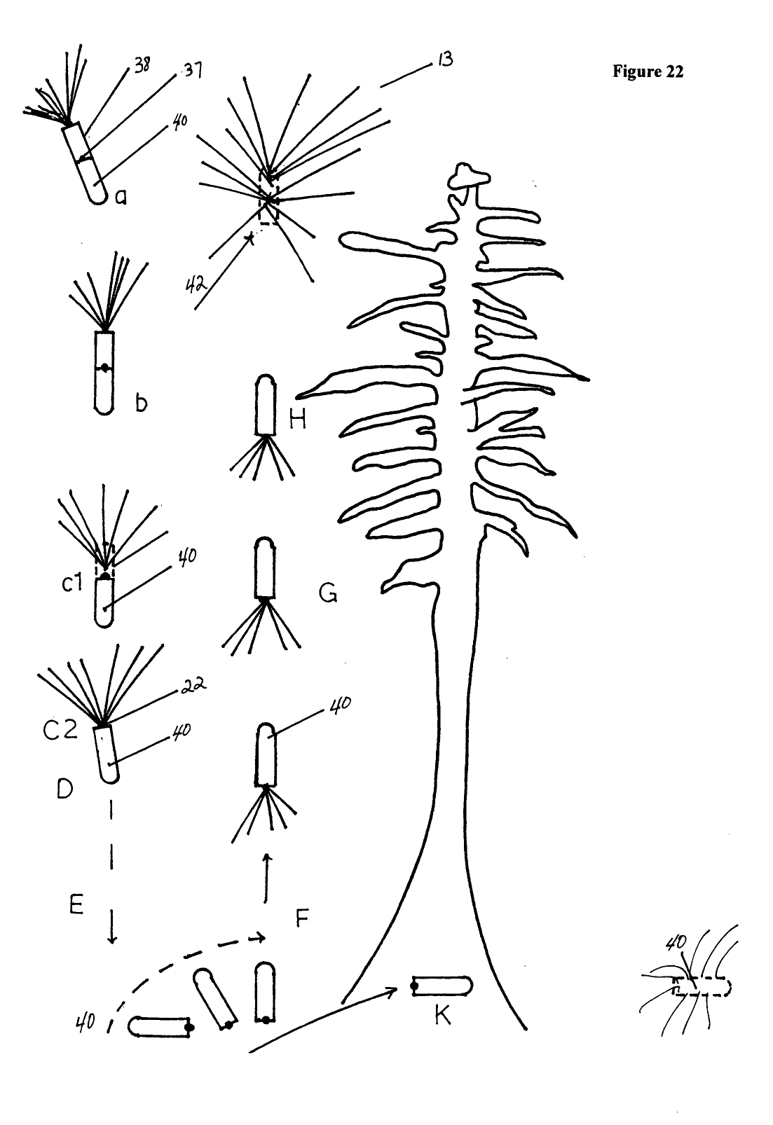

FIG. 22 illustrates a Two-stage pop-up thin-walled fire suppressant capsule projected or (aerial) dropped into a forest fire zone.

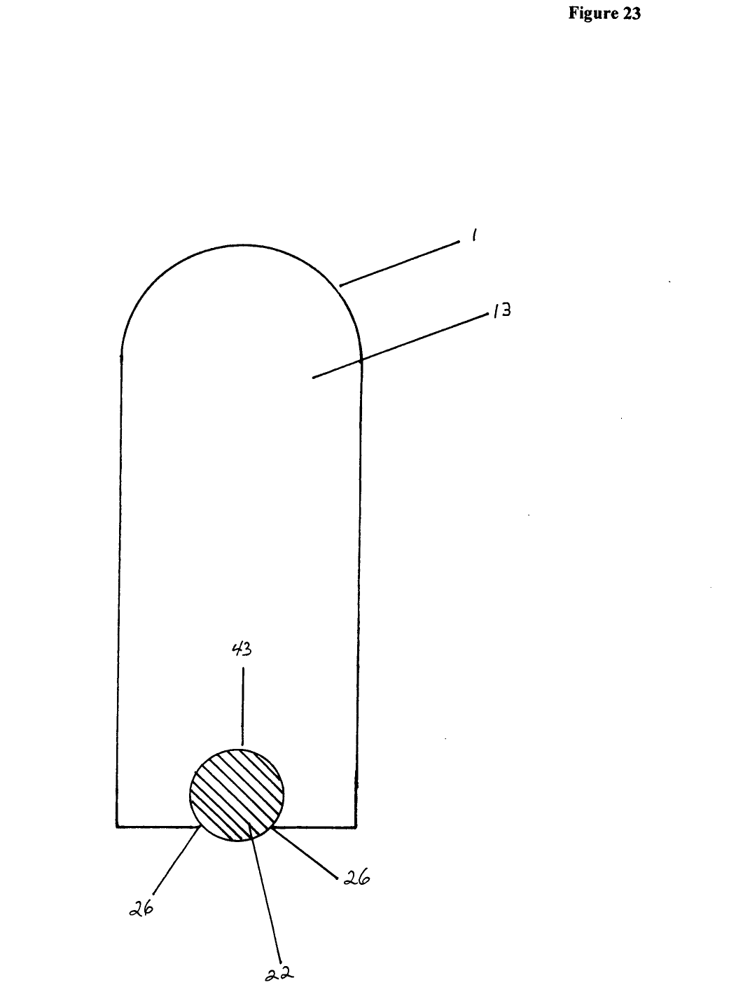

FIG. 23 illustrates a thin-walled fire suppressant capsule containing an internal flush mount soft-spot propellant core at its base.

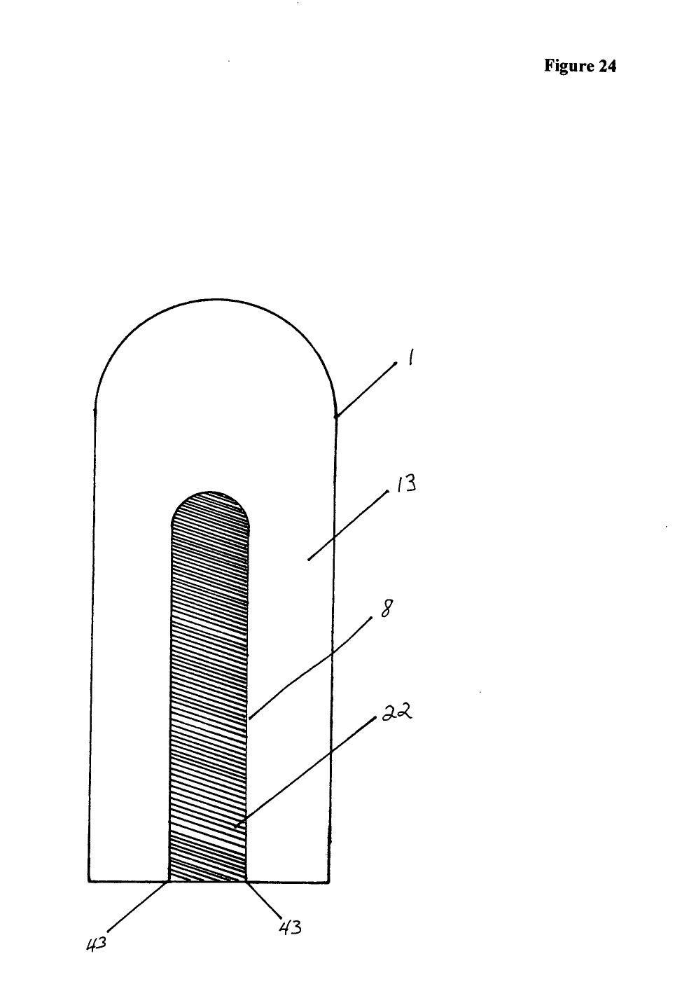

FIG. 24 illustrates a thin-walled fire suppressant capsule containing a central propellant core, where the base of the core is flush with the capsule's base.

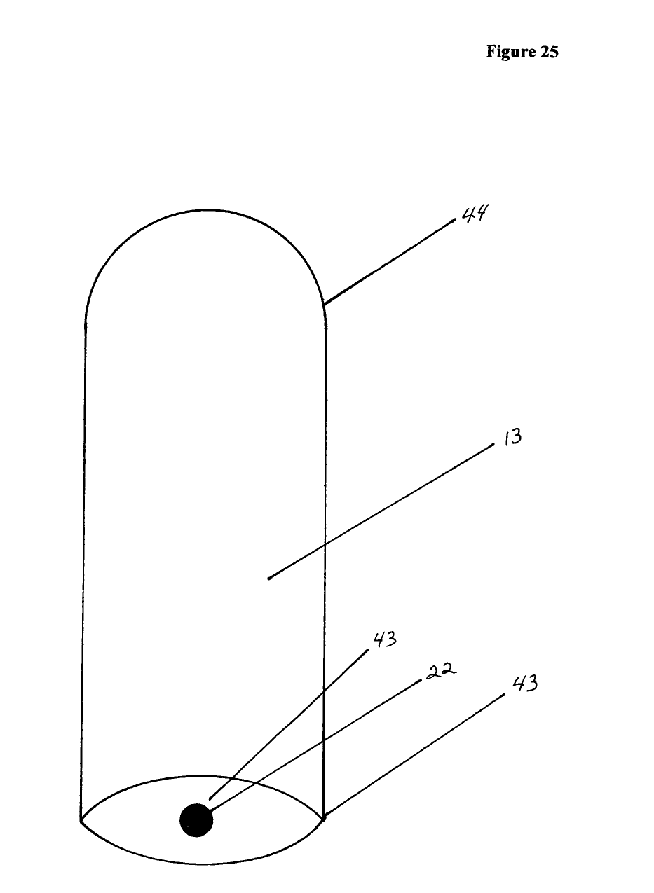

FIG. 25 is a partial, three dimension view of a flush mount soft-spot propellant core, of a Single-stage pop-up fire suppressant capsule.

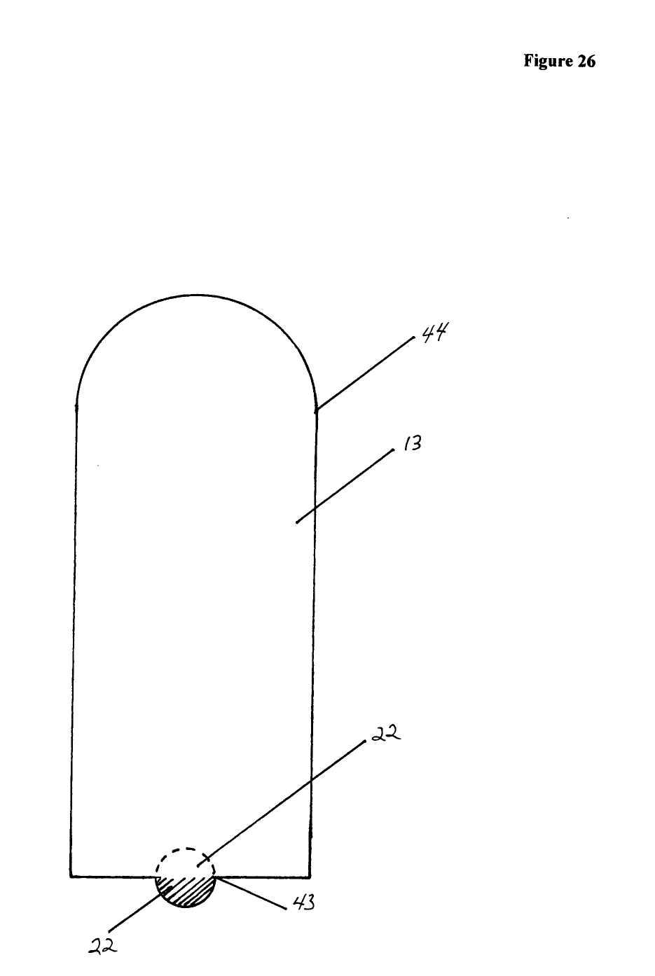

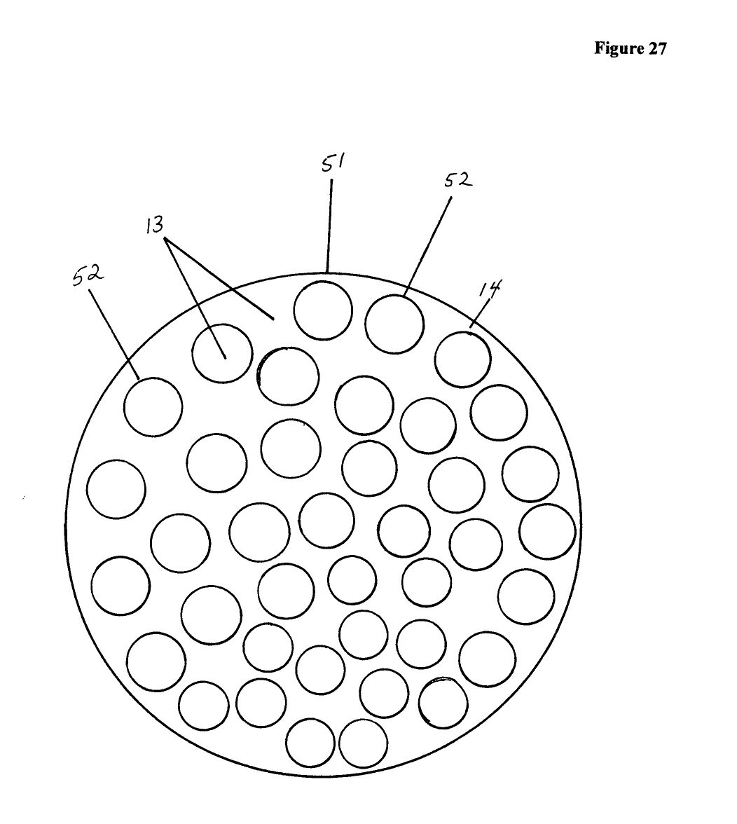

FIG. 26 is a partial cross-section view of a protruding soft-spot propellant core, of a Single-stage pop-up fire suppressant capsule.

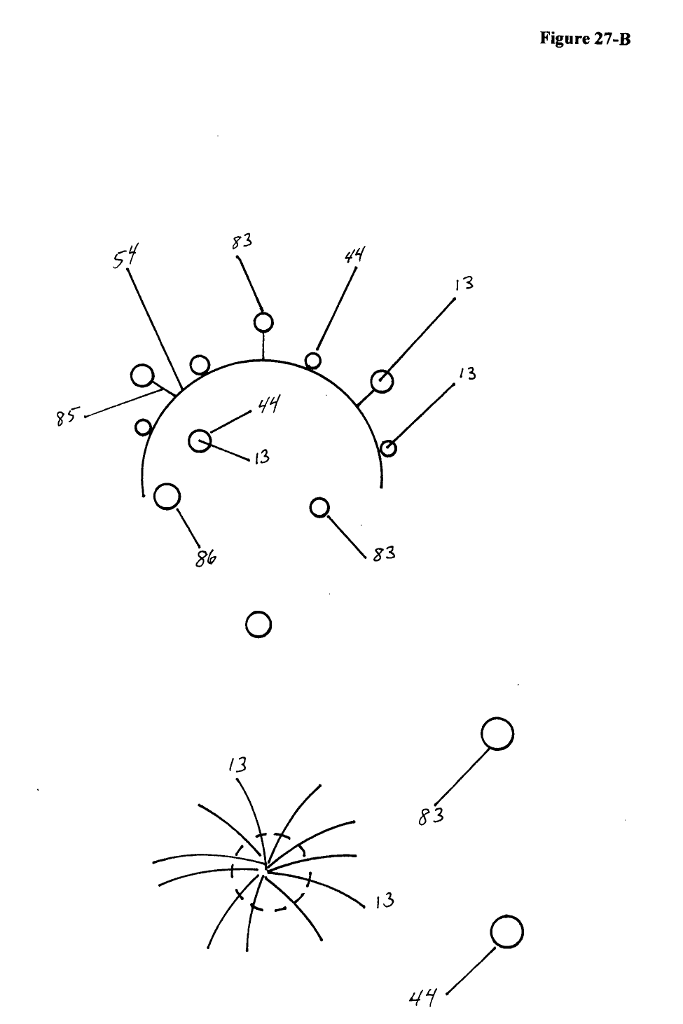

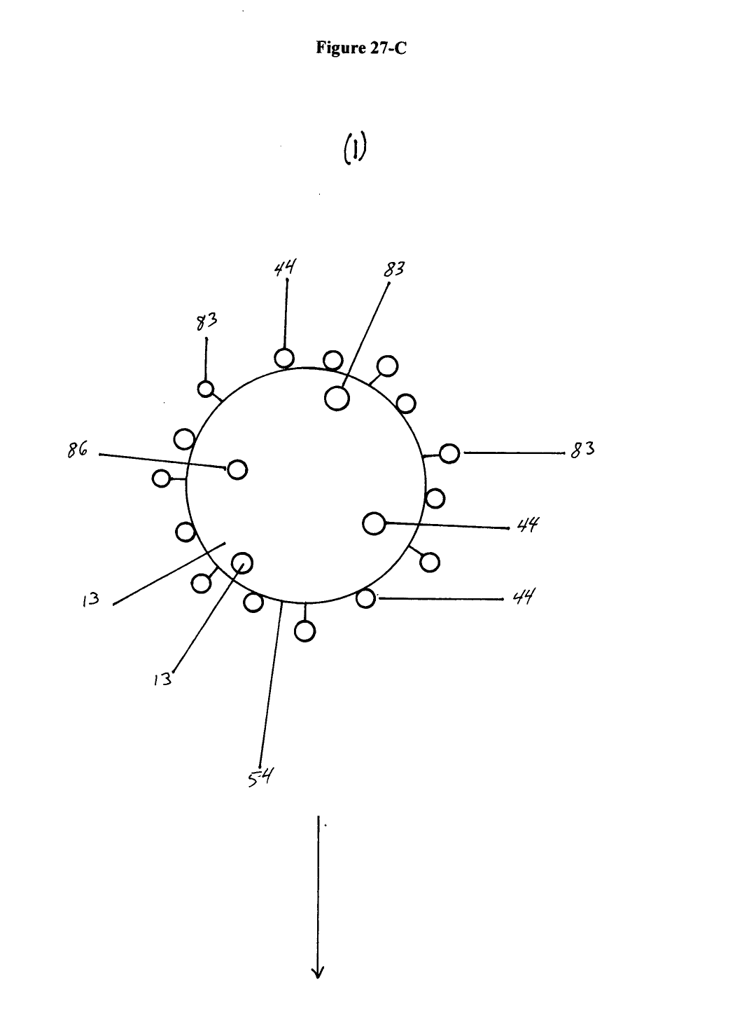

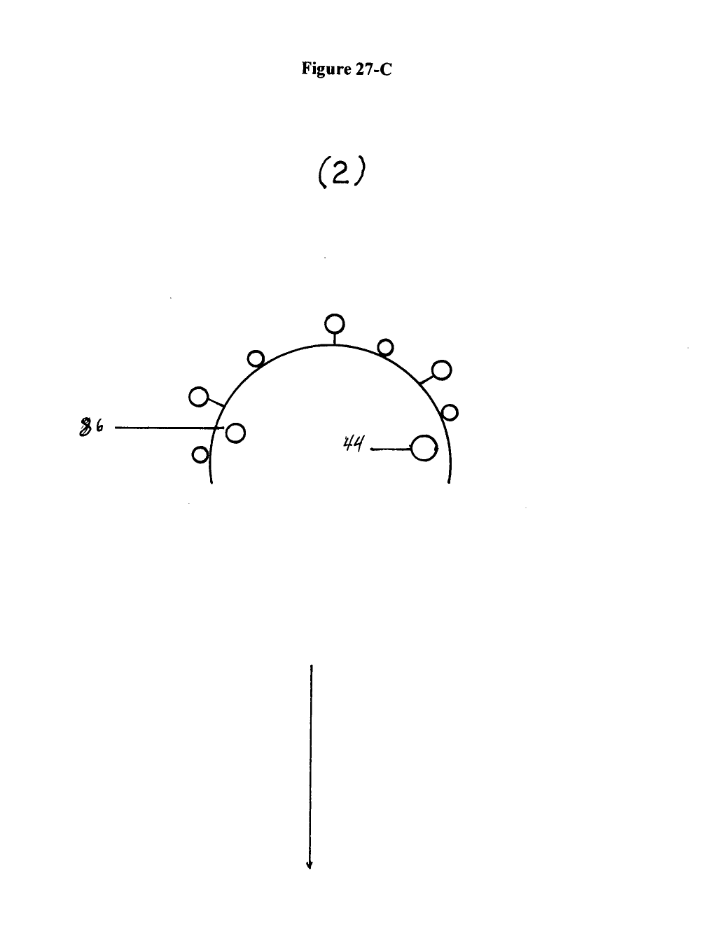

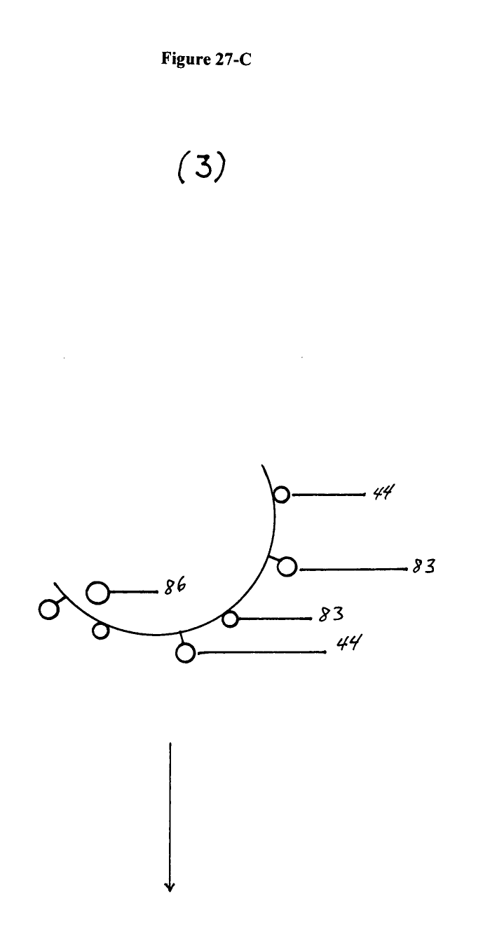

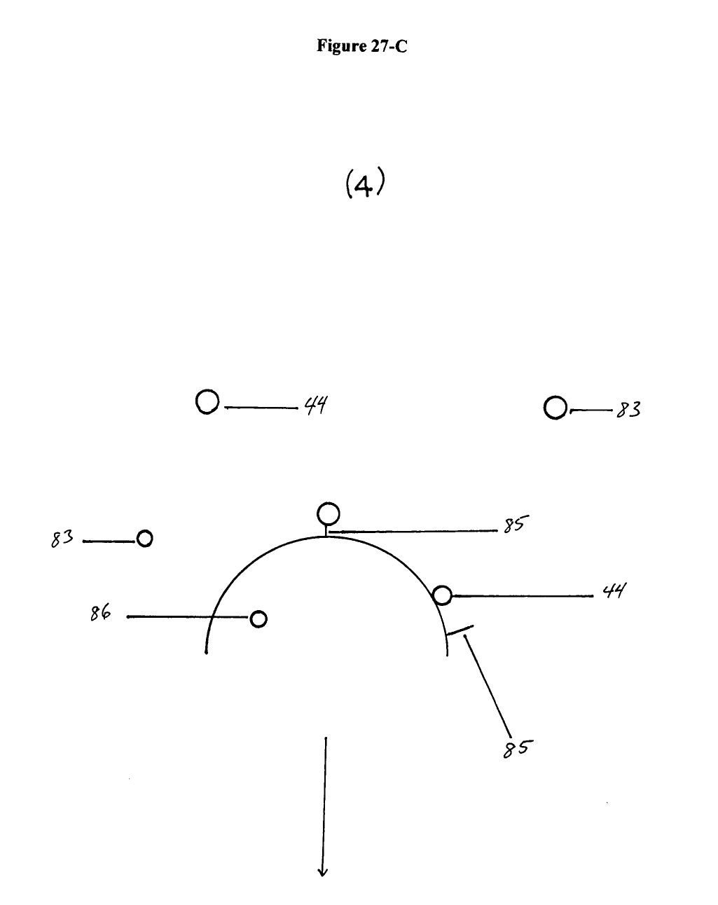

FIG. 27 is the main concentric thin-walled fire suppressant capsule—the general spherical Primary Concentric Capsule—containing its own high pressure fire suppressant load and multiple Secondary fire suppressant Capsules.

FIG. 27-A is a main concentric thin-walled fire suppressant capsule the primary housing additional shells attached to its external surface. The primary shell and secondary shells contain their own fire suppressant load.

FIG. 27-B The primary shell is developed and programmed to discharge the secondary shells attached to its surface, or to release the secondary shells for subsequent discharge, prior to, or simultaneous to the primary shell discharging its own fire suppressant contents.

Alternatively, developing the surface attached shells with a propellant, the shells can be projected out from and away from the primary shell for subsequent discharge.

FIG. 27-C the primary shell houses its own fire suppressant material, with additional shells internally and attached to its external surface.

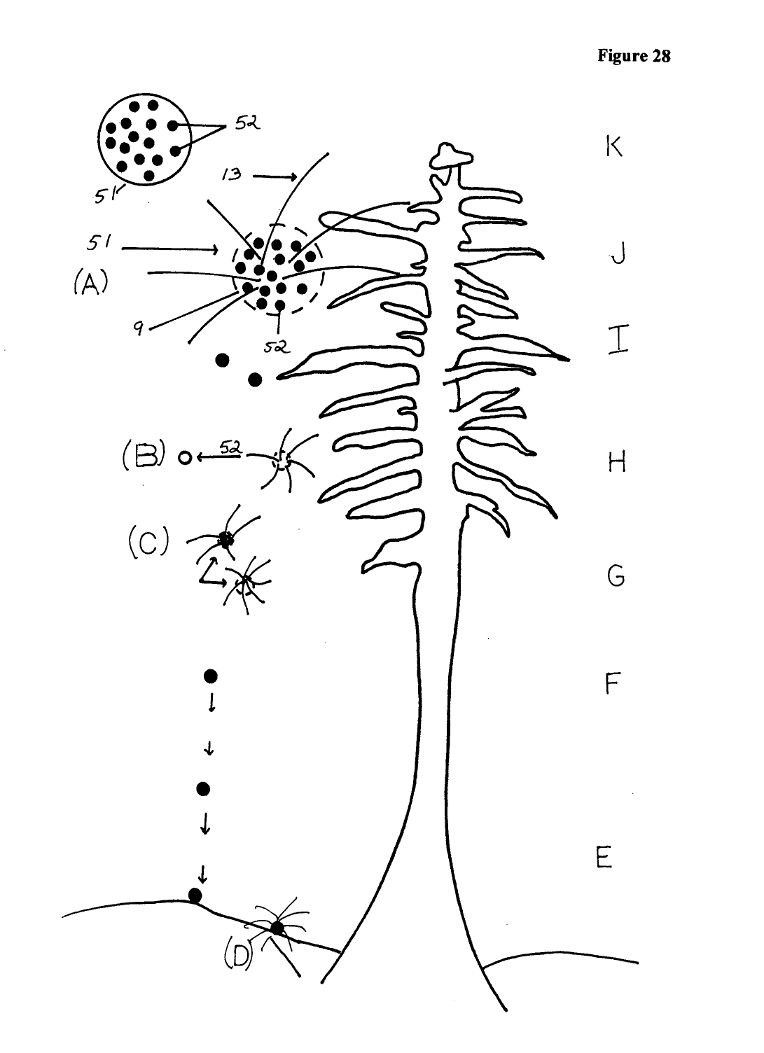

FIG. 28 illustrates the descent and dispersal pattern of the general spherical Primary Concentric Capsule and the Secondary fire suppressant Capsules, at FIG. 27.

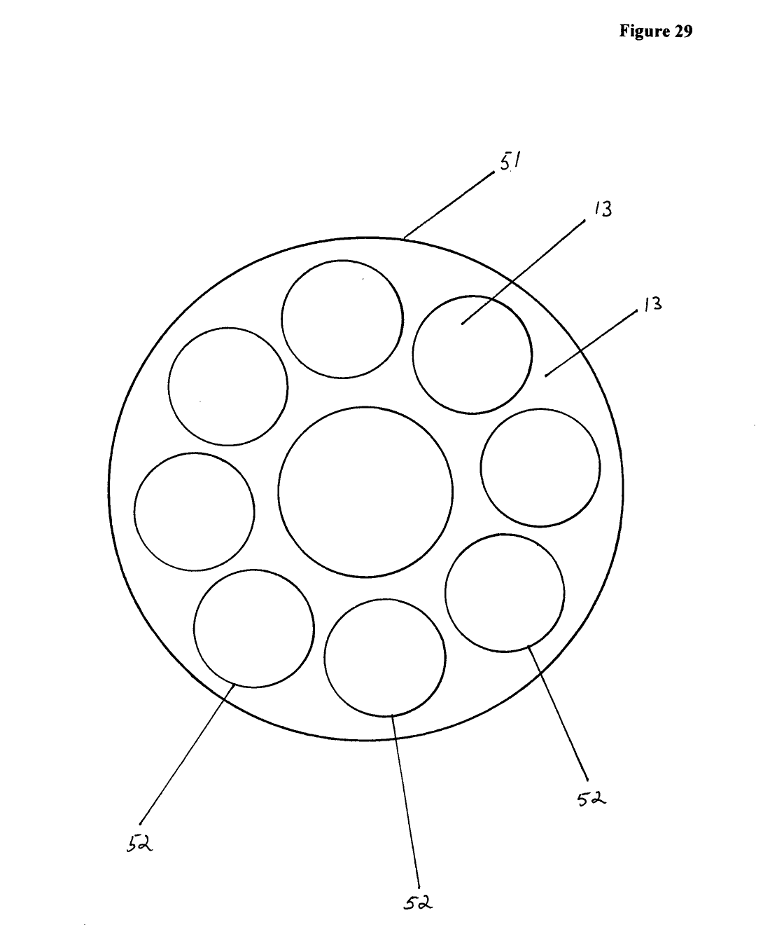

FIG. 29 is a second diagram of FIG. 28, containing larger Secondary concentric fire suppressant capsules.

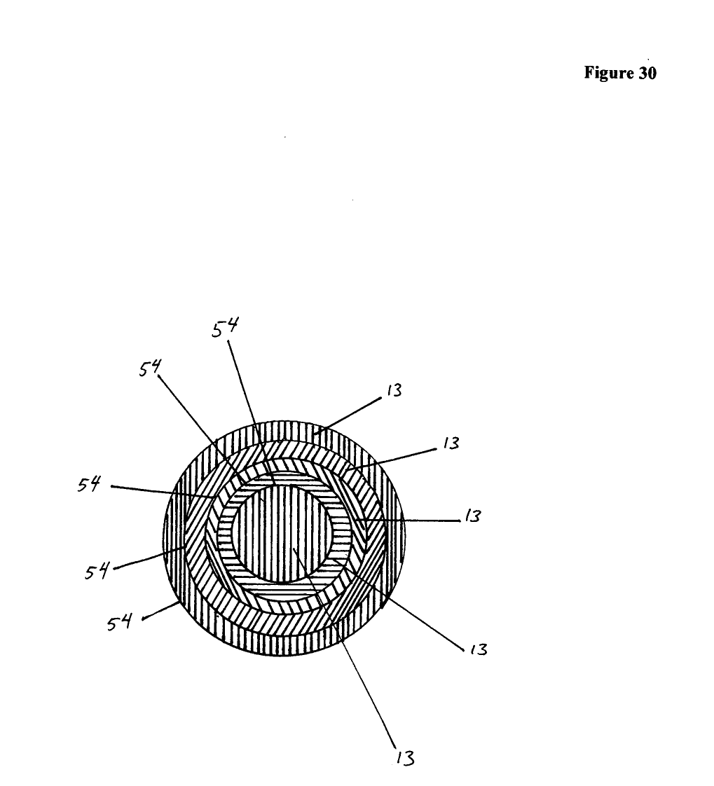

FIG. 30 is a concentric fire suppressant capsule with multiple secondary concentric high pressure fire suppressant capsules.

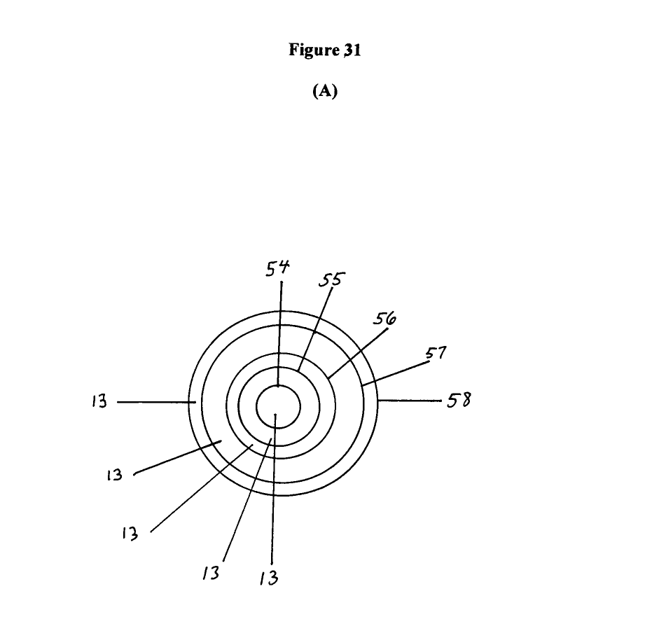

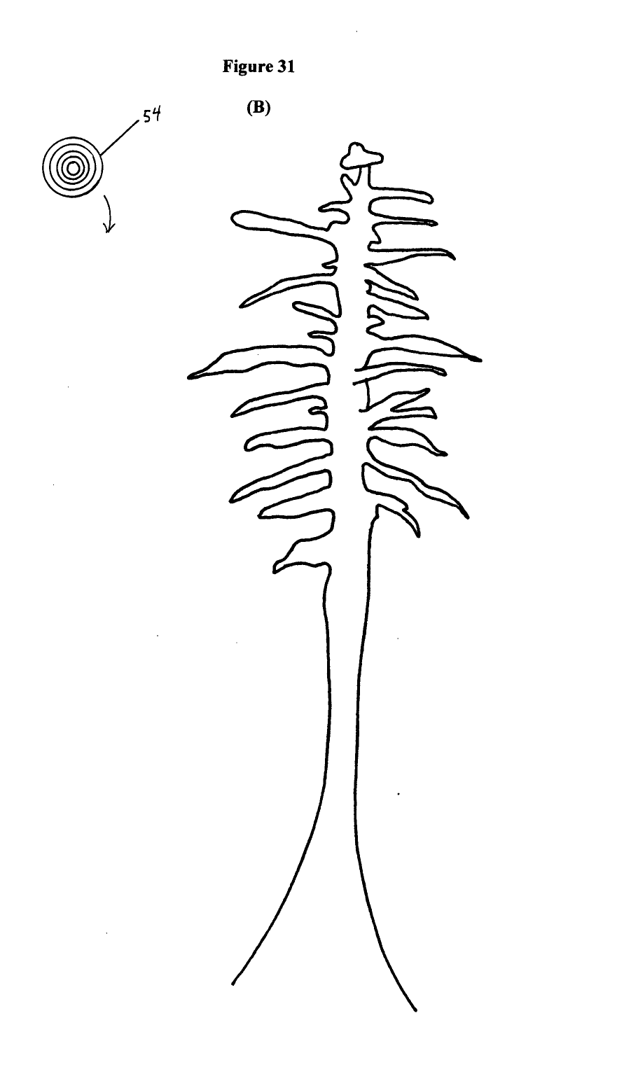

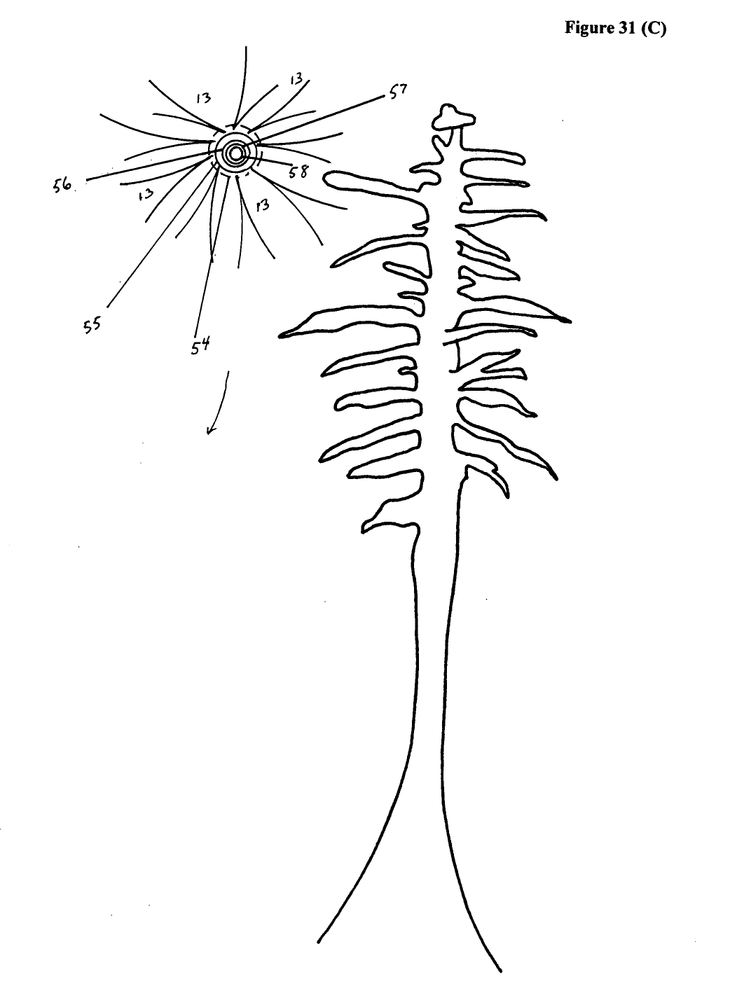

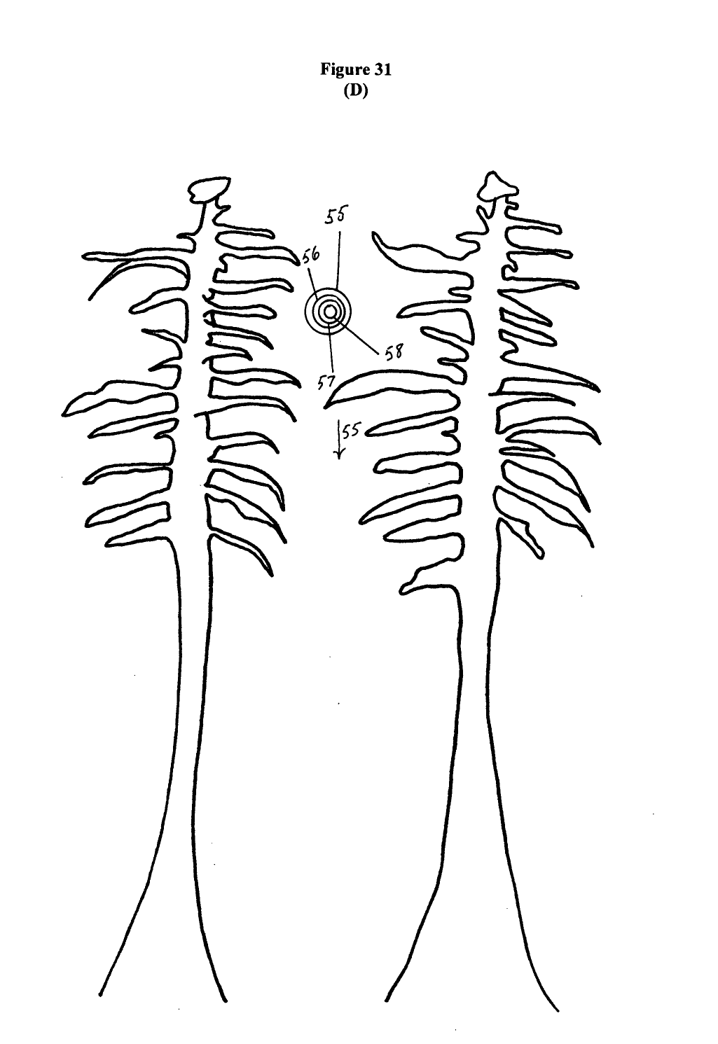

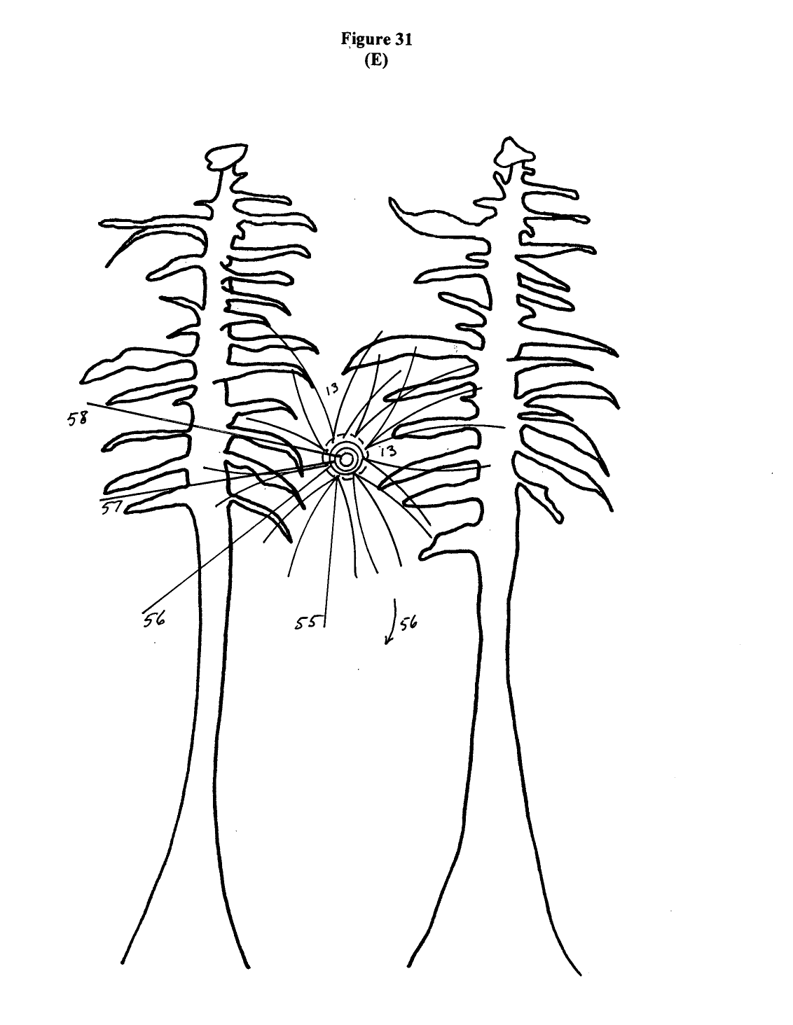

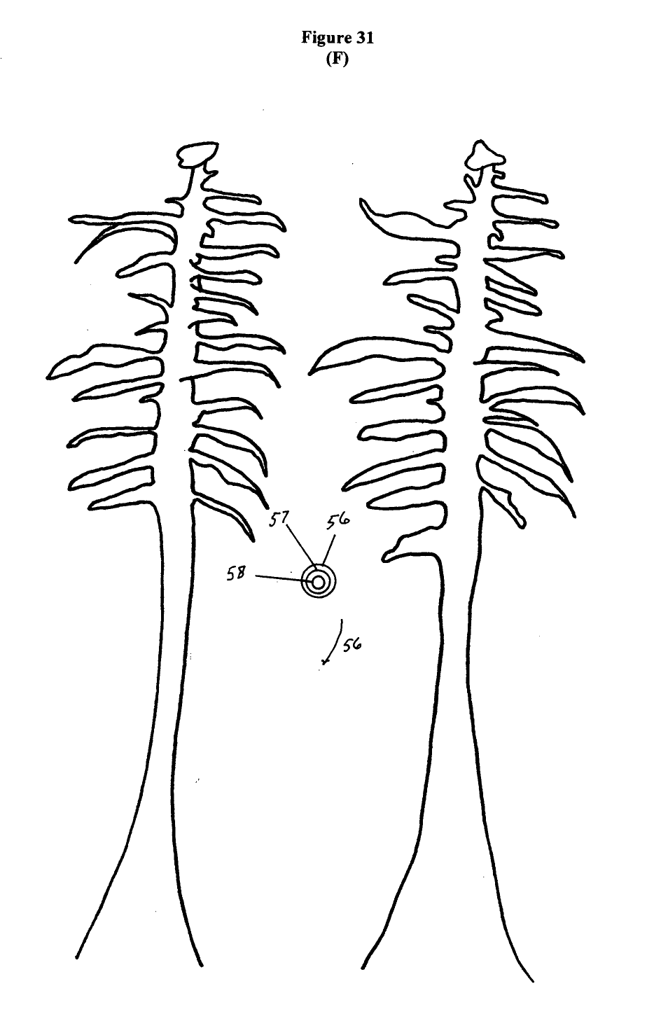

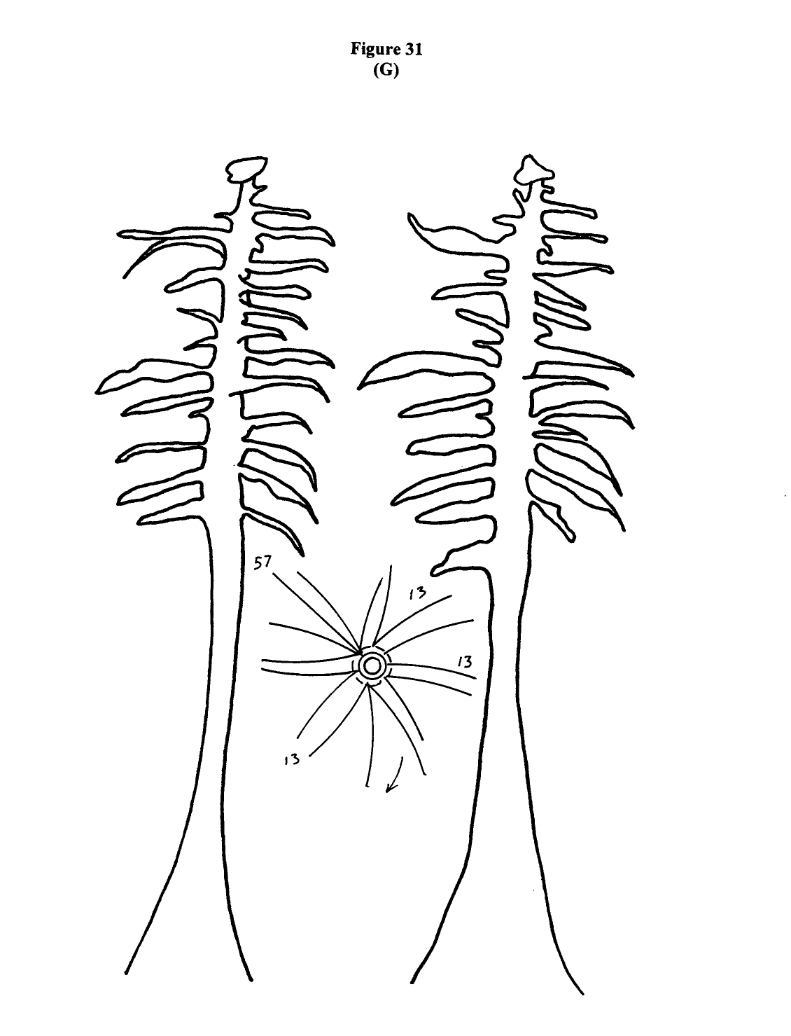

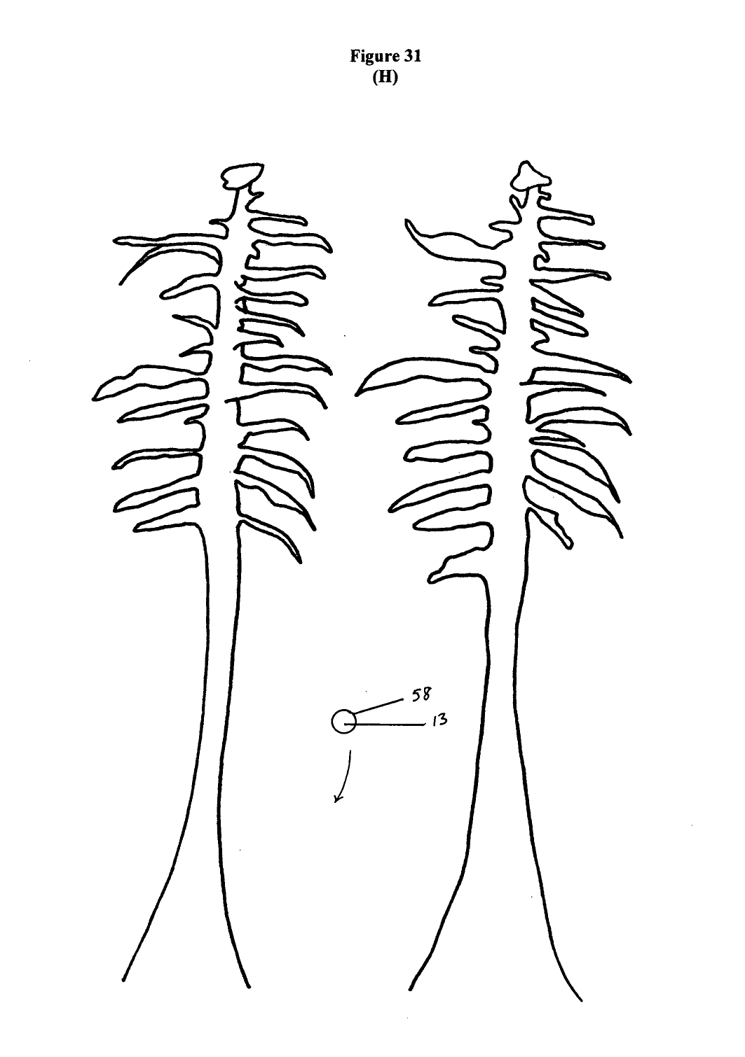

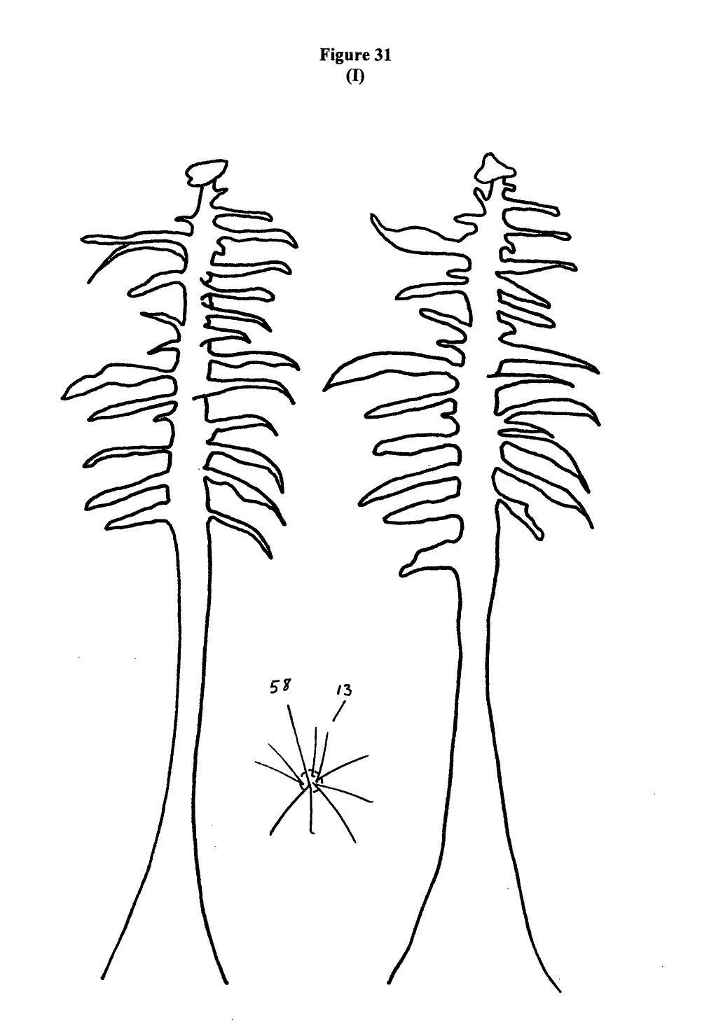

FIG. 31 is a schematic representation of the flow pattern when the Primary Concentric Capsule from FIG. 30 shatters, releasing its fire suppressant load and drops the next or second concentric capsule.

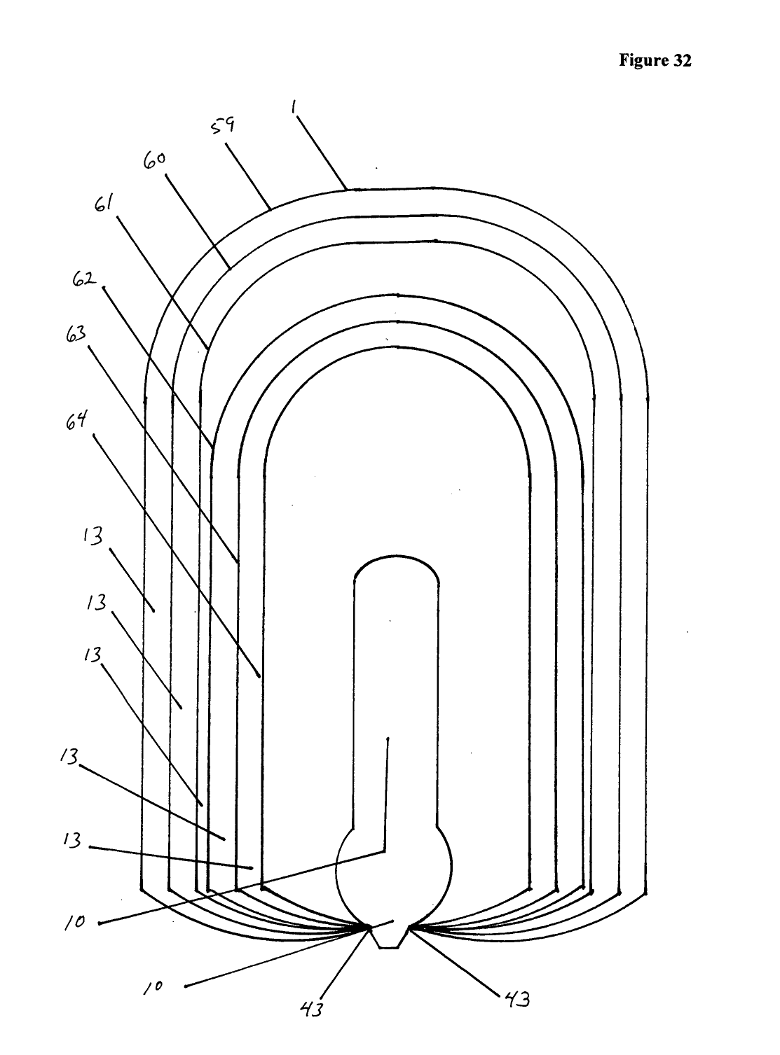

FIG. 32 diagrams a main concentric thin-walled fire suppressant capsule that is a general cylindrical Primary Cylindrical Concentric Pop-up Capsule—containing its own high pressure fire suppressant load and multiple Secondary Cylindrical fire suppressant capsules.

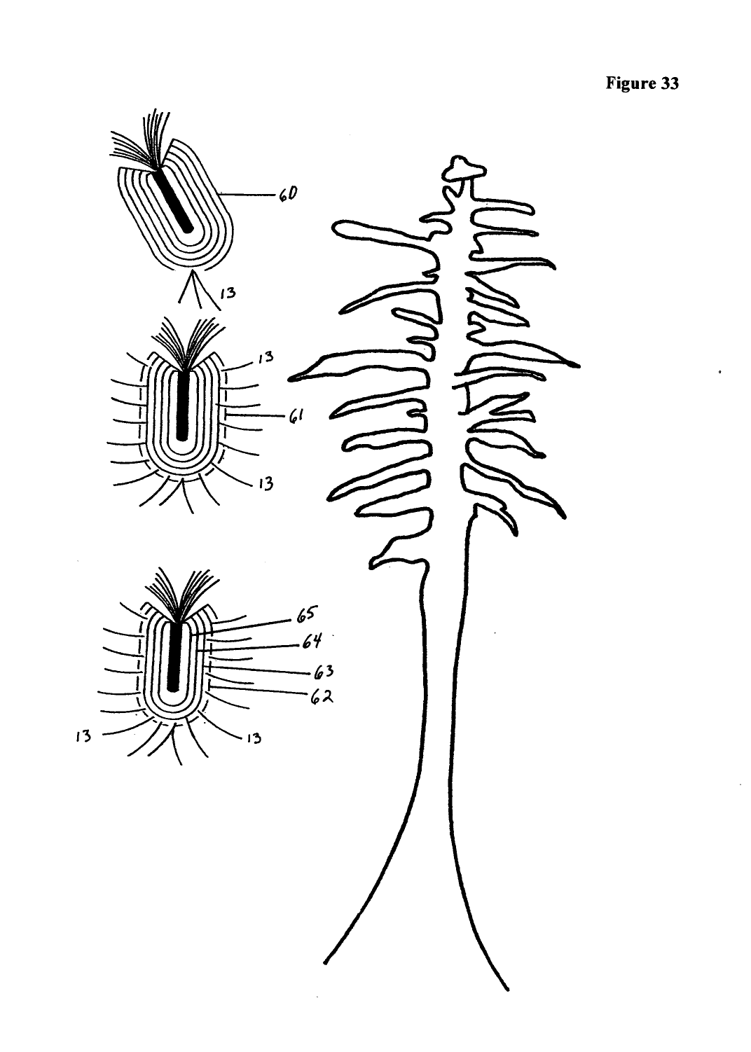

FIG. 33 is a schematic representation of the flow pattern issuing from FIG. 32 and discharge of each successive concentric fire suppressant capsule while descending into and through a fire zone.

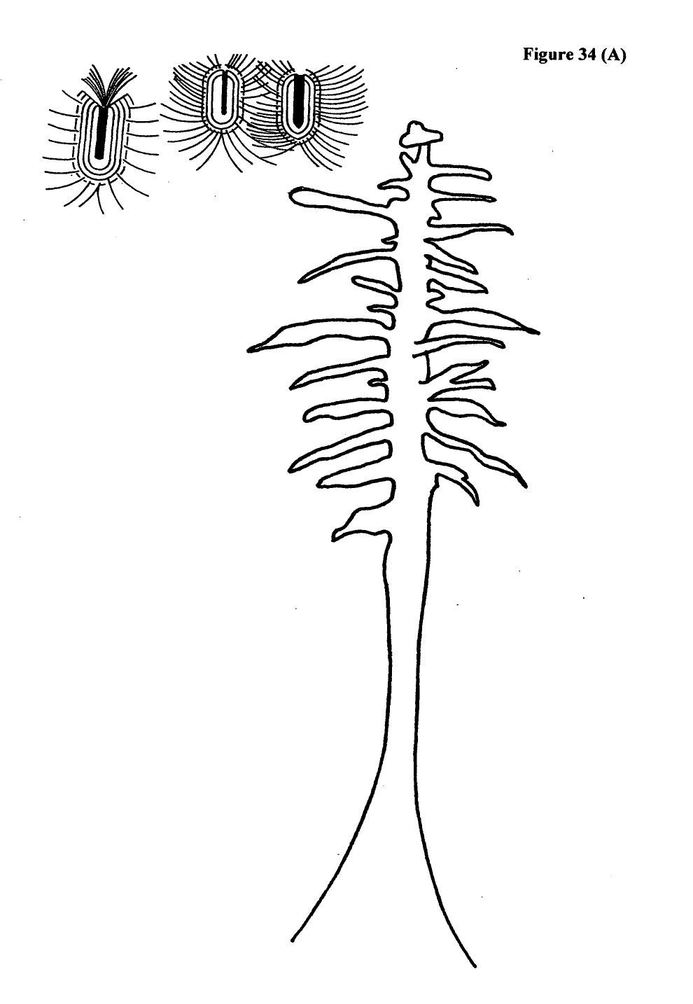

FIG. 34 is a second schematic representation of the flow pattern issuing from FIG. 32.

Point-a illustrates a field array of Primary Cylindrical Concentric Pop-up Capsules fired simultaneously or in close sequence, where the fire suppressant load released forms an overlapping canopy.

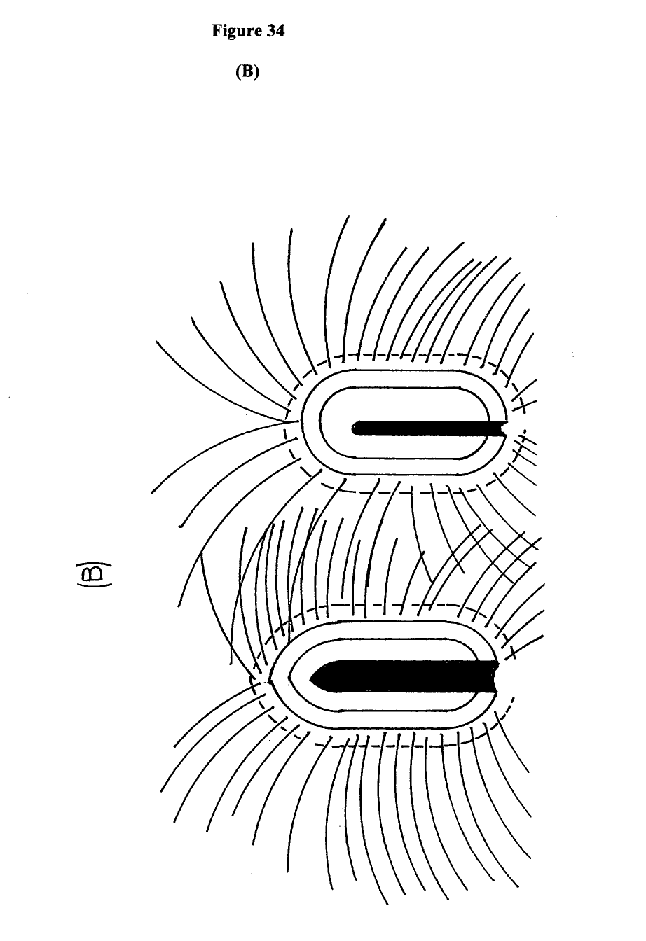

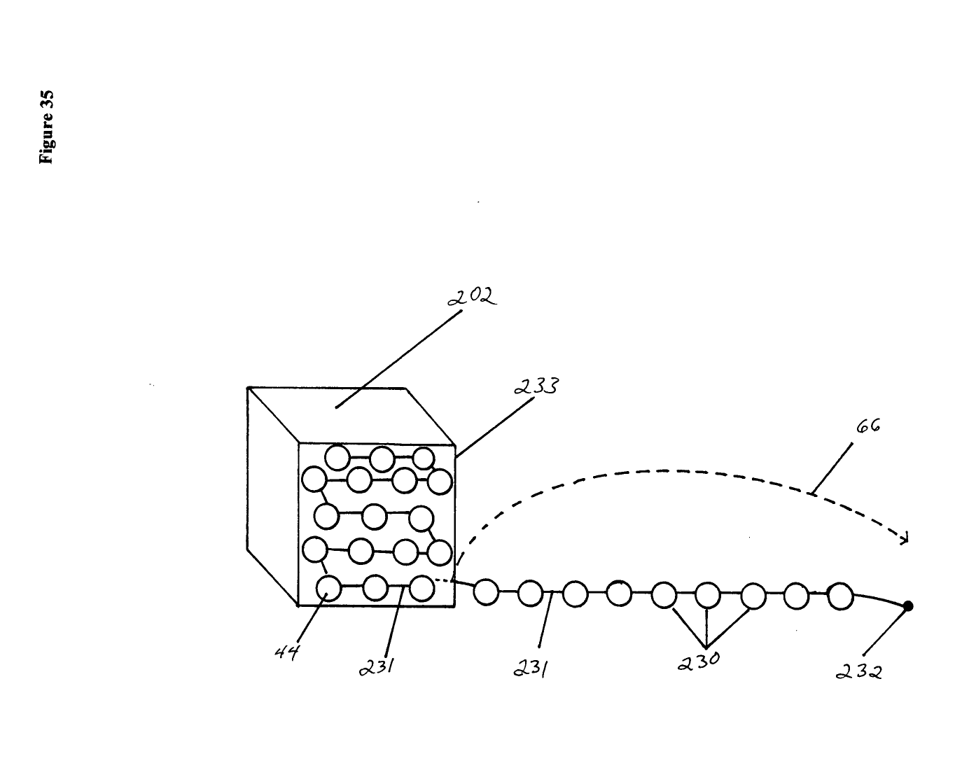

FIG. 35 represents a large square rectangular or box like canister containing multiple pop-up fire suppressant capsules.

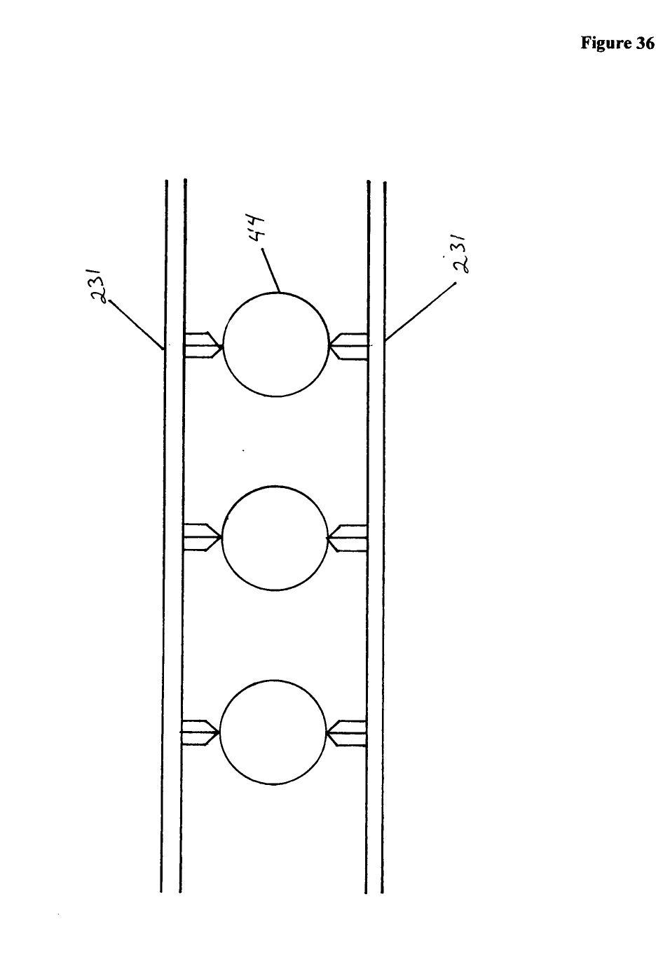

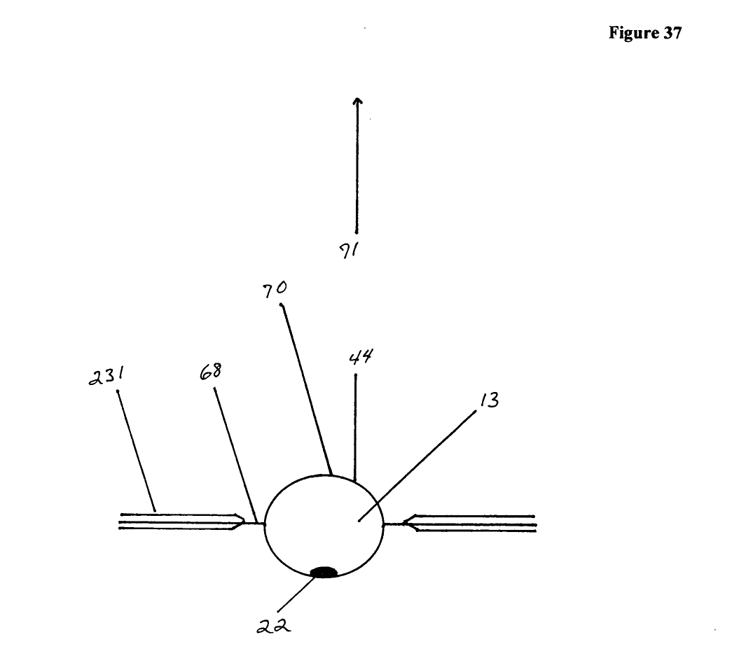

FIG. 36 is a horizontal view of multiple fire suppressant (pop-up) capsules attached to a double stranded ribbon. FIG. 37 is a lateral view diagram of an individual

Single-stage pop-up fire suppressant capsule on a ribbon from FIG. 35.

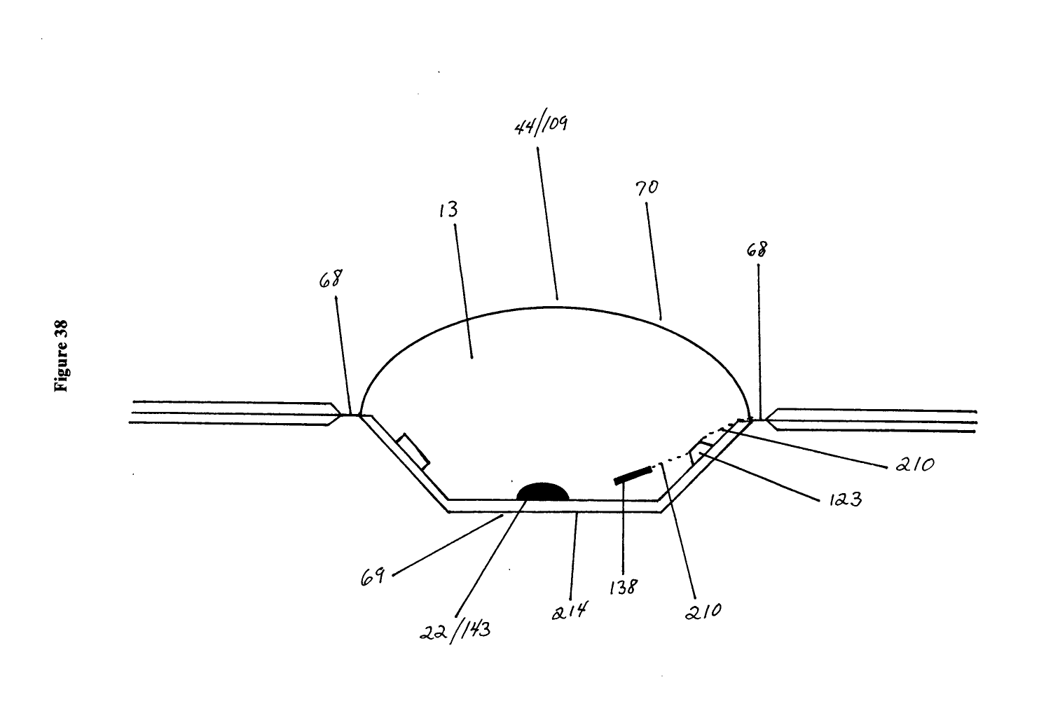

FIG. 38 is a lateral view of an alternate design of FIG. 7.

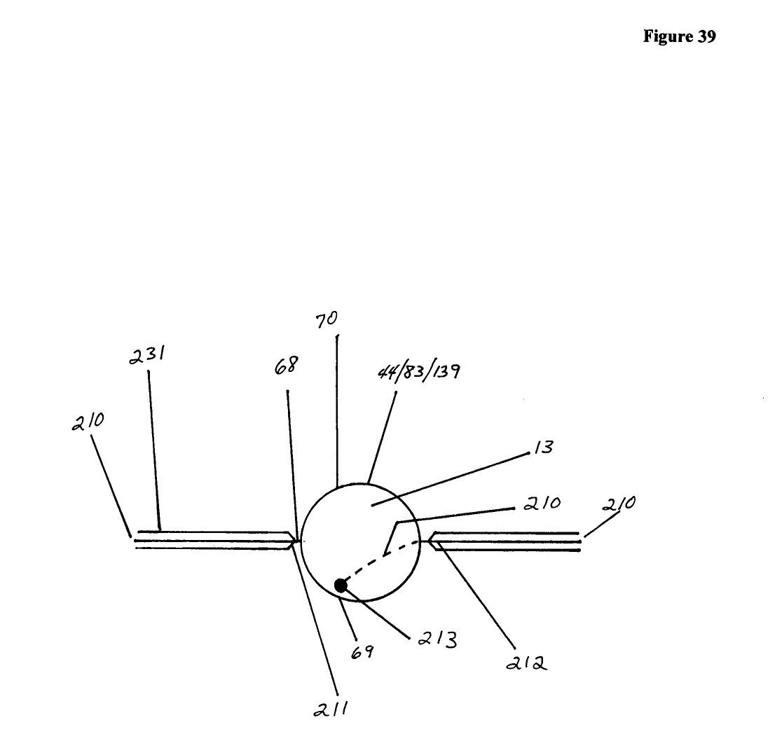

FIG. 39 is a lateral view of the Single-stage pop-up fire suppressant capsule, a Single-stage non pop-up fire suppressant capsule or a ground-based discharge capsule attached to a single ribbon.

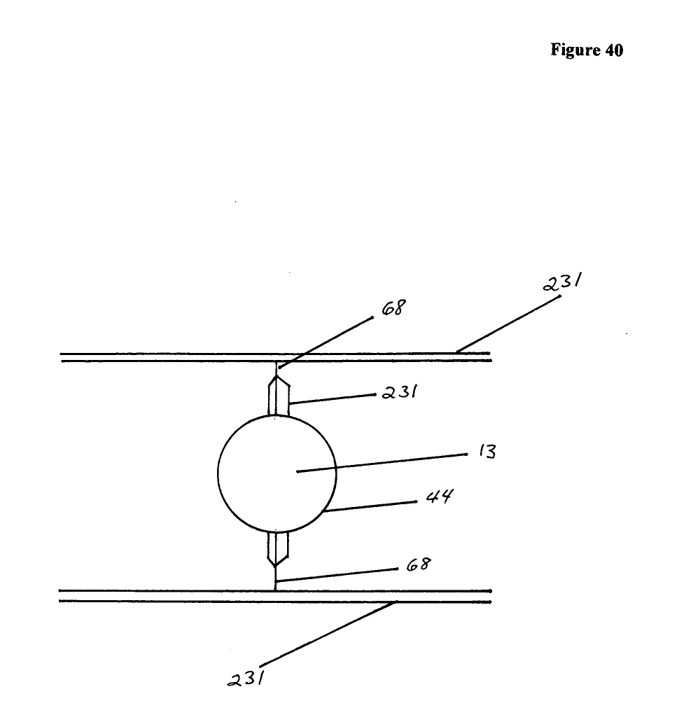

FIG. 40 is a second horizontal view of FIG. 36.

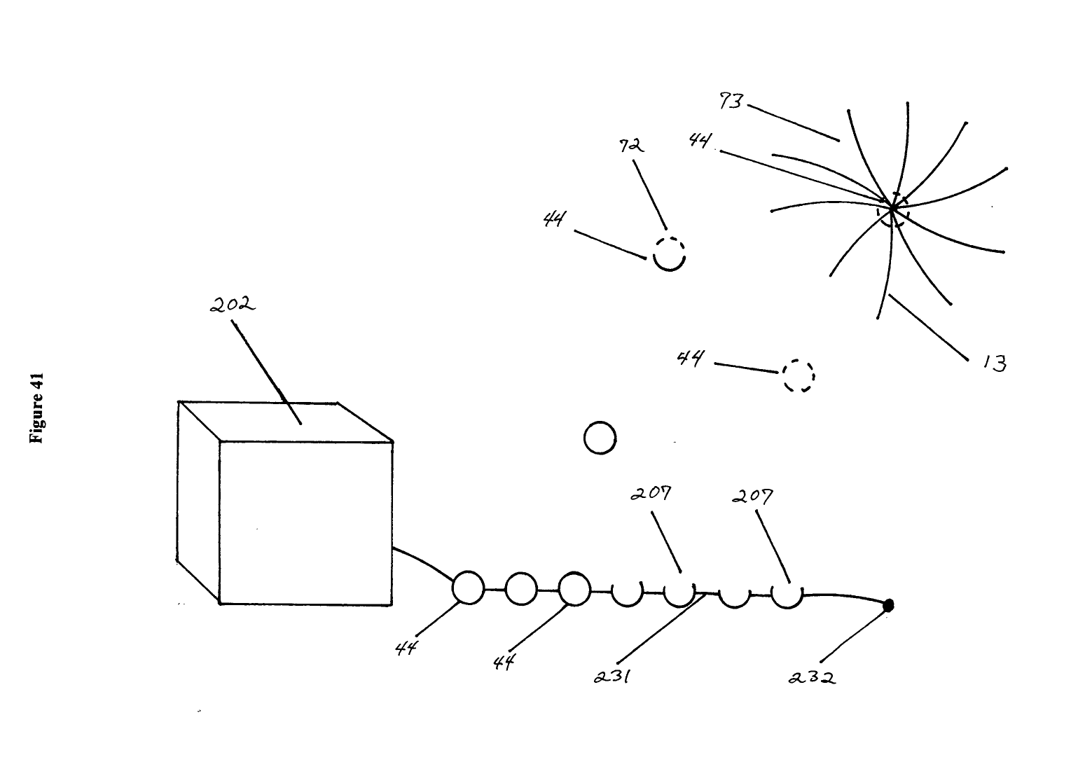

FIG. 41 is a schematic representation of the release pattern of the Single-stage pop-up fire suppressant capsule projected from the canister of FIG. 35.

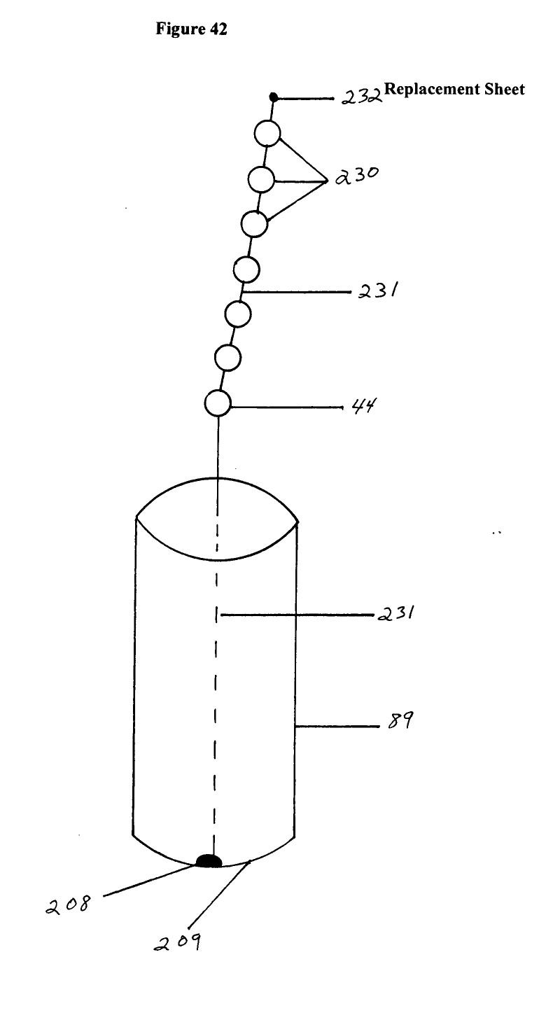

FIG. 42 represents a vertical canister containing multiple pop-up fire suppressant capsules attached consecutively to a ribbon.

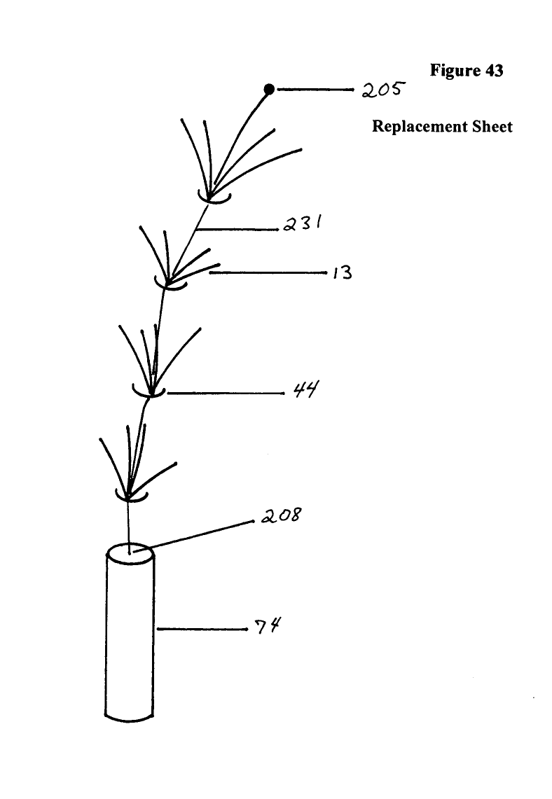

FIG. 43 represents the fire suppressant release pattern of pop-up fire suppressant capsules projected from the vertical canister of FIG. 42.

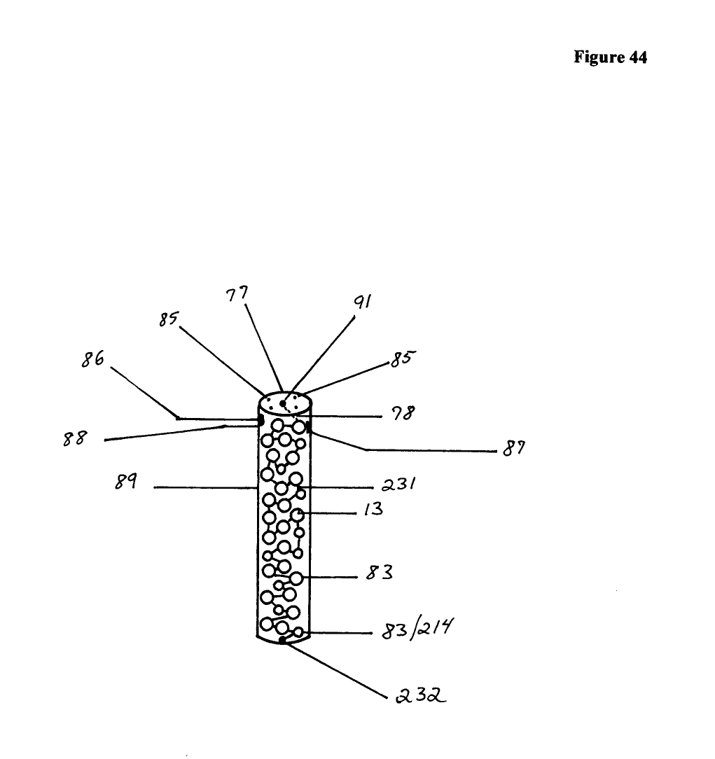

FIG. 44 illustrates the vertical canister used for aerial deployment with the intent that its ribbon and fire suppressant load will project well in advance of the canister striking the ground.

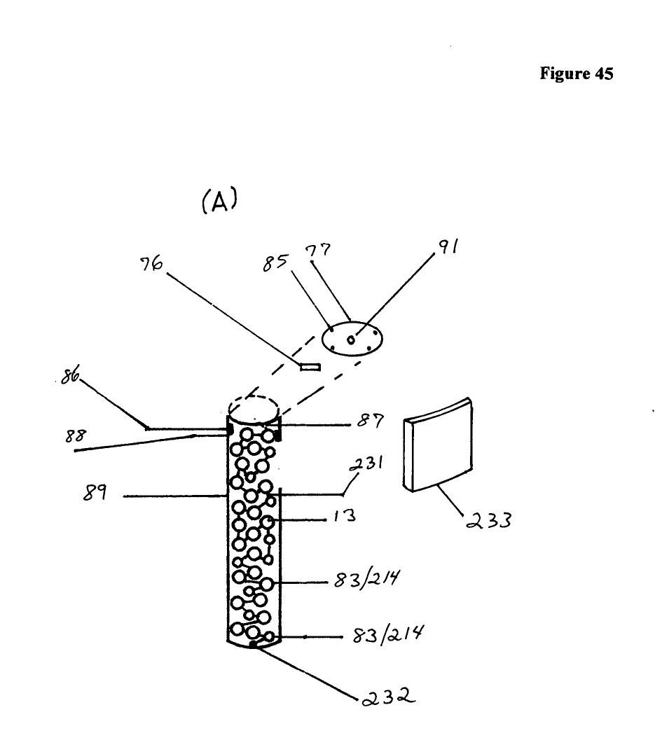

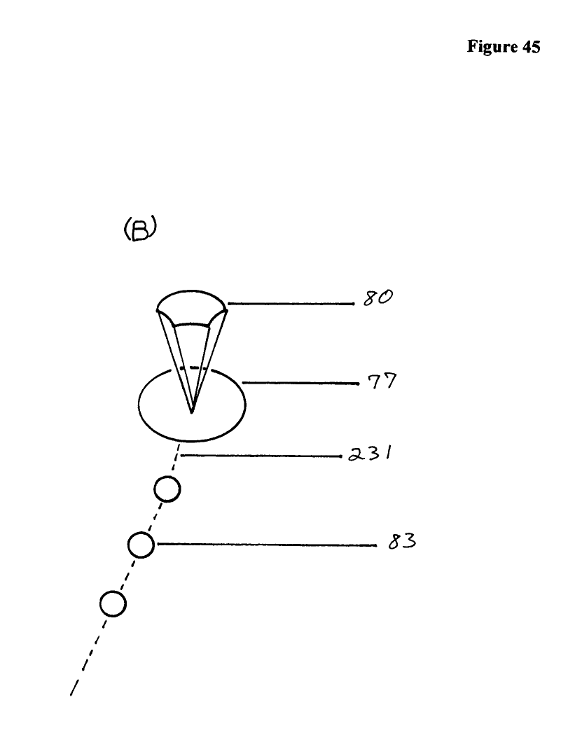

FIG. 45 is a partial exploded view of the vertical canister being aerially deployed.

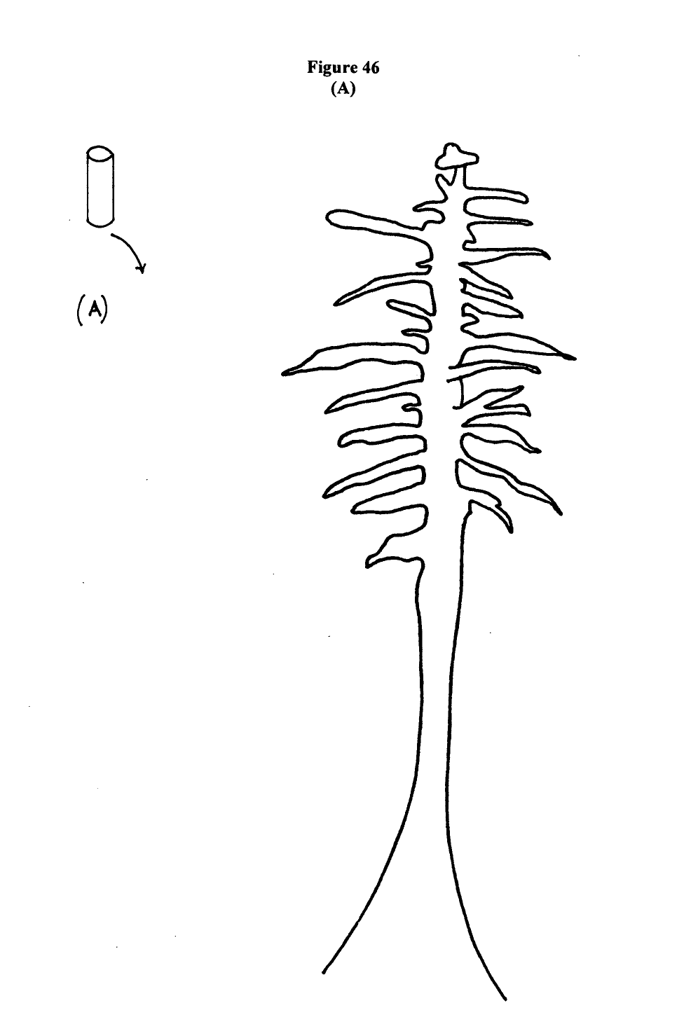

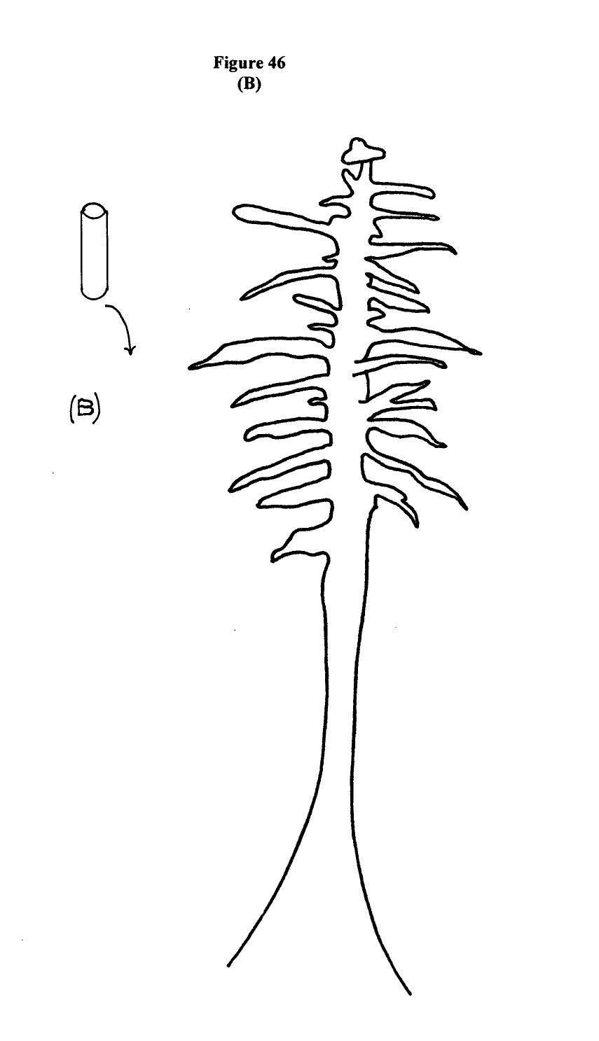

FIG. 46 is a schematic representation of the vertical canister with multiple Non Pop-up fire suppressant capsules during aerial deployment.

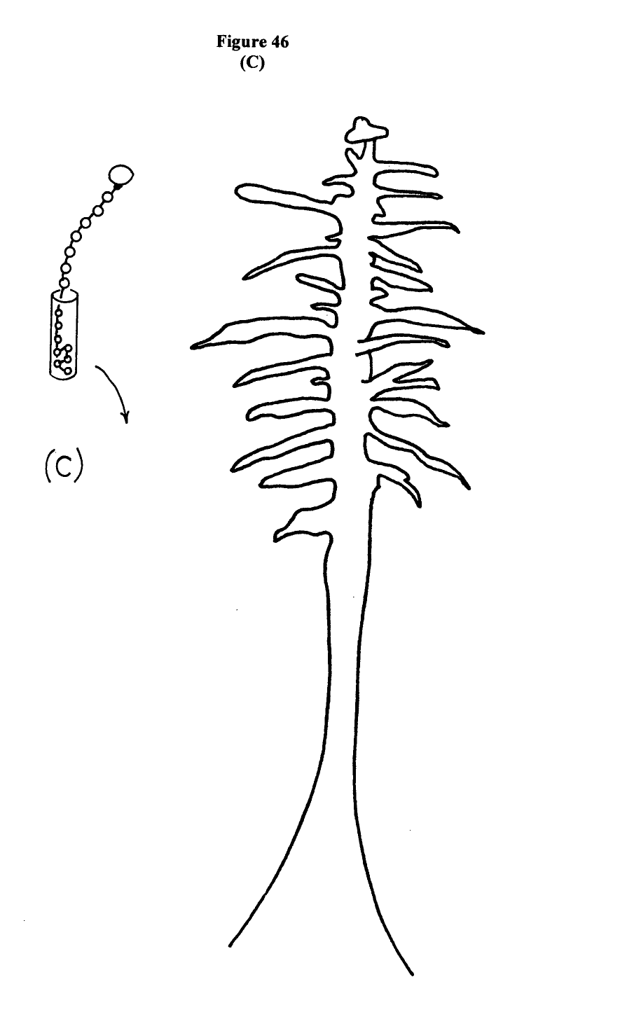

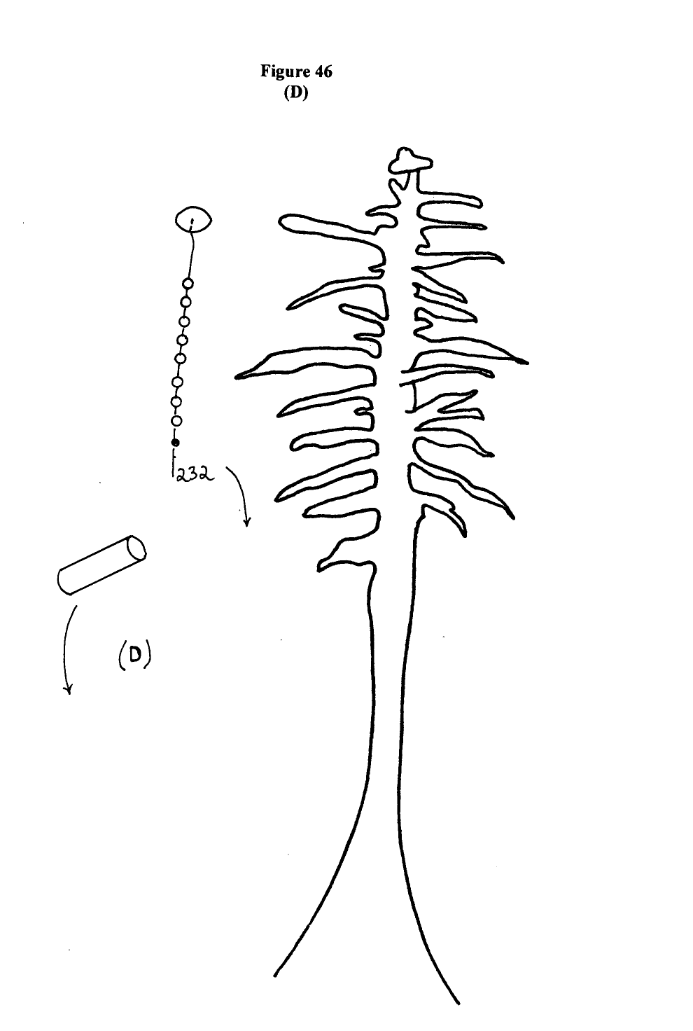

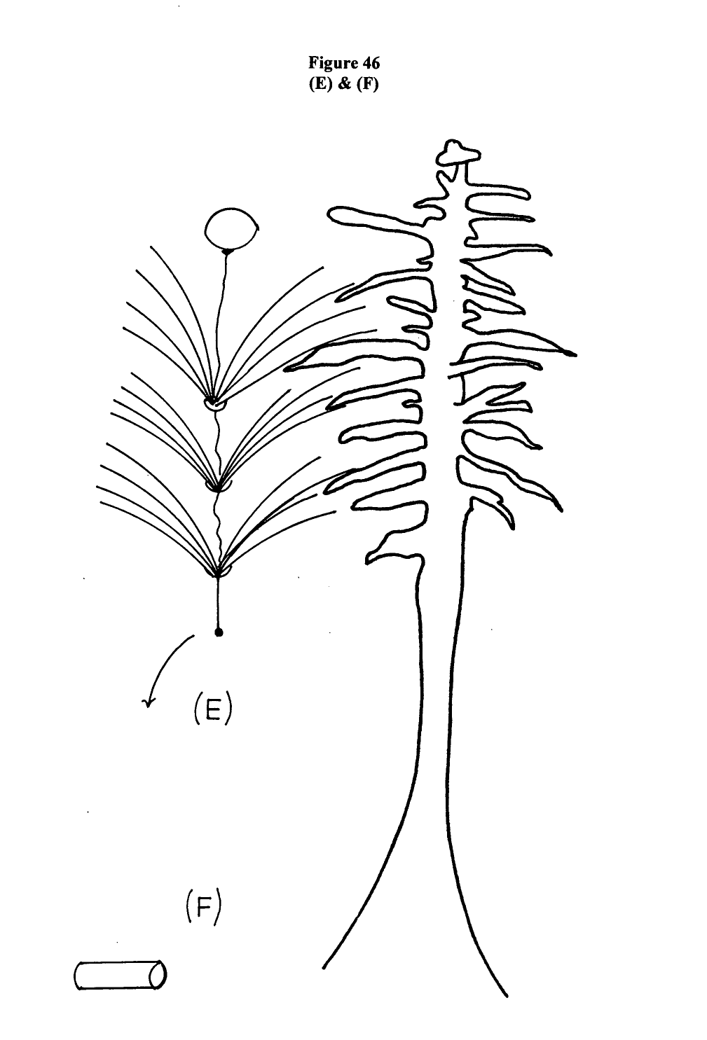

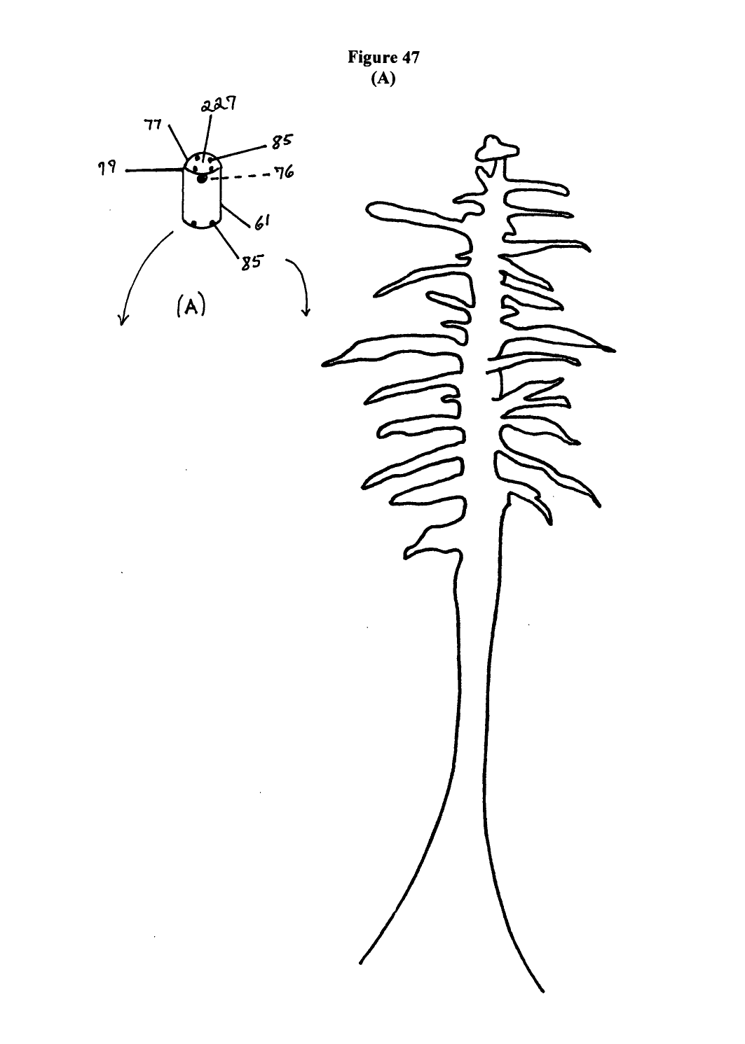

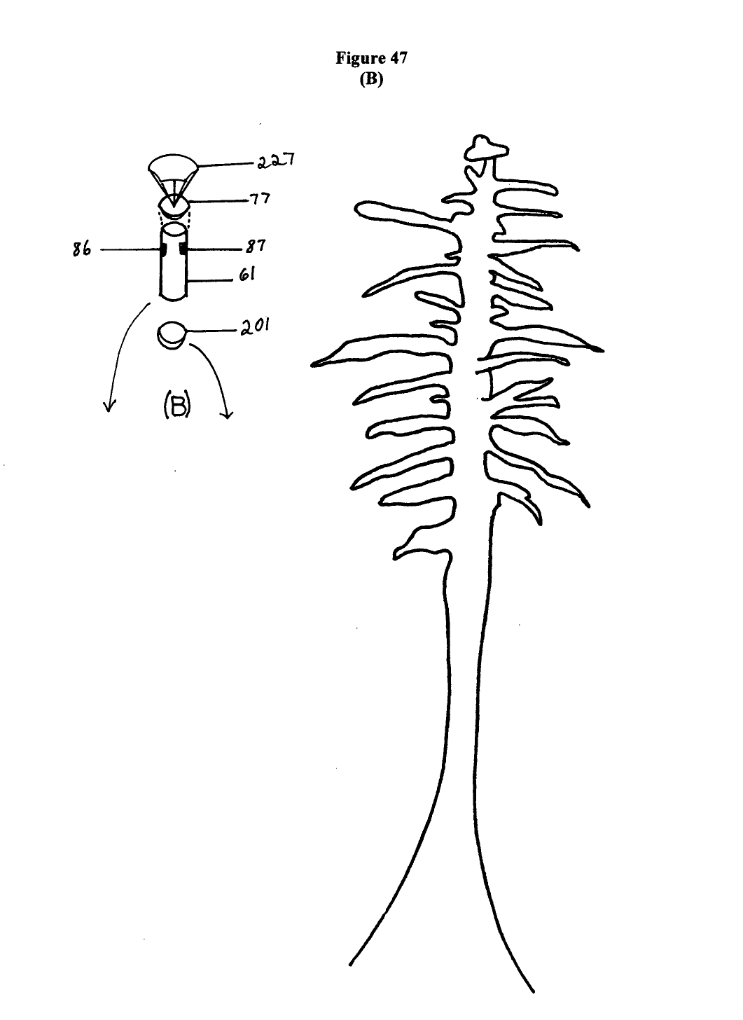

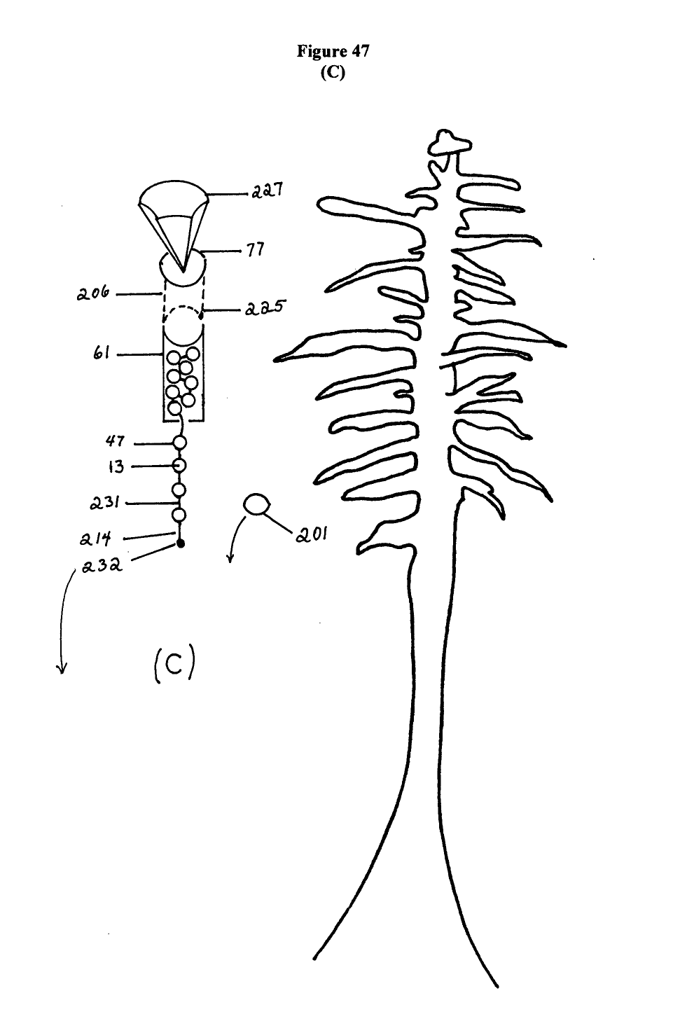

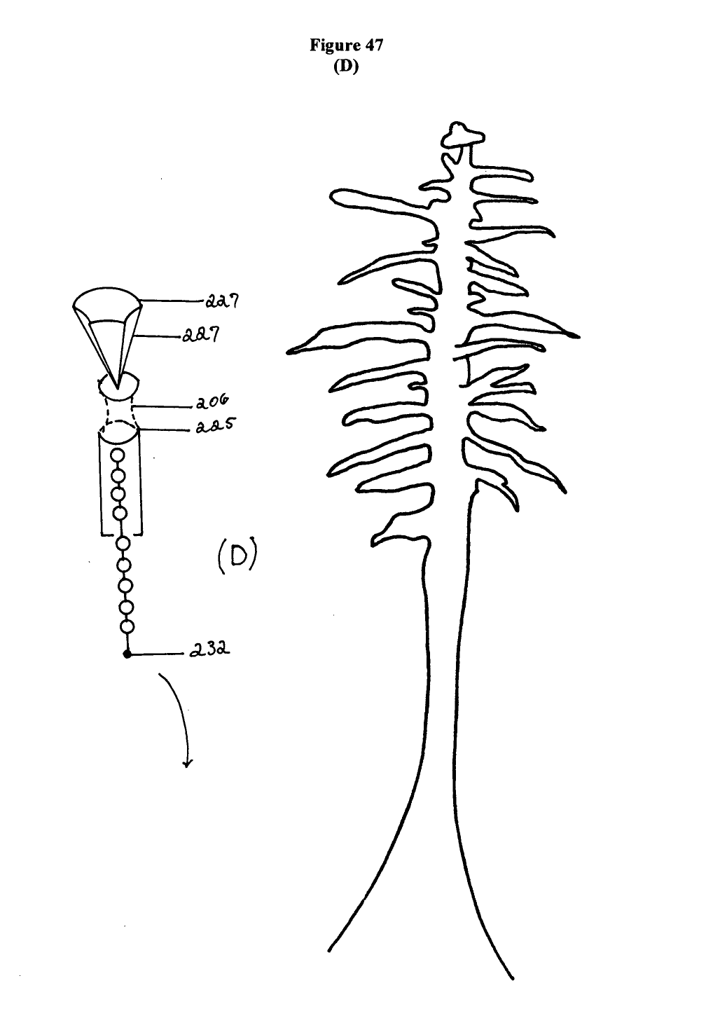

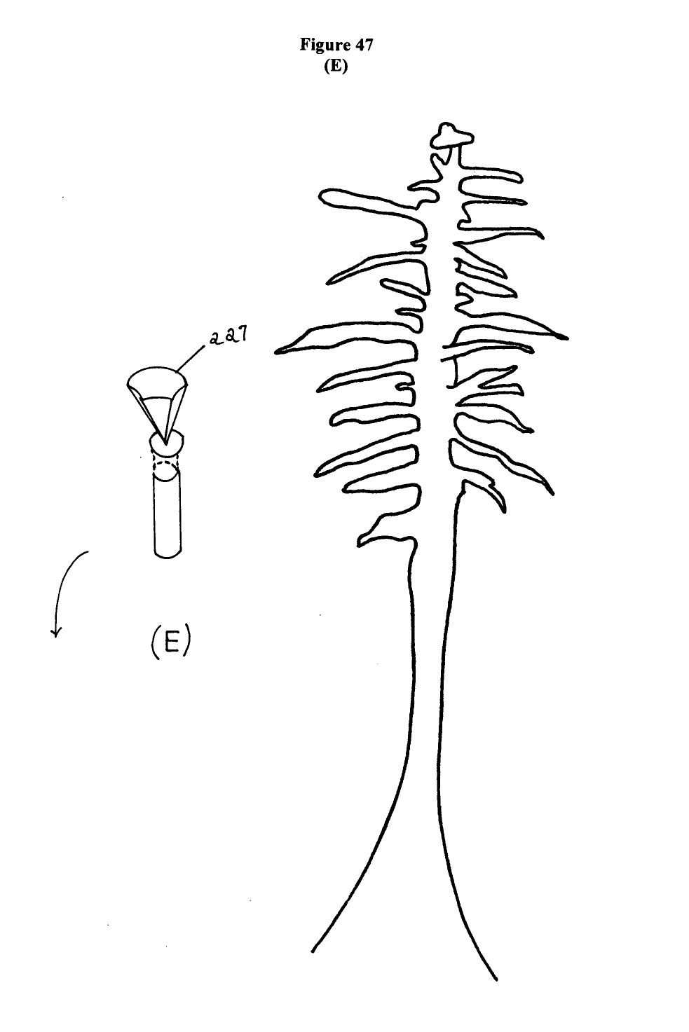

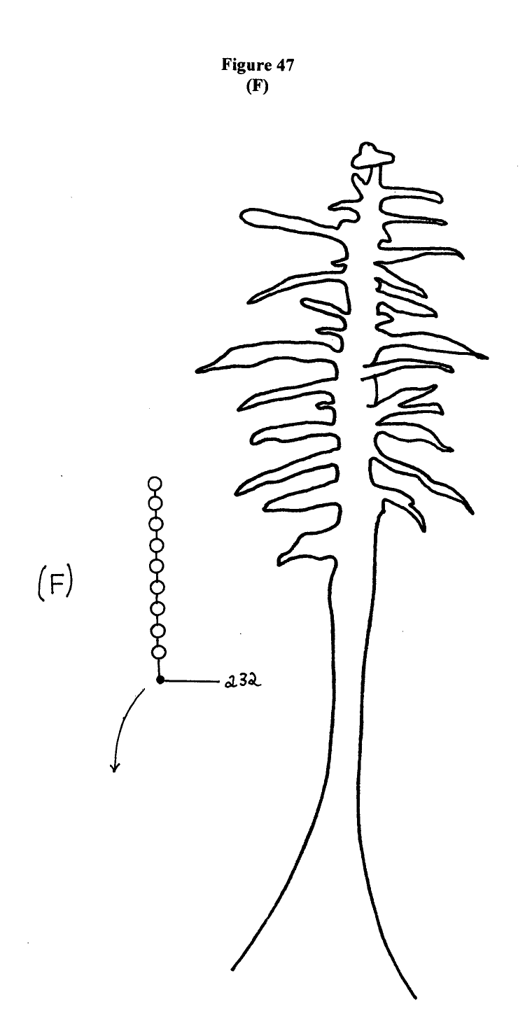

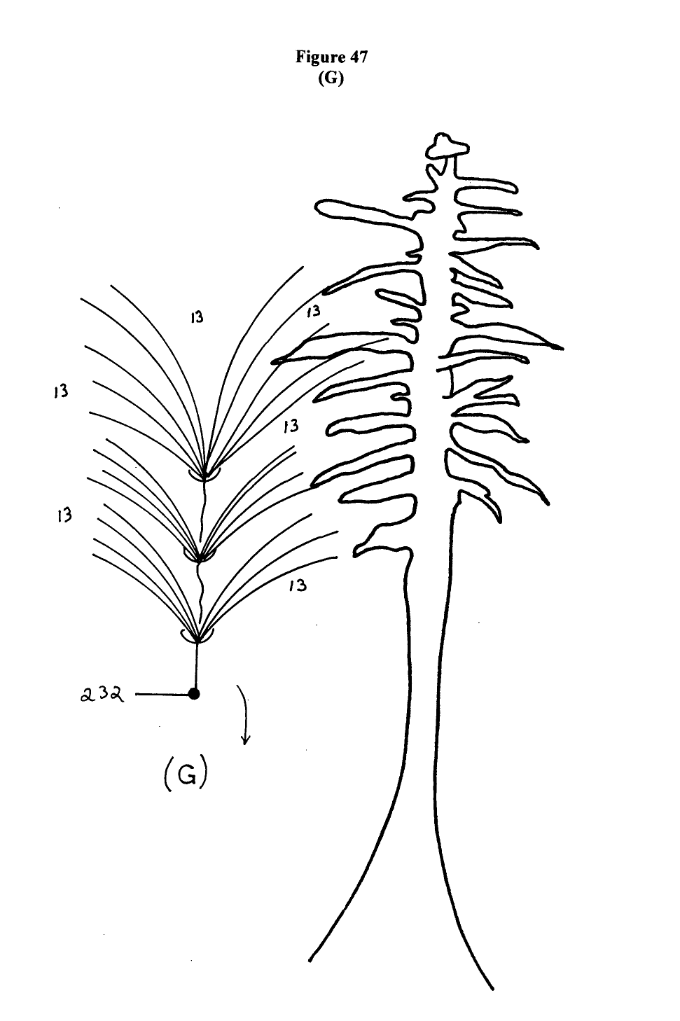

FIG. 47 is a schematic representation of the inverted vertical canister with multiple Non Pop-up fire suppressant capsules during aerial deployment.

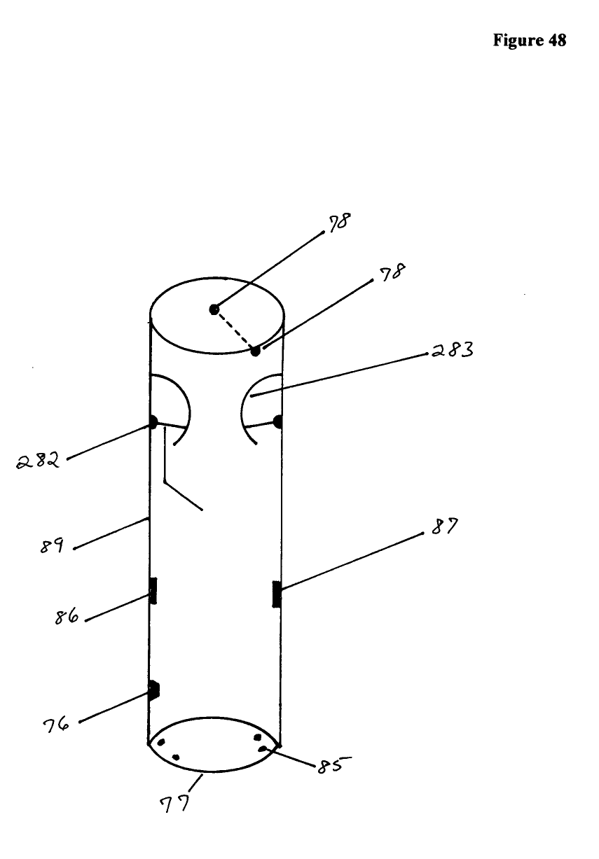

FIG. 48 is an alternative schematic representation of the inverted vertical canister of FIG. 47, with multiple Non Pop-up fire suppressant capsules during aerial deployment.

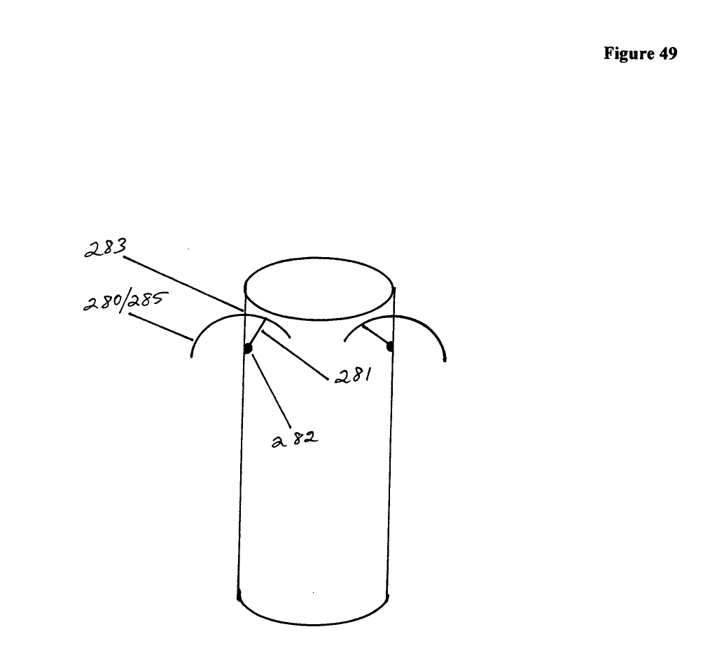

FIG. 49 is a schematic representation of FIG. 48, where the hood has been extended to slow the canister's vertical descent.

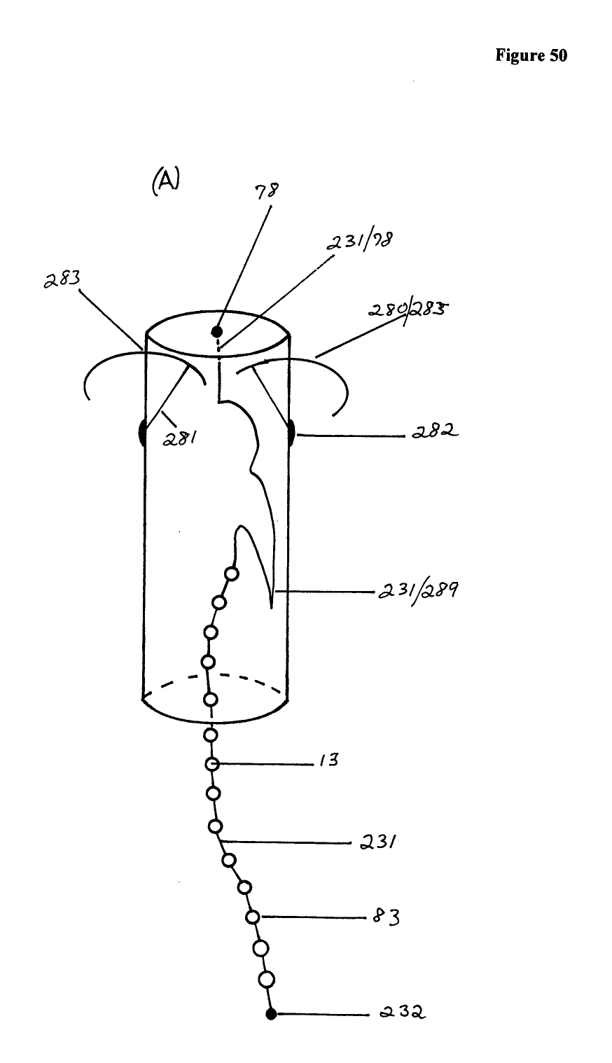

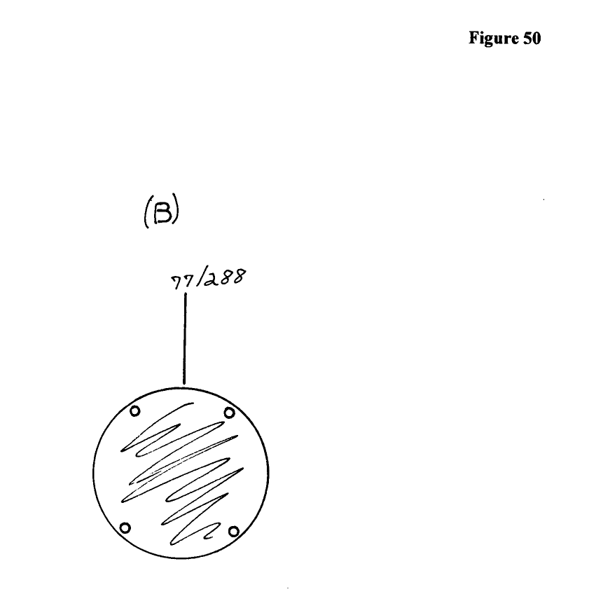

FIG. 50 is a schematic representation of FIGS. 48 and 49.

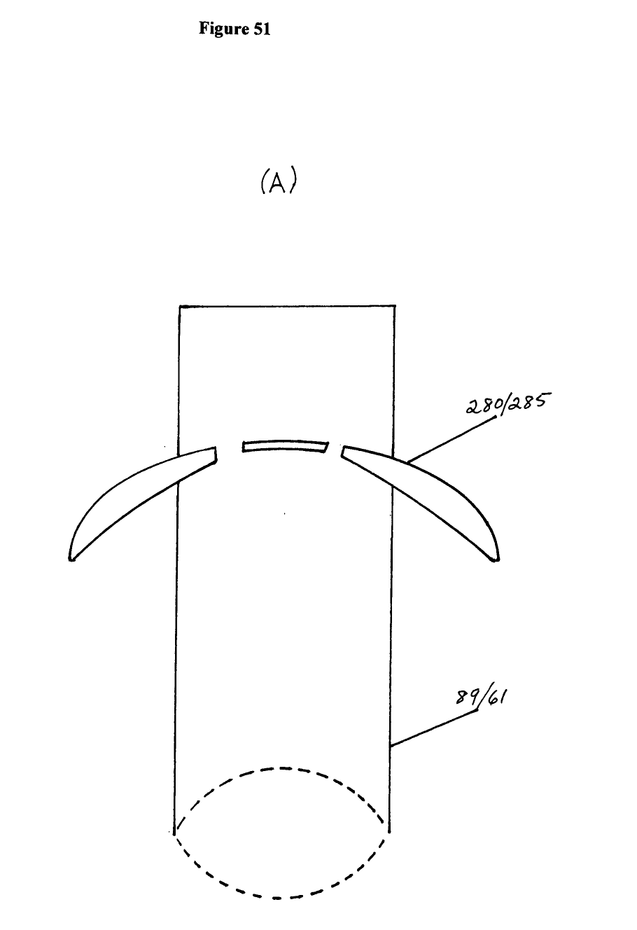

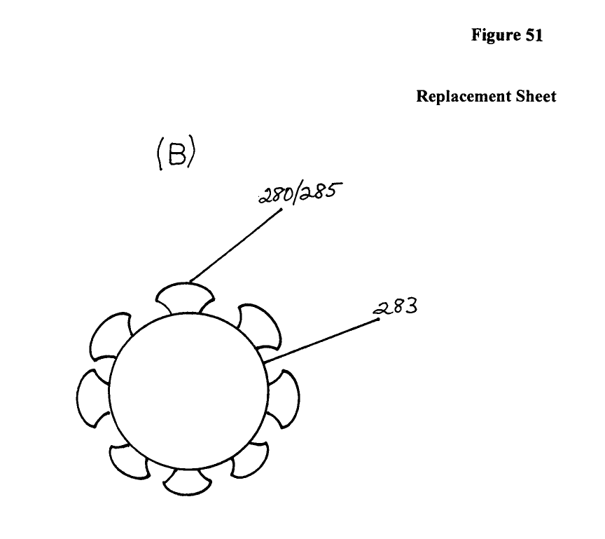

FIG. 51 is an isolated overhead view schematic representation of FIG. 48.

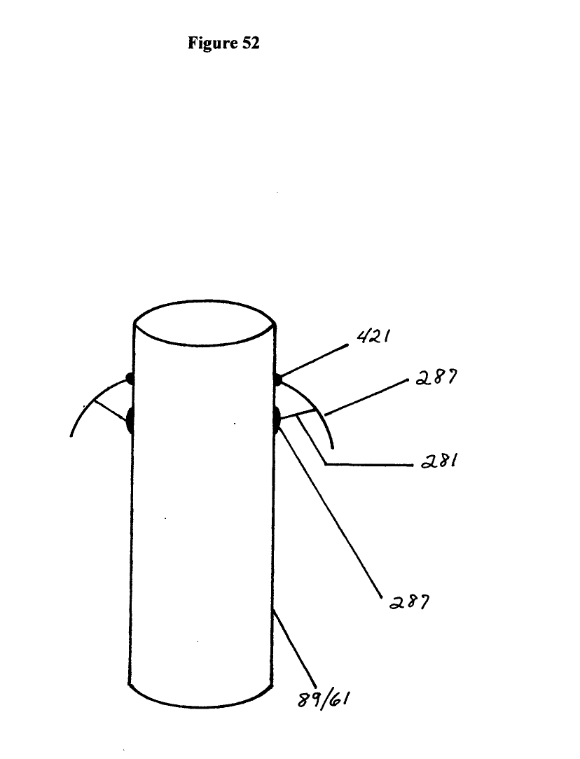

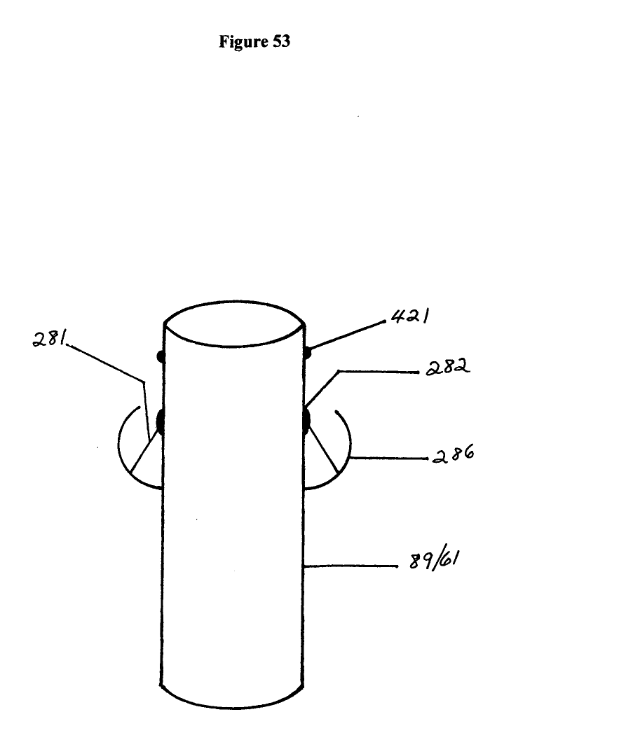

FIGS. 52 and 53 represent an alternative design to FIG. 48, where the hood that will slow descent is externally mounted to the canister.

FIG. 54 illustrates a large breakaway square or rectangular canister or other suitable structures containing multiple pop-up fire suppressant capsules on a ribbon.

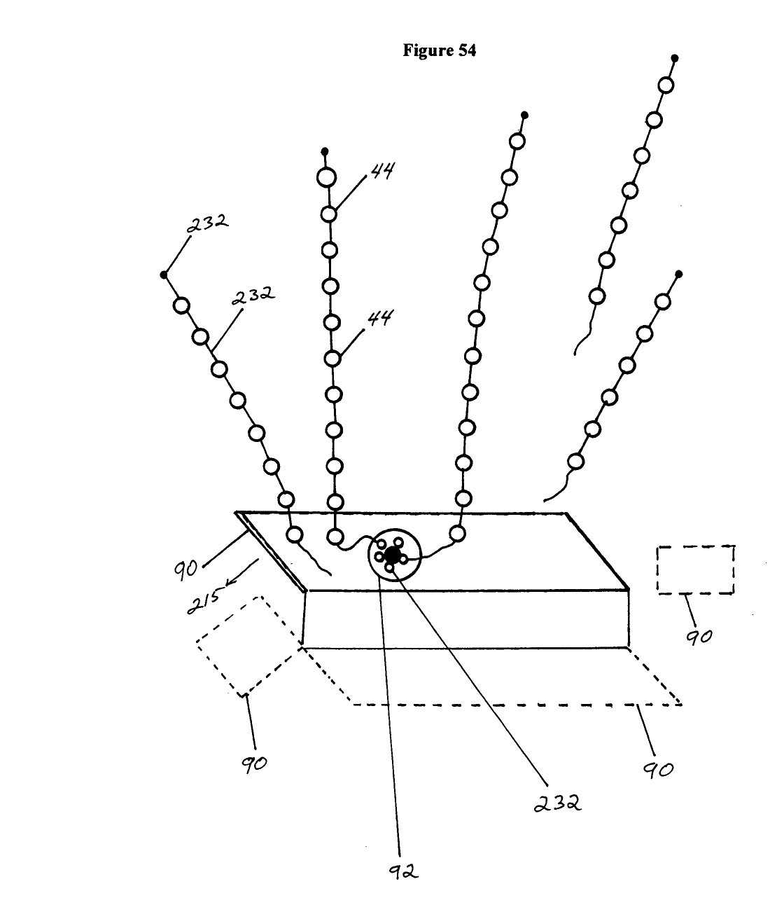

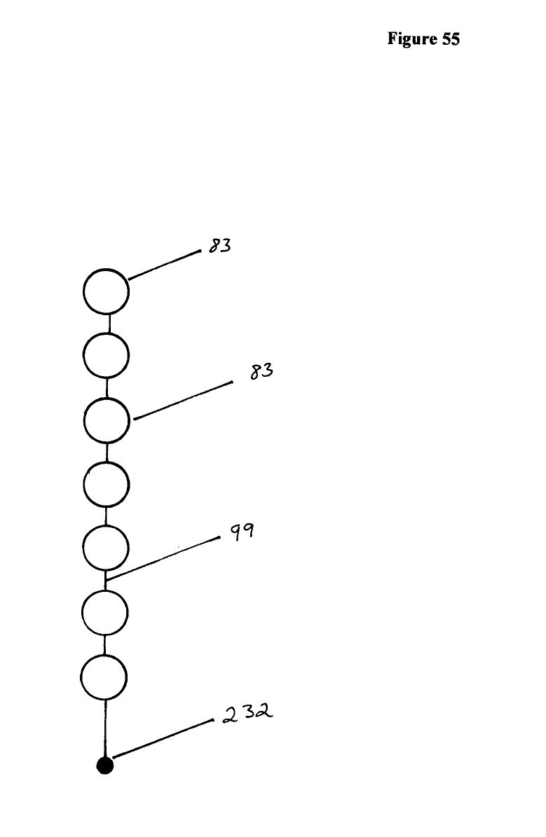

FIG. 55 illustrates Non Pop-up fire suppressant capsules with a weighted tag end (attached to a vertical ribbon, for aerial deployment to a fire zone.

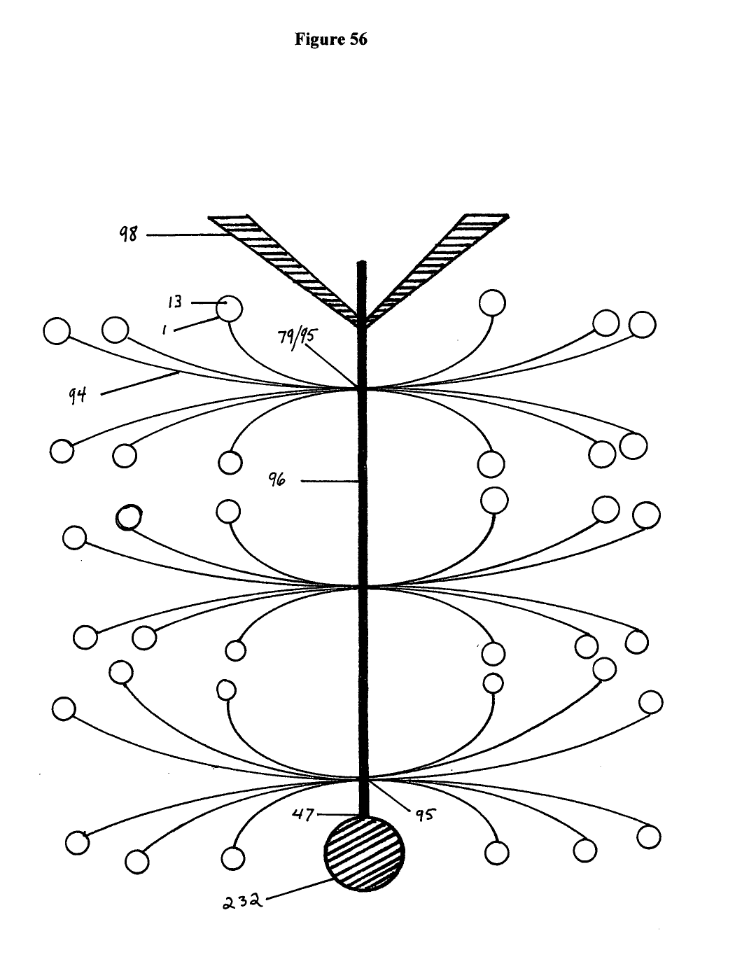

FIG. 56 illustrates multiple independent fire suppressant capsules attached to independent flexing arms of an umbrella rig.

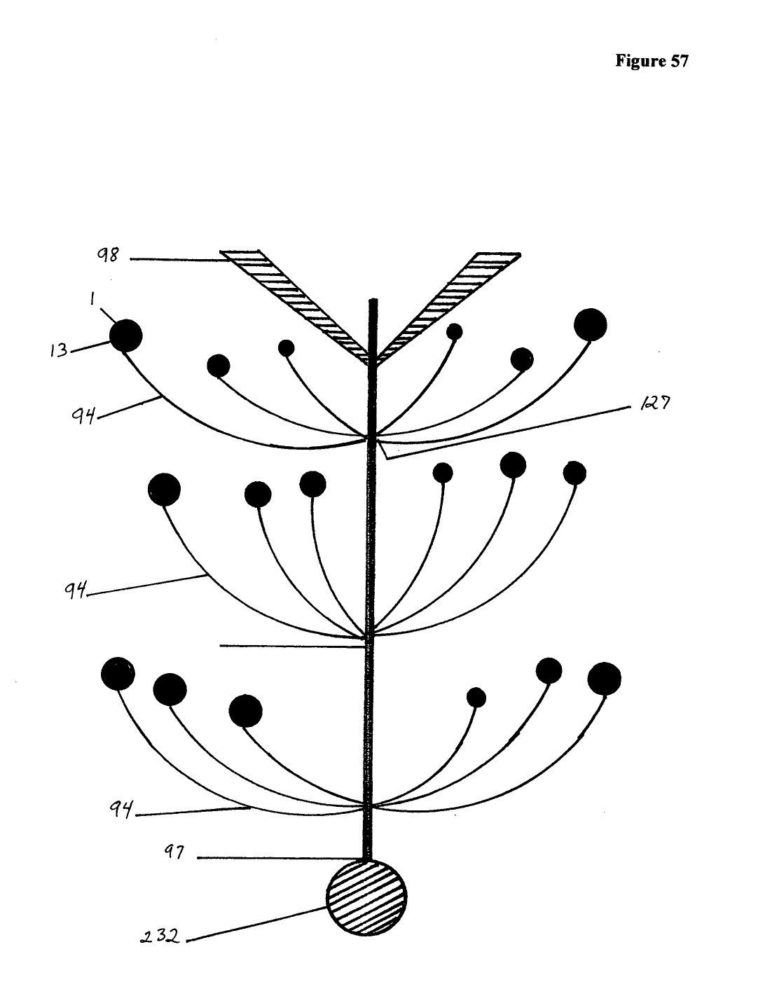

FIG. 57 is a second version of FIG. 56, with unidirectional umbrella rig attachments.

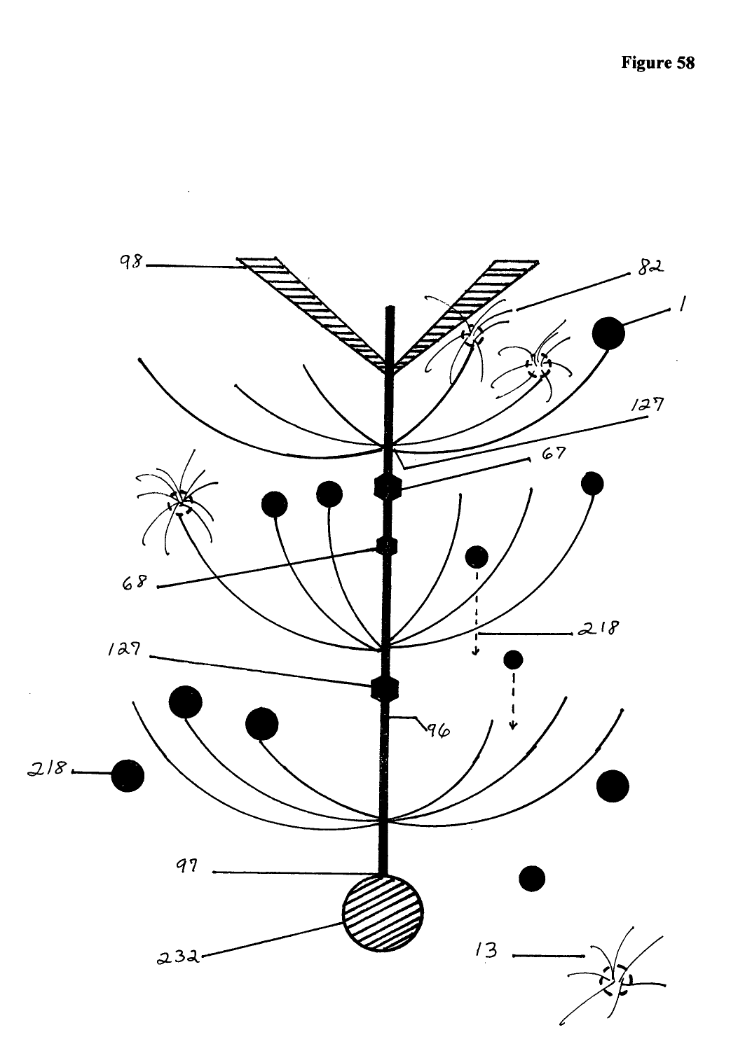

FIG. 58 is a schematic representation of the release pattern of the multiple independent fire suppressant capsules of FIG. 56 and FIG. 57.

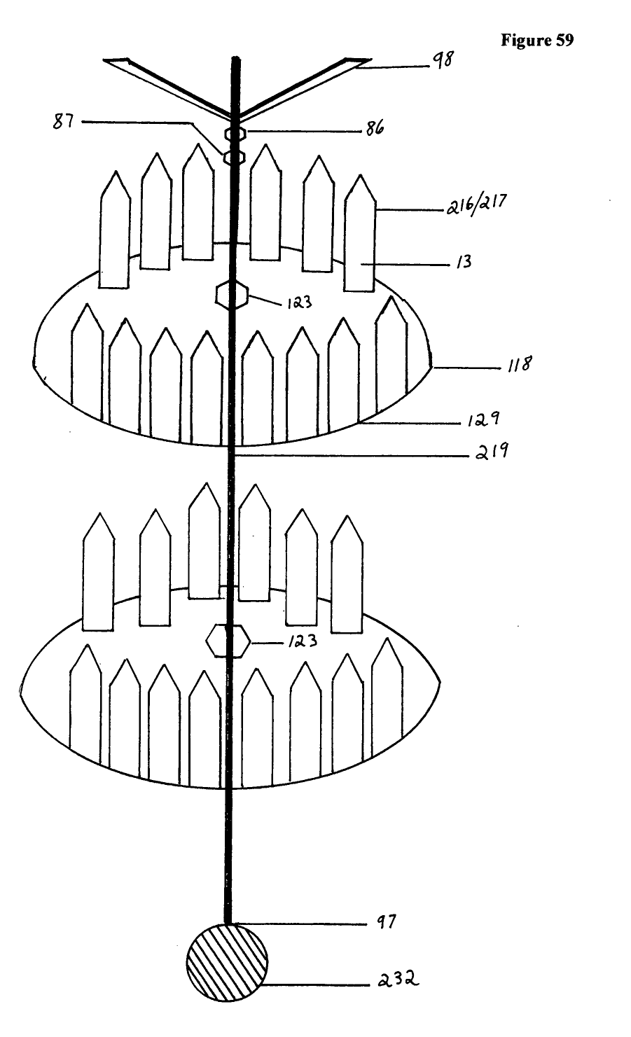

FIG. 59 illustrates multiple independent tubular or canister-type fire suppressant capsules vertically attached to a circular ring, for aerial deployment to a fire zone (101-104).

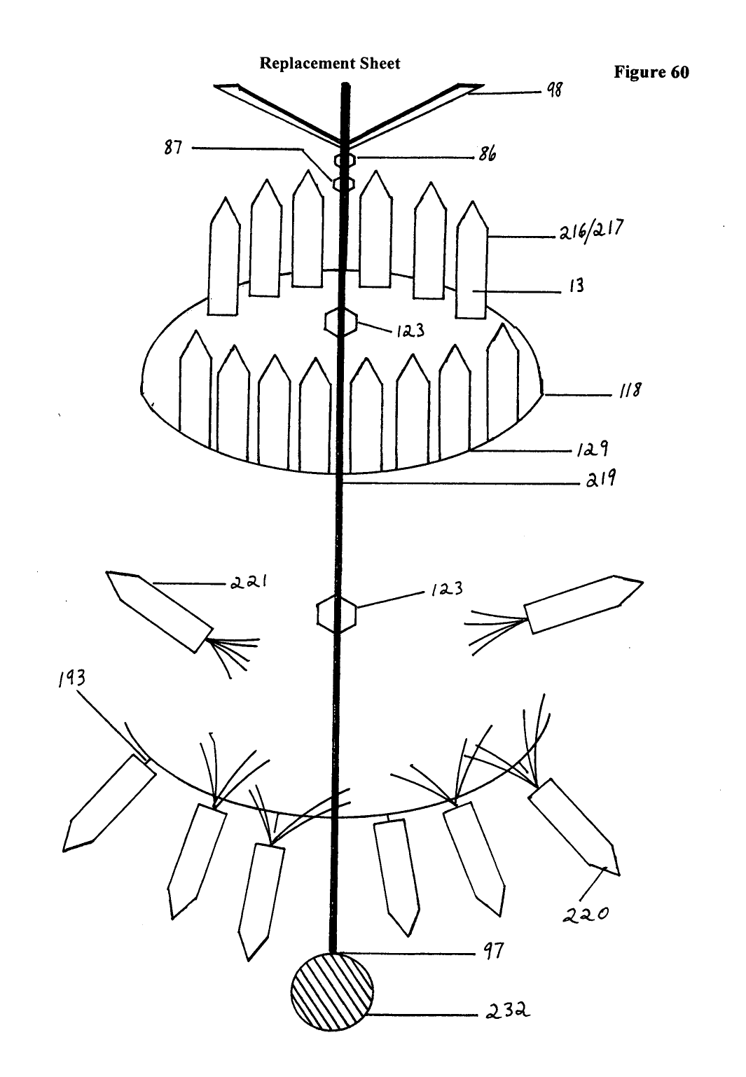

FIG. 60 illustrates the firing pattern of canister/capsules of FIG. 59.

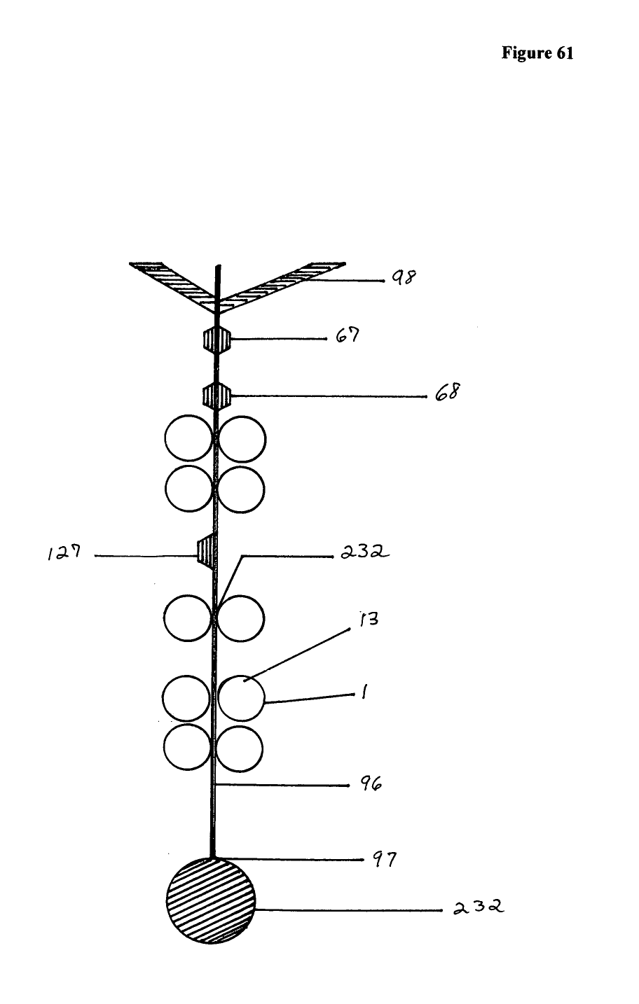

FIG. 61 illustrates multiple (independent) spherical fire suppressant capsules or canisters attached to a central post, for aerial deployment into a fire zone.

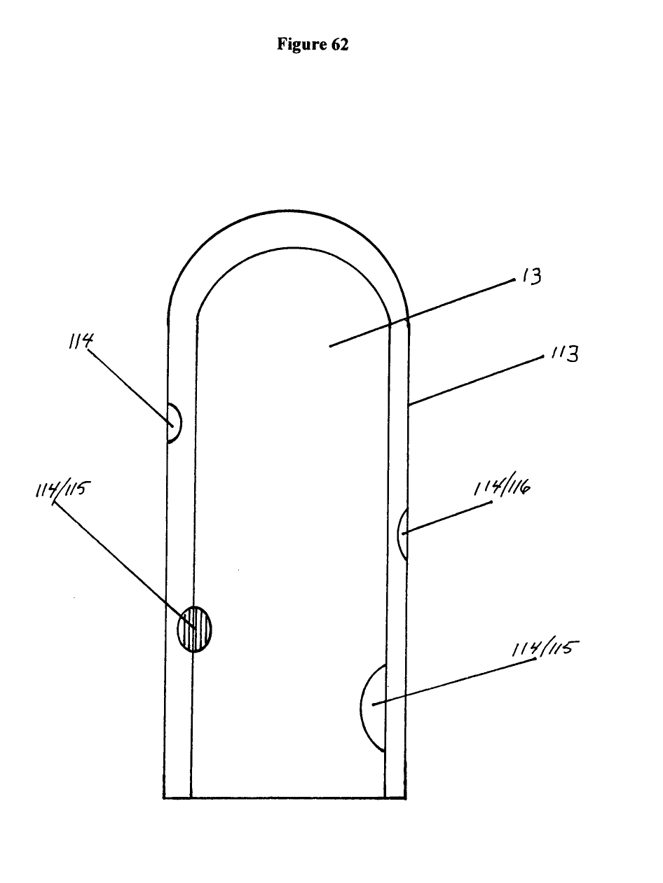

FIG. 62 is a double thin-walled fire suppressant capsule with microchips embedded in the interior and exterior walls, to effect electronic discharge of the fire suppressant load.

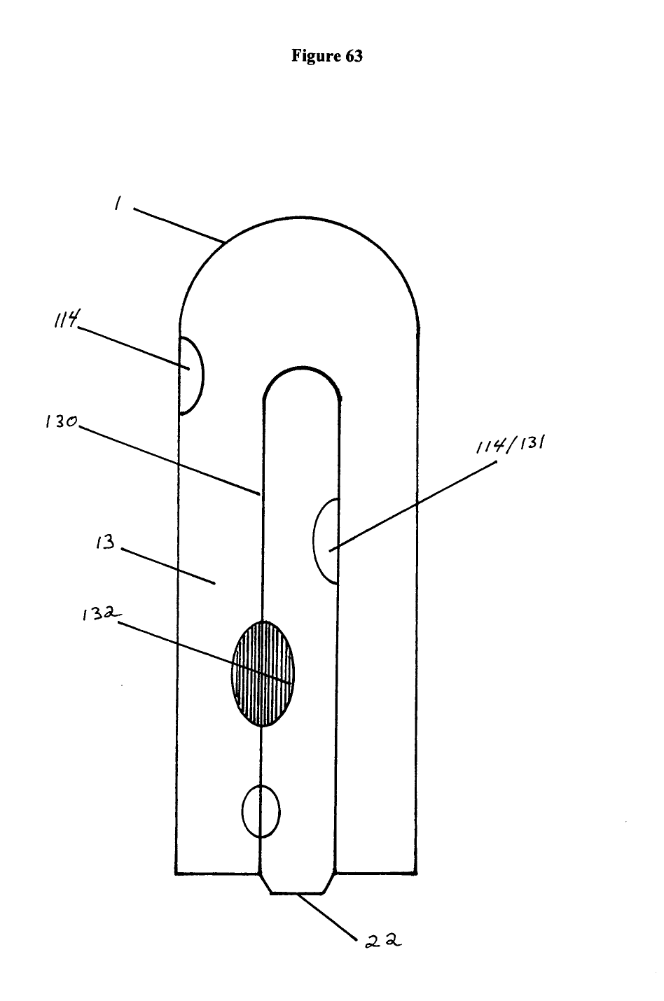

FIG. 63 is a schematic representation of FIG. 62, a thin-walled fire suppressant capsule containing a deep central propellant core with a protruding soft-spot.

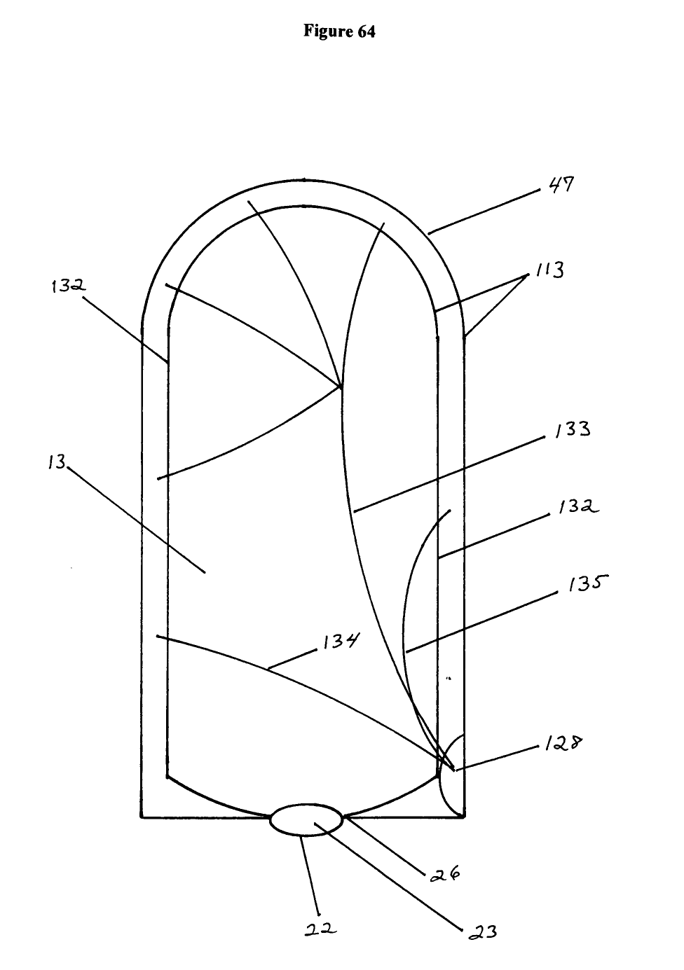

FIG. 64 is a schematic representation of heat/temperature specific discharging fire suppressant capsule, as at FIG. 62, demonstrating multiple physical leads emanating from the microchip or microprocessor to the capsule.

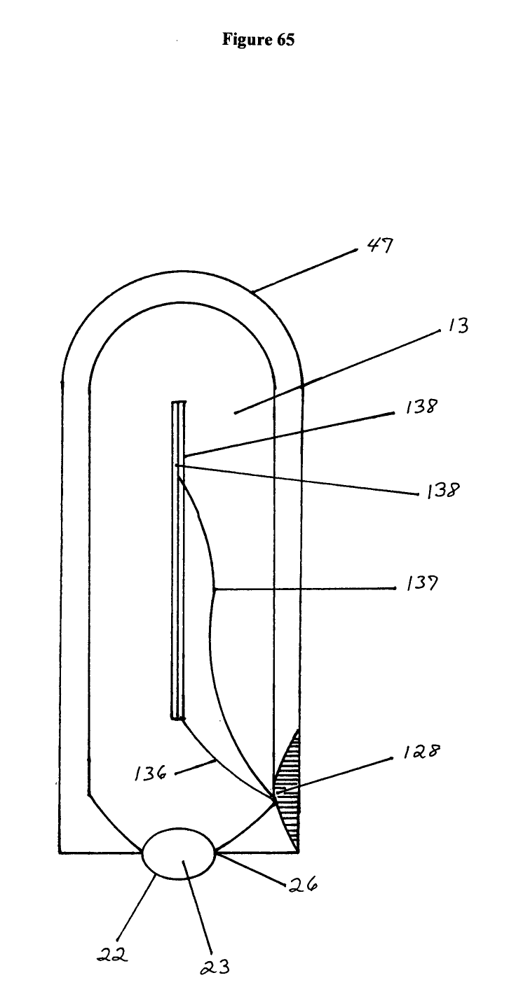

FIG. 65 is a second schematic representation of FIGS. 62, 63 and FIG. 64. Instead of using multiple physical leads, as at FIG. 64, one or two leads emanate from the microchip or microprocessor, to a central chemical strip. When the chemical strip receives an electrical charge from the microprocessor, it creates a micro explosion that shatters the capsule and forcibly projects the fire suppressant load.

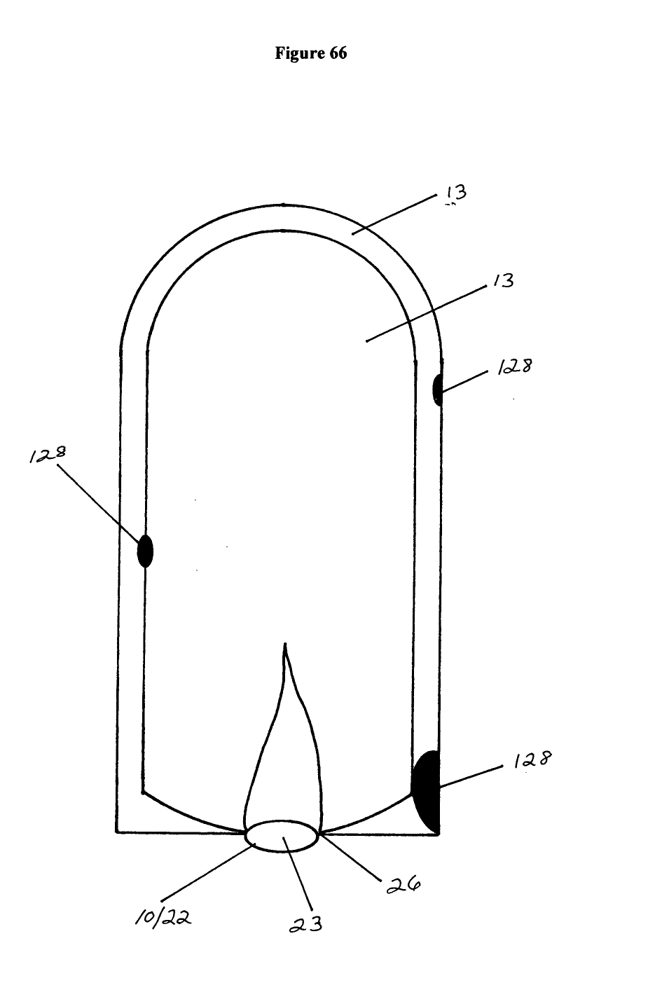

FIG. 66 as at FIG. 62 through and including 64, FIG. 66 is a microprocessor controlled fire suppressant capsule designed for expulsion of its load at a designated height/altitude, temperature, time, etc.

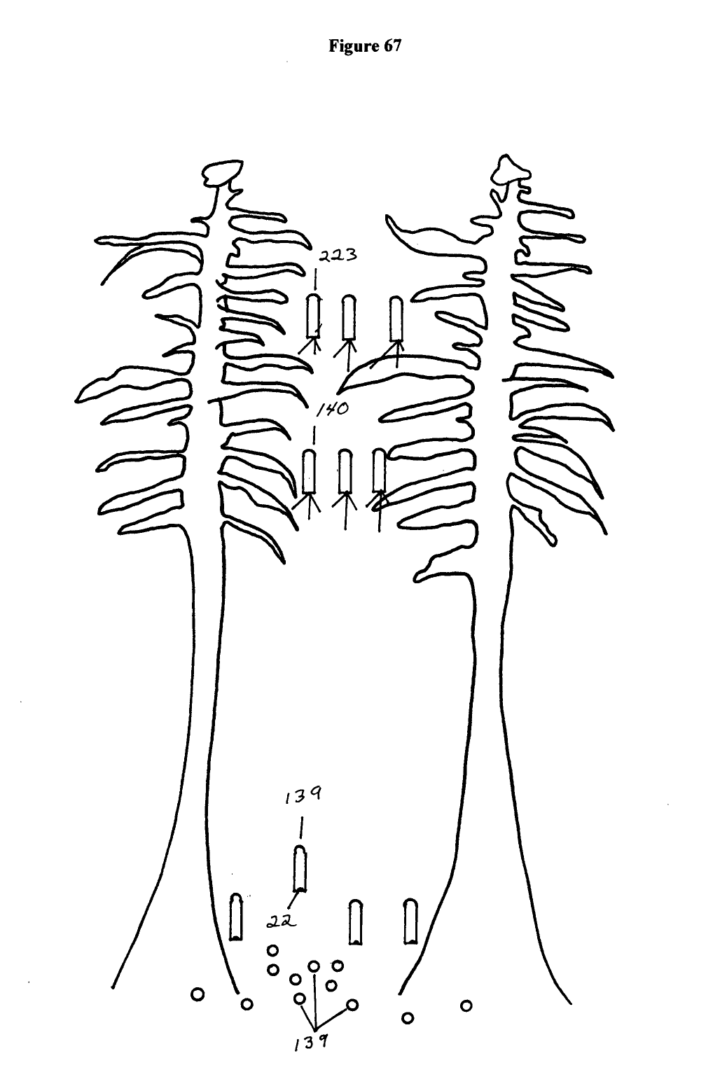

FIG. 67 is a schematic representation of a mixed array of multiple independent ground-based discharging capsules and high and mid-altitude pop-up fire suppressant capsules deployed for simultaneous controlled discharge of the fire suppressant.

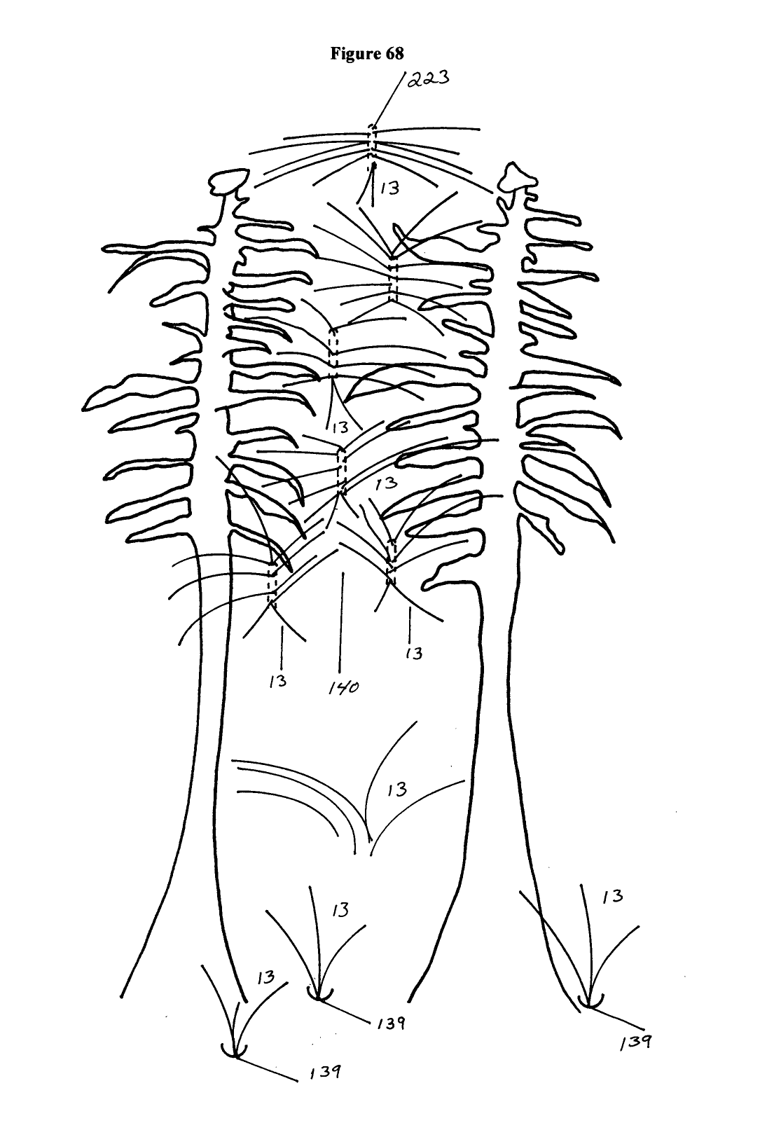

FIG. 68 is a schematic representation of FIGS. 66 and 67 illustrating the release pattern of multiple independent ground-based discharging capsules, and high and mid-altitude pop-up fire suppressant capsules deployed for controlled discharge of the fire suppressant.

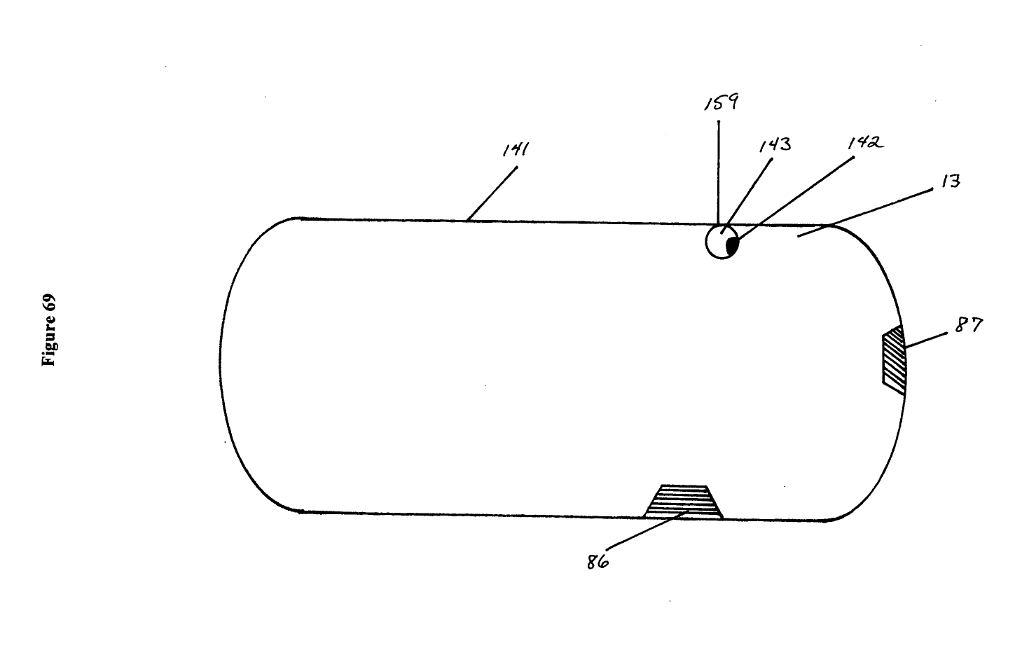

FIG. 69 is chafe-charge type fire suppressant capsule: i.e., a single thin walled fire suppressant capsule containing a global positioning system, gyroscopic sensor microprocessor and altimeter control microprocessors, in addition to a single chafe-charge mechanism that will penetrate the shell of the capsule at the point closest to the intended target fire area, directing the fire suppressant in a specified direction.

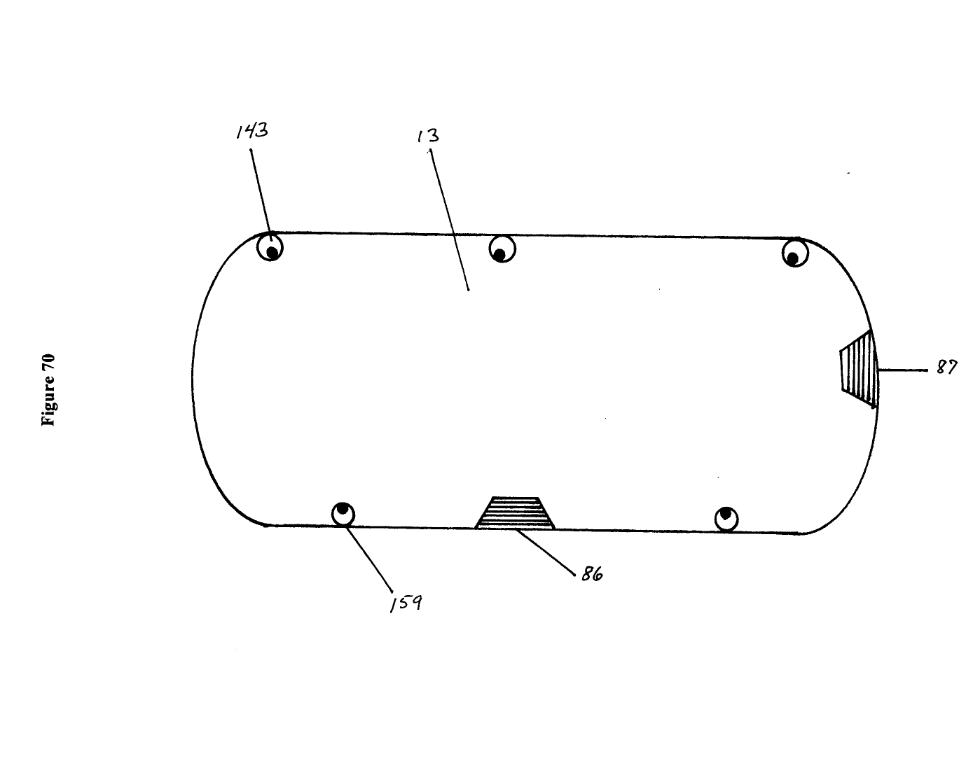

FIG. 70 is a second diagram of FIG. 69, showing multiple chafe-charge mechanisms placed throughout the interior of the fire suppressant capsule.

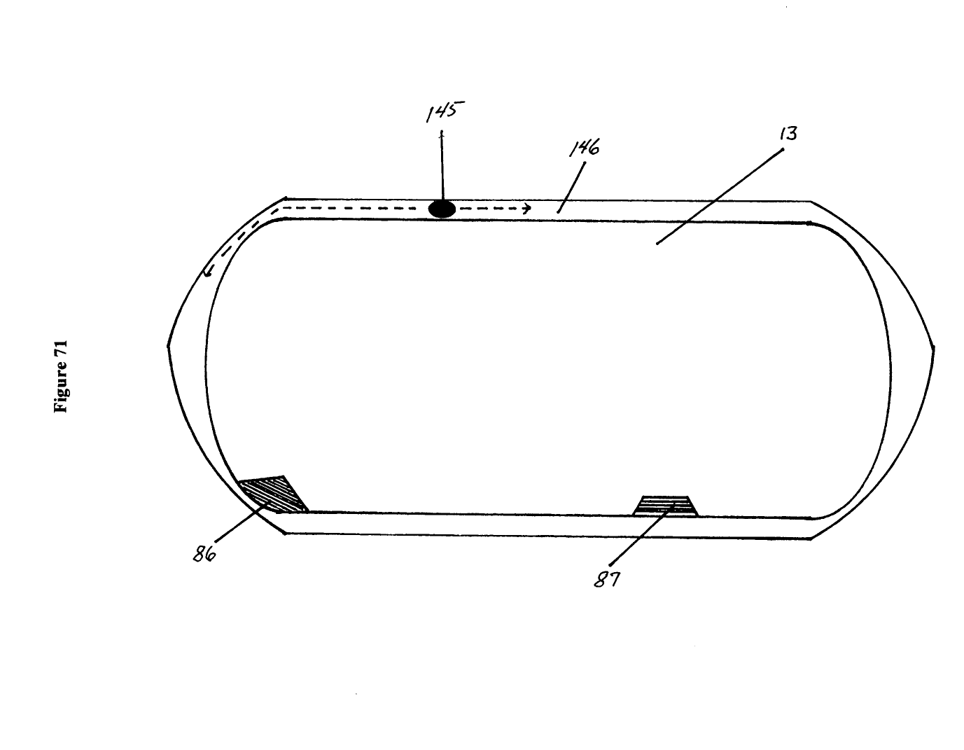

FIG. 71 is a double thin-walled fire suppressant capsule containing a global positioning system, gyroscopic sensor microprocessor, altimeter control microprocessor, and a single free-floating chafe-charge mechanism placed between the chamber walls.

FIG. 72 illustrates the chafe-charge penetrating the fire suppressant capsule of FIG. 57, expelling its fire suppressant load.

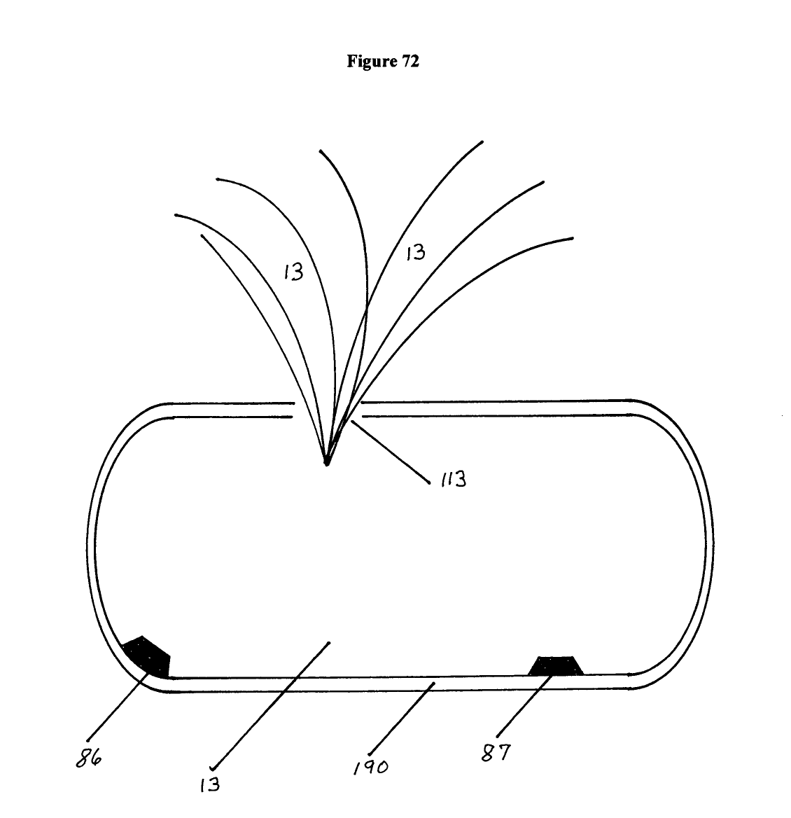

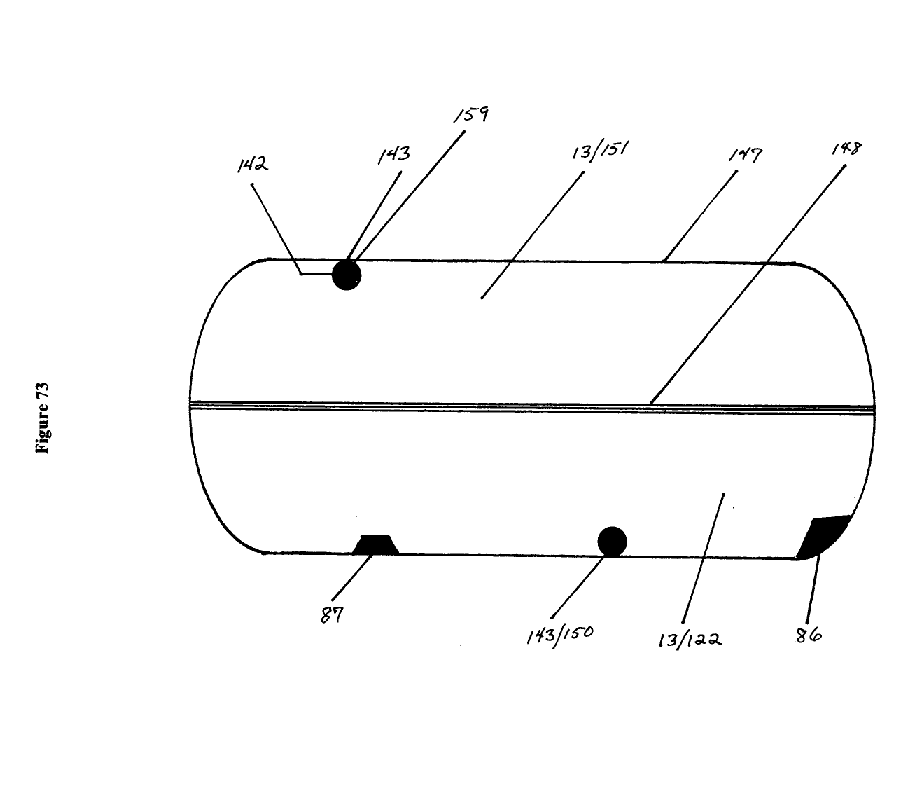

FIG. 73 is a horizontal descending/vertical dispersal, horizontal-bifurcated fire suppressant capsule containing a single chafe-charge mechanism in each half of the capsule.

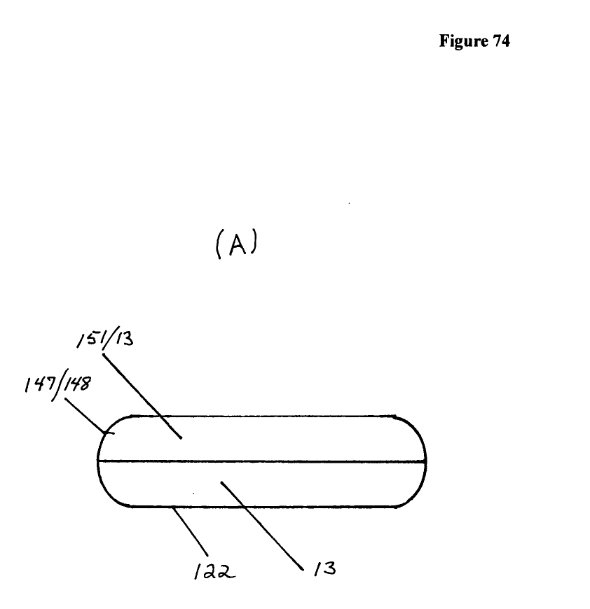

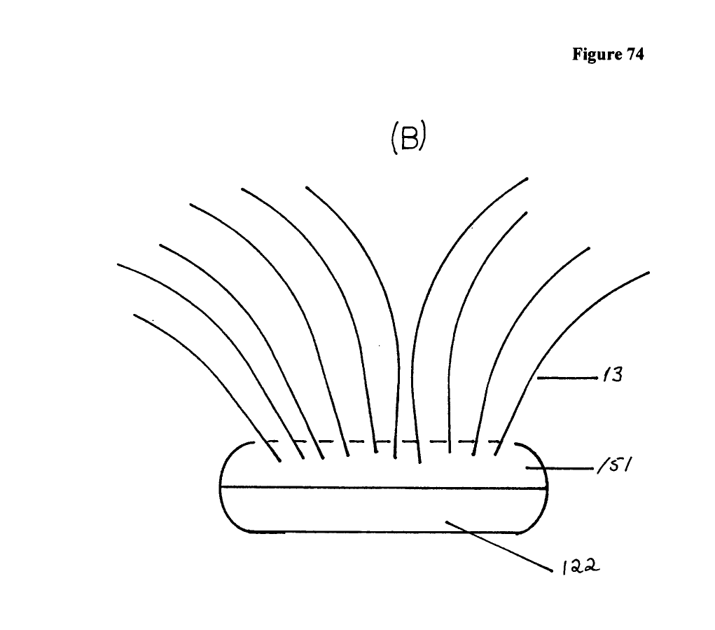

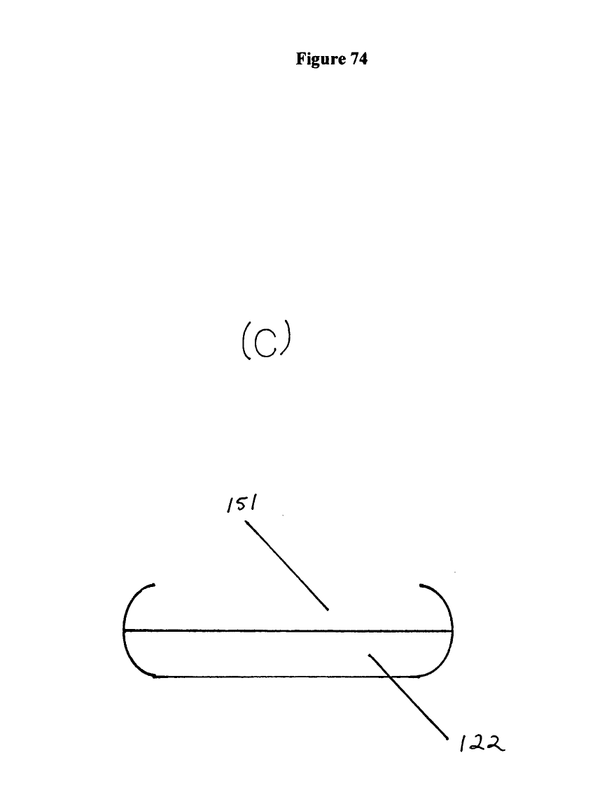

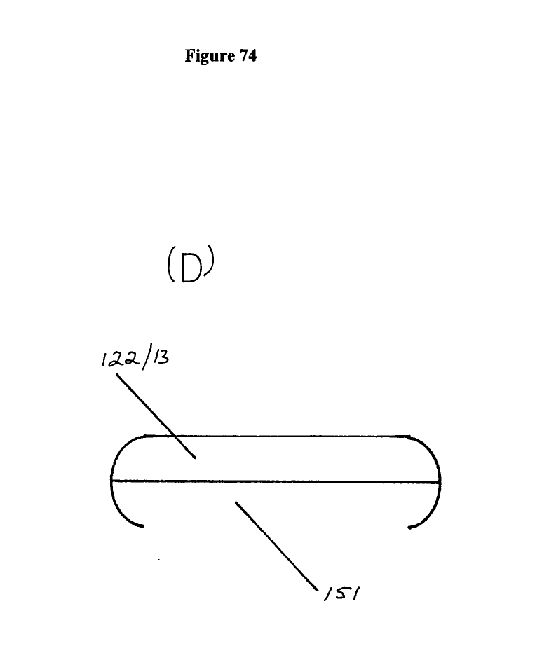

FIG. 74 is an illustration of FIG. 73 after a dorsal rotation, for positioning to vertically discharge the second half of its fire suppressant load.

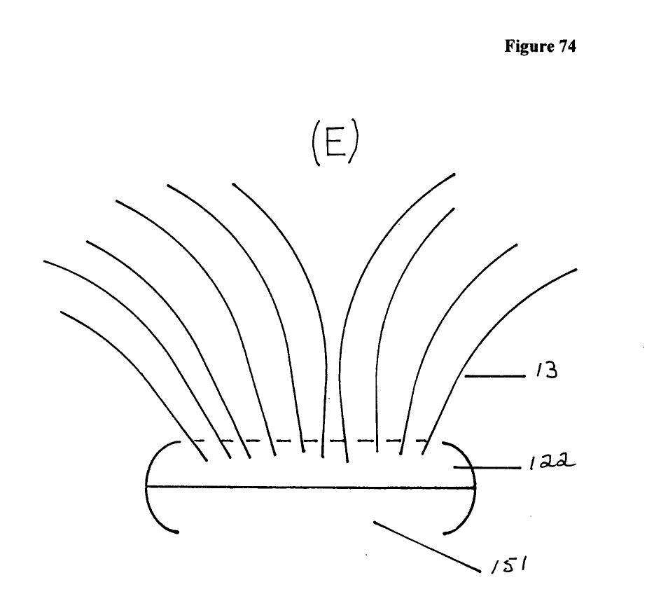

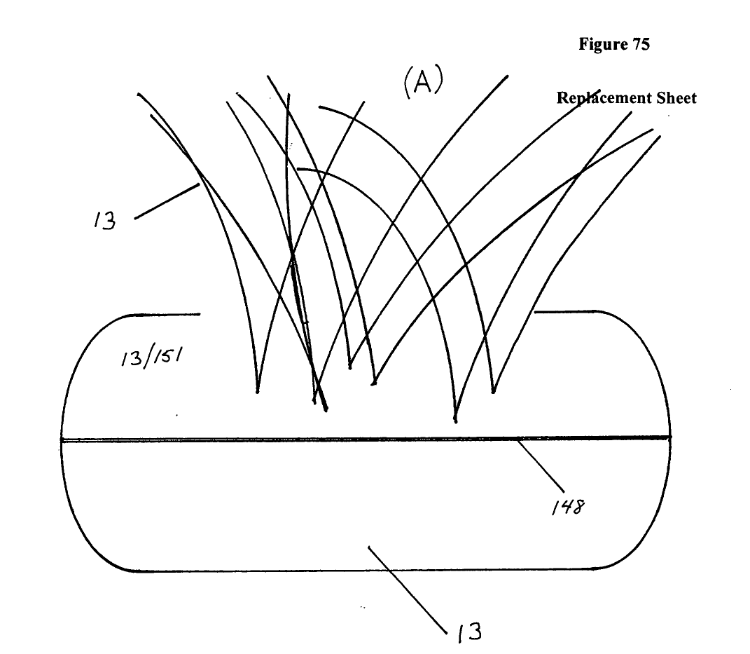

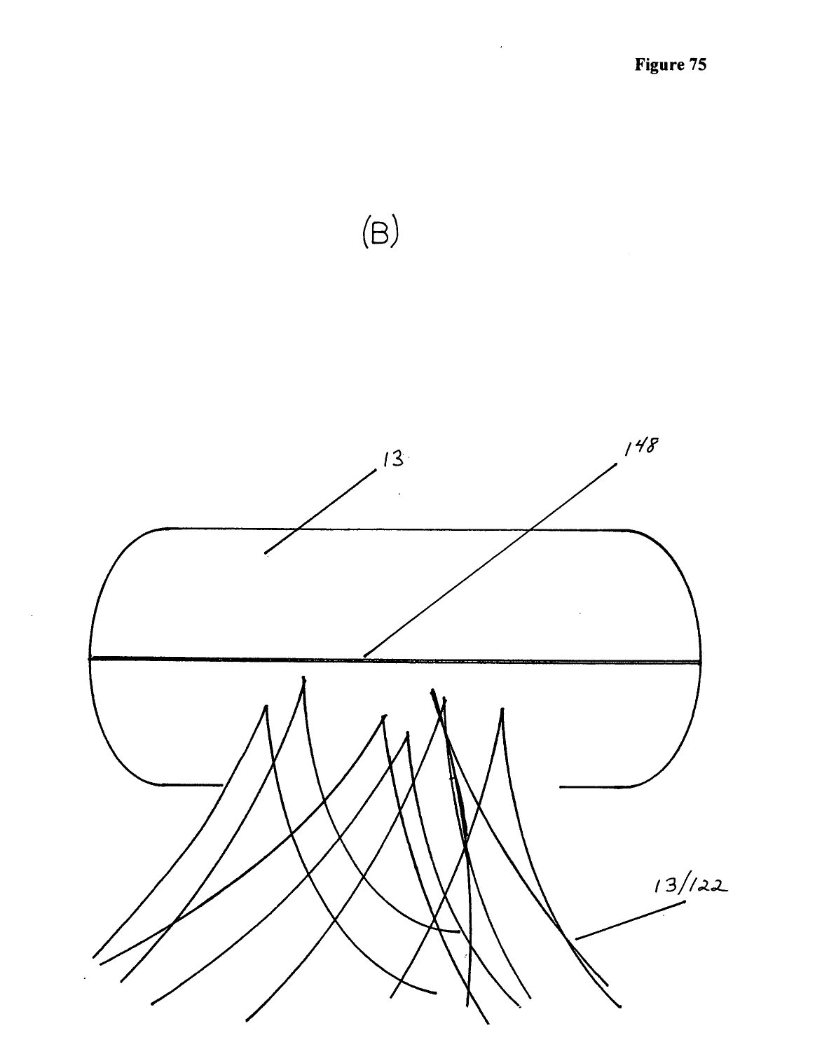

FIG. 75 is a schematic of independent upward/downward vertical discharge pattern of FIG. 73.

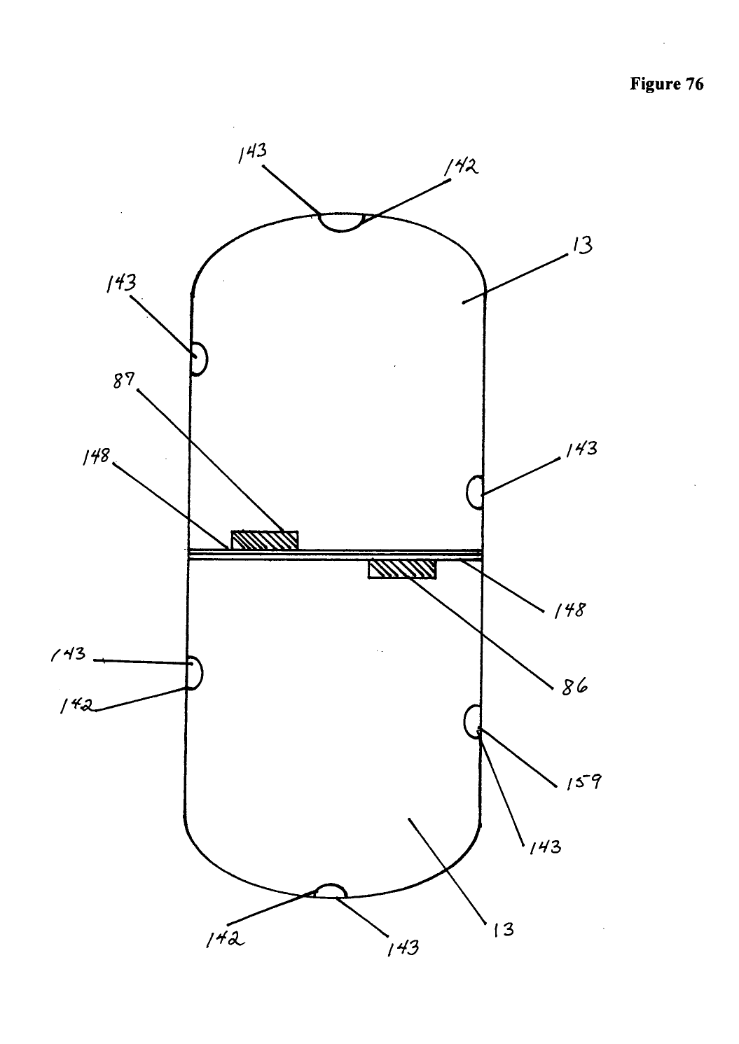

FIG. 76 is a vertical descending/vertical dispersal, horizontal-bifurcated fire suppressant capsule containing multiple chafe-charges, along with centrally located global positioning system, gyroscopic sensor and altimeter microprocessors.

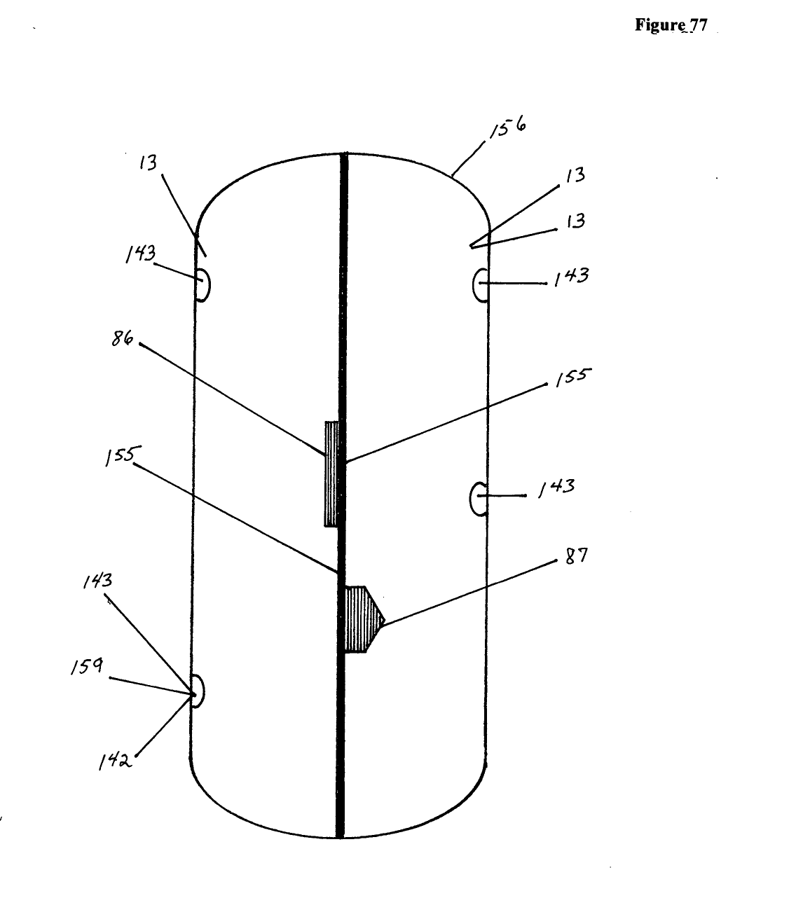

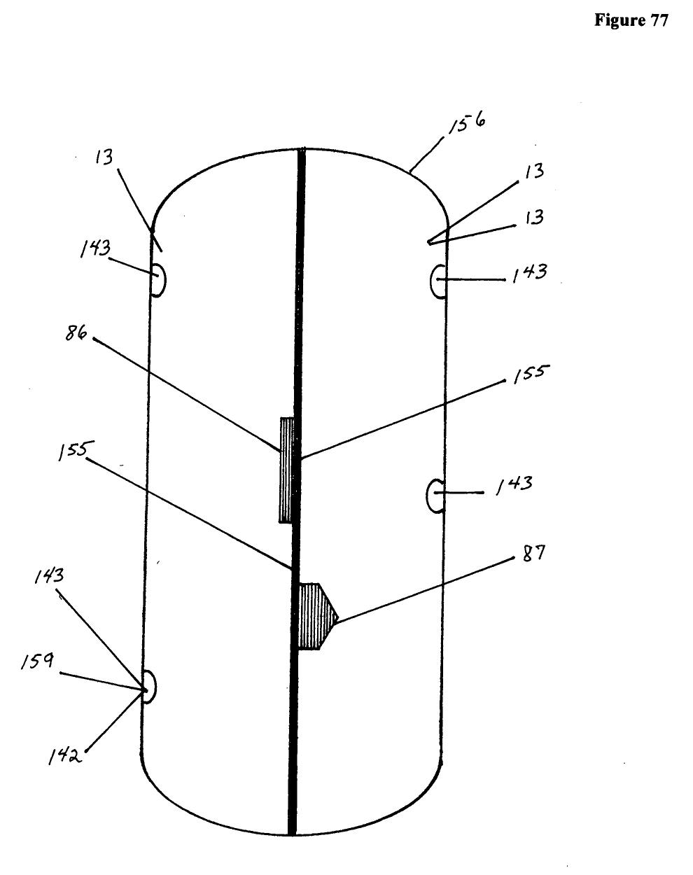

FIG. 77 is a vertical descending/horizontal dispersal, vertical bifurcated fire suppressant capsule containing multiple chafe-charges.

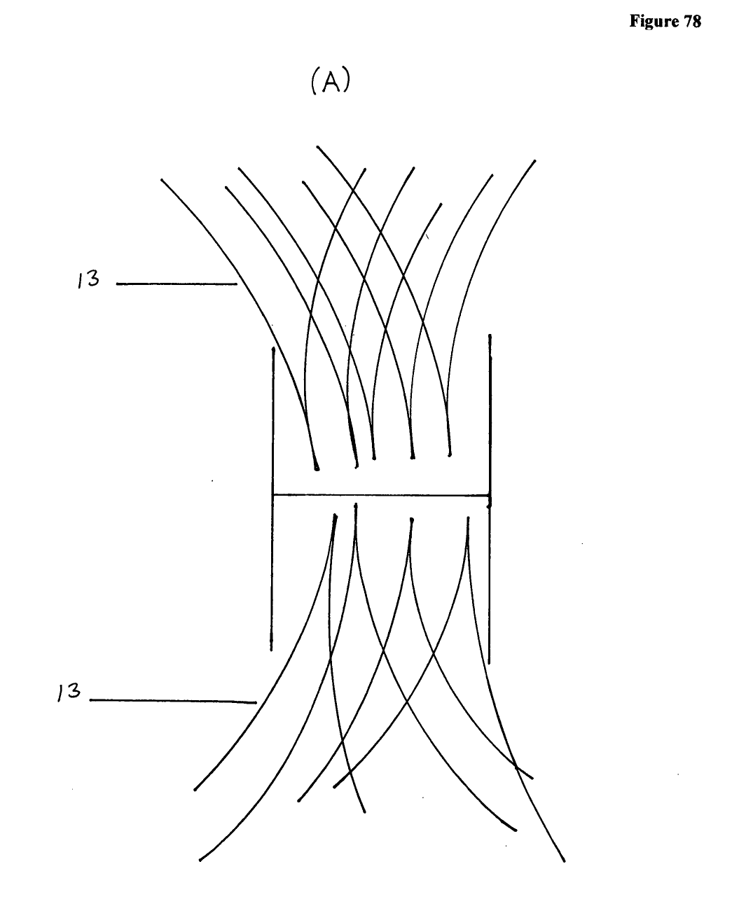

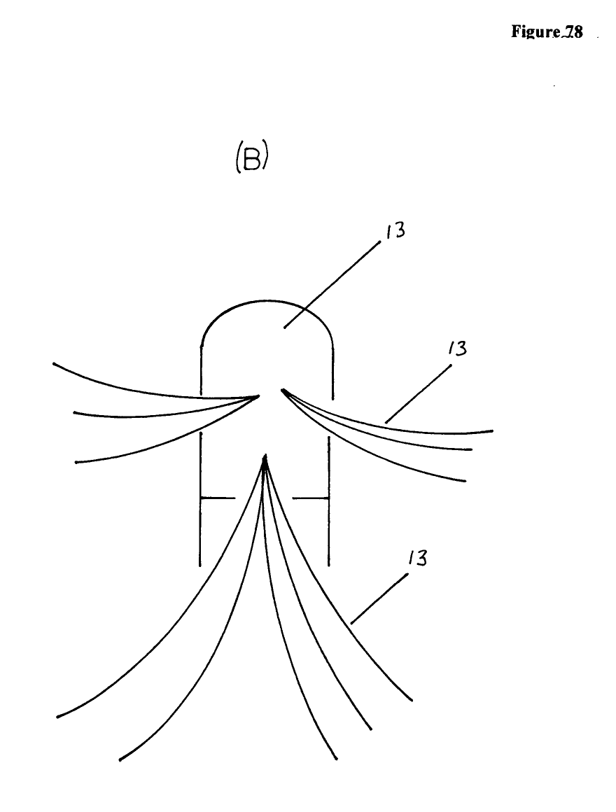

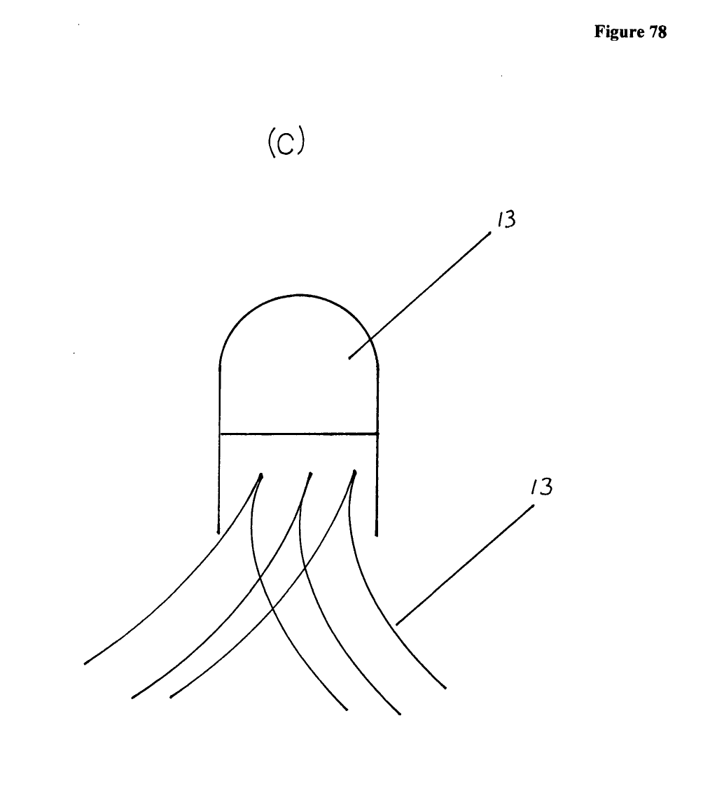

FIG. 78 is the vertical descending/horizontal dispersal patterns, of the vertical-bifurcated version of FIG. 76's fire suppressant capsule.

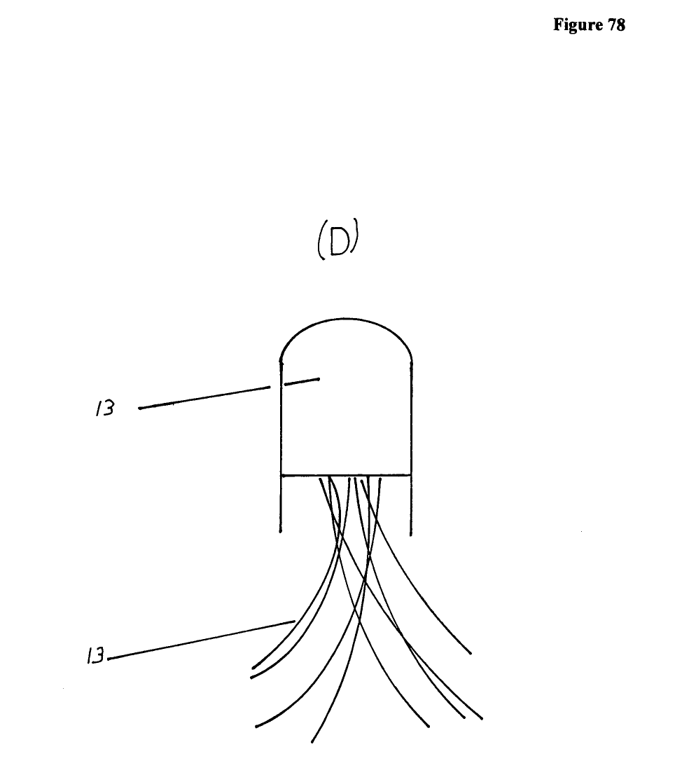

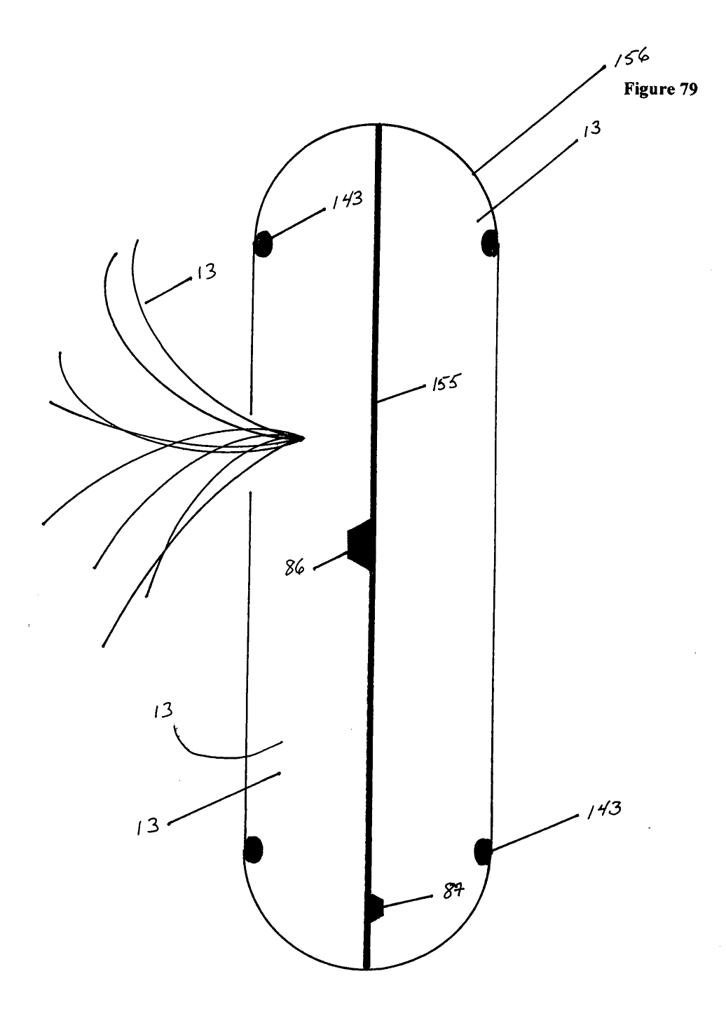

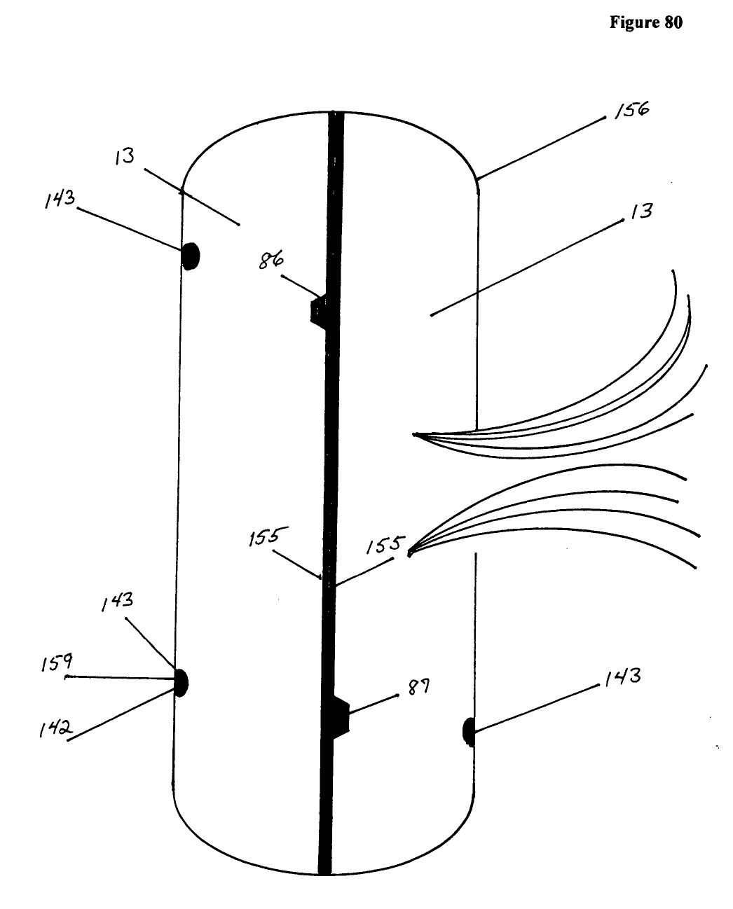

FIGS. 79 and 80 illustrate the independent horizontal dispersal pattern of FIG. 77.

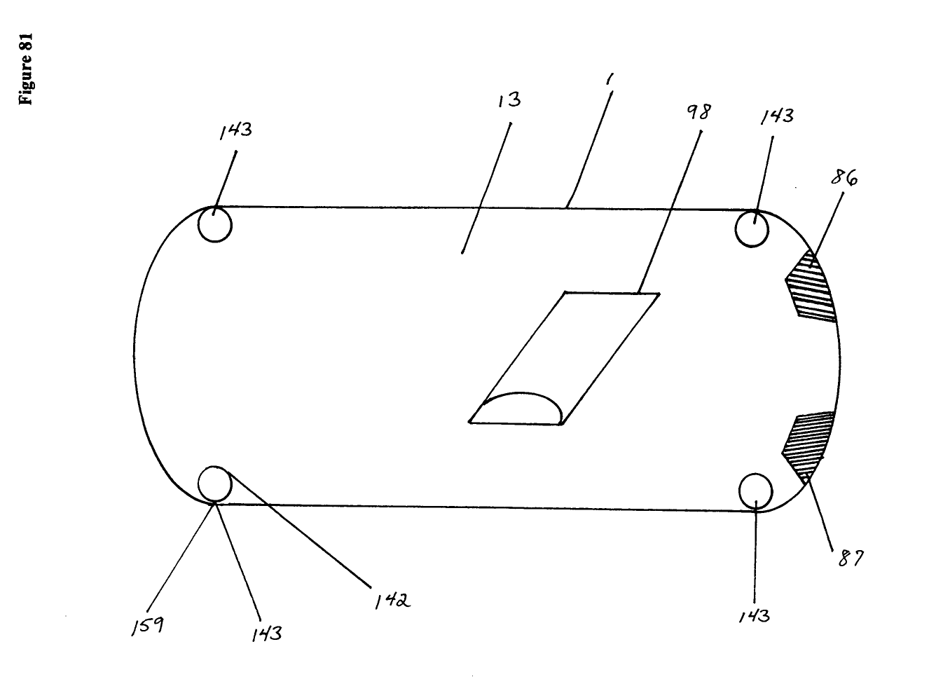

FIG. 81 illustrates a single thin-walled fire suppressant capsule containing multiple, fixed chafe-charges, an adjustable stabilizing flange/wing, a global positioning system, gyroscopic sensor microprocessor, and an altimeter control microprocessor.

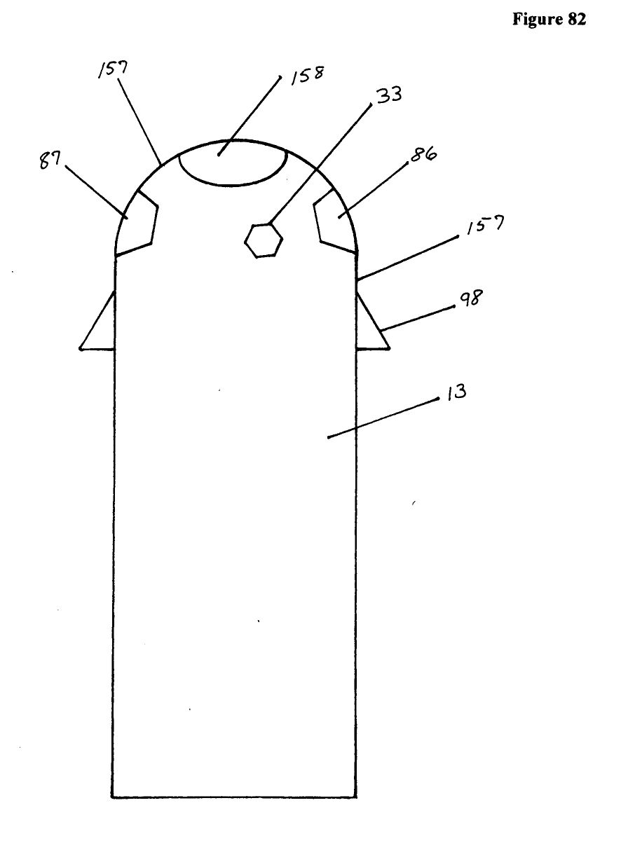

FIG. 82 is a Smart Fire Extinguishment Encasement, with a smart chip. If a fire retardant capsule is deployed to a fire situation, the smart chip employed would target a thermal range between 325° F. to 1,000+° F. The Smart Fire Extinguishment Encasement can be fitted with a visual and/or electronic marker for tagging its target area, and identify pre-ignition areas for targeting of a fire suppressant, fire retardant, or an endothermic agent.

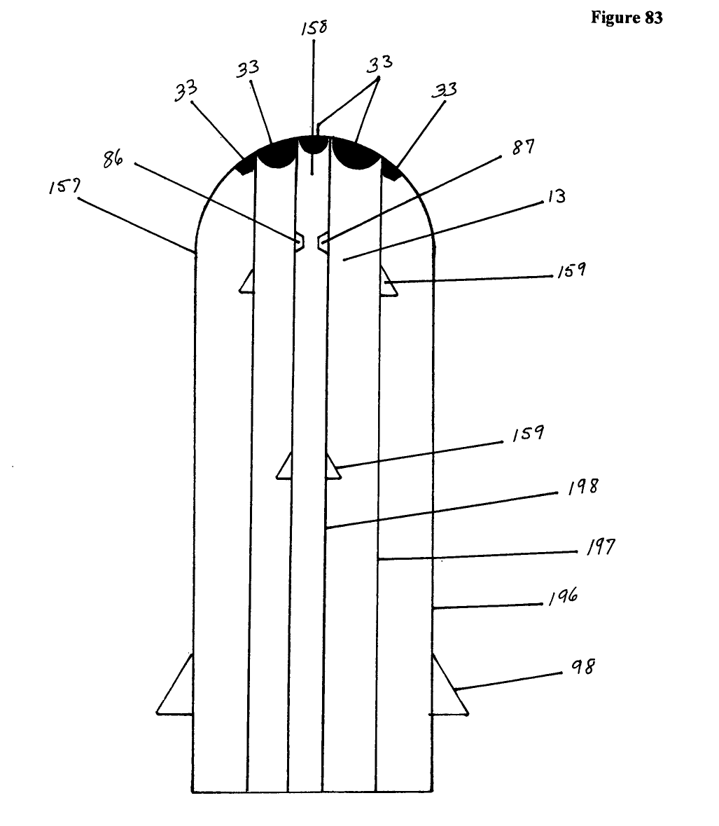

FIG. 83 is a Smart Fire Extinguishment Encasement, with a smart chip, global positioning system, gyroscopic sensor microchip and internal or embedded adjustable stabilizing flanges/wings. As each level of the capsule disintegrates it frees the next level of adjustable wings.

FIG. 84 illustrates the release pattern of a Smart Fire Extinguishment Encasement cited at FIG. 82 and 83.

FIG. 85 illustrates the release pattern of a Smart Fire Extinguishment Encasement cited at FIG. 82 through 83.

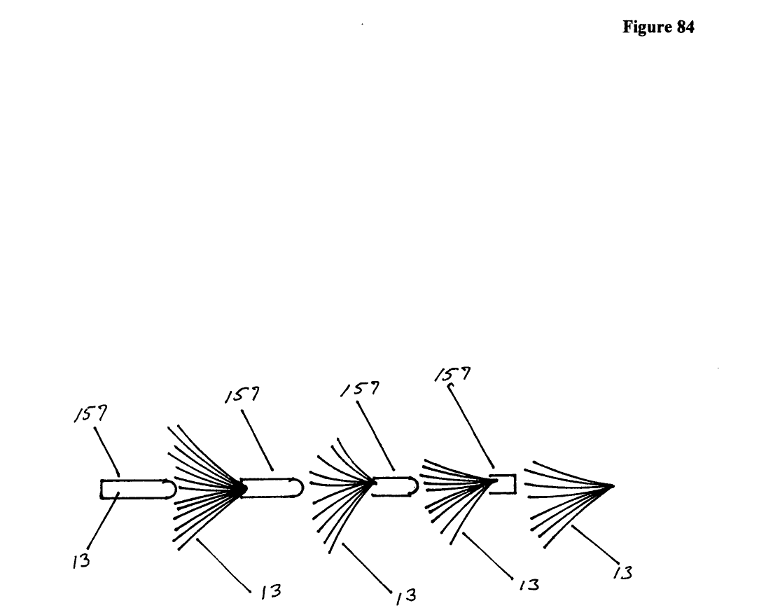

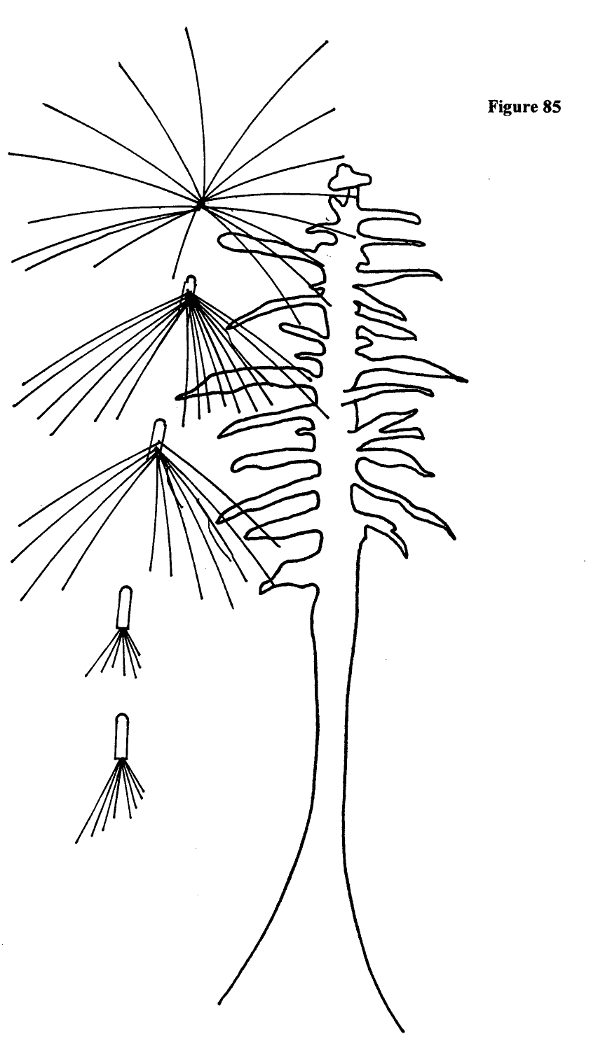

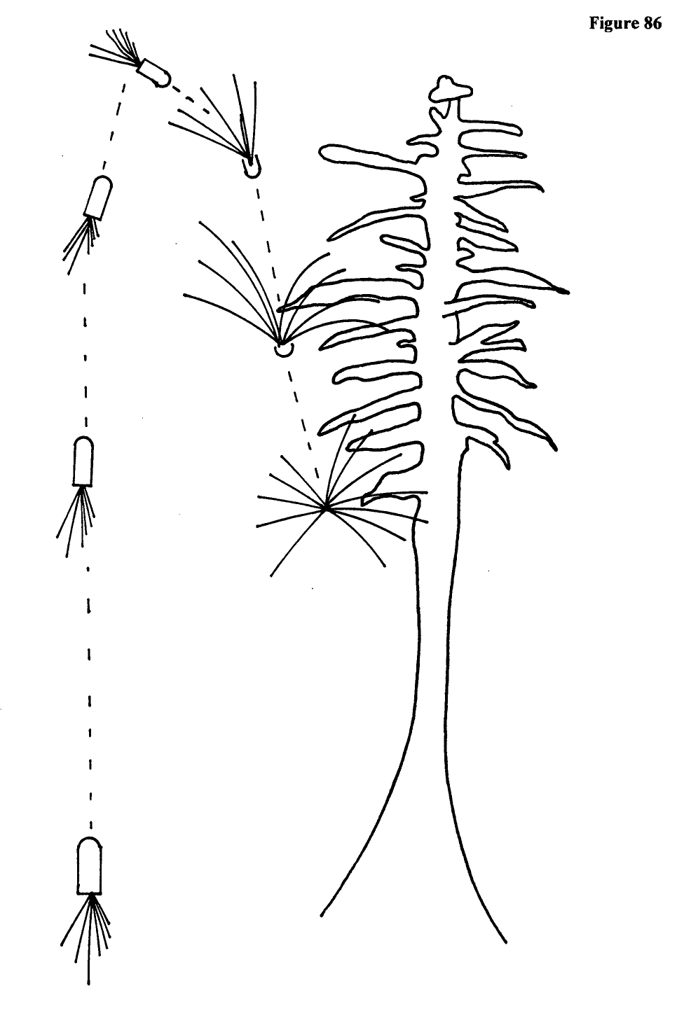

FIG. 86 illustrates the release pattern of a Smart Fire Extinguishment Encasement cited at FIG. 85.

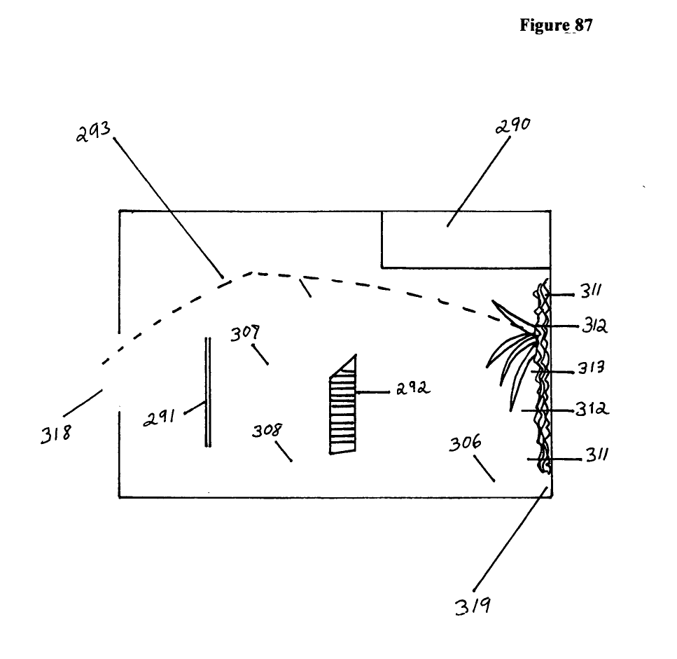

FIG. 87 illustrates and overhead view of the trajectory release pattern for a Smart Fire Extinguishment Encasement projected into a building from an outside position.

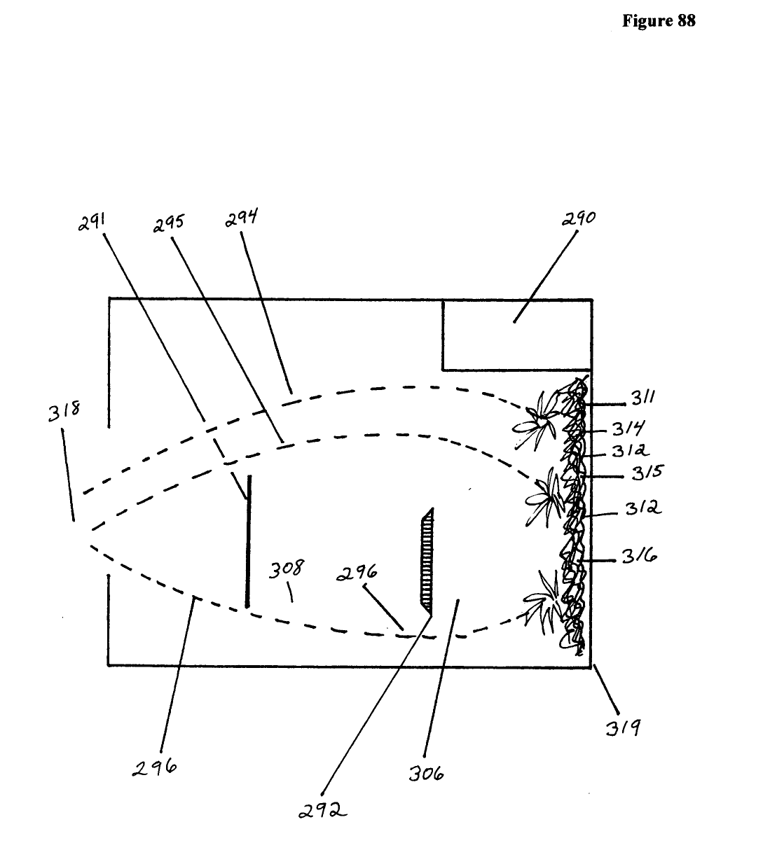

FIG. 88 illustrates the trajectory pathways of three successive Smart Fire Extinguishment Encasements projected into a structure, subsequent to entry of a predecessor Smart Fire Extinguishment Encasement.

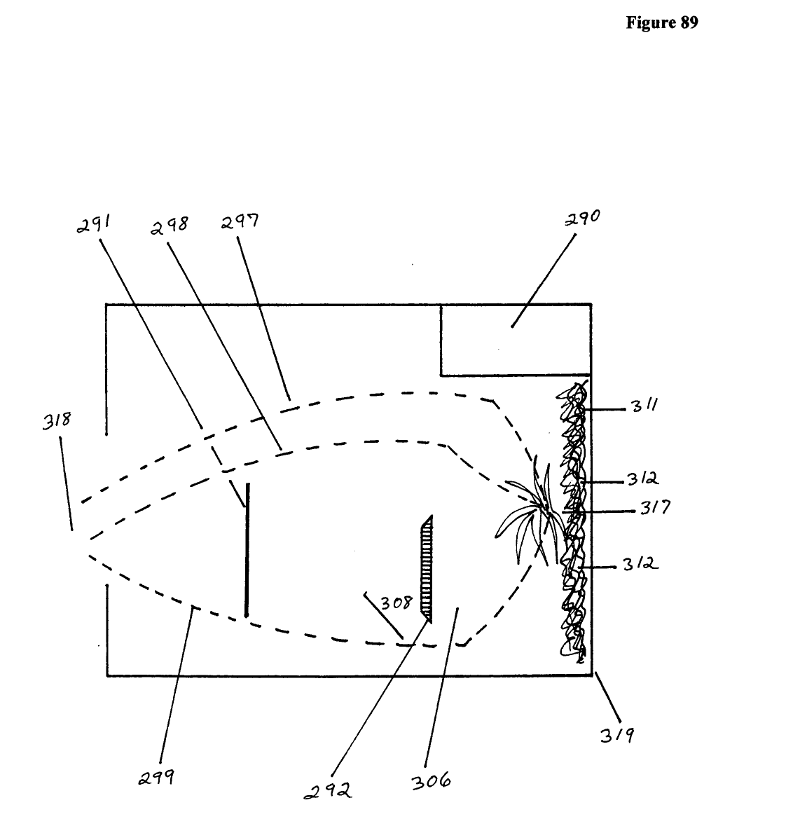

FIG. 89 is a second illustration of FIG. 88, with the exception that each of the Smart Fire Extinguishment Encasements is programmed to strike the same target as its predecessor capsule.

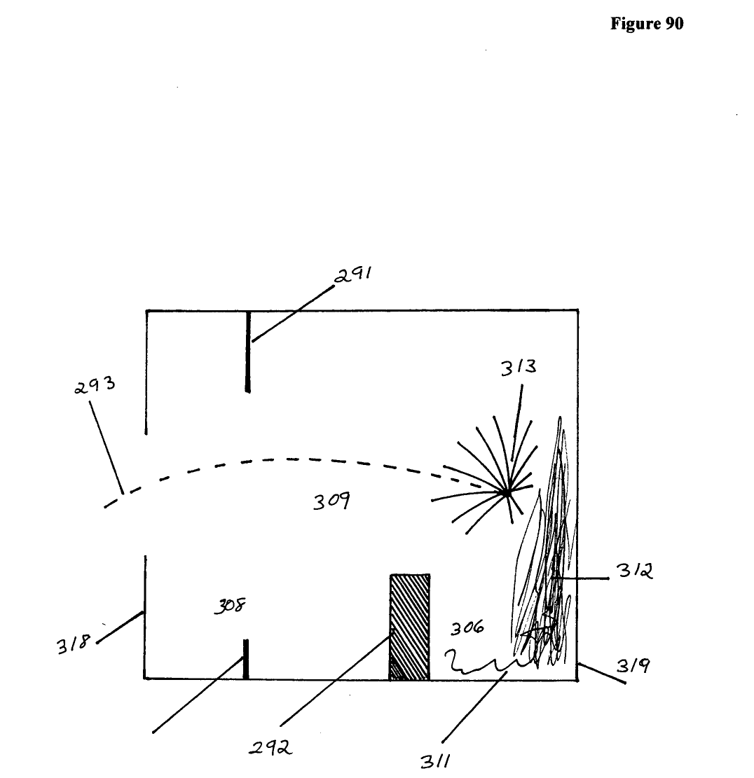

FIG. 90 is a horizontal illustration of FIG. 87.

FIG. 91 is an illustration of the Glass Penetrating Capsule is intended for areas where the only or most viable point of entry to combat a fire is through a window, particularly the upper floors of high rise structures where one's ability to reach to and access the area may be limited to a ground level approach. This is a two-part system where the outer capsule or Glass Penetrating Capsule serves as the carrier module containing a fire suppressant capsule that will eventually enter the structure and target the fire. This system is one method of reaching the upper levels of a structure from or near a ground level position.

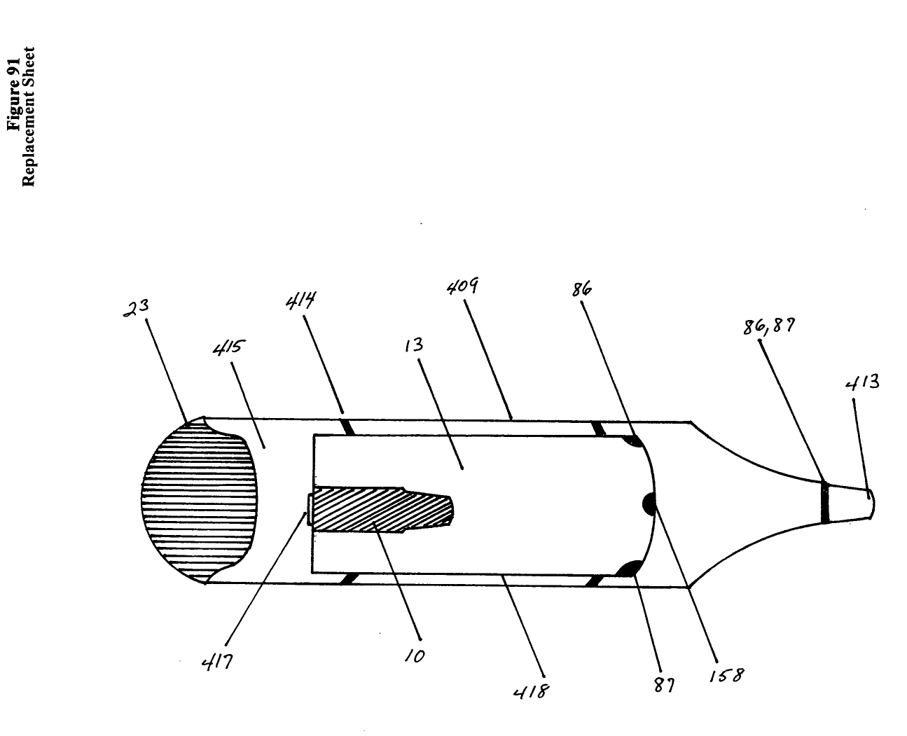

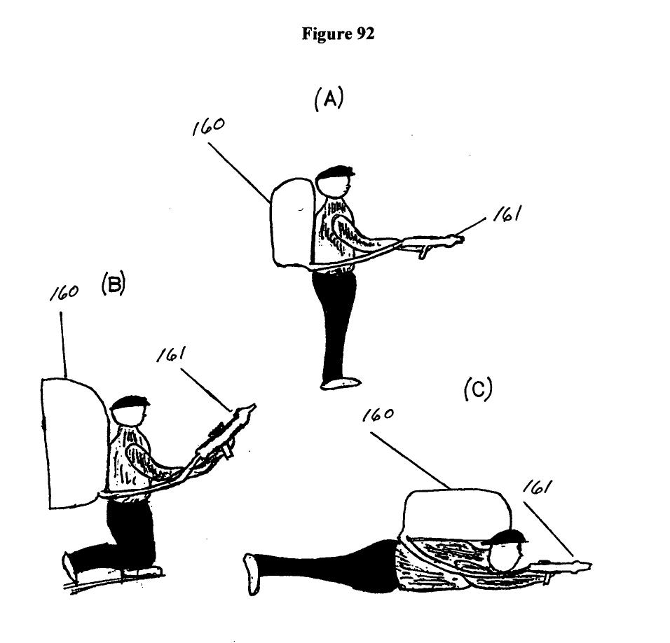

FIG. 92 is the light weight, insulated, Personal Carrier a backpack type system that is fitted with a Smart Fire Extinguishment Encasement.

The purpose of the Personal Carrier and its a Smart Fire Extinguishment Encasement launcher, is to give fire fighters and fire jumpers the ability to walk directly into a fire situation with a high concentration of encapsulated fire suppressants at hand, for immediate pinpoint or line of sight deployment.

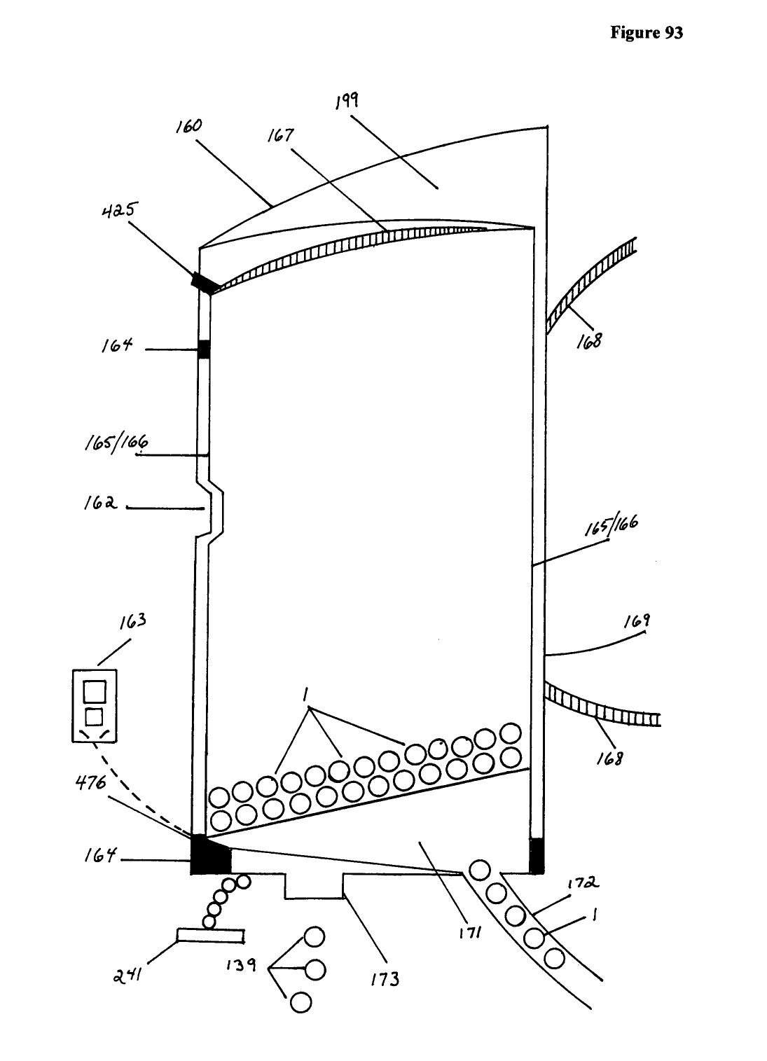

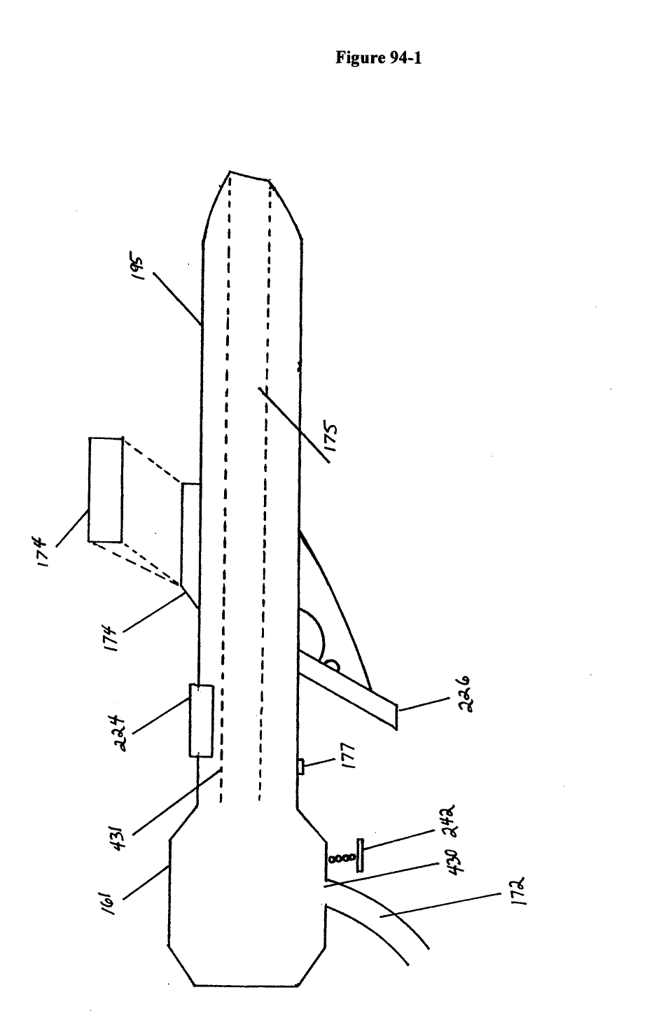

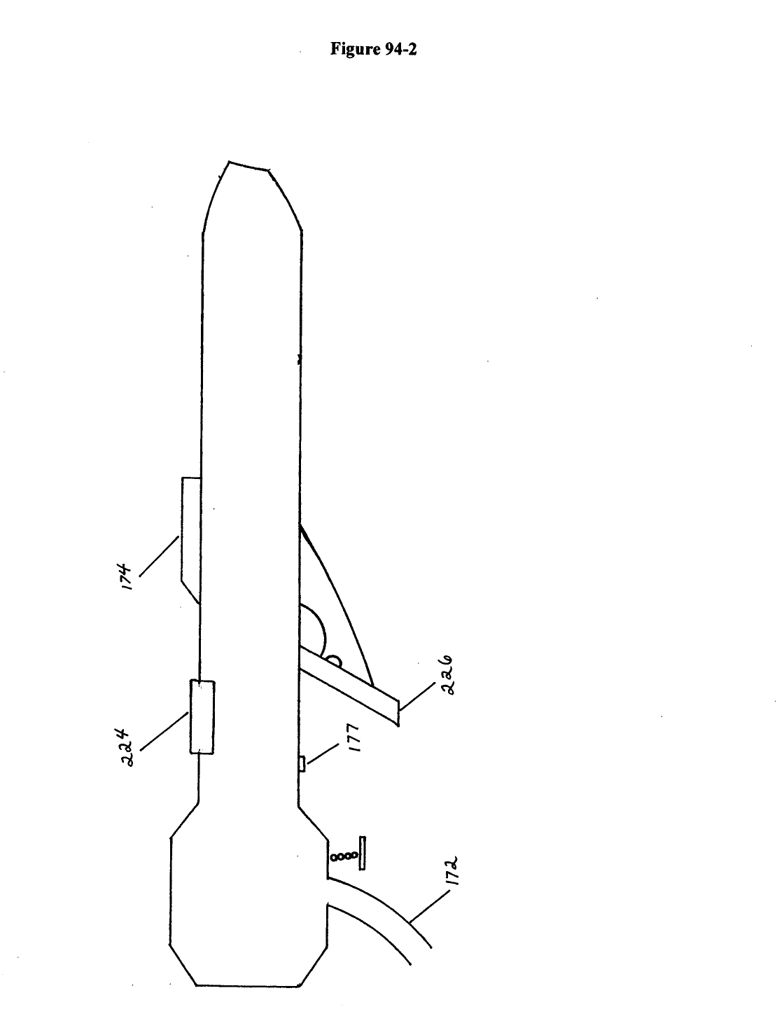

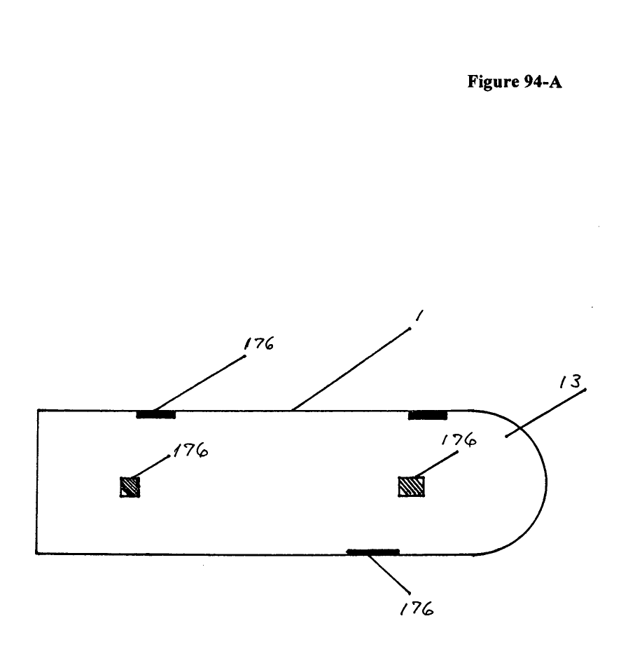

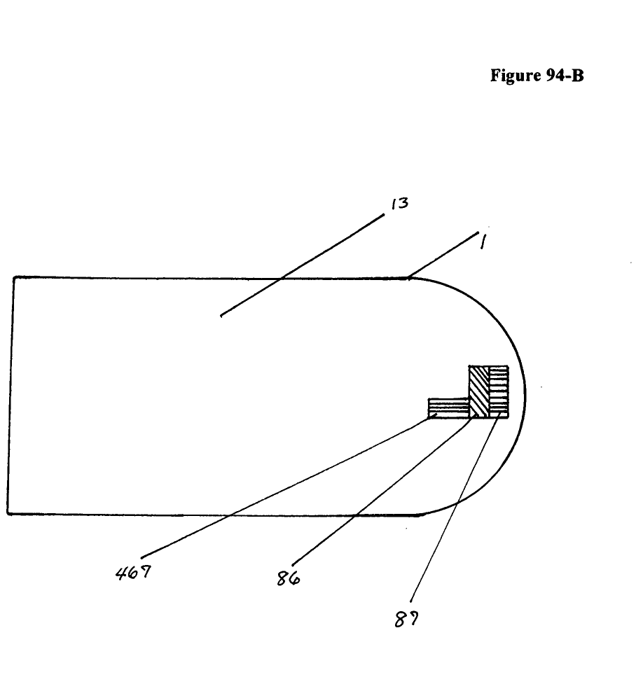

FIG. 93 illustrates the Personal Carrier with sequentially numbered capsules that can be electronically programmed en masse or individually, after being loaded into the Personal Carrier, through the use of an external programming module or a removable hand-held programming module (see, FIG. 94) that plugs into an external docking port.

FIG. 94 is a lateral and partially exploded view of the Personal Carrier's Launcher, with an exploded view of the Launcher's capsule programming module.

FIGS. 94-A and 94-B are lateral views of a generic fire suppressant capsule for use in the operation of the Personal Carrier's Launcher

FIG. 95 is a cross-sectional view from FIG. 94, showing the interior of the Launcher's barrel and the redundant electronic contact points used to program each fire suppressant capsule.

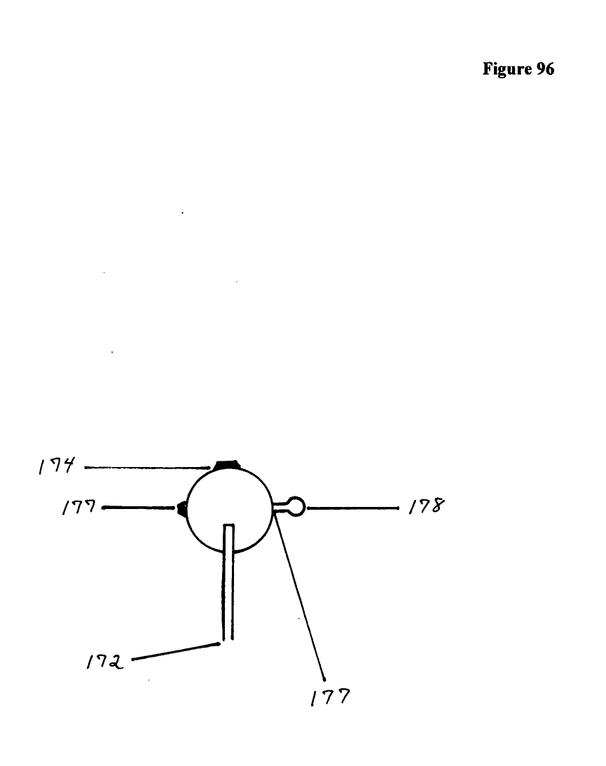

FIG. 96 is a partial rear-view of the Fire Extinguishment Encasement Launcher, showing the programmable module and gas canister port and gas canister.

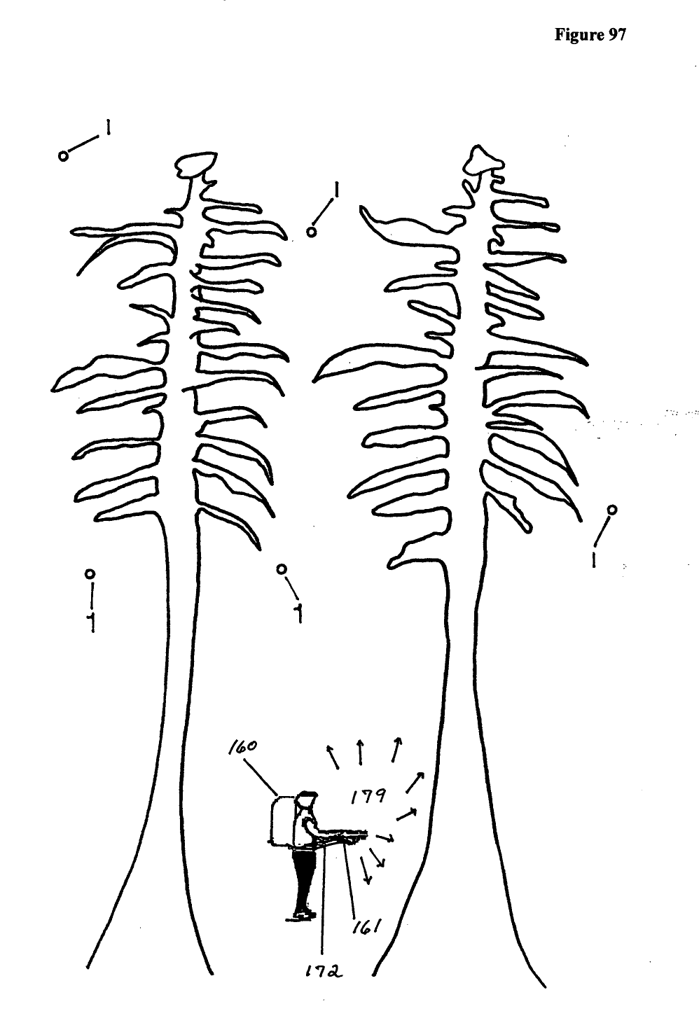

FIG. 97 illustrates the projection pattern of fire suppressant capsules fired from the Launcher of FIG. 94, into a forest fire zone.

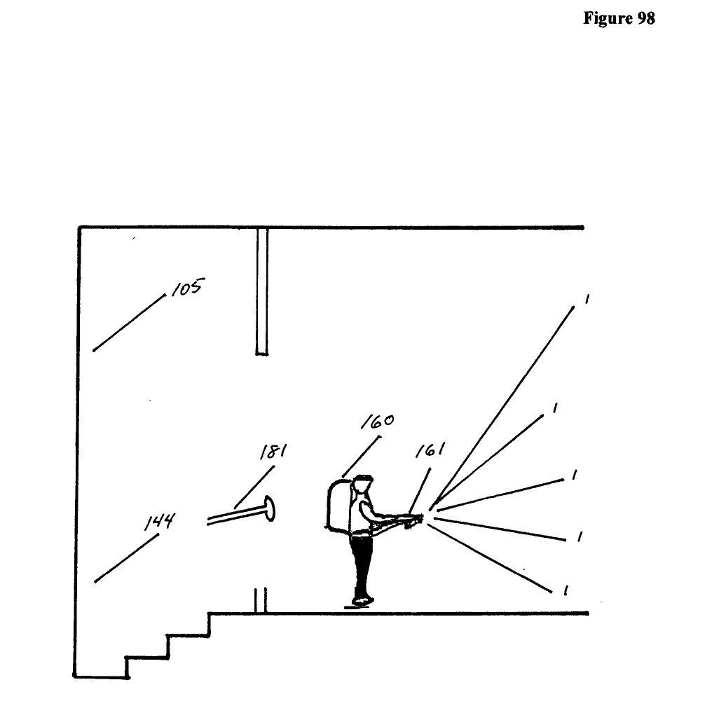

FIG. 98 illustrates the limited reach of a fire hose when entering from the stairwell of a burning structure or high-rise building, contrasted to a fire fighter using the light weight, insulated, Personal Carrier system loaded with programmable fire suppressant capsules, and fitted with a Smart Fire Extinguishment Encasement launcher.

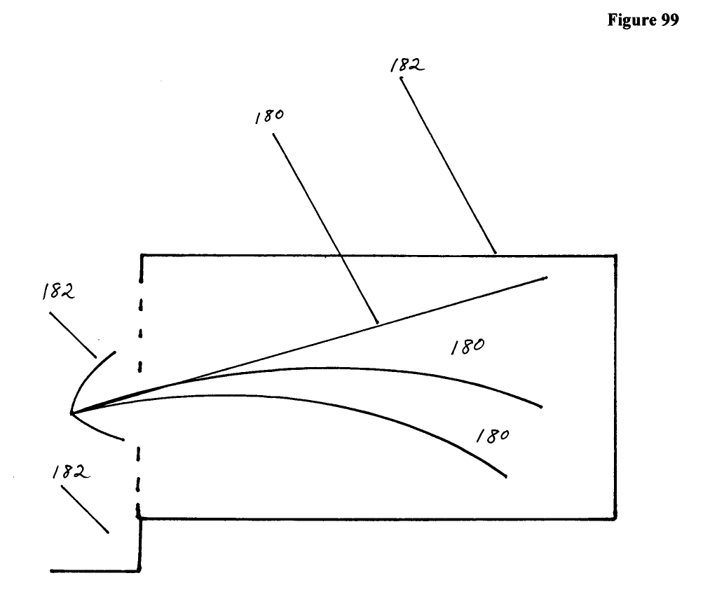

FIG. 99 illustrates what can be the limited reach of water projected from a fire hose by a fire fighter restricted to standing outside a burning structure. This illustration, along with FIG. 100, represents one of several limiting aspects faced by fire fighters using conventional methods to put down a fire.

FIG. 100 illustrates the arcing pattern and limited reach of water projected from a fire hose by fire fighters standing outside a burning two-story structure, and the use of a aerial fire hose to reach a second or higher floor of a structure.

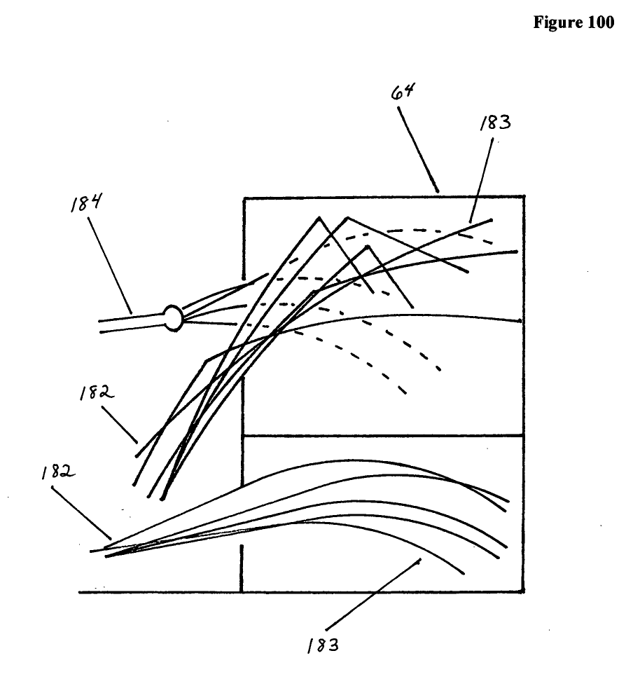

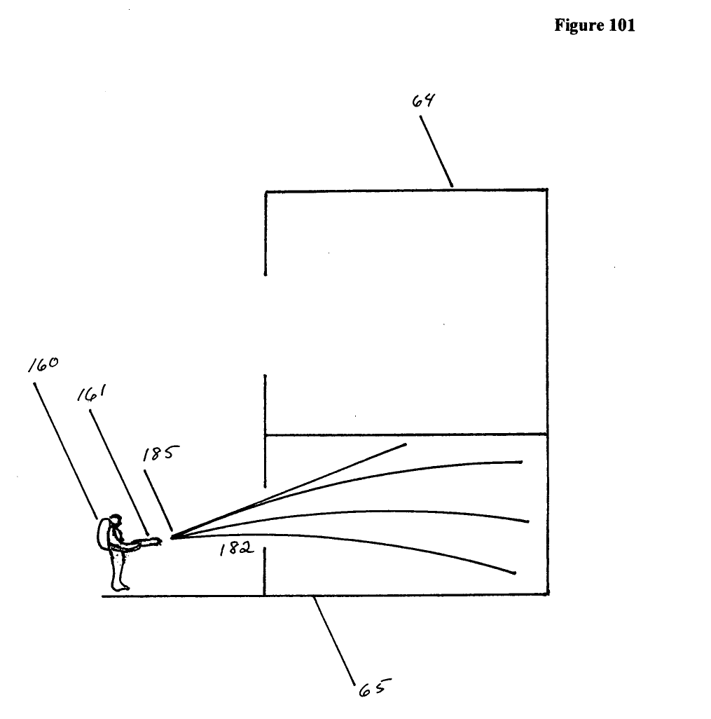

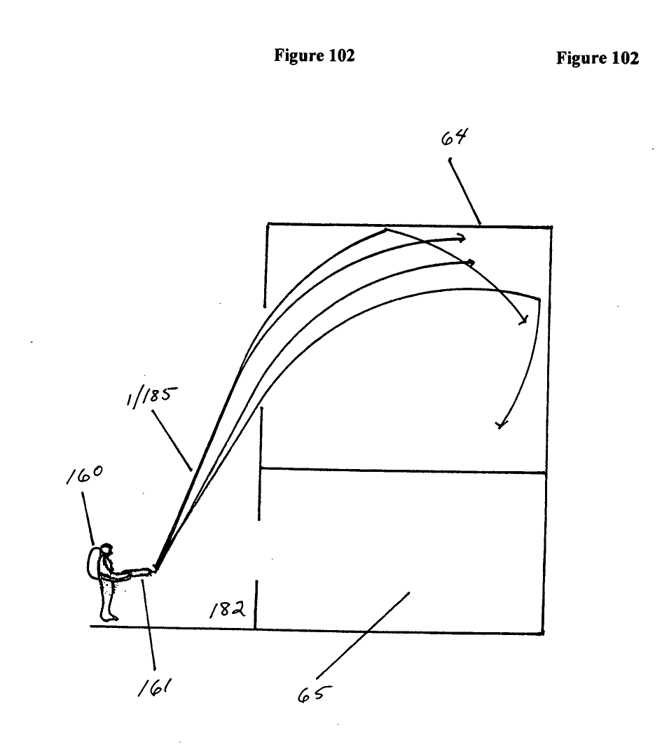

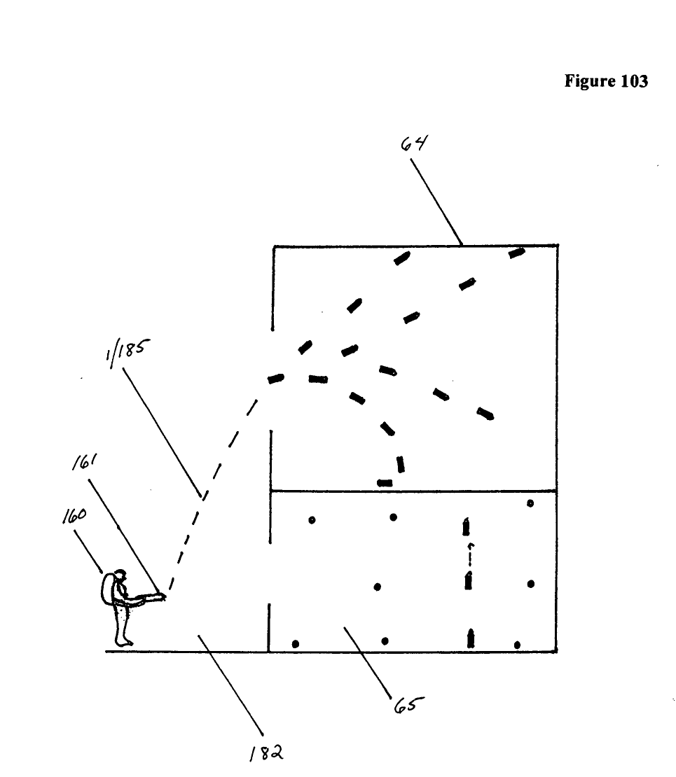

FIGS. 101, 102 and 103 illustrate the trajectory pattern of fire suppressant capsules projected into a ground floor structure and to the second floor (or higher) of a structure, by fire fighter using a Launcher while standing outside the burning structure.

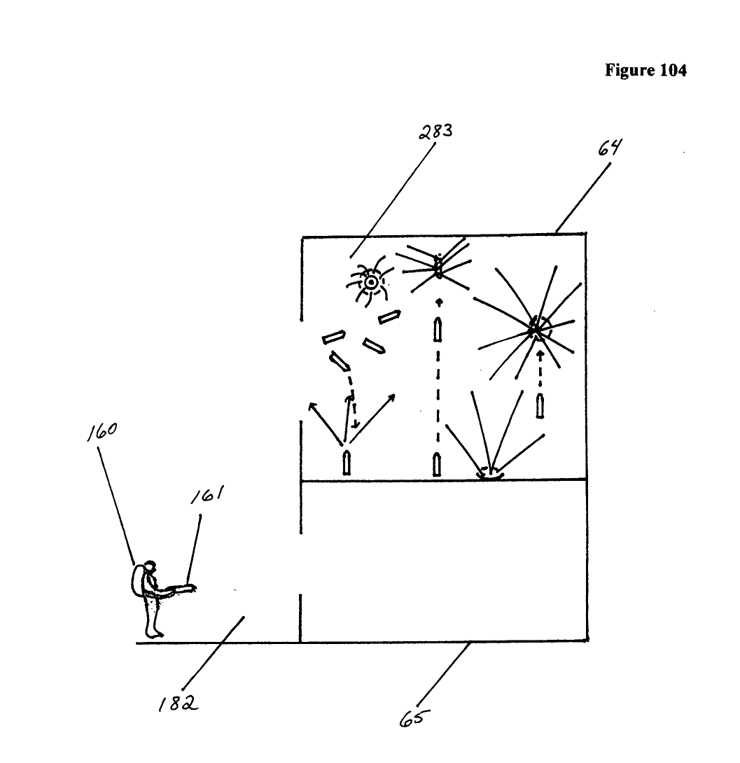

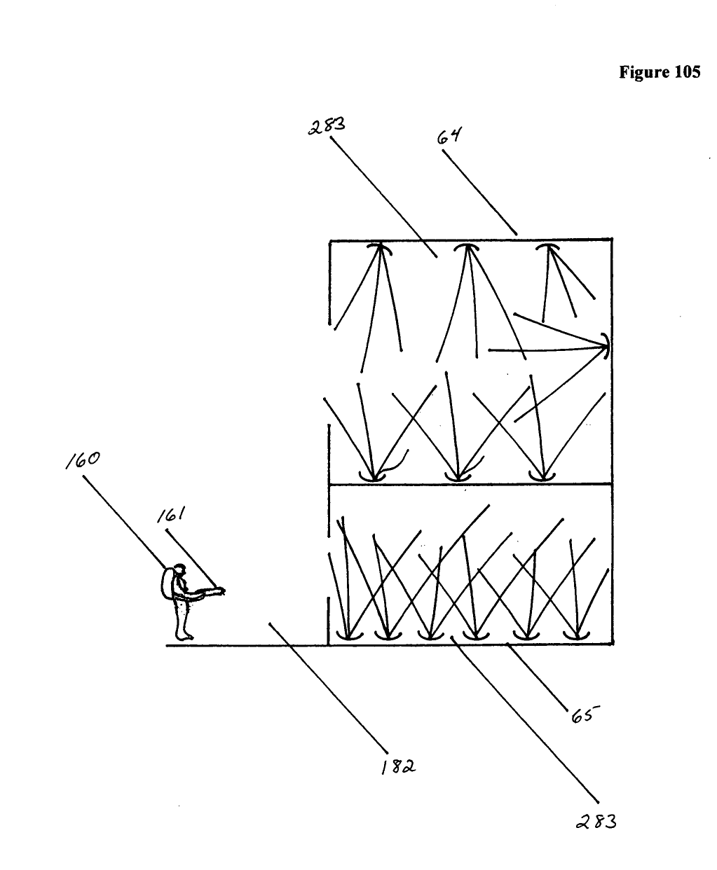

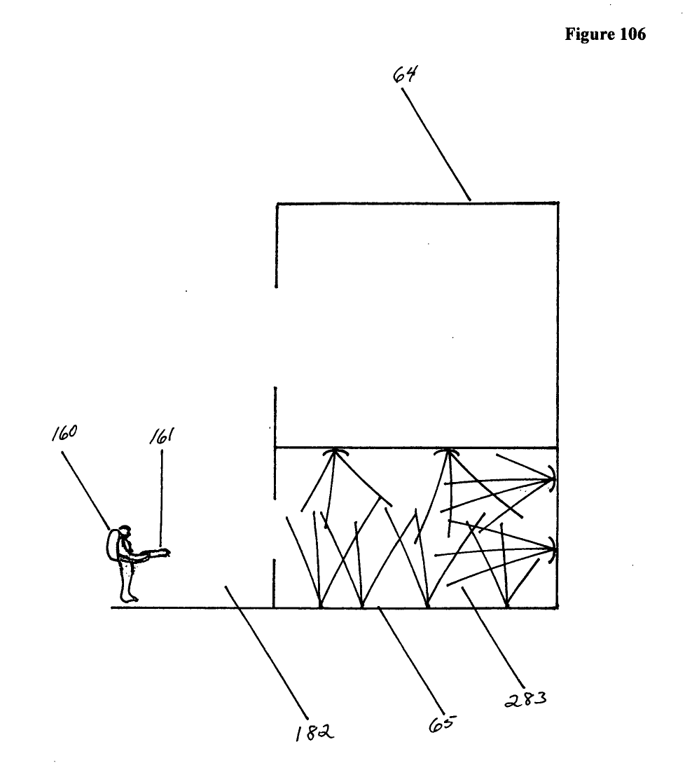

FIGS. 104, 105 and 106 illustrates the dispersal pattern of fire suppressants discharged from the capsules projected into a structure.

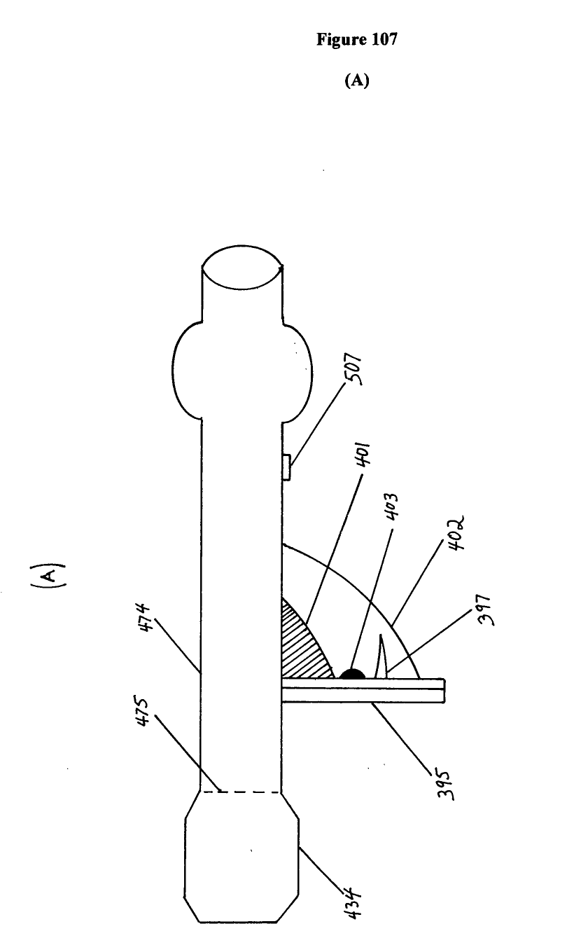

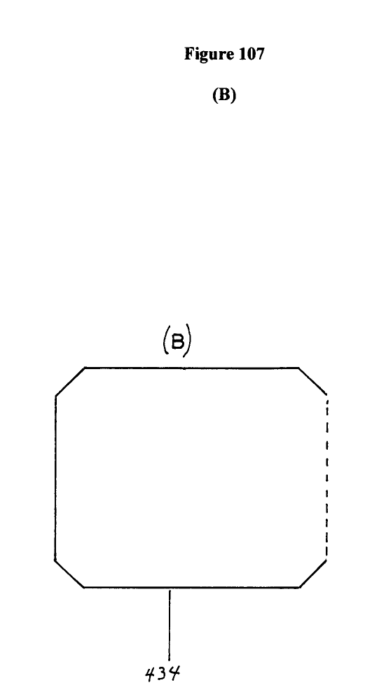

FIG. 107 illustrates a Launcher, as in FIG. 94, modified to accept a rear-loading fire suppressant capsule magazine.

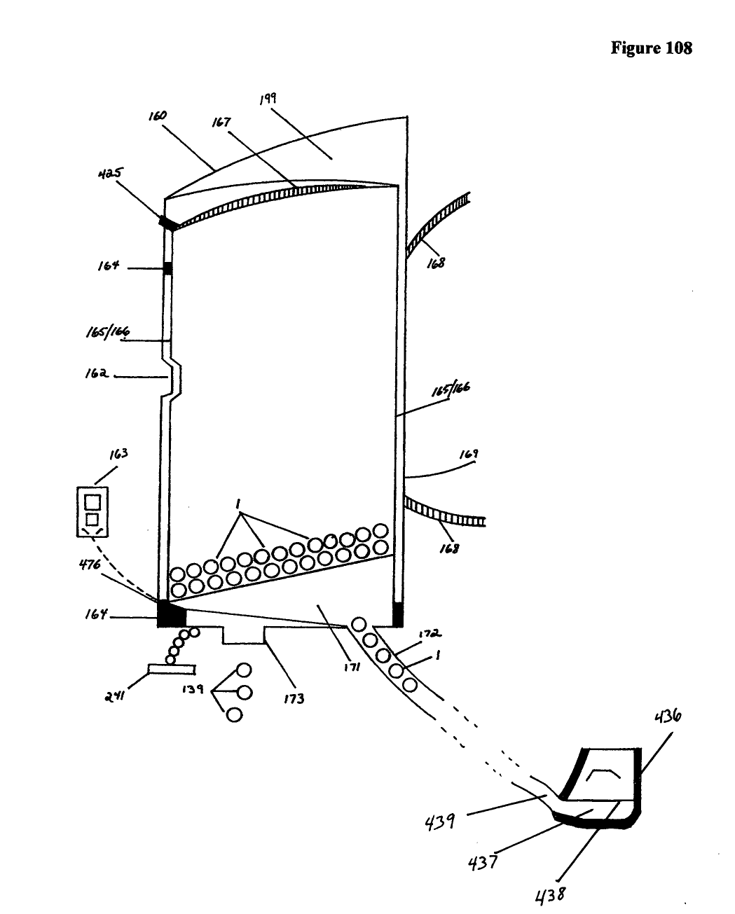

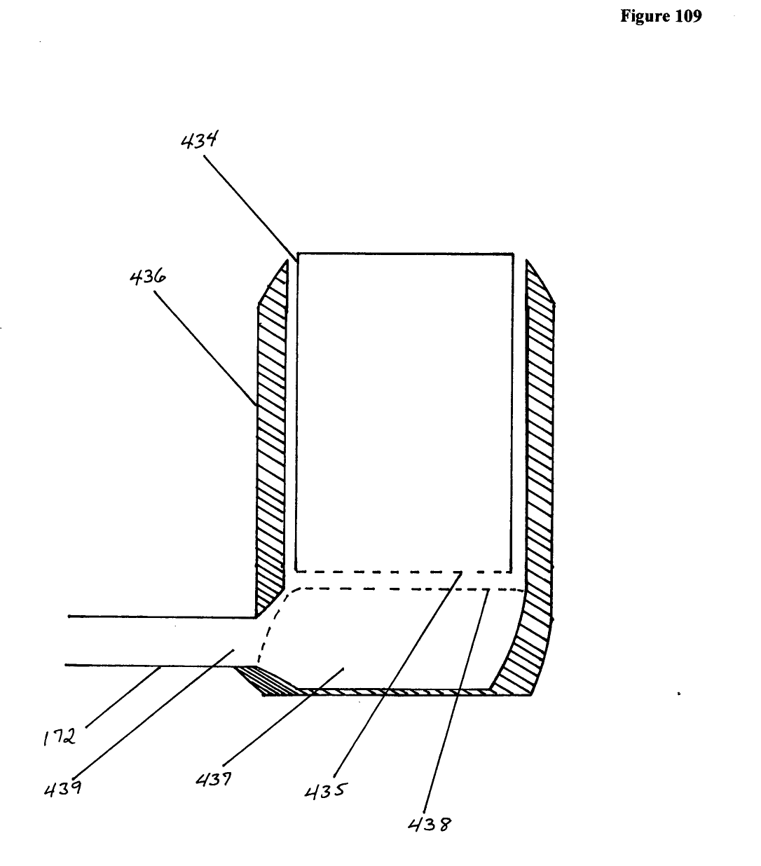

FIGS. 108 and 109 illustrate a modification to the Personal Carrier of FIG. 94 and 95, to accommodate use of the Fire Suppressant Capsule Magazine of FIG. 107.

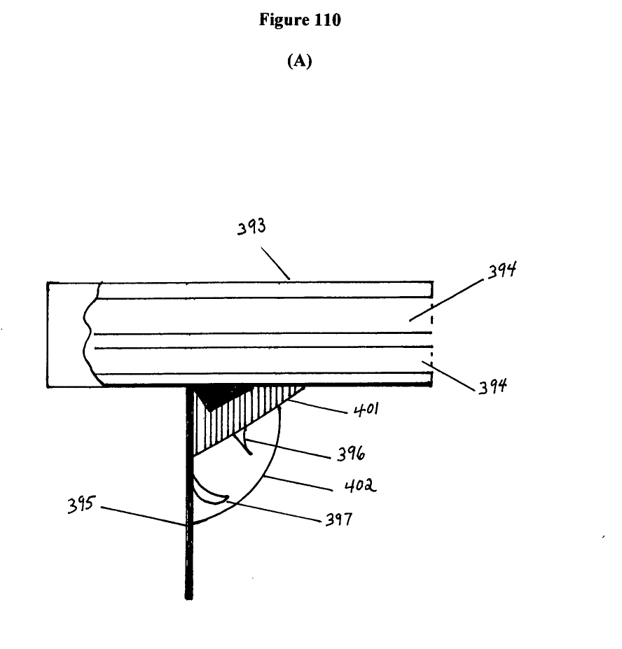

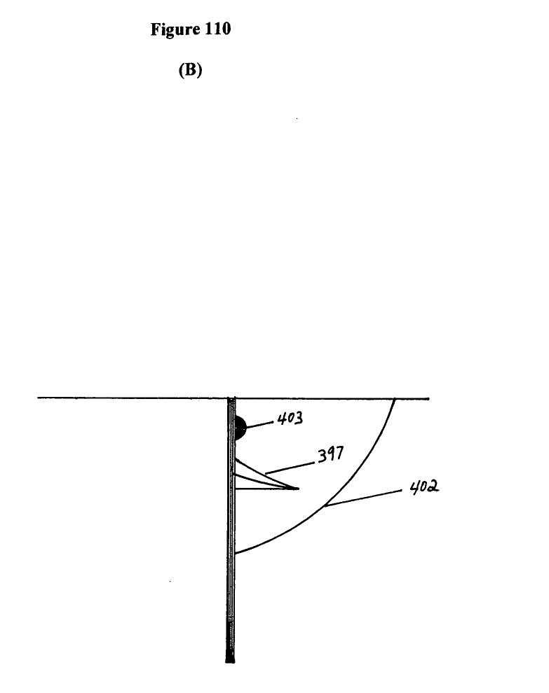

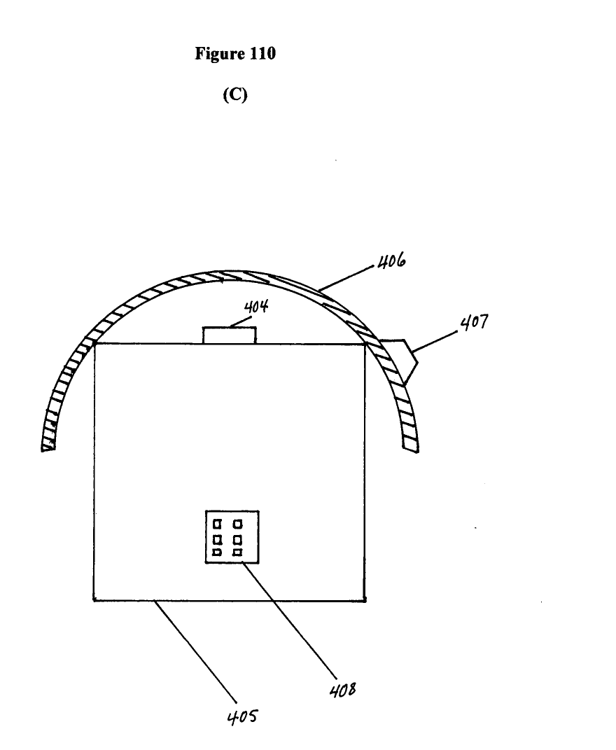

FIG. 110 illustrates Shoulder-mount Multiple-tube High-speed Capsule Launcher is a multiple, reusable, re-loadable, short barrel system similar in design and function as FIG. 94 and 95, comprised of two-to-four barrels or launch tubes and the same features as in FIGS. 94 and 95: except for the absence of the flex tube, the front or top drop loader and the fire suppressant capsule magazine.

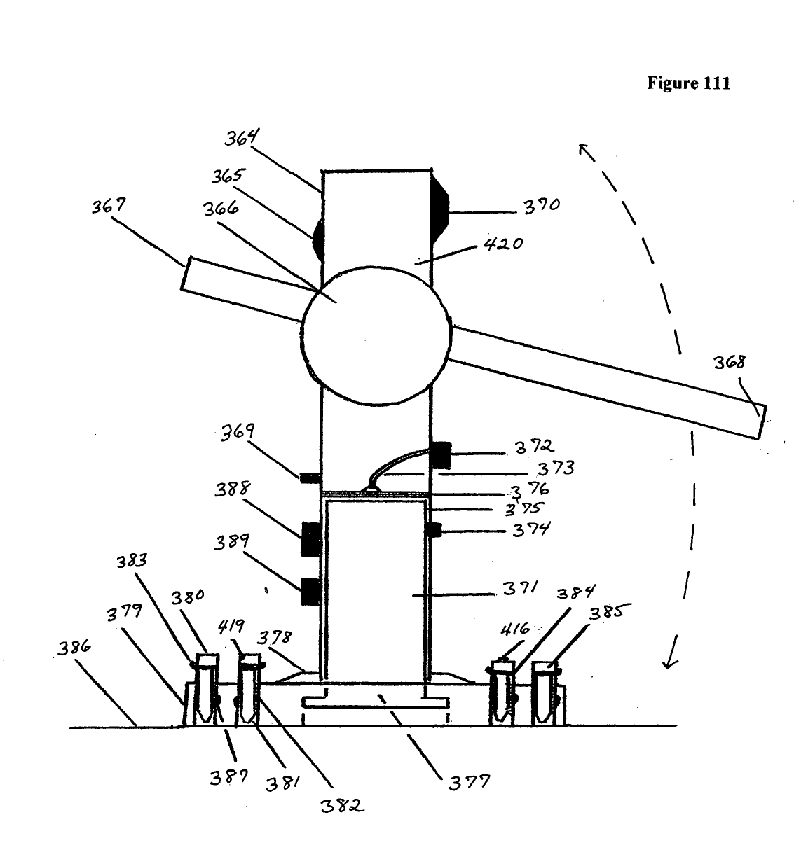

FIG. 111 illustrates the Stationary Anchored Fire Suppressant Capsule Launcher, capable of lifting into firing position capsules/canisters that are too large for use by hand, shoulder mount or other launchers, that will be projected from a ground position into (or above) a fire zone, such as a major forest fire.

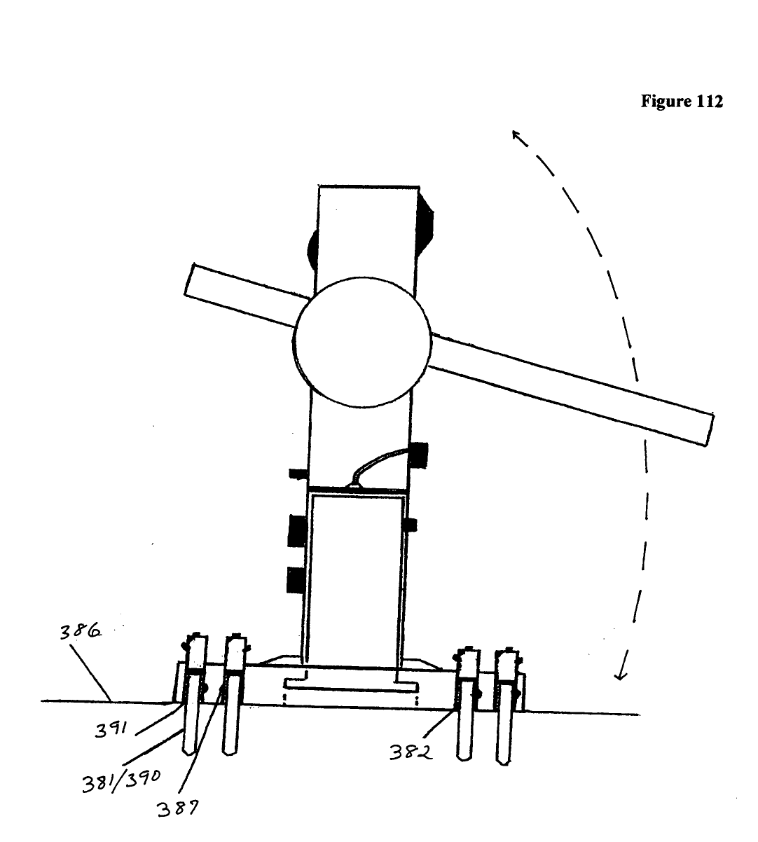

FIG. 112 further illustrates the anchoring mechanism of FIG. 111, where the steel spikes have been driven through the ground.

FIG. 113 illustrates the use of the push rod to free the Stationary Anchored Fire Suppressant Capsule Launcher from its anchored position.

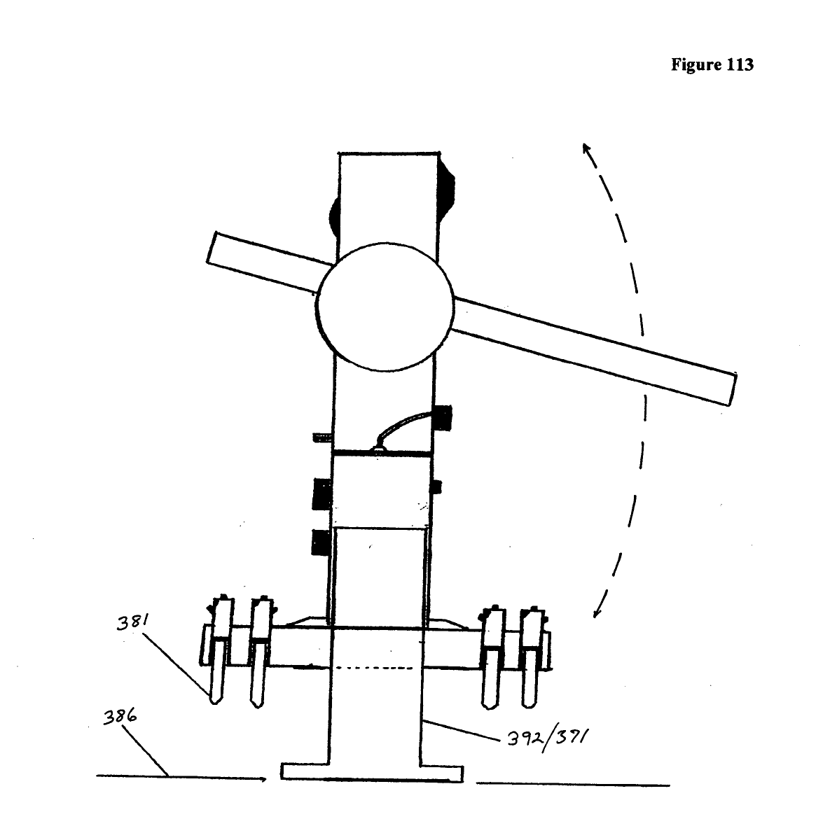

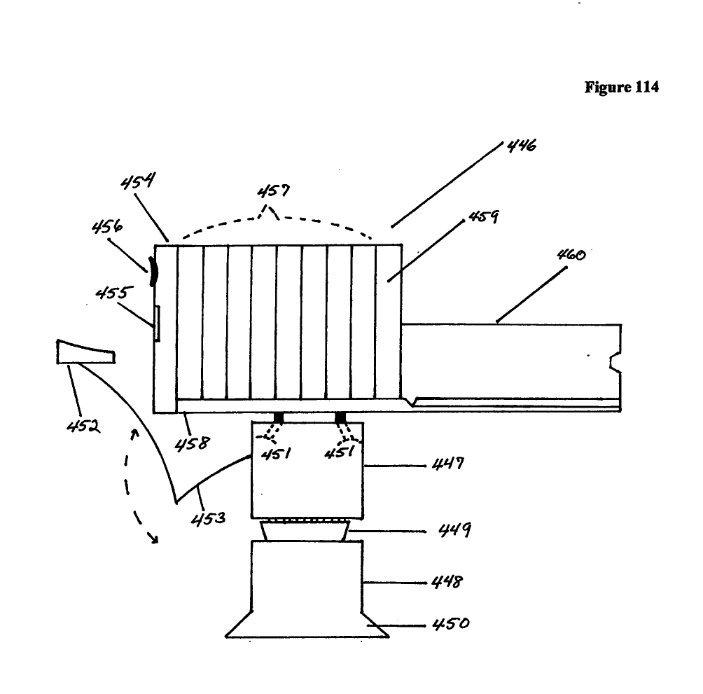

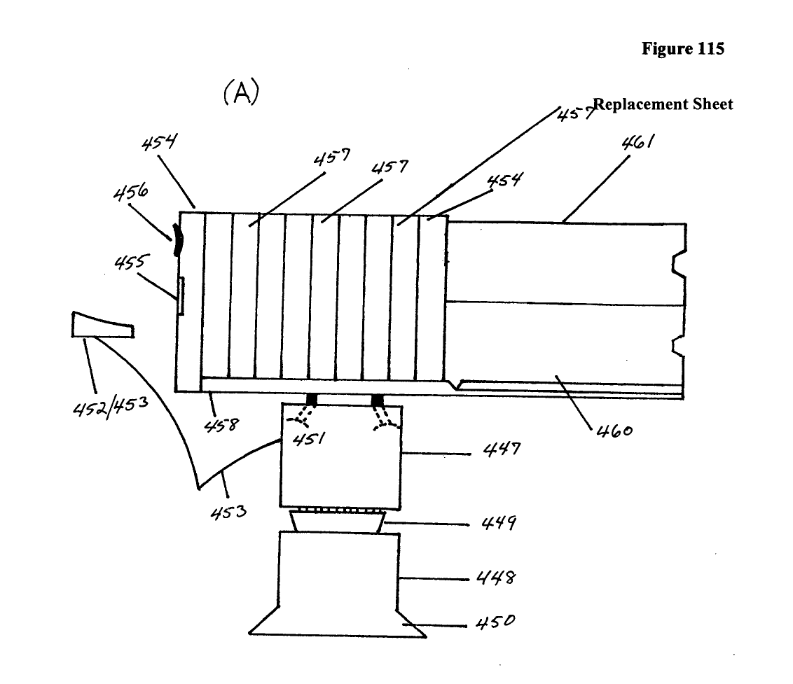

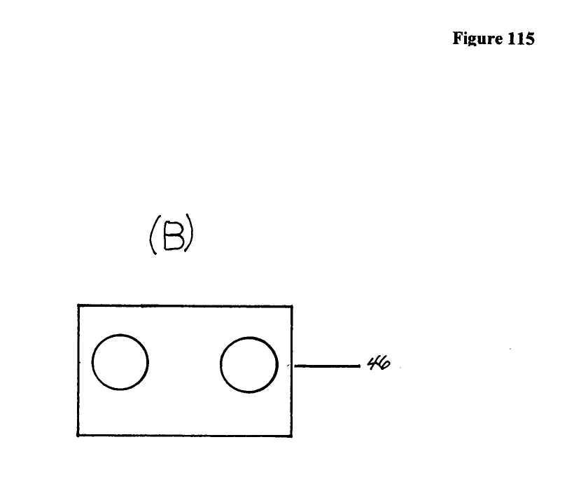

FIGS. 114 and 115 illustrate a rotating, Vehicle Mounted Multi-tube Fire Suppressant Capsule Launcher.

FIG. 115 illustrates the same system at FIG. 114, but with a dual level launcher (barrel) housing: showing a two-and four-barrel configurations.

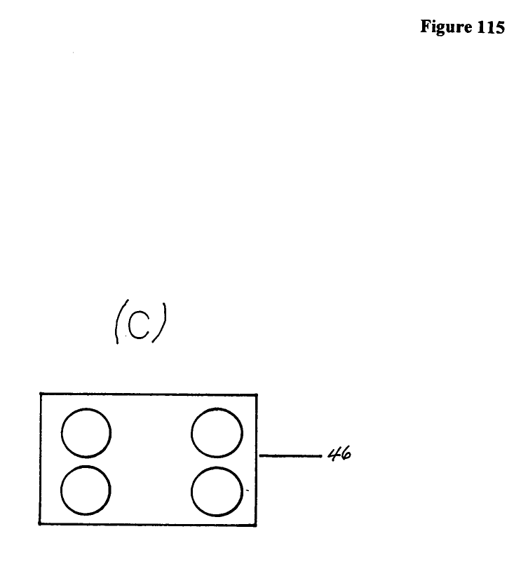

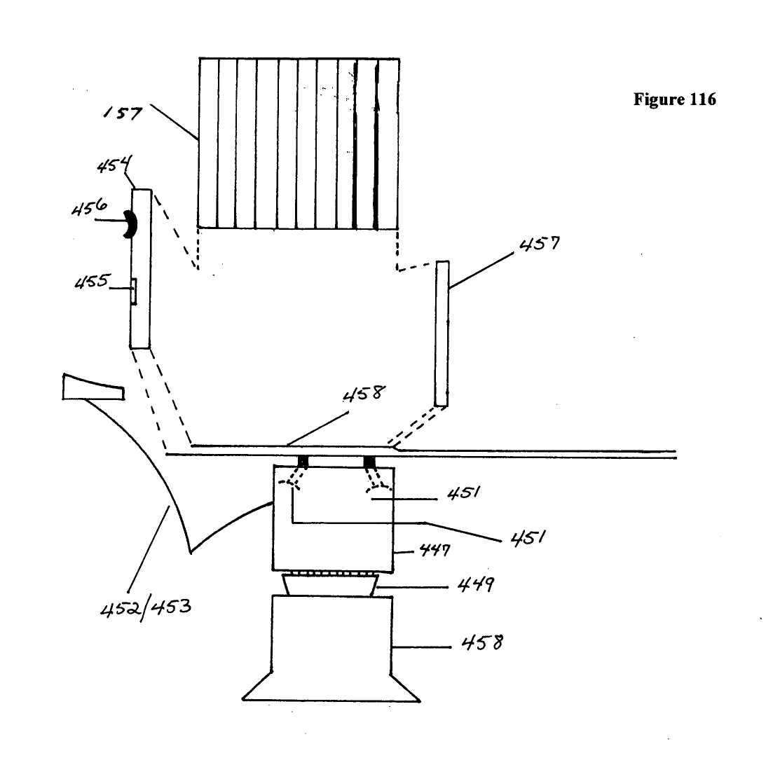

FIG. 116 is a partially exploded view of the FIG. 114's and 115's Launcher platform.

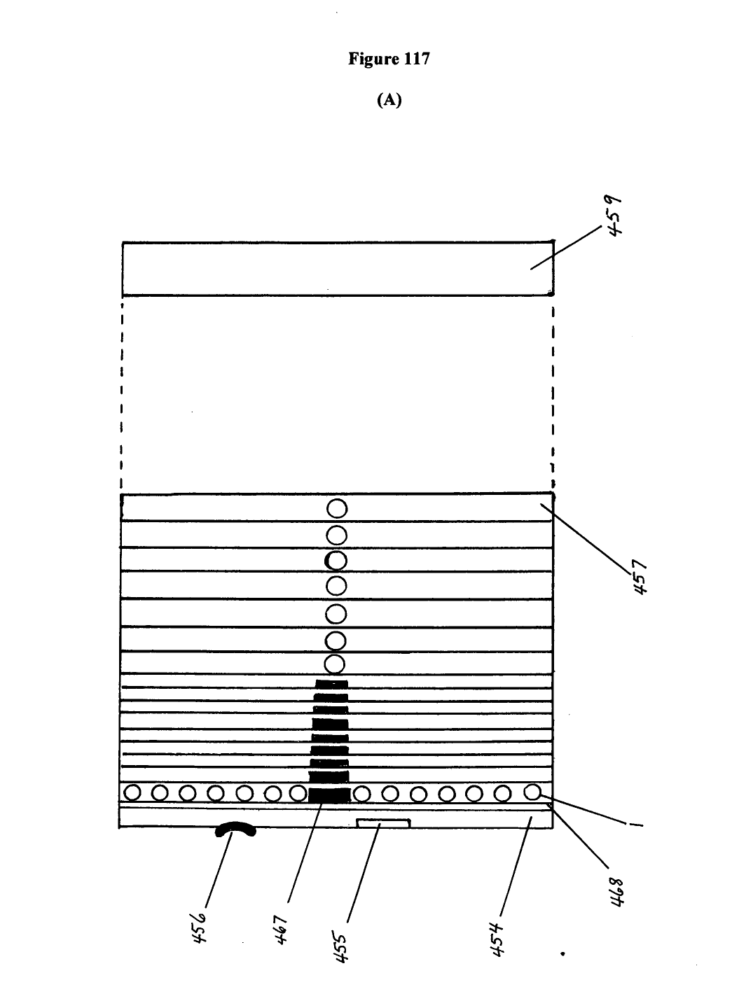

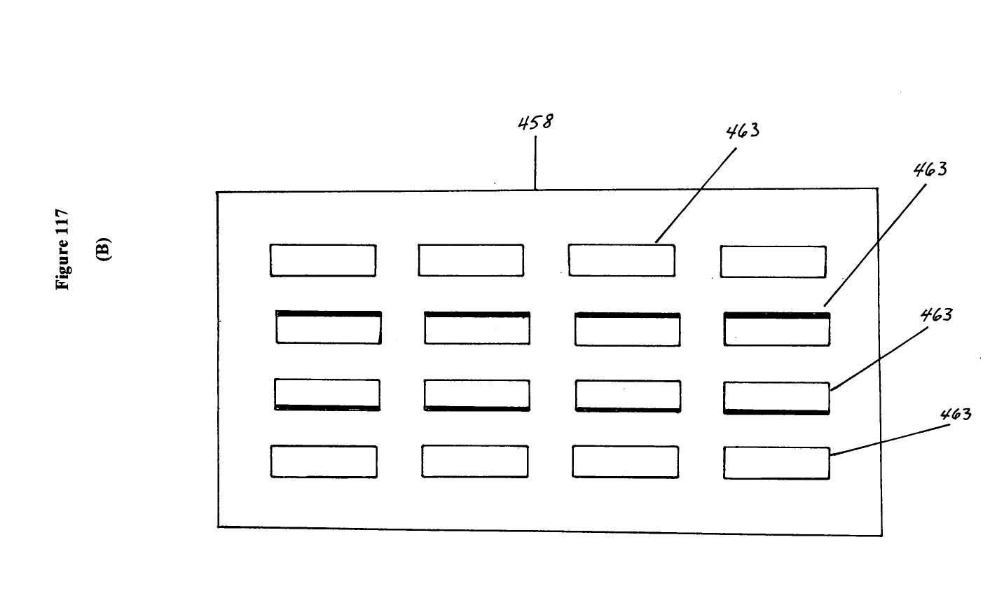

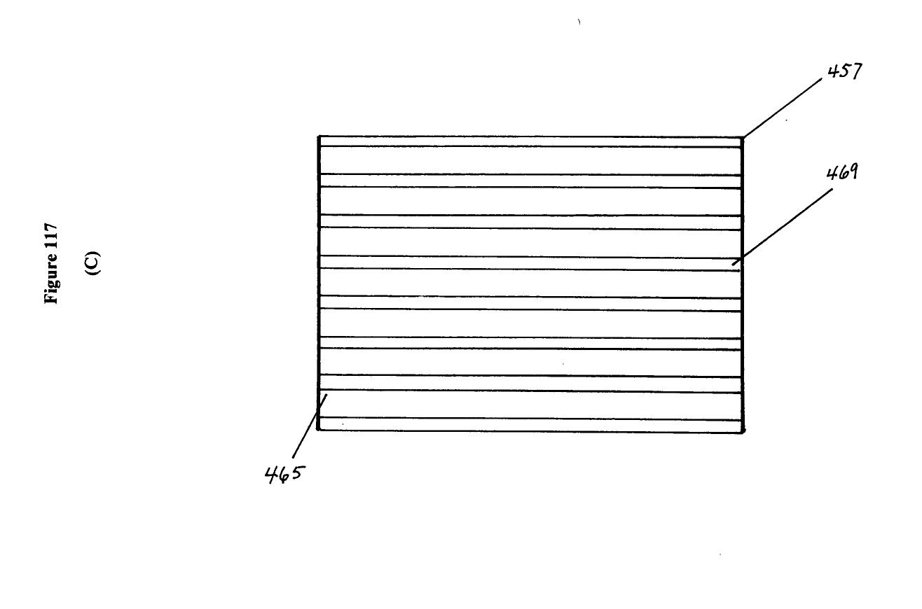

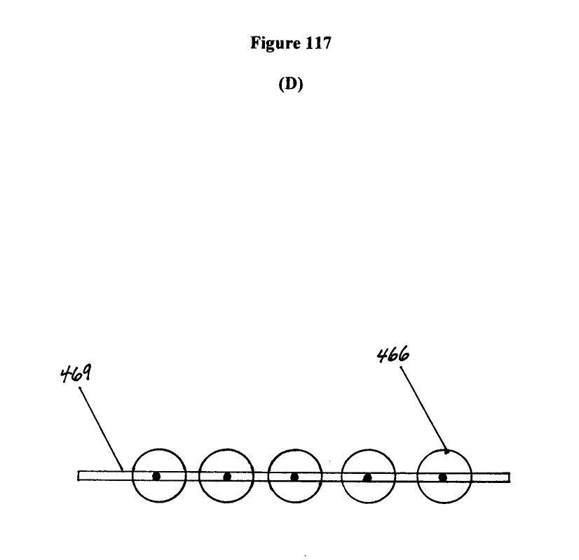

FIG. 117 illustrates an additional option for the loading of fire suppressant capsules to FIGS. 114 and 115.

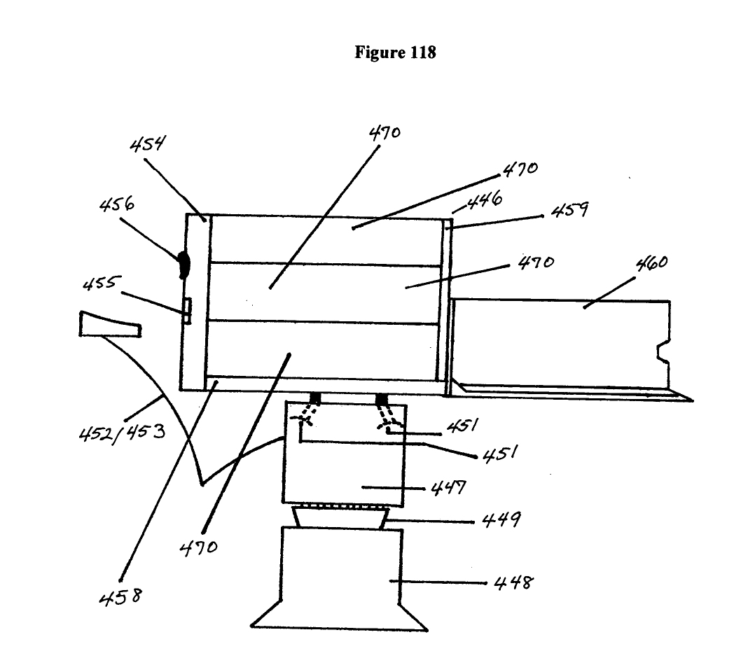

FIG. 118 illustrates a third representation of FIGS. 114 and 115, where the vertical containment racks have been replaced with horizontal containment racks or tubes, containing a miniature roller assembly of FIG. 117.

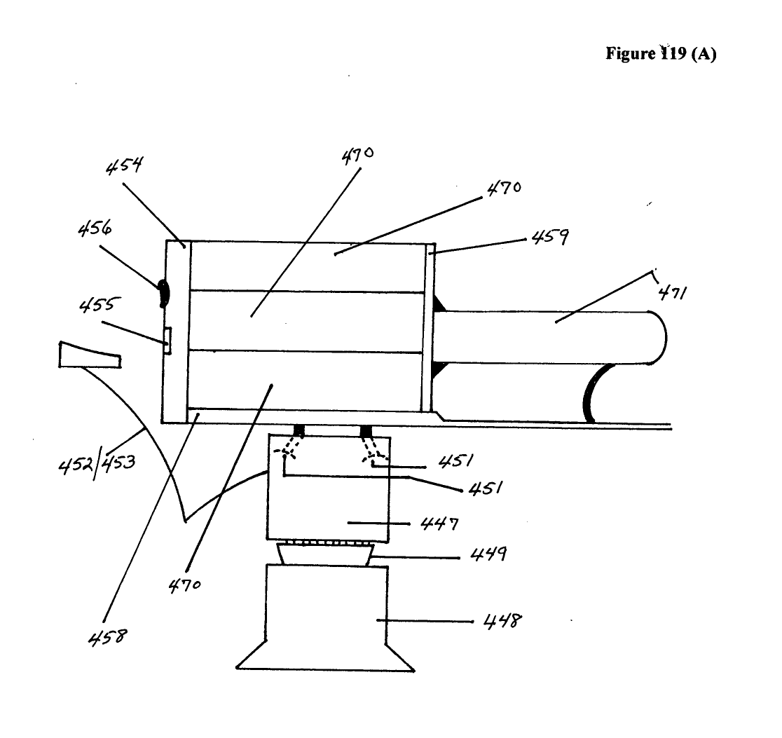

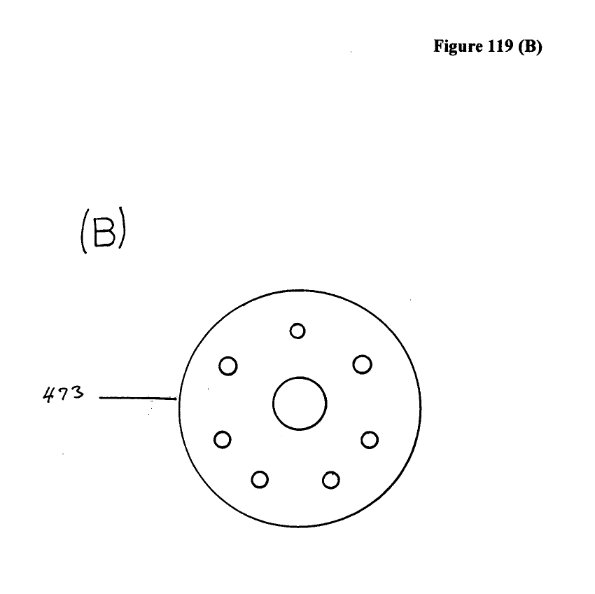

FIG. 119 illustrates FIG. 118 with a single rotating launcher assembly, resembling the operational function of a Gatling Gun, Machine Gun, or Phalanx Gun, or similar system.

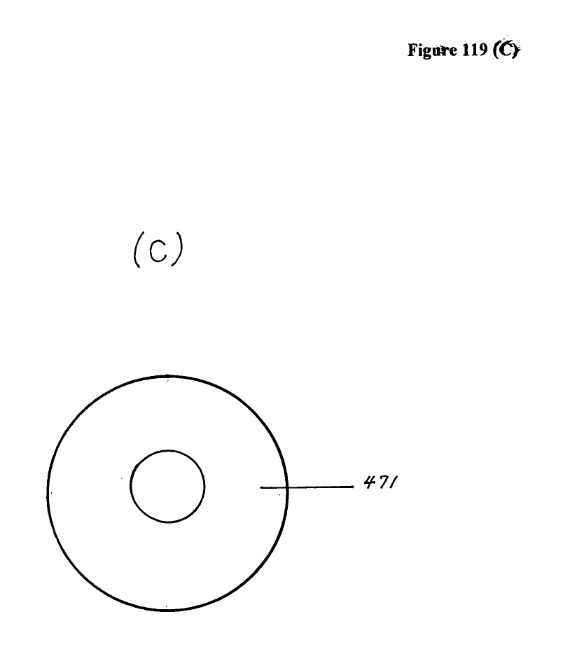

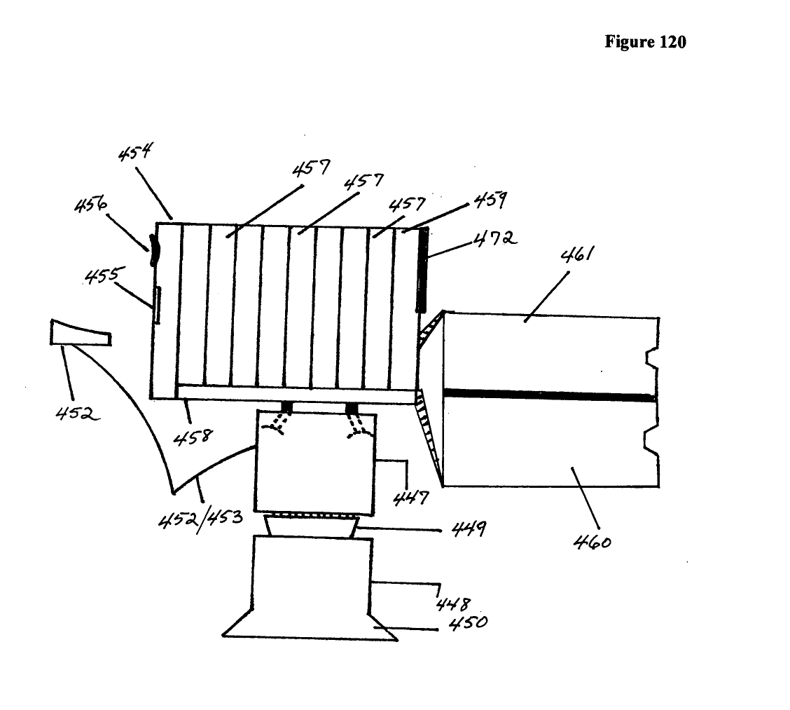

FIG. 120 illustrates FIG. 118 with a vertical movement single or dual level launcher housing.

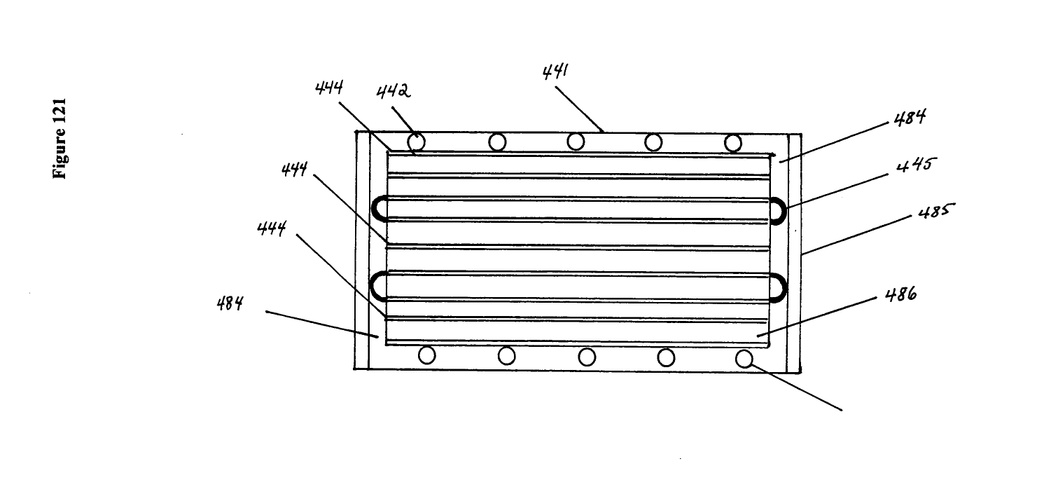

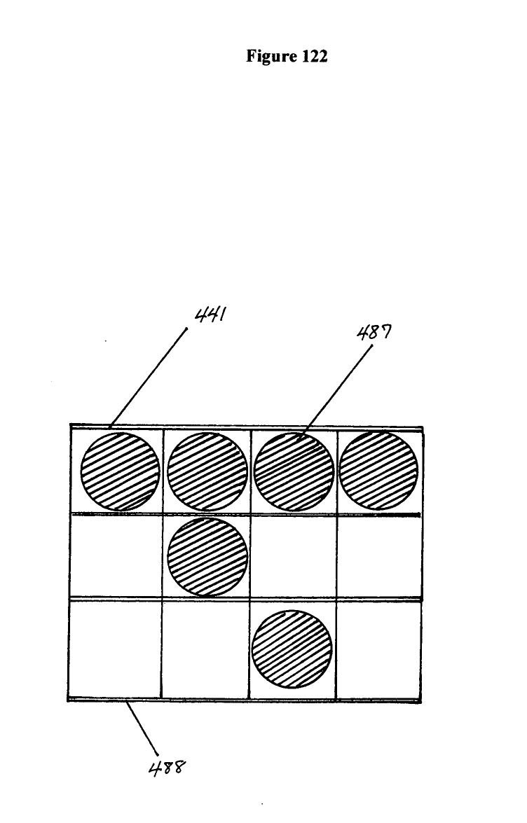

FIGS. 121 and 122 illustrate a rear view of a horizontal and tubular rack system adapted for use in modified fire fighting, military, utility or other suitably modified vehicles that may or may not incorporate the use of capsule launchers, fire suppressant capsules in place of standard fire suppressant mediums.

If a permanent or semi permanent containment rack system is used then, the use of recessed rollers, motorized motor track, winch and similar systems mentioned above, may be unnecessary. However, in place of same, external capsule loading and offloading system will be necessary to fill the containment system as required.

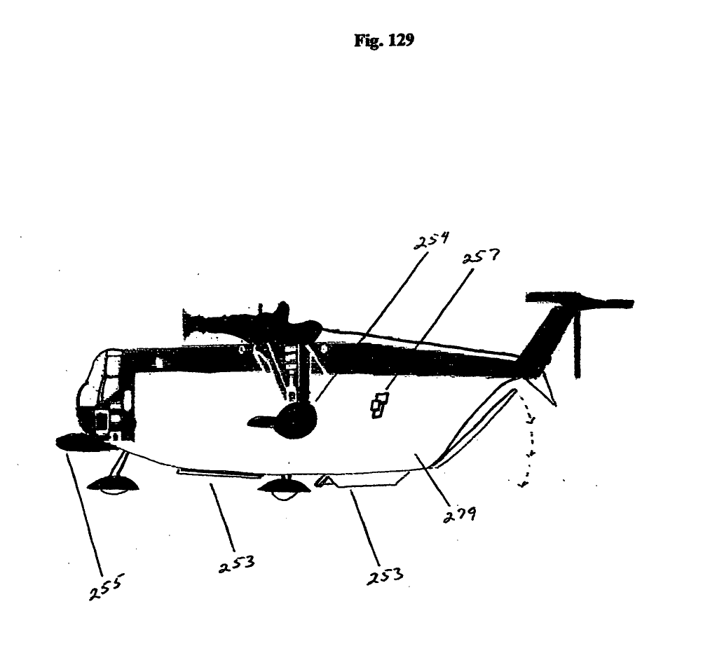

The methods of containment and launcher loading expressed in FIGS. 121, 122, 123 and 124 may also be applied to FIGS. 129 through and including 141.

FIG. 122 illustrates a tubular fire suppressant capsule containment rack system that contains the same elements of FIG. 121. As an option, each tube can be individually replaced.

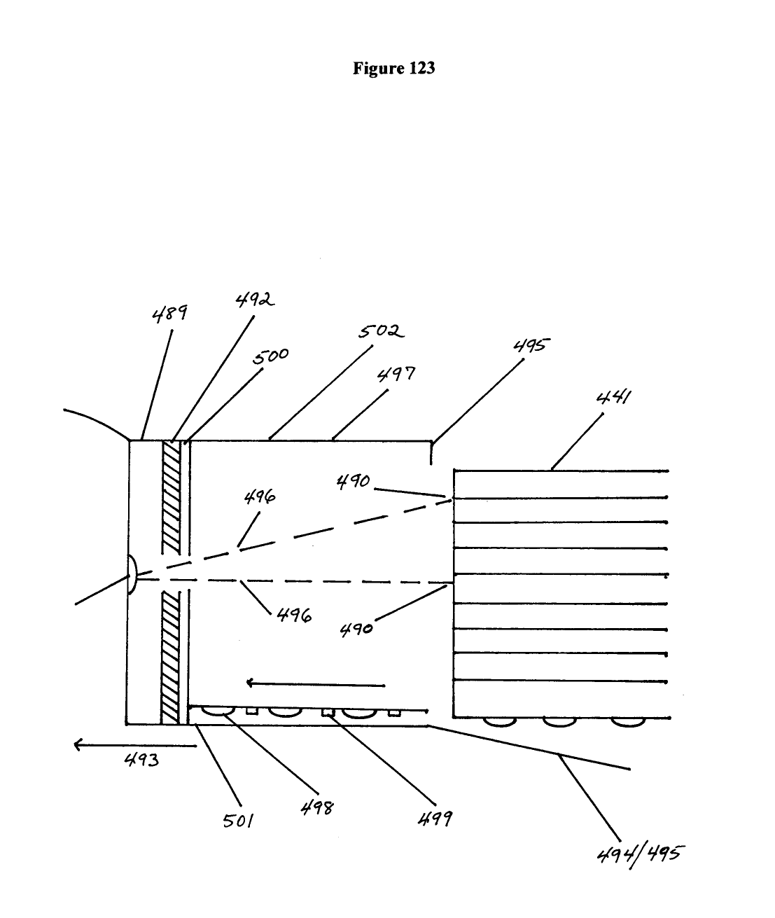

FIG. 123 illustrates a cross sectional view of the vehicle containment area to provide a loading view of the fire suppressant capsule containment rack system. Once loaded into the containment area the containment rack assembly is brought forward to the vertical capsule loading system and aligned with the capsule loader, and levelizing tracks align the rack assembly with the capsule loader.

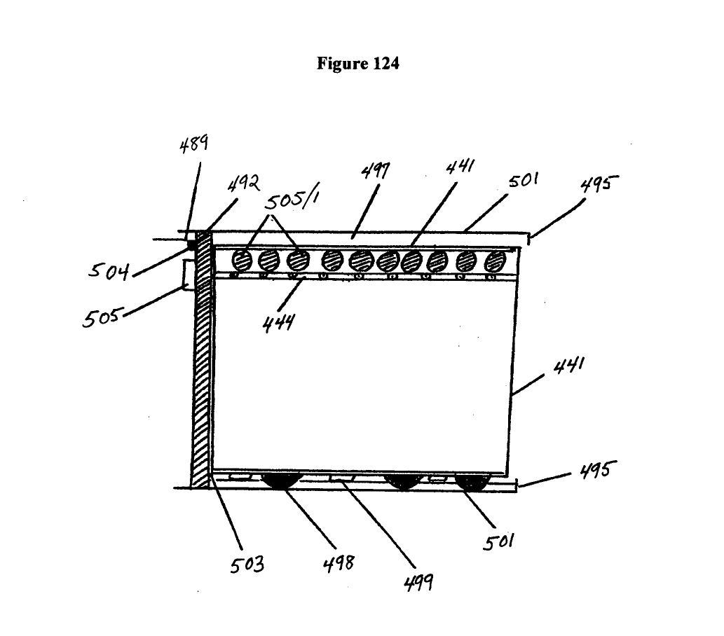

FIG. 124 illustrates a cross sectional view, where the fire suppressant capsule containment rack system is loaded into the vehicle and aligned with the fire suppressant capsule loader.

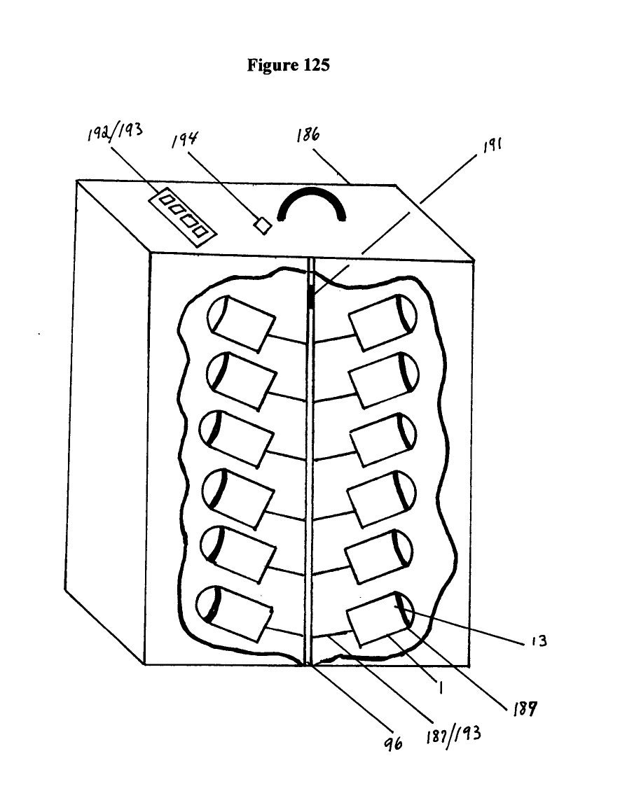

FIG. 125 is a partial cross-sectional frontal view of the Drop Satchel. The Drop Satchel is a light weight portable bag containing a multiple array of up fire suppressant capsules or canisters with a smart chip.

FIG. 126 is a free standing illustration of the Drop Satchel's central post with fire suppressant capsules attached by a fixed arm or retractable arm.

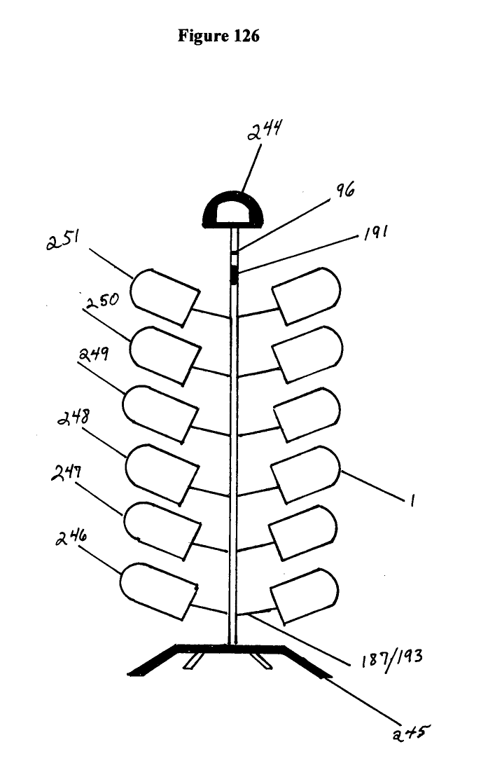

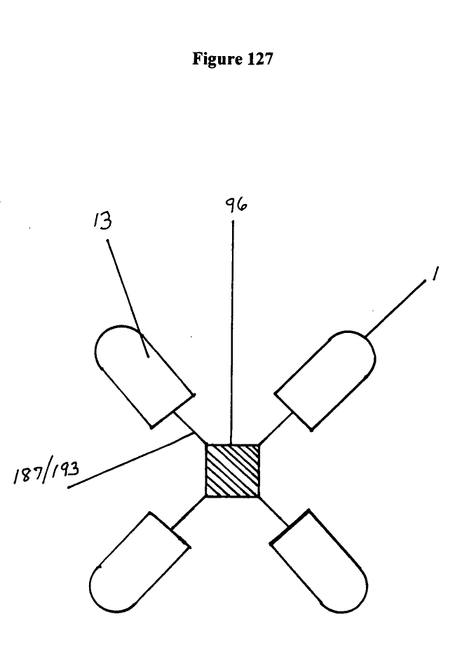

FIG. 127 is an overhead view of the Drop Satchel's central post with fire suppressant capsules attached by a fixed arm or retractable arm.

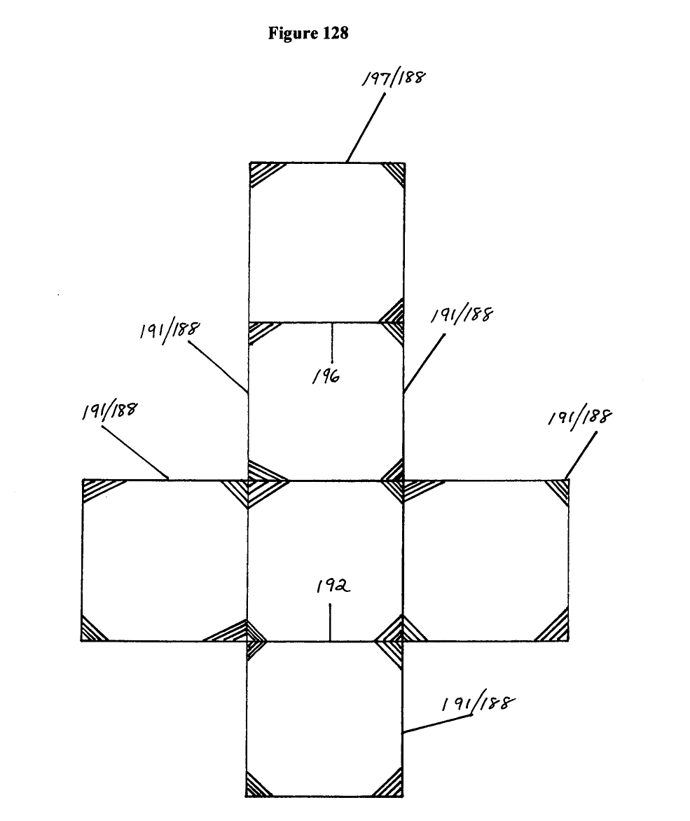

FIG. 128 illustrates an unfolded Drop Satchel, where the central post has been removed. Each side can be closed by using snap closures, velcro attachment, or zippers.

FIG. 129 is a illustrates a lateral view of a Sikorsky S-64's helicopter hull, and adapted to deliver suppressant capsules and canisters in place of water, foam, and loose pack fire suppressants.

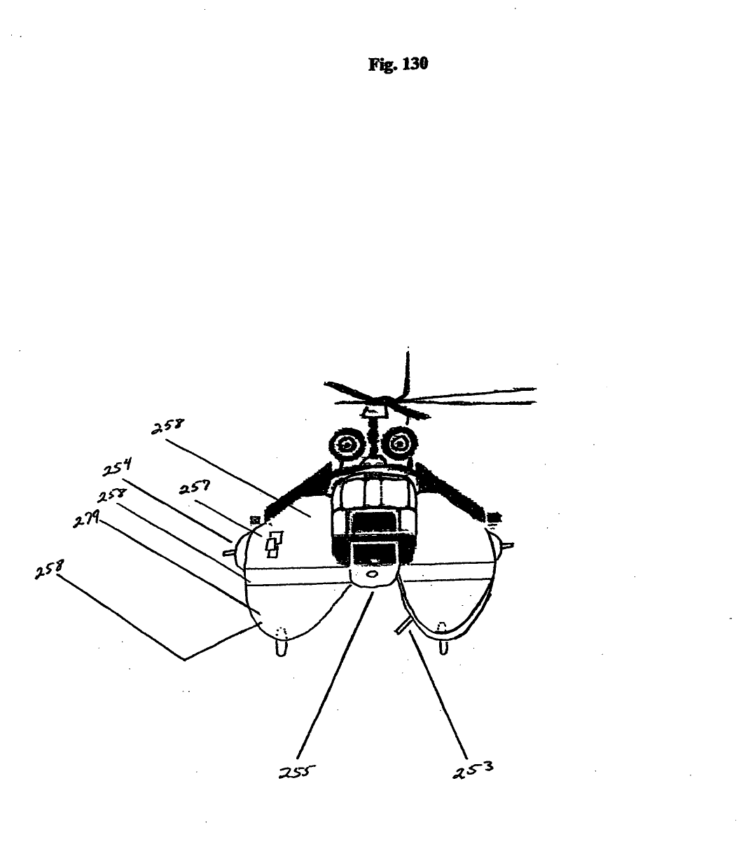

FIG. 130 is a frontal view of FIG. 129, showing compartmentalization of the hull's interior. As an alternative to the hull's compartmentalization and use of drop doors, the hull can be fitted with FIGS. 121's—124's permanent or temporary fire suppressant capsule containment racks.

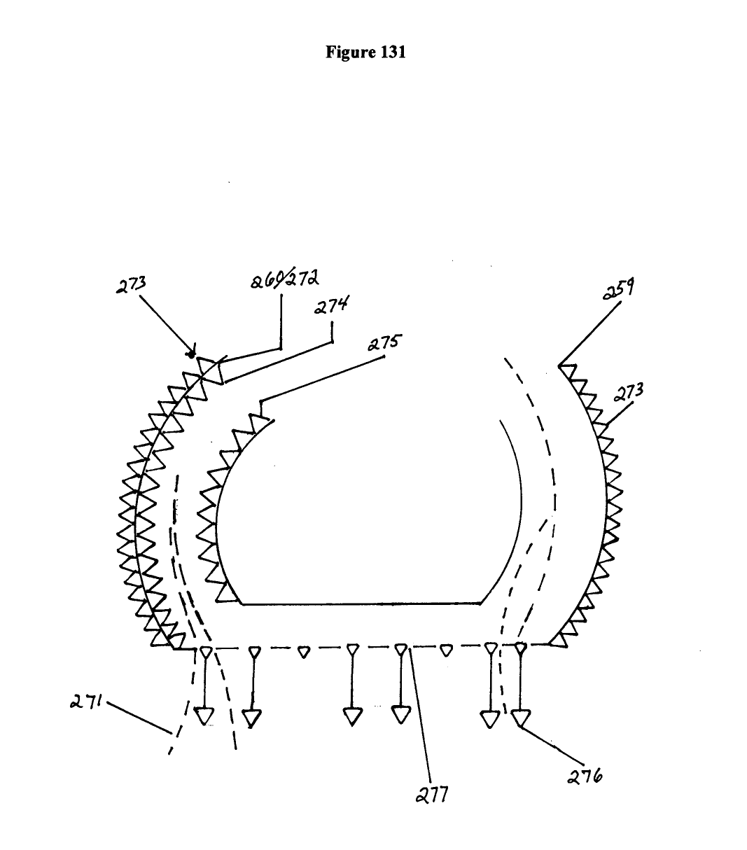

FIG. 131 is a schematic drawing of non-load bearing partial outer hull or secondary skin fitted to or recessed into the fuselage of a helicopter or an unmanned aerial fire drone, to reduce the impact of thermal updrafts created by intense fires. The intent here is to channel away from and around the helicopter/aerial drone the high altitude winds and thermal updrafts associated with combating high-rise and forest fires.

The outer hull should be recessed into the hull of the helicopter/aerial drone, providing a normal, flat surface profile during normal flight operations.

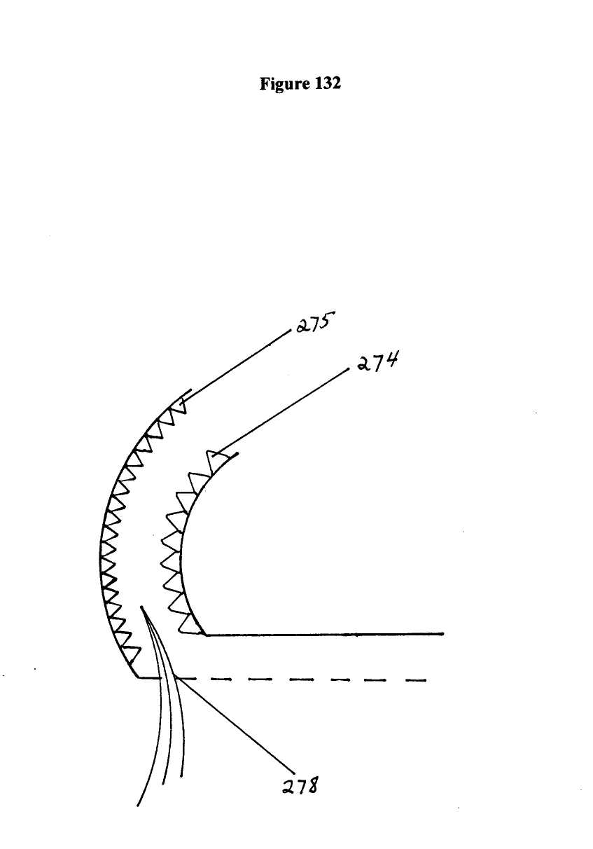

FIG. 132 is a cross-sectional view of FIG. 131, showing air as it is baffled through an opening in the outer hull, and channeled by the baffles lining the interior of the outer hull: around and away from the hull and fuselage of the helicopter/aerial fire drone, reducing buffeting and allowing for increased stabilization of the vehicle.

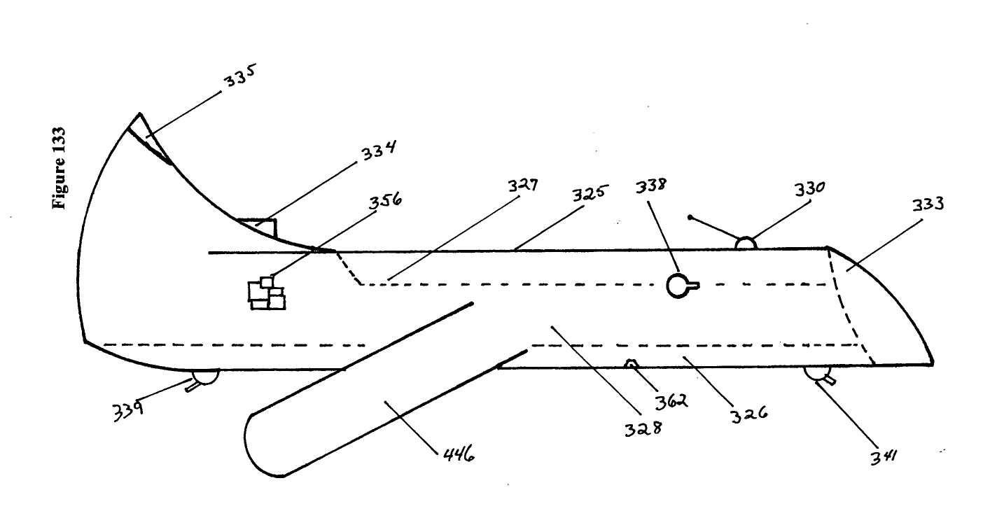

FIG. 133 illustrates an Aerial Fire Suppression Drone, i.e., a low altitude, unmanned, remote controlled/computer guided aerial vehicle that can deliver a large payload of fire suppressant capsules/canisters to the exterior of a high rise, off shore structure, and to operate within grassland, forest fire and similar fire situations.

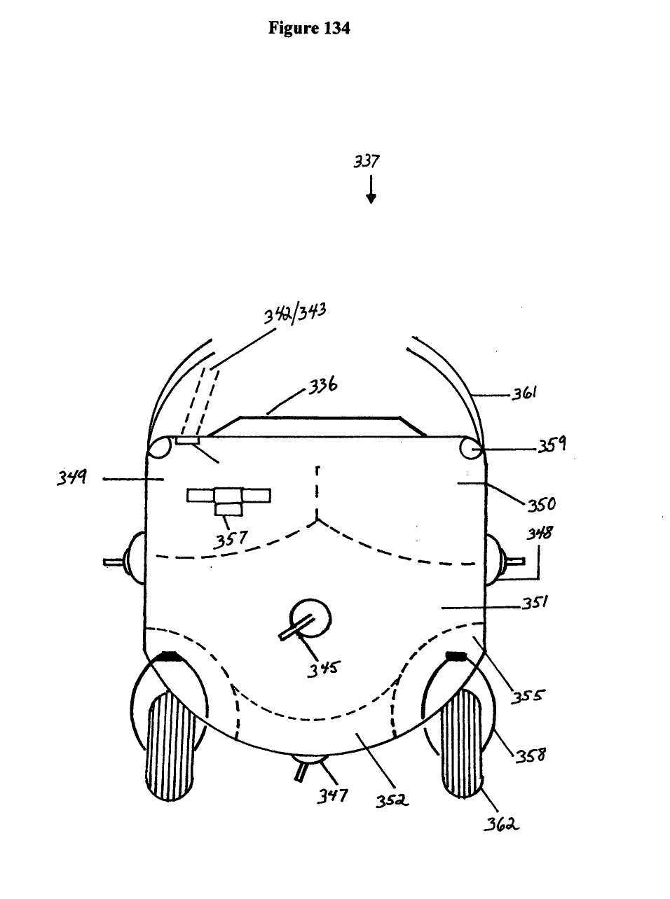

FIG. 134 illustrates the detachable Pod, a bulbous bulk fire suppressant capsule containment structure that can be attached to the underside of the Aerial Fire Suppression Drone via a docking collar, with the Drone serving as the lift and control vehicle.

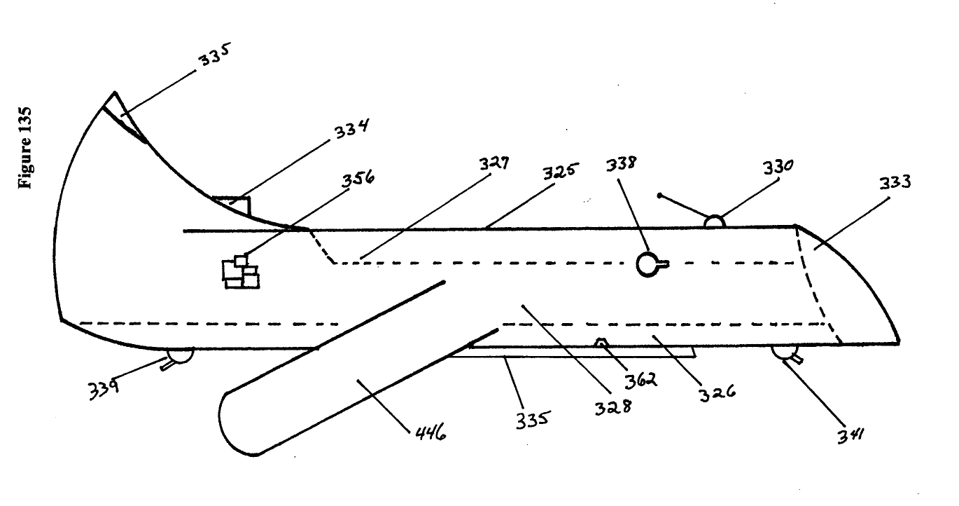

FIG. 135 is a lateral view of FIG. 134.

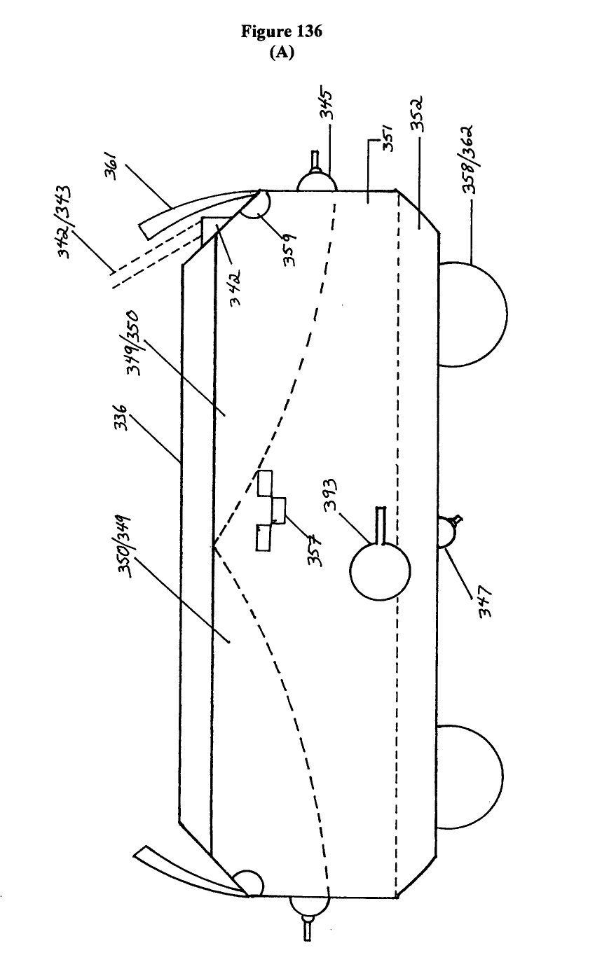

FIG. 136 illustrates the Aerial Fire Suppression Drone of FIG. 133 attached to the Pod of FIG. 134, connected by its docking collars.

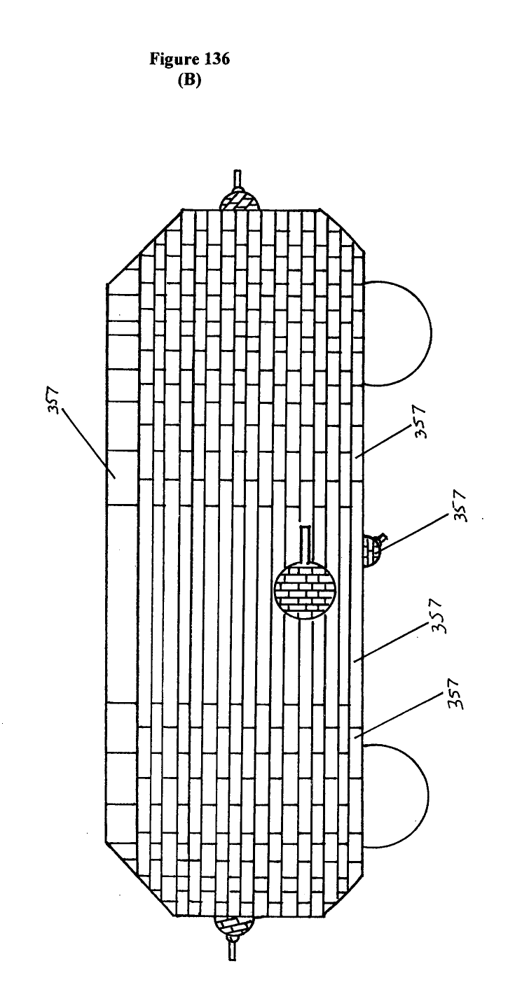

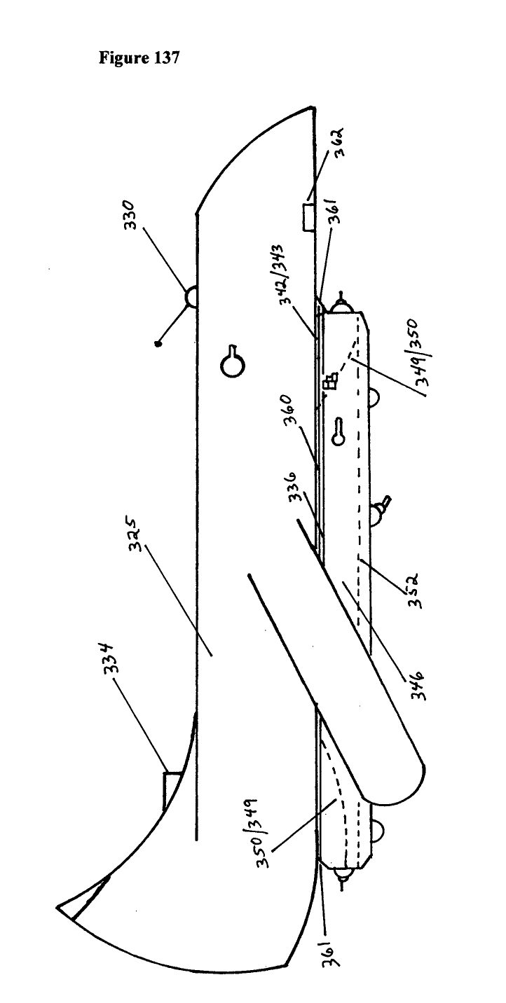

FIG. 137 is a second lateral view of FIG. 136 illustrating the Aerial Fire Suppression Drone attached to the Pod.

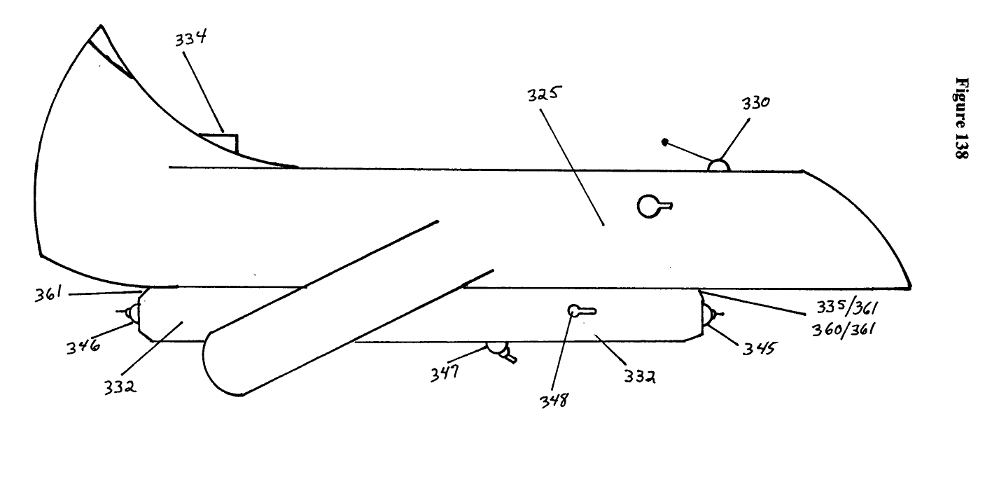

FIG. 138 is a frontal view of FIG. 136, where the Aerial Fire Suppression Drone is attached to the Pod.

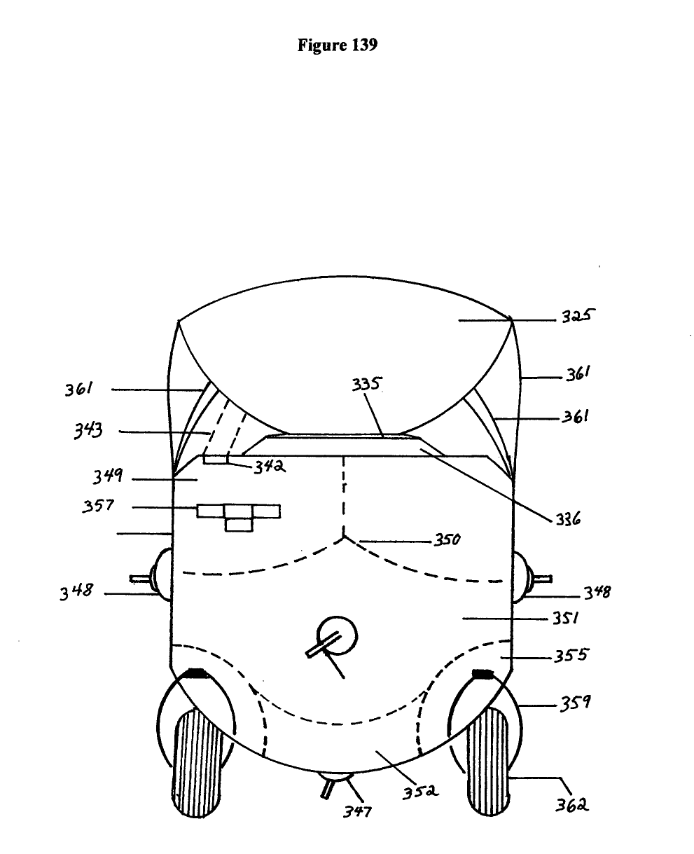

FIG. 139 illustrates FIG. 138, with the Pod's landing gear retracted.

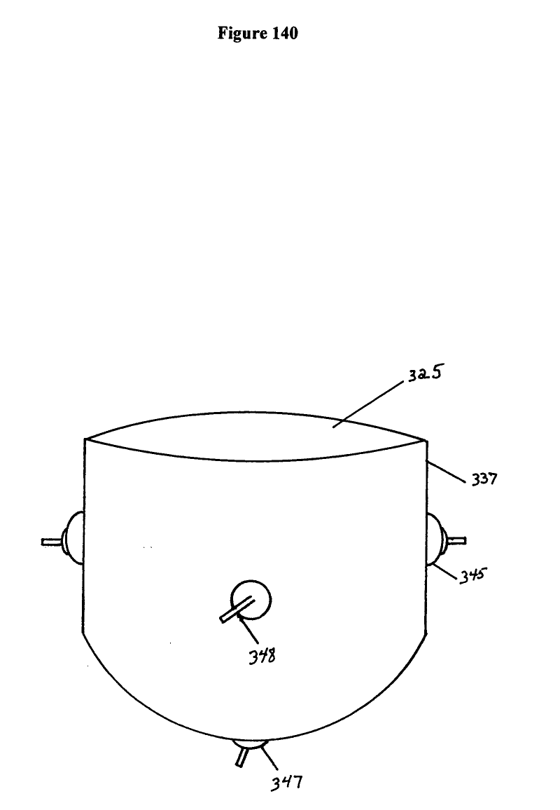

FIG. 140 illustrates the Aerial Fire Suppression Drone with its docking collar.

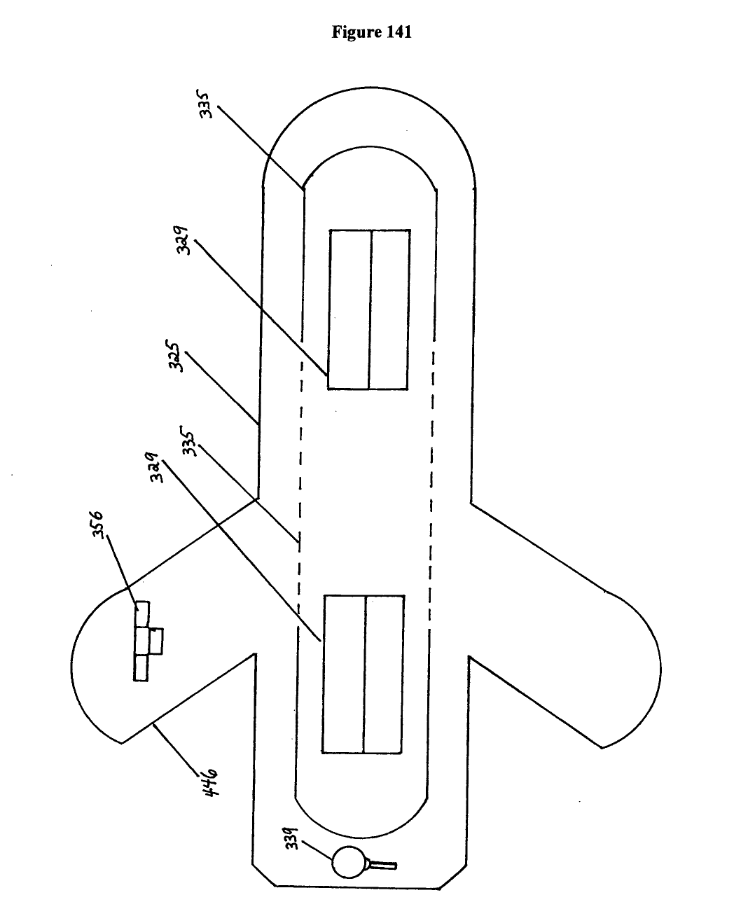

FIG. 141 illustrates an underside view of FIGS. 133 and 136: the Aerial Fire Suppression Drone with its docking collar retracted; and, (double) drop doors.

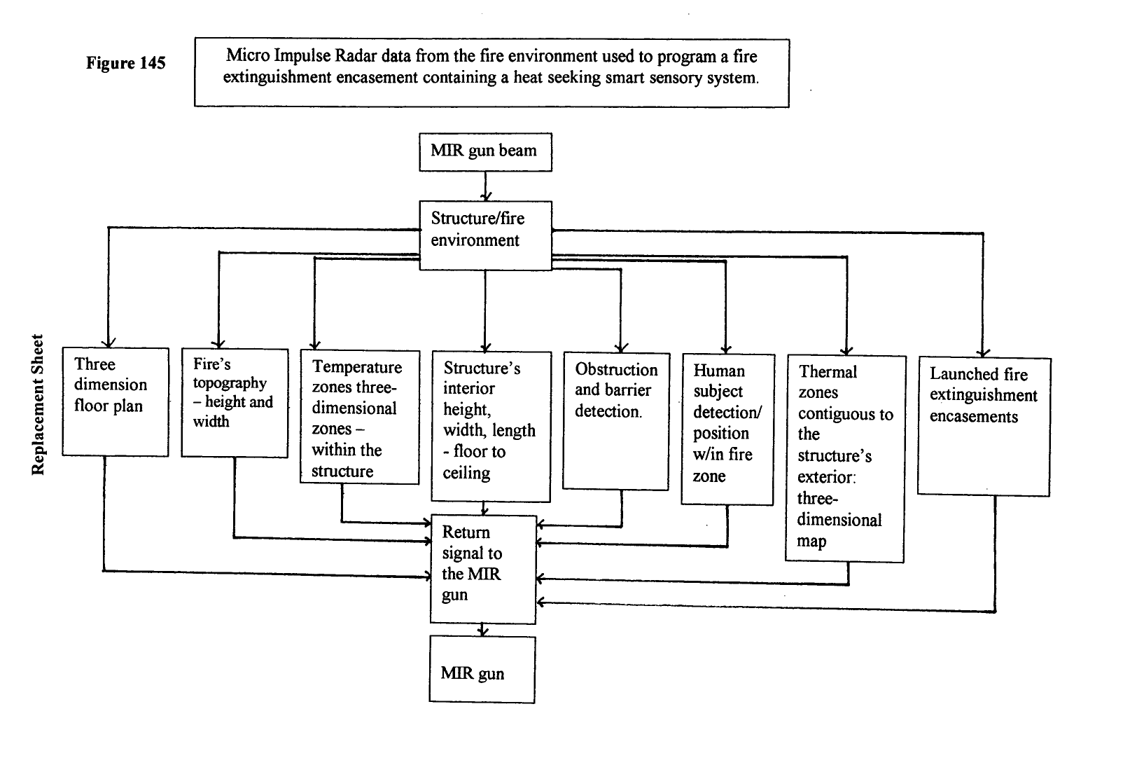

FIG. 145 illustrates use of the MIR-gun to scan a structure and fire zone. Based upon this data a software program produces a three-dimensional map of the layout of the structure and the fire's thermal topography. The software is then used to determine the number of encasements and the fire-extinguishing load required to extinguish the fire.

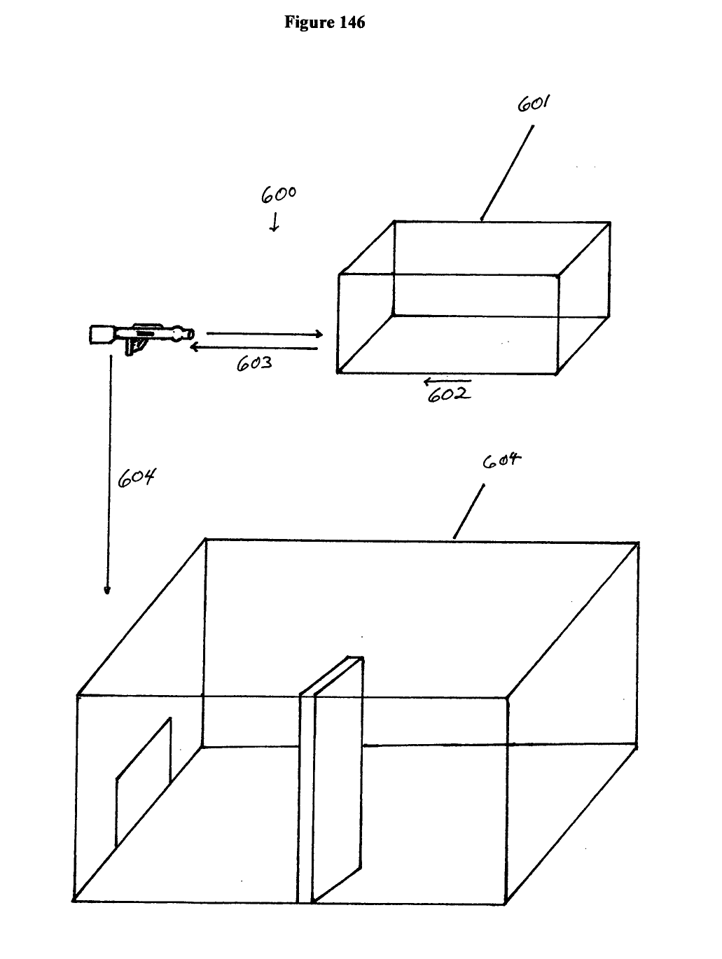

FIG. 146 illustrates use of the MIR-gun feature incorporated within the launcher, where the latter is aimed at the intended structure while the operator is located outside the structure or scanning from within a stairwell or similar area. The launcher's software program translates data from the returning MIR-beam to produce the three-dimensional software image of the structure, showing the showing floor, ceiling, walls, door, barrier walls, and structures commonly associated with e.g., an office tower, and obstructions.

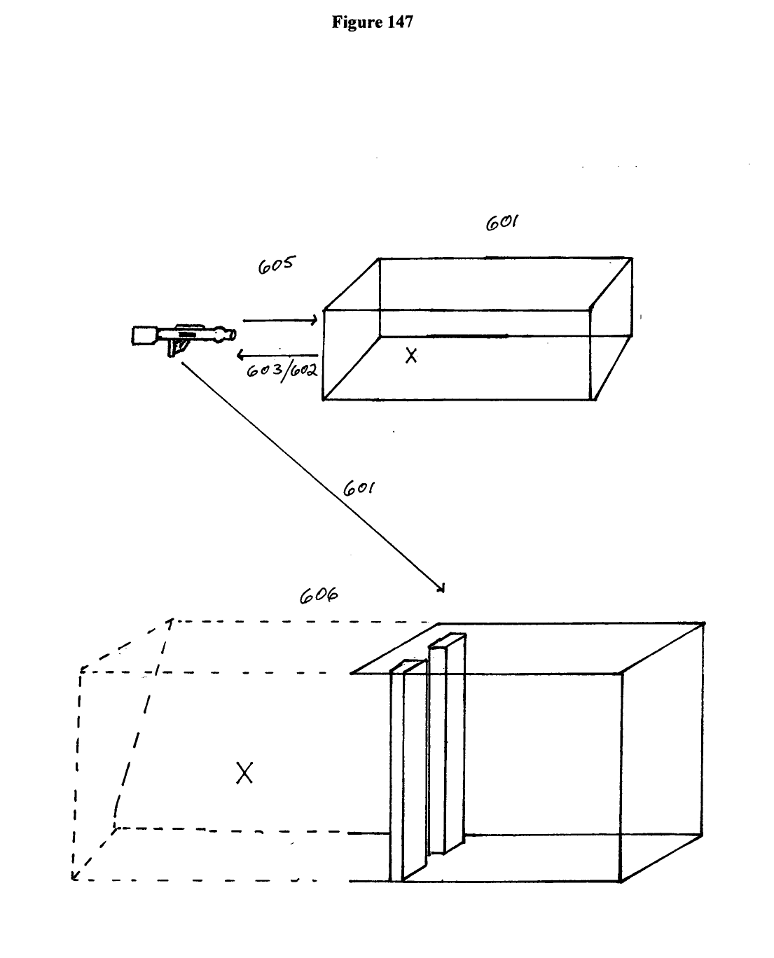

FIG. 147 illustrates use of the MIR-gun feature incorporated within the launcher, where the operator is standing within the intended structure or scan area at Point X, scanning further within same.

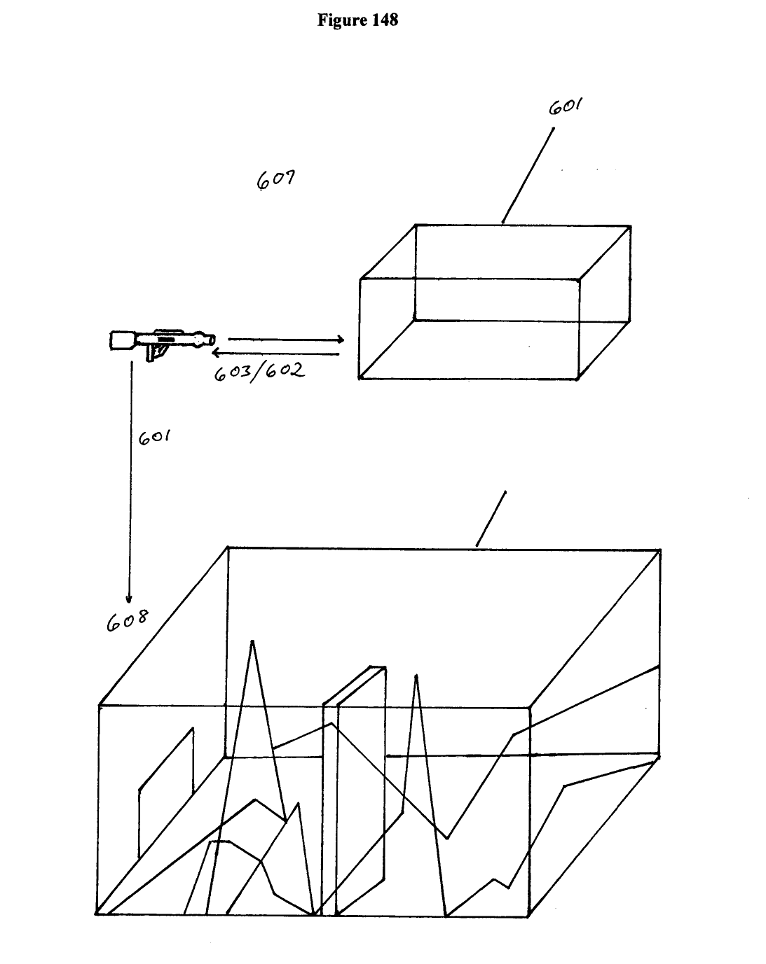

FIG. 148 illustrates how the MIR-scan data provides a three-dimensional overlay of the fire's thermal topography, with each (color) area representing a different temperature or thermal range.

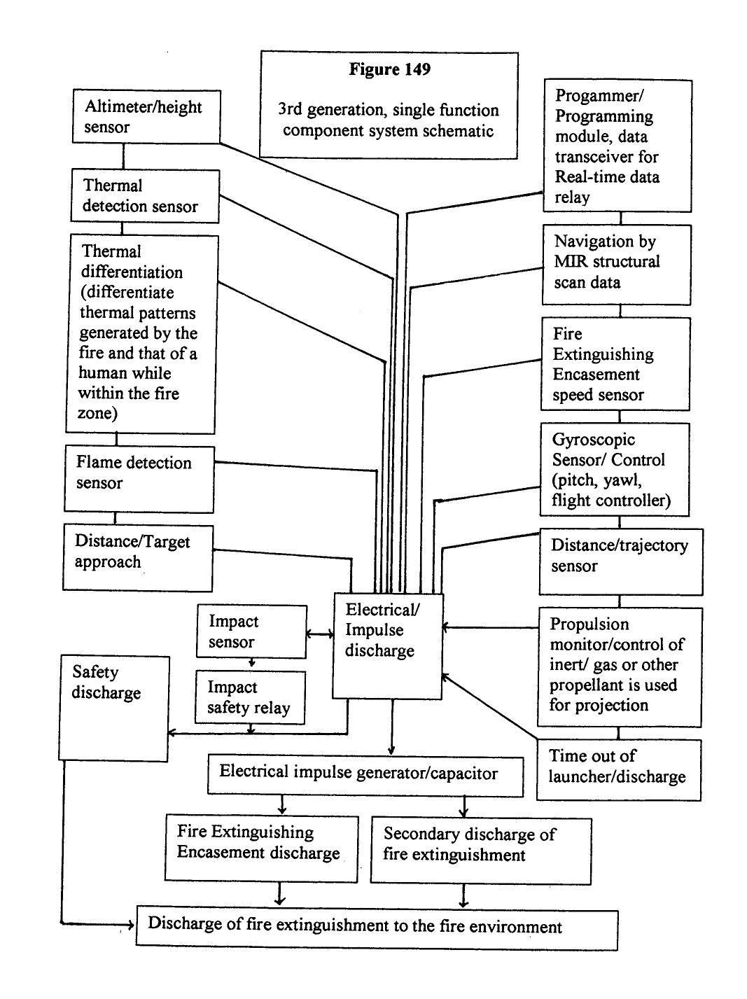

FIG. 149 is a block diagram of a Third Generation, Single Function Component System schematic, each component is individually detailed and linked within the Smart Encasement system.

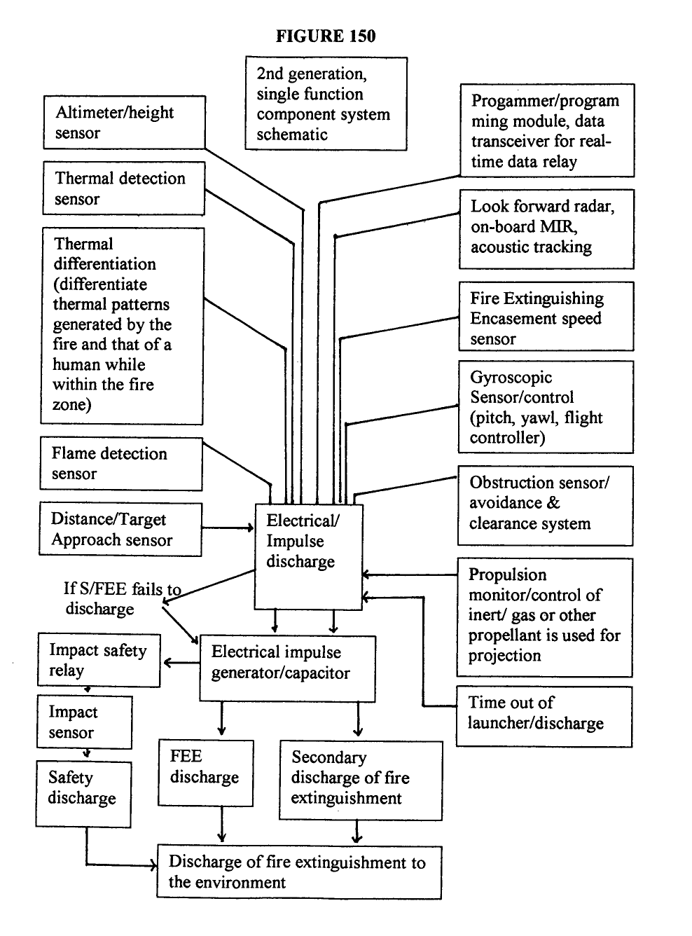

FIG. 150 is a block diagram illustrating the second generation, single function component system schematic format.

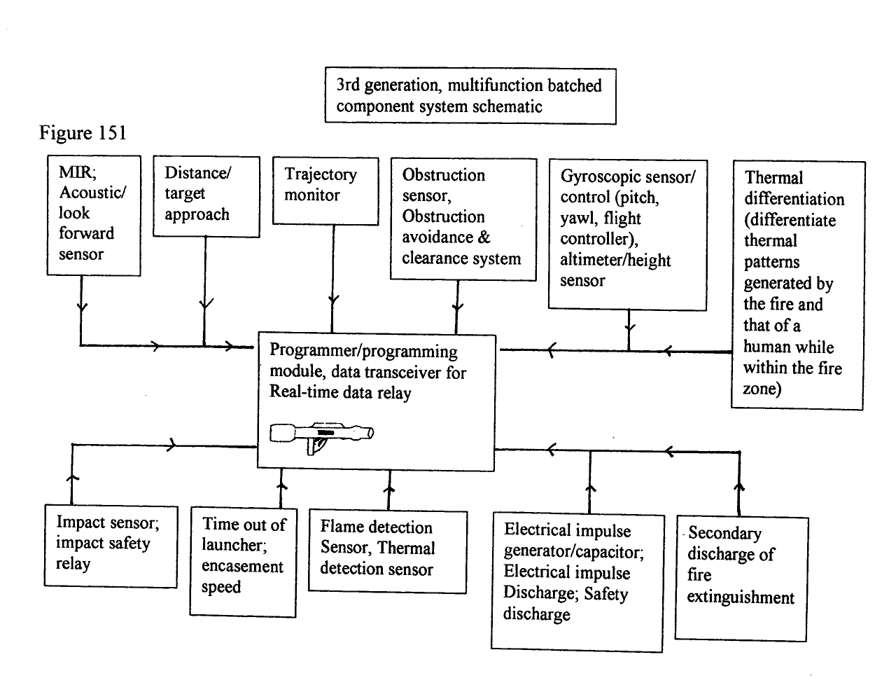

FIG. 151 is a block diagram illustrating the 3rd generation, multifunction batched component system schematic format.

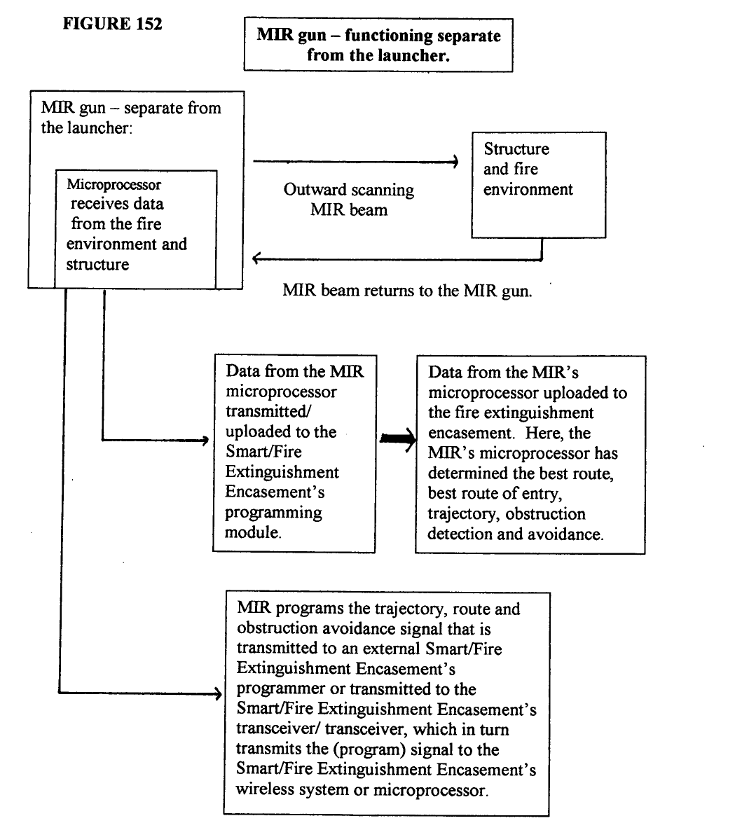

FIG. 152 illustrates a block diagram of the MIR gun system utilized to scan a structure, where the MIR function is used as a stand alone, independently operated system, separate from the launcher.

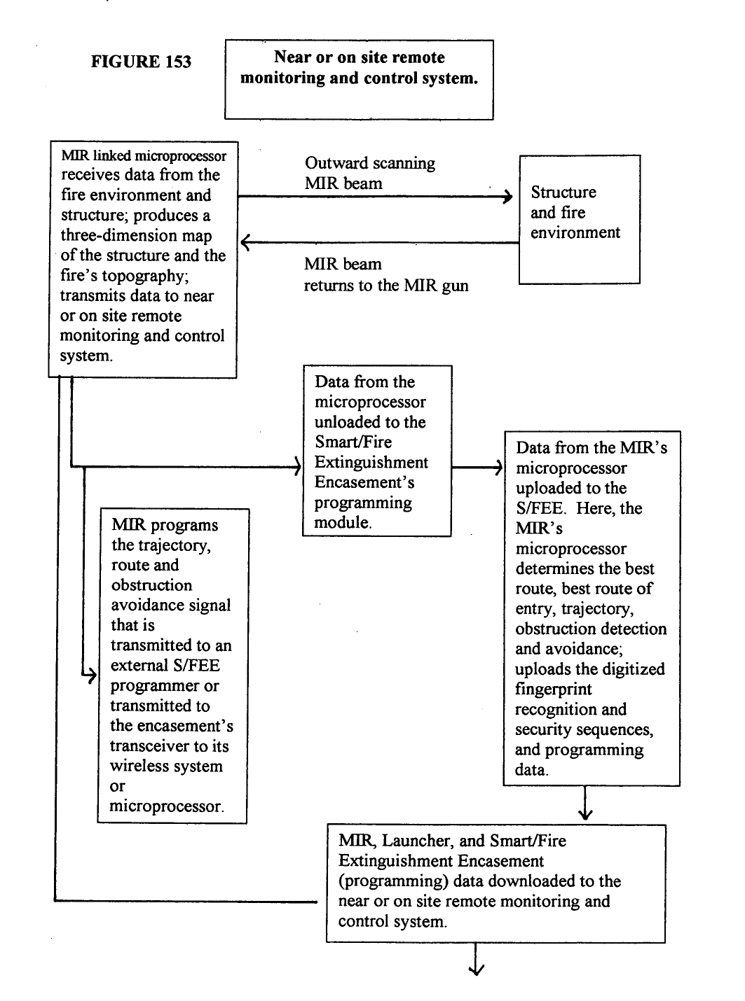

FIG. 153 illustrates a block diagram of the MIR gun system utilized to scan a structure, where the MIR function is used as a stand alone, independently operated system, separate from the launcher. Here, the data produced by the MIR scan function is downloaded or transmitted to a near or on site remote monitoring and control system.

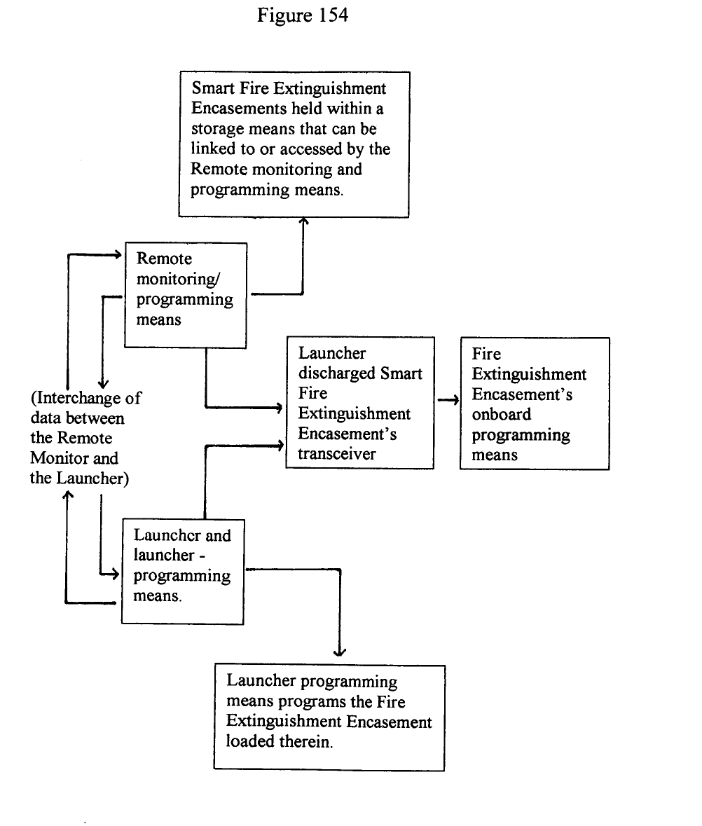

FIG. 154 is a block diagram illustrating the interchange scan data between the remote monitoring and programming means and the launcher.

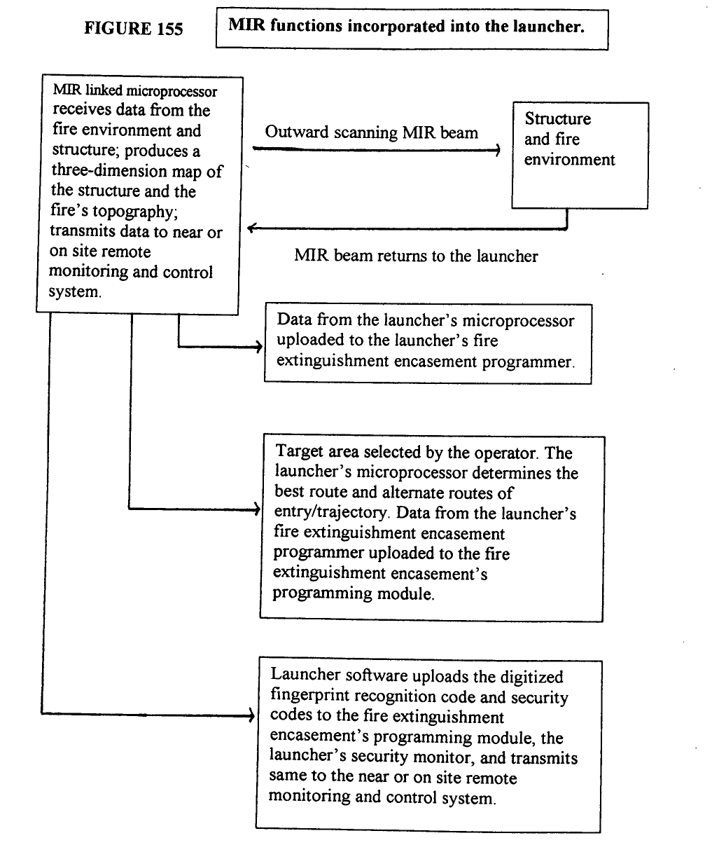

FIG. 155 illustrates a block diagram where the MIR system is incorporated within a hand-held launcher. Here, the MIR scan data produced is directly downloaded to the launcher's monitor and programming software; downloaded or transmitted to a remote encasement launcher programming system; or, downloaded or transmitted to a remote monitoring and programming system.

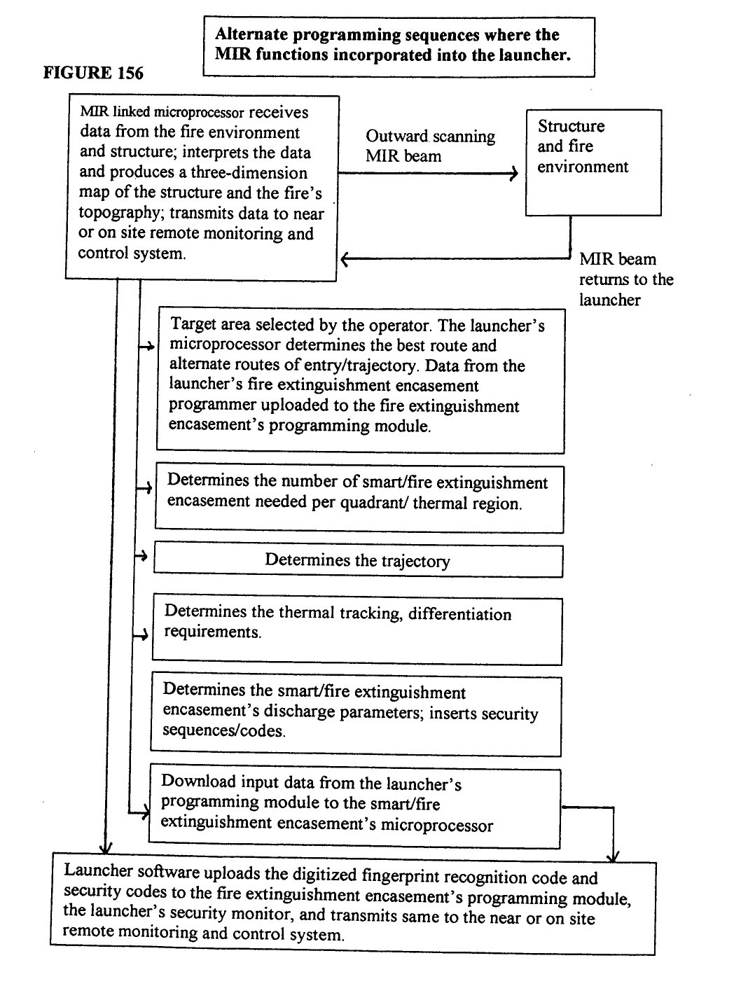

FIG. 156 is a block diagram illustrating an alternate programming sequence where the MIR functions are incorporated into the launcher.

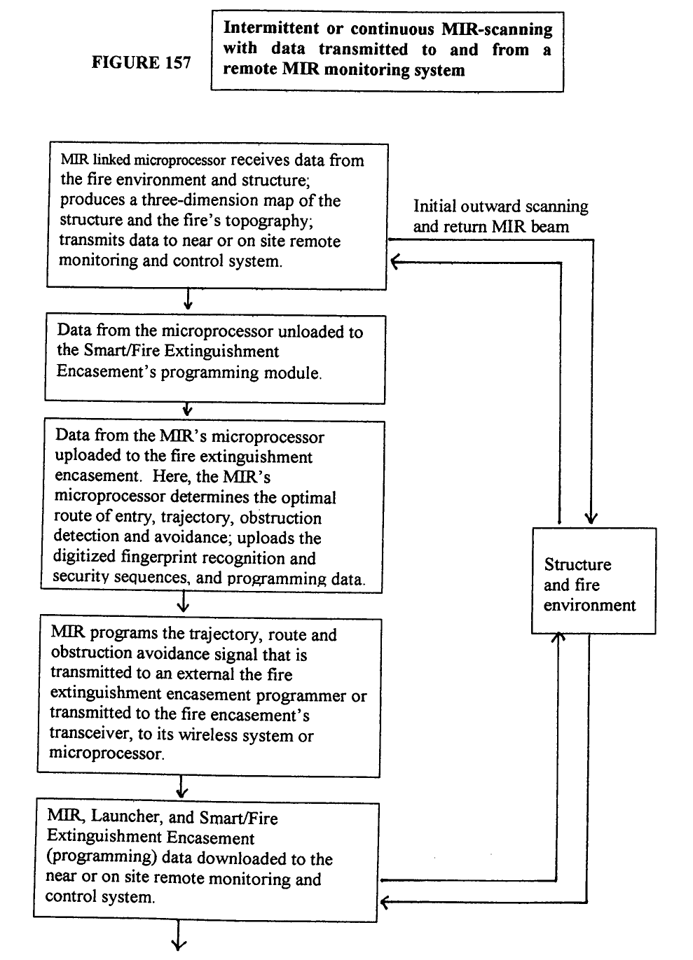

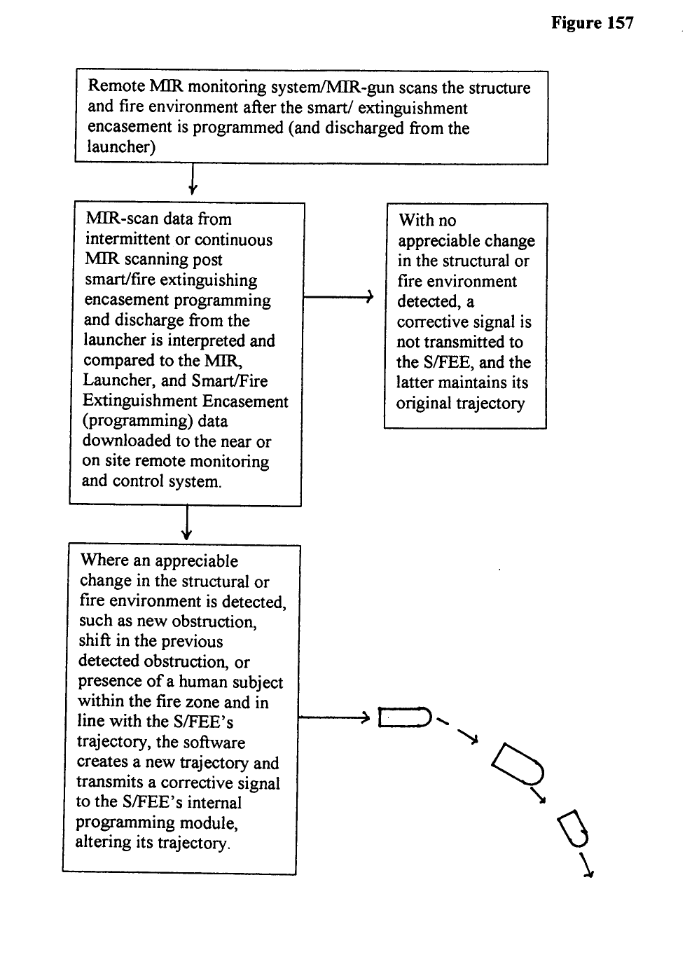

FIG. 157 is a block diagram illustrating intermittent or continuous MIR-scanning with data transmitted to and from a remote MIR monitoring system.

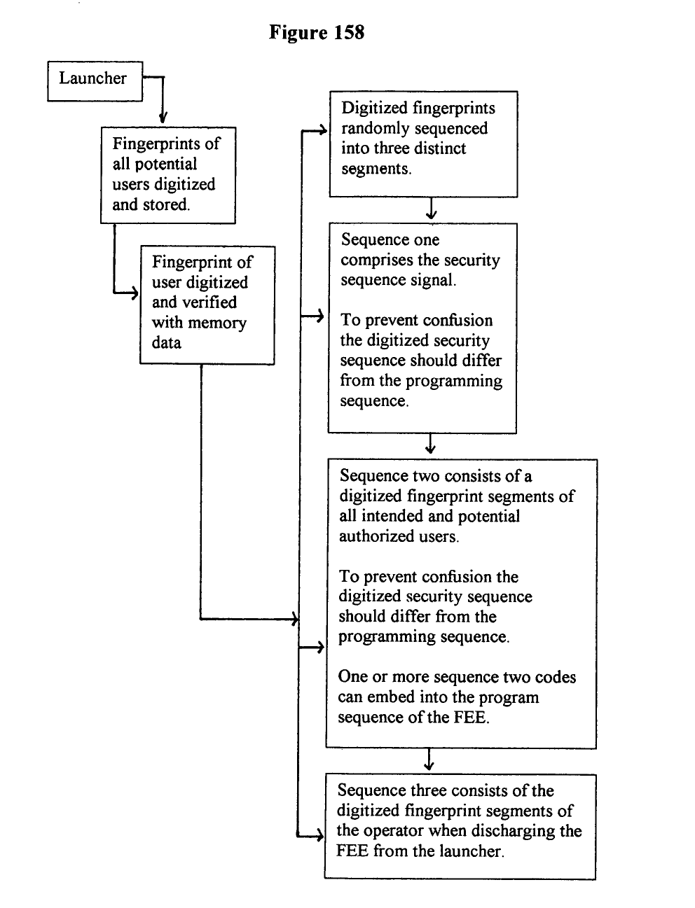

FIG. 158, the launcher's smart technology security means first recognizes the authorized user when the latter takes hold of the pistol grip, thereafter creating three distinct fingerprint patterns.

FIG. 158 is a block diagram illustrating the process by which an operator's fingerprint is scanned, digitized, confirmed where authorized, then uploaded to the appropriate programming features of the launcher and the encasement.

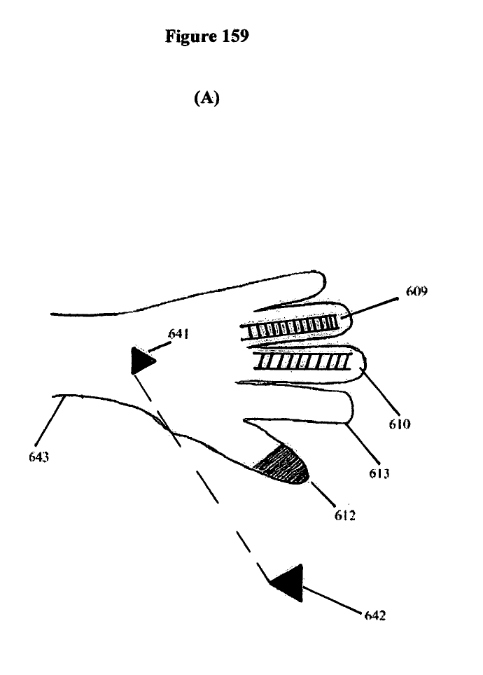

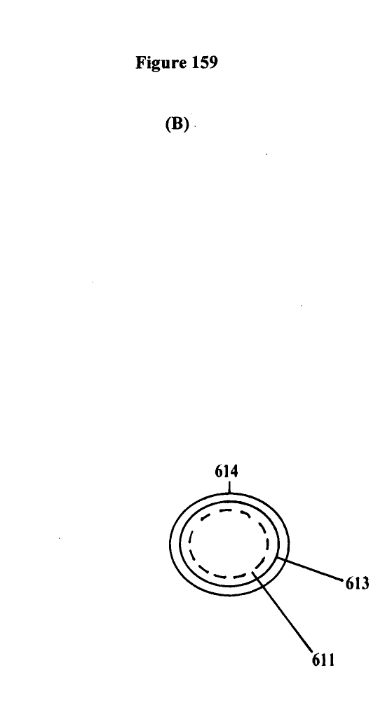

FIG. 159 illustrates the construction and use of an electronic glove for use in operation of the launcher.

FIG. 159 represents a linear or circular sensor that measure capillary density of the operator's sensor that corresponds with the security feature cited above.

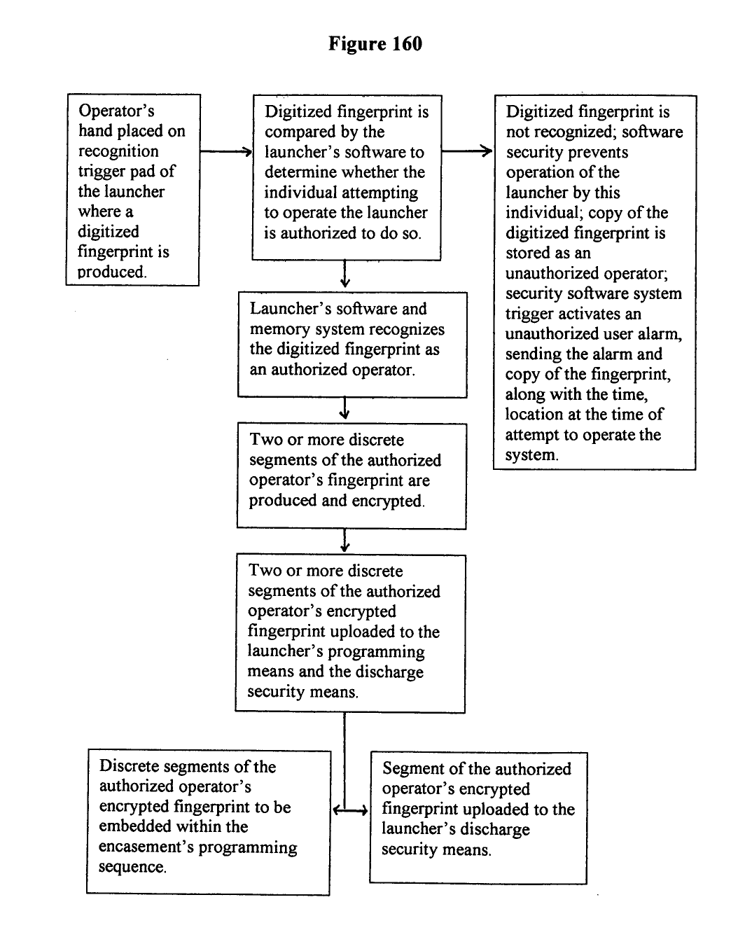

FIG. 160 provides a block diagram of the security verification system.

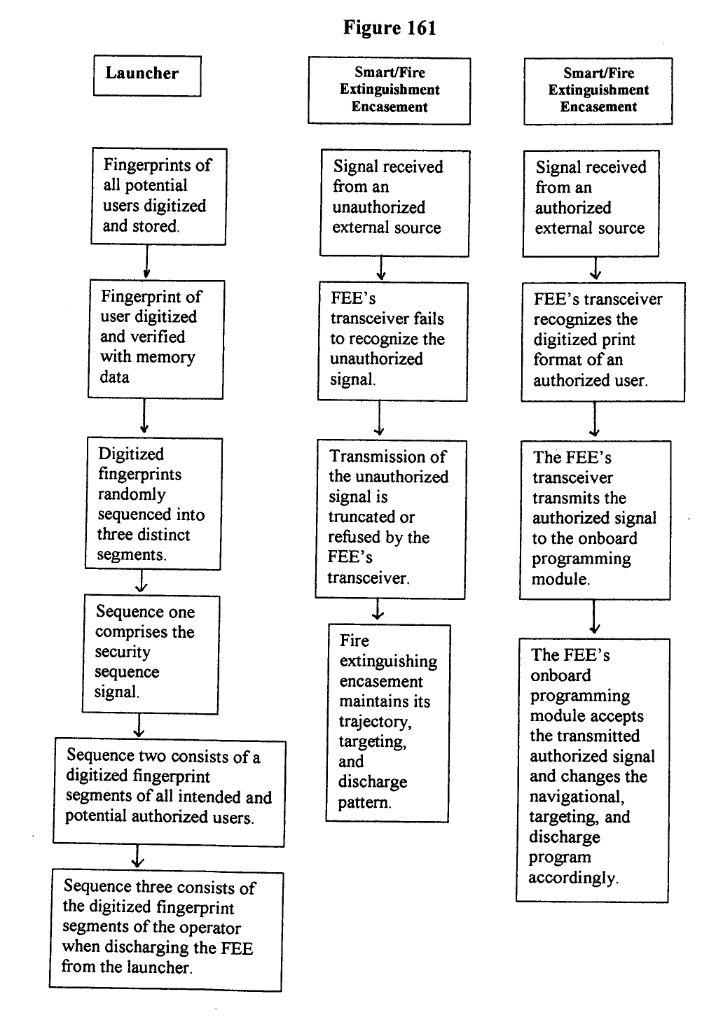

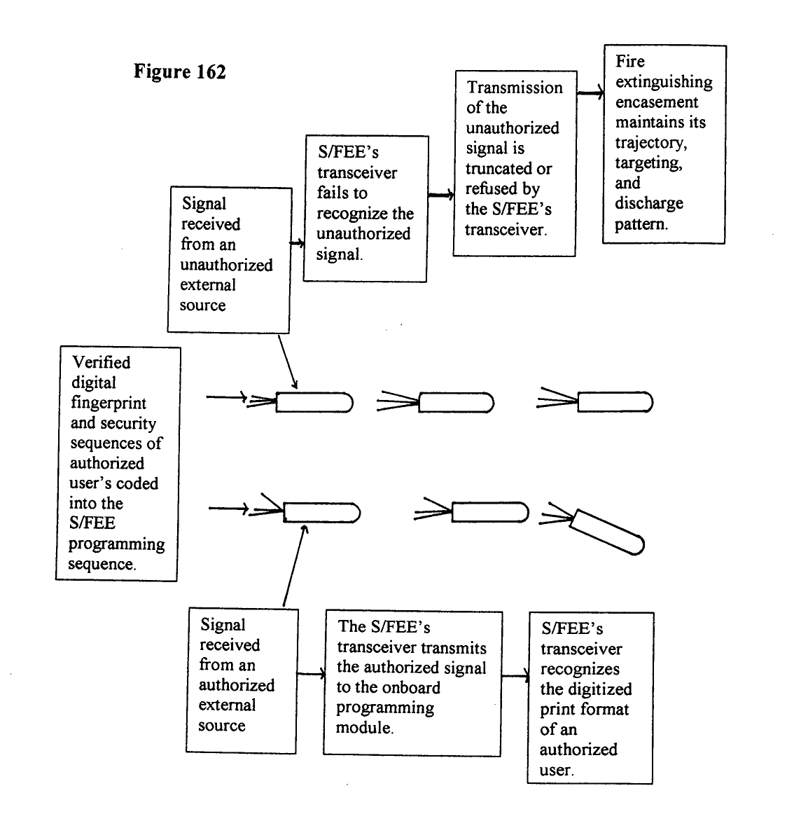

FIGS. 161 and 162 provide block diagrams to illustrate the progression of the security verification process to effect changes to the encasement's programming sequence, post discharge from a launcher, where the transceiver must first recognize an authorized digitized print.

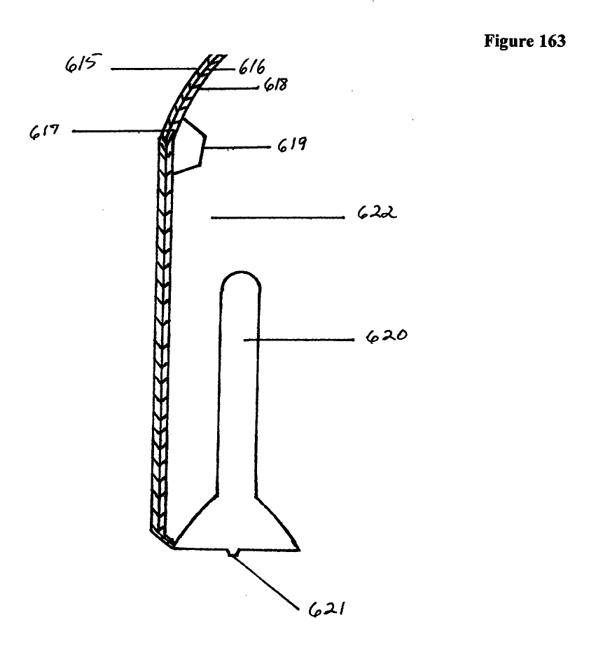

FIG. 163, which is a partial cross-section view of an encasement illustrating the exterior wall structure, the interior wall structure and the near interior wall structure.

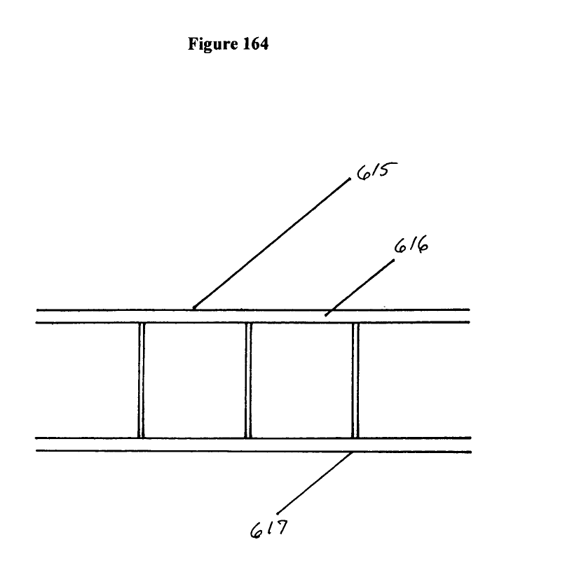

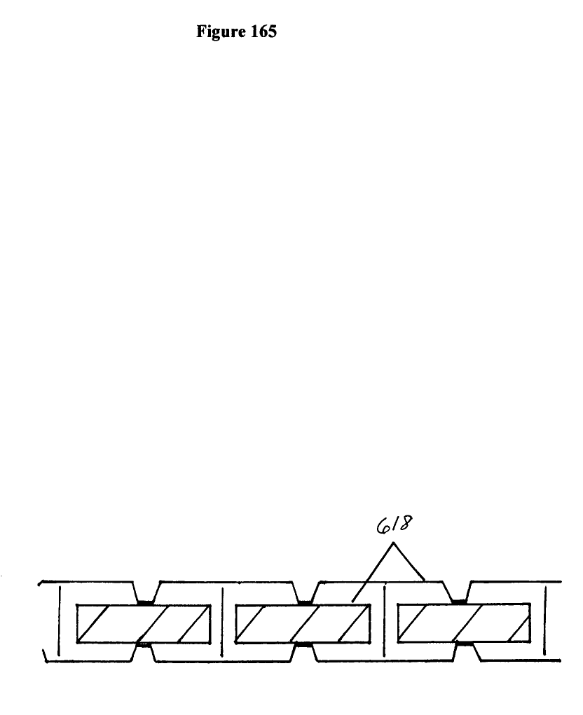

FIGS. 164 and 165 illustrate the encasement's exterior, near exterior, and interior wall, prior to being filed with the fire extinguishment material. The wall is constructed so that when the containment area is compression filled with the fire extinguishment the tensile strength of the exterior surface area increases.

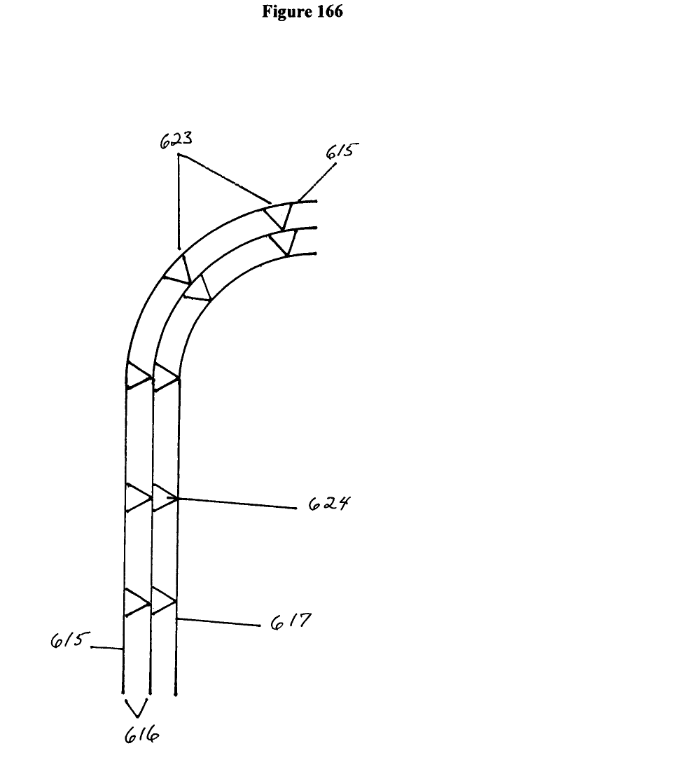

FIG. 166 illustrates a cut-away section of an encasement comprising two levels of micro capstone-like sections are built into the encasement walls. The intent of these structures is to increase the tensile strength of the encasement, with increased pressure exerted internally (pushing outwardly) and impact pressure exerted from the exterior environment.

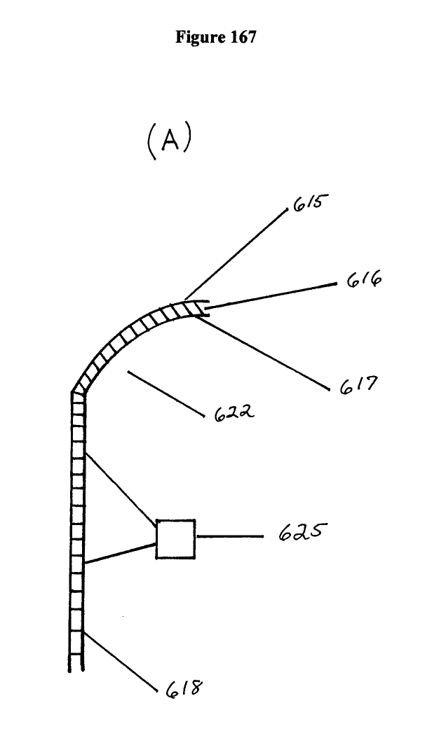

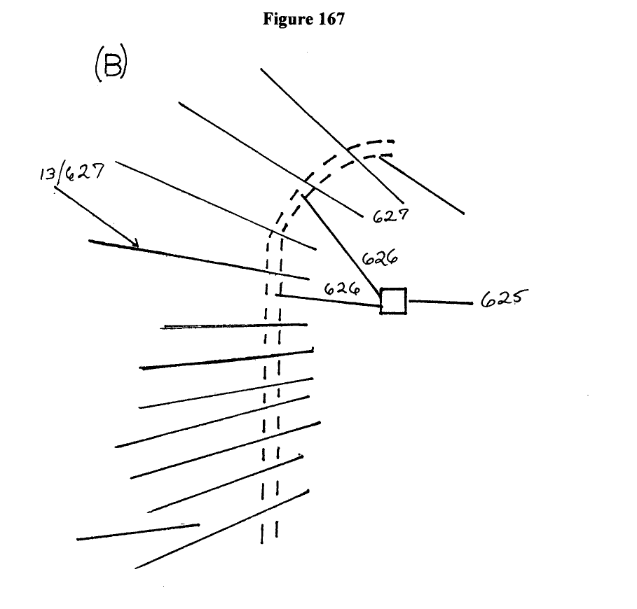

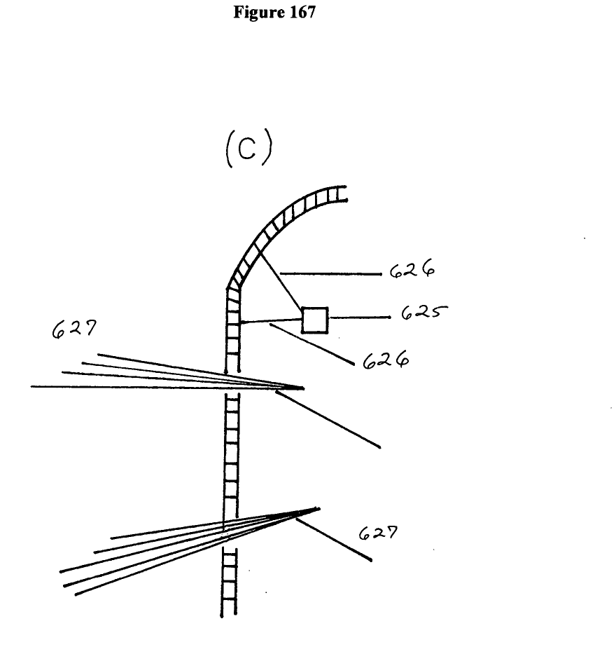

FIG. 167 illustrates a cut-away section of the Smart Encasement showing the Kevlar lacing as part of the composite material comprising the encasement with the electronically controlled electrical charge generator hardwired to the near exterior surface.

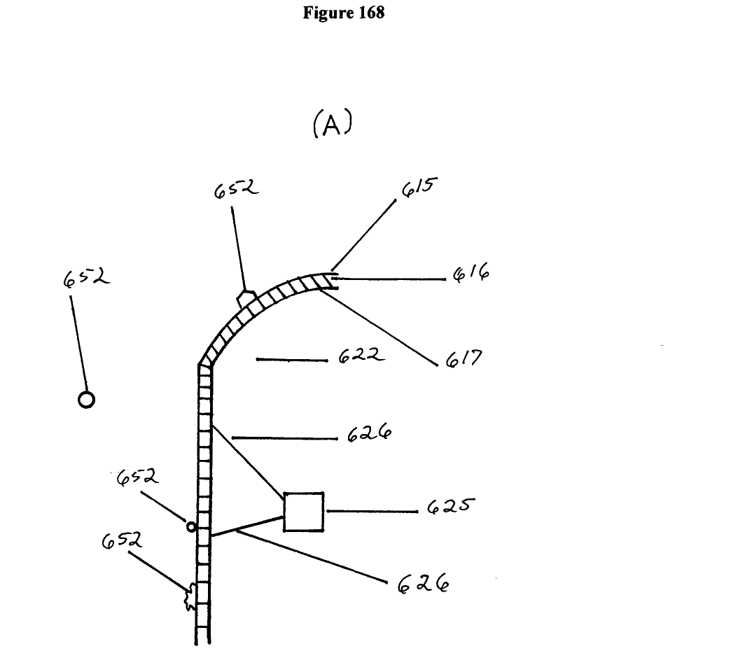

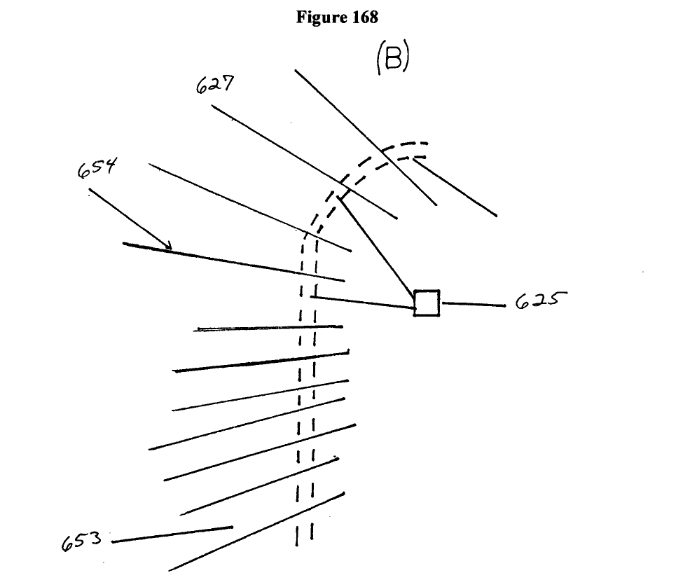

FIG. 168 illustrates the intent of developing the encasement to strengthen with an increased internal load and orientation of the wall structure to resist degradation by impact with an external source.

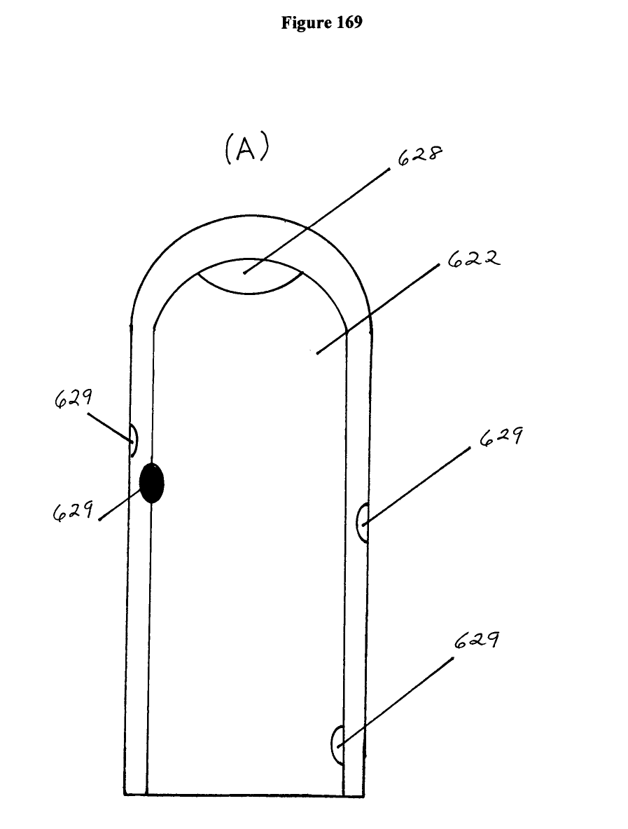

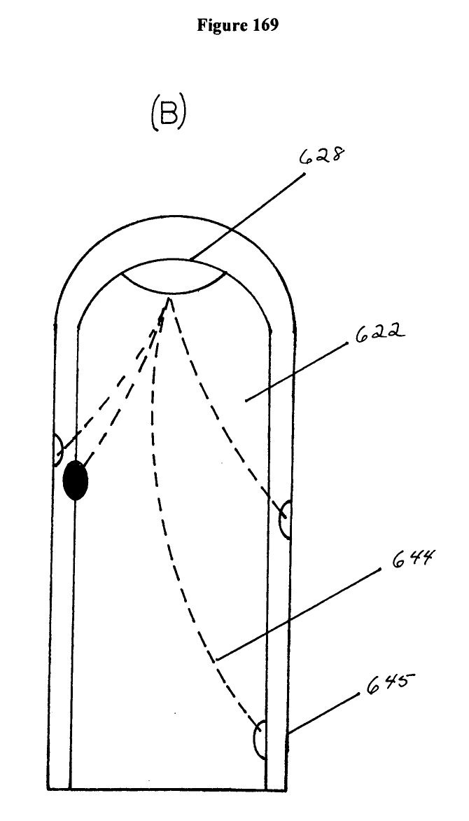

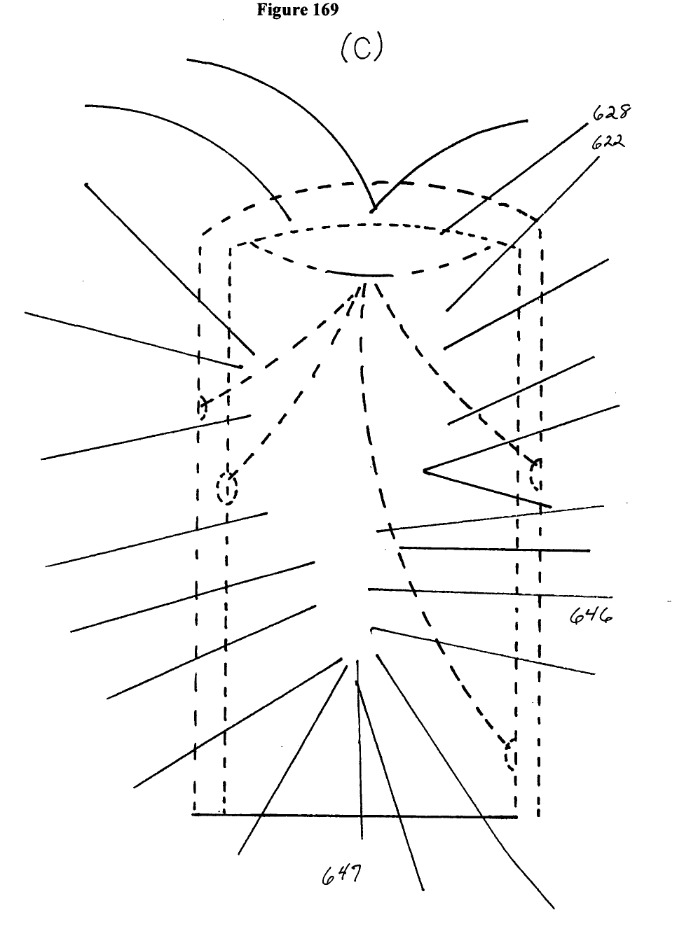

FIG. 169 comprises an electronically controlled electrical charge generator, that when activated, will generate an electrical charge that will travel through strategically hardwired to various points within the encasement's wall structure, or generate an electronic signal that will cause strategically placed capacitor or contact surfaces to vibrate or produce a charge of such magnitude as to cause the material of the encasement's wall to rapidly disintegrate.

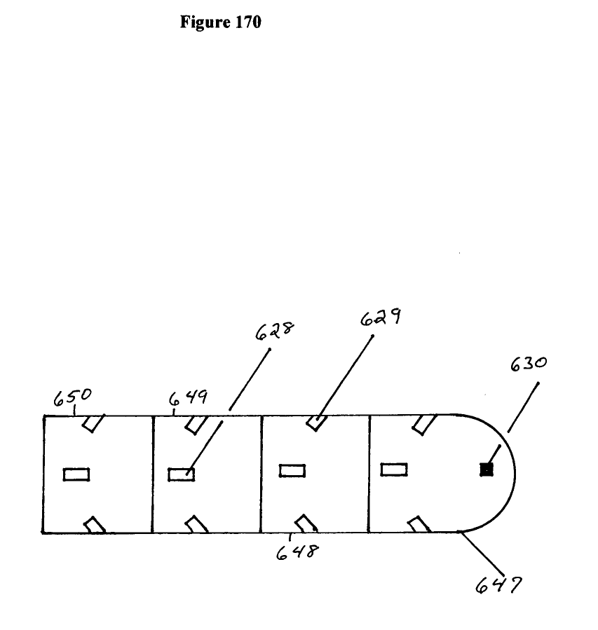

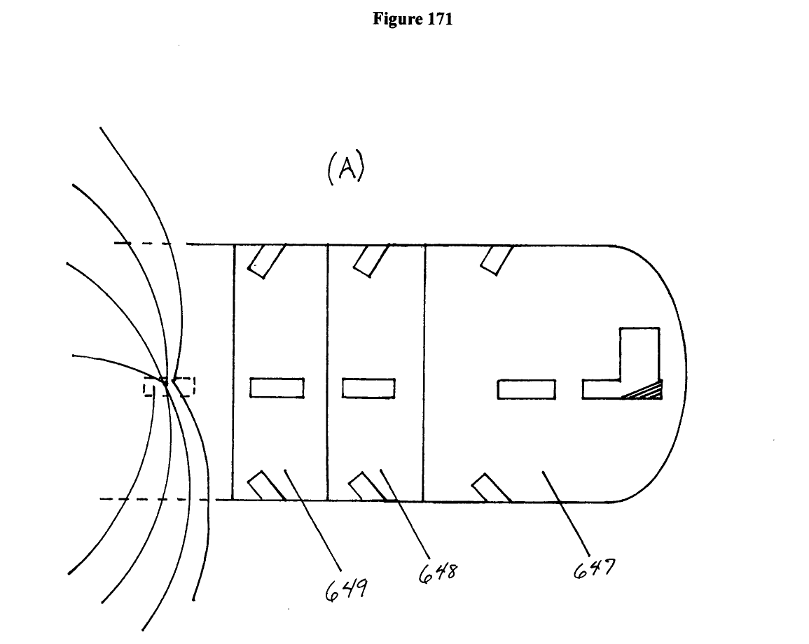

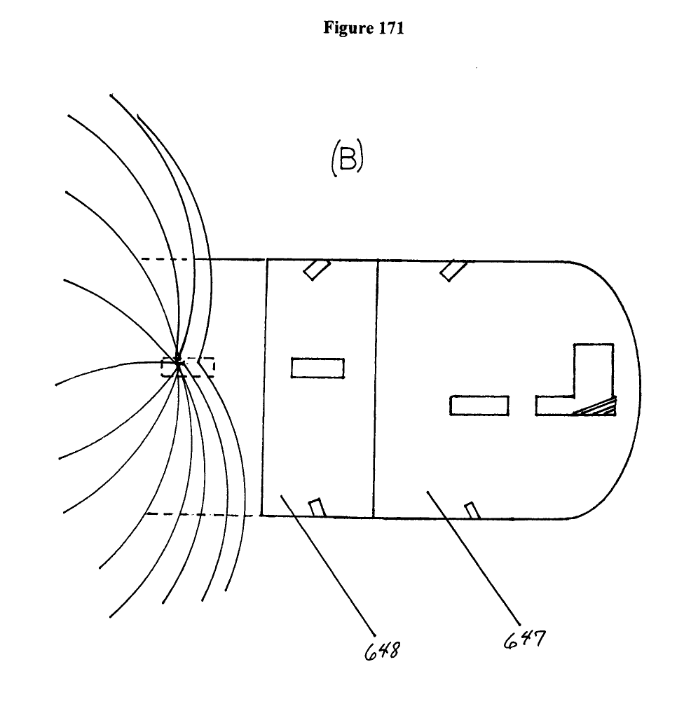

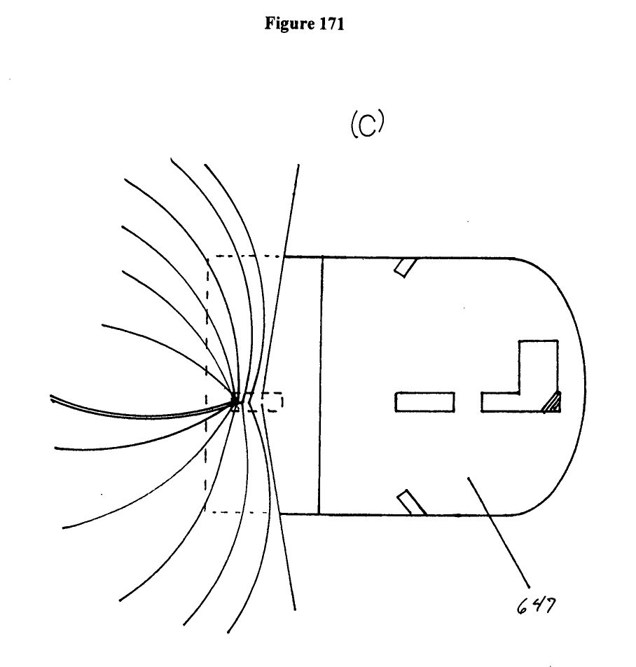

FIGS. 170 and 171 comprise an encasement (here) that is divided into four discrete segments, each containing as an option an independent gas generated propellant core, further illustrating the wireless programming means, discharge means, transceiver, and an electronically controlled electrical charge generator. This encasement can be programmed to discharge its entire fire extinguishment load simultaneously, or released consecutively by quadrant.

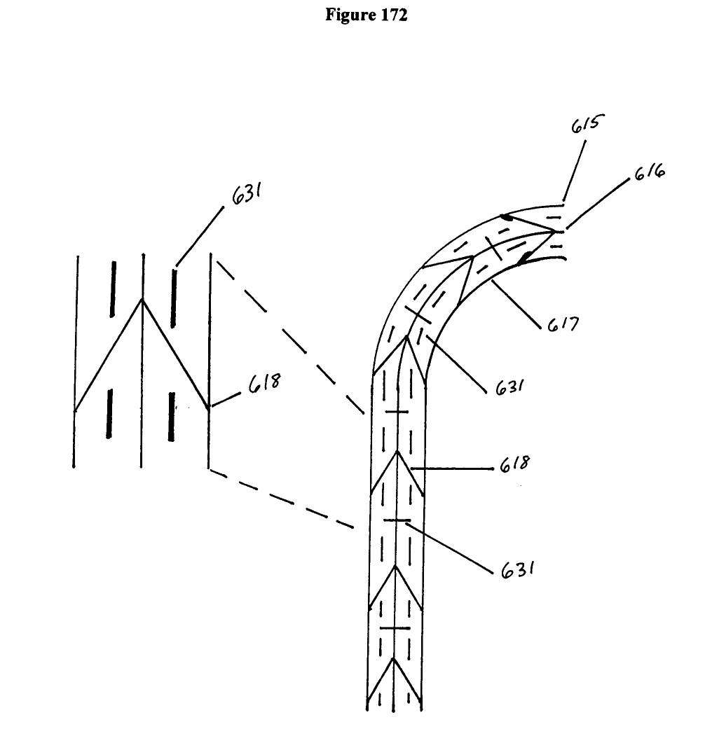

FIG. 172 illustrates the placement of microfilaments to the exterior, near exterior, and interior surfaces of the encasement that will respond to a specific pitch emitted by a tuning fork or tuning fork-like device. Placement of the microfilaments is to augment stabilization of the encasement and the controlled degradation process.

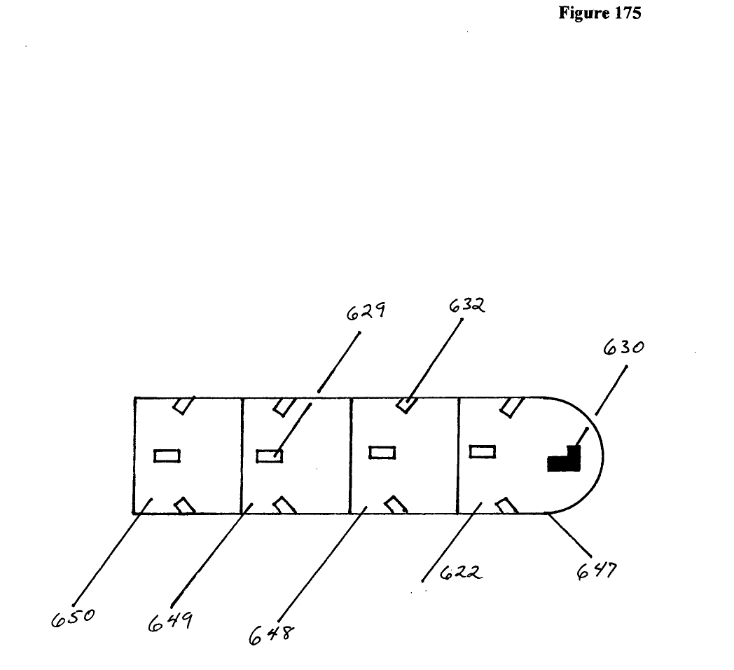

FIG. 175 illustrates the use of controlled degradation to disintegrate discrete areas of an encasement for release of its contents to the environment.

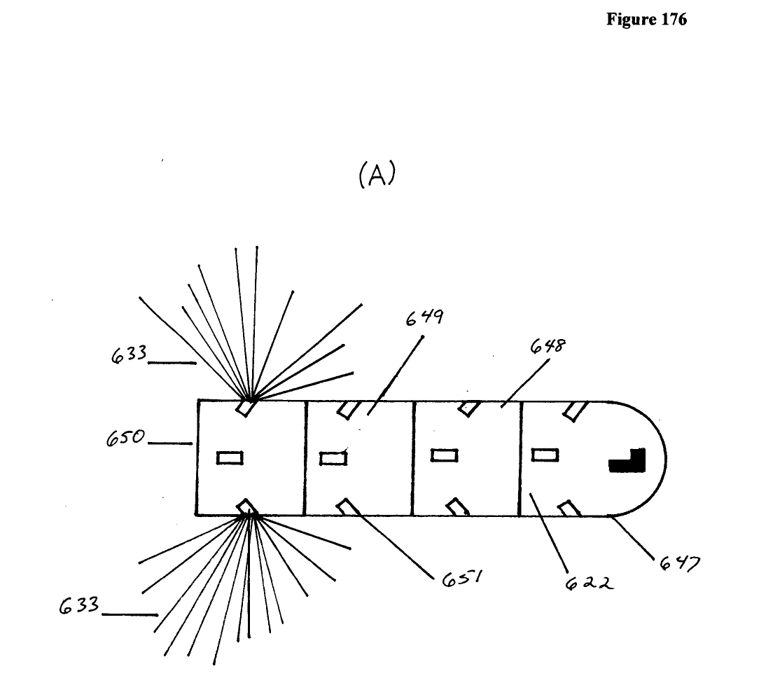

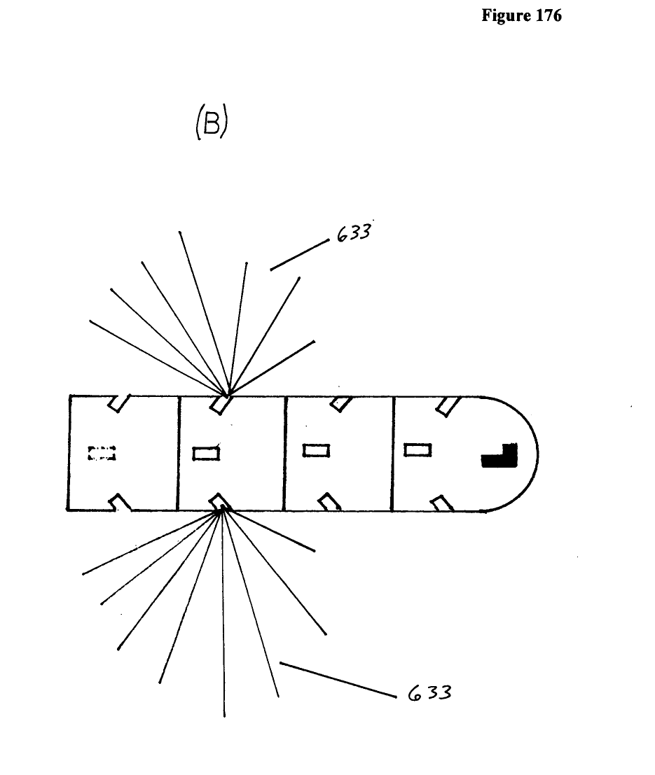

FIG. 176 further illustrates FIG. 175, where the encasement is compartmentalized to discrete sections, where release of the fire extinguishment material contained therein begins at the base segment, progressing forward, with the extinguishment is released through control degradation ports.

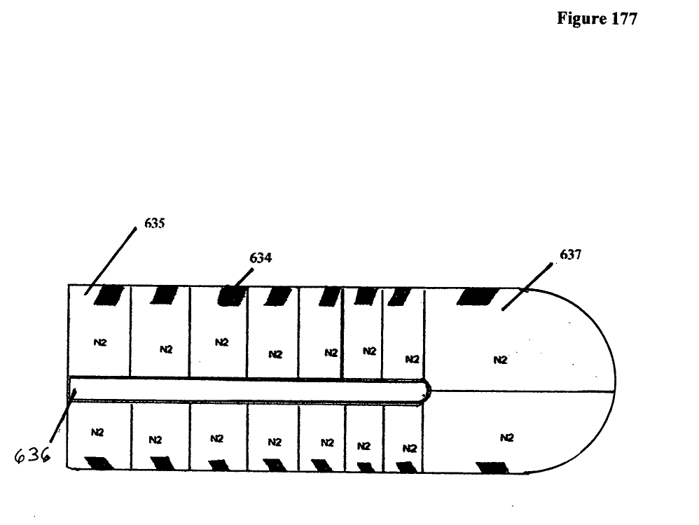

FIG. 177 is an illustration where each chamber is filled with nitrogen or other inert gas as the fire extinguishment. The propellant core is segregated from the internal chamber that contains the fire extinguishment.

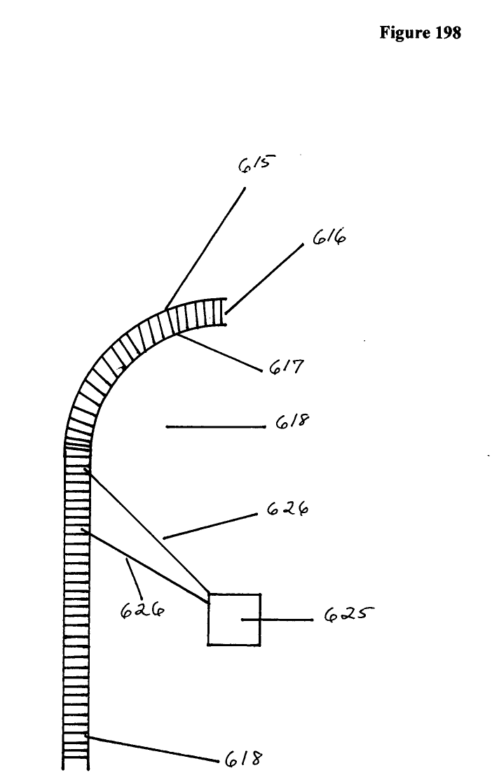

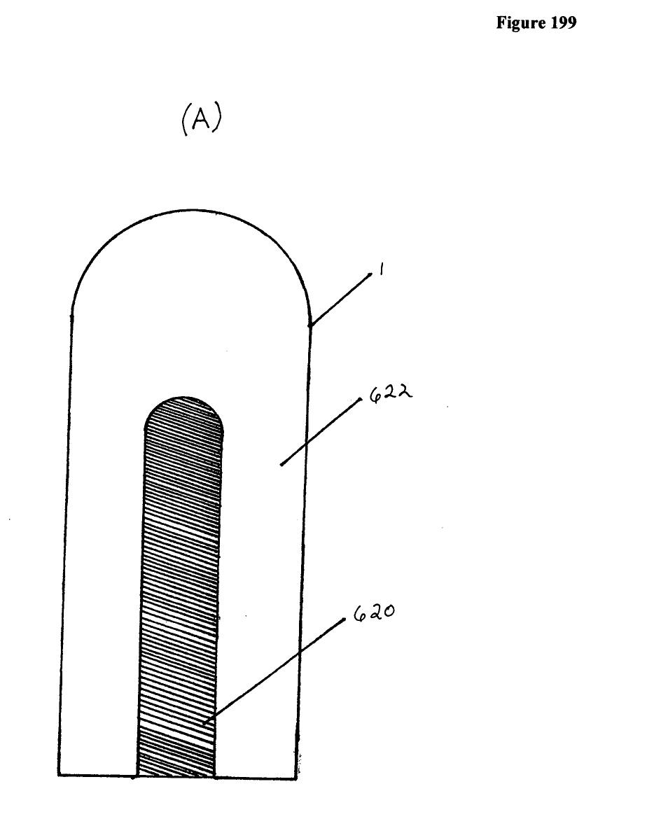

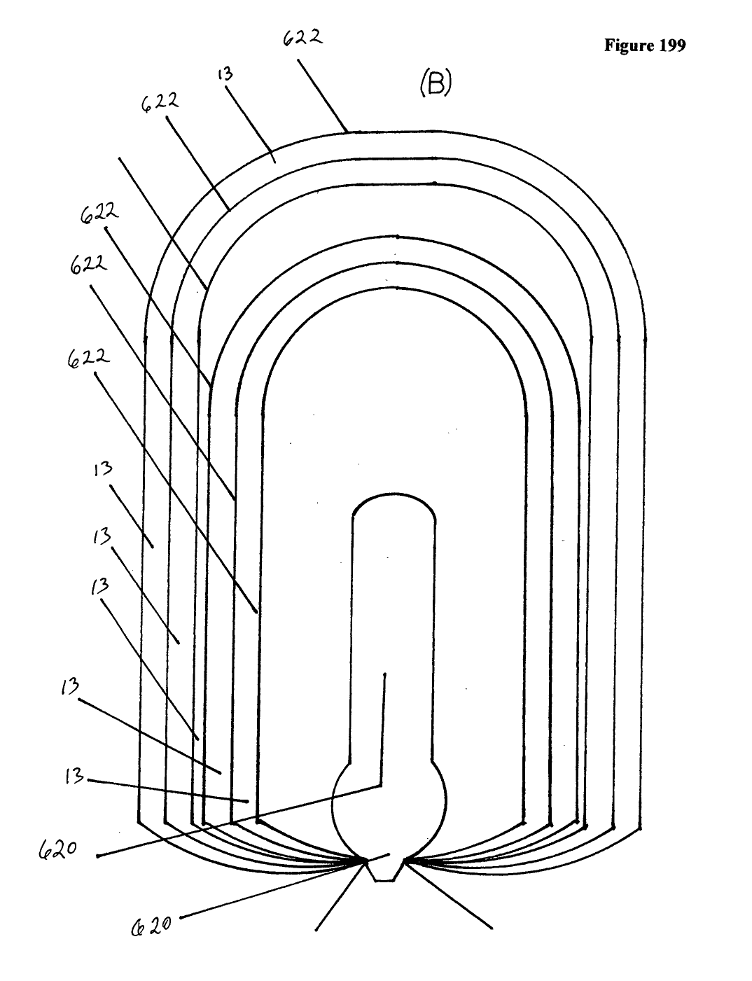

FIGS. 198, 199 and 200 illustrate a cut-away cross section of an encasement, where the propellant core is centrally placed within the encasement.

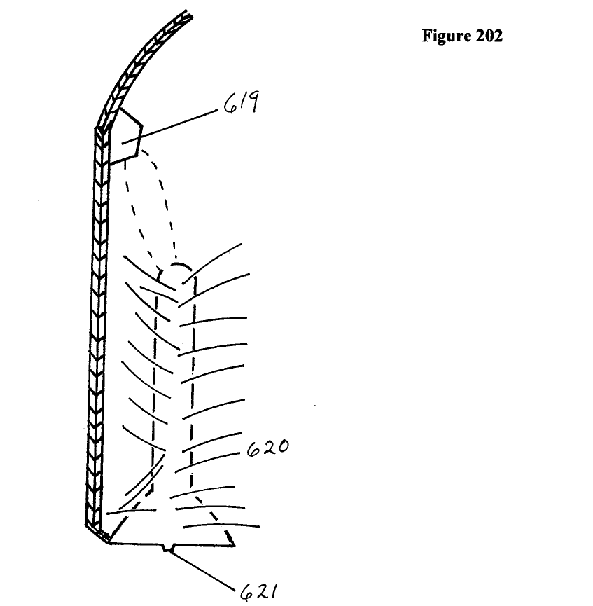

FIG. 202 illustrates that when the wall of the propellant core is exposed to an electrical charge emanating from within the encasement's interior or fire extinguishment containment area, such as by the electronically controlled electrical charge generator (621), the electrical charge should cause the propellant core's material to pulverize, resulting in the expulsive release of the encased propellant material to the interior of the encasement.

FIG. 203, as a continuation from FIG. 202, with controlled degradation of the encasement, the propellant will forcibly project the fire extinguishing material to the fire environment.

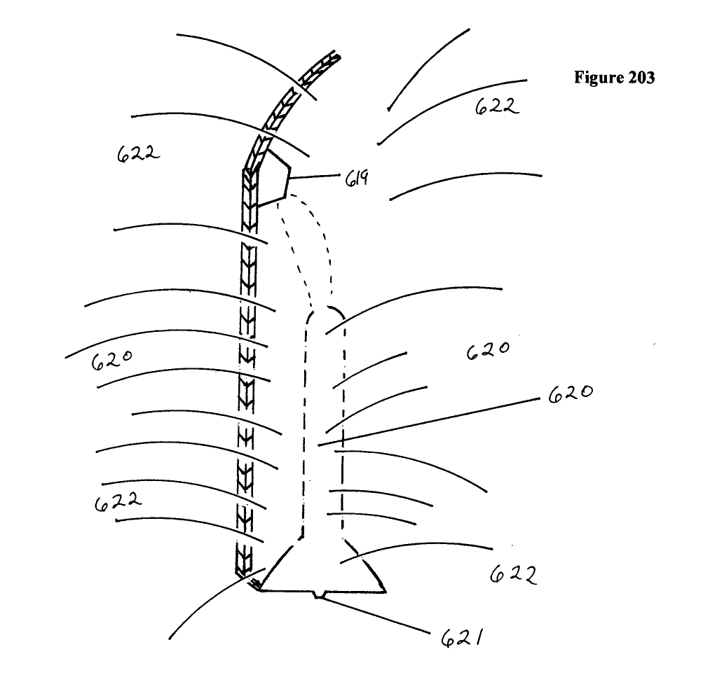

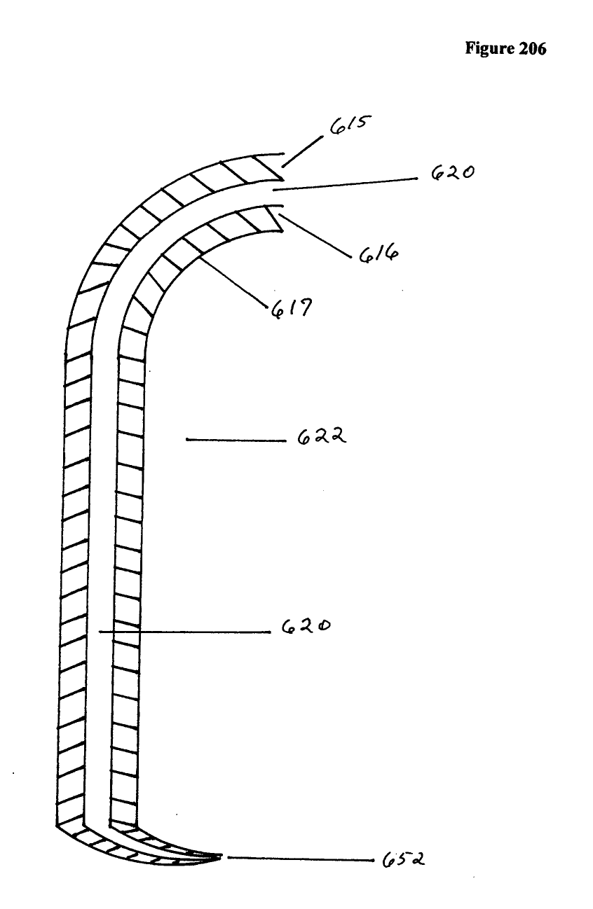

FIG. 206 illustrates a cut away section, comprising an encasement where the propellant containment is sandwiched between the near exterior surface and the interior surface of the encasement, spanning the majority of the encasement with the exception of the base and nose area. Release of the propellant, for drive purposes, is through a base located propellant exhaust aperture.

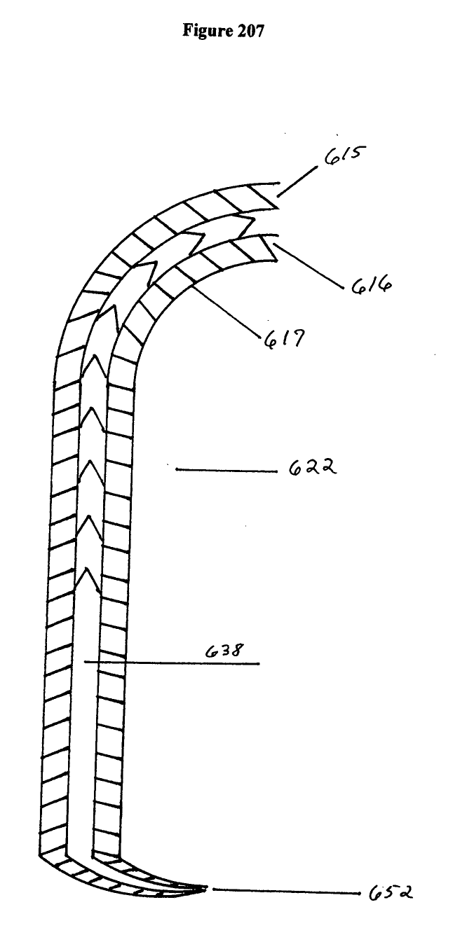

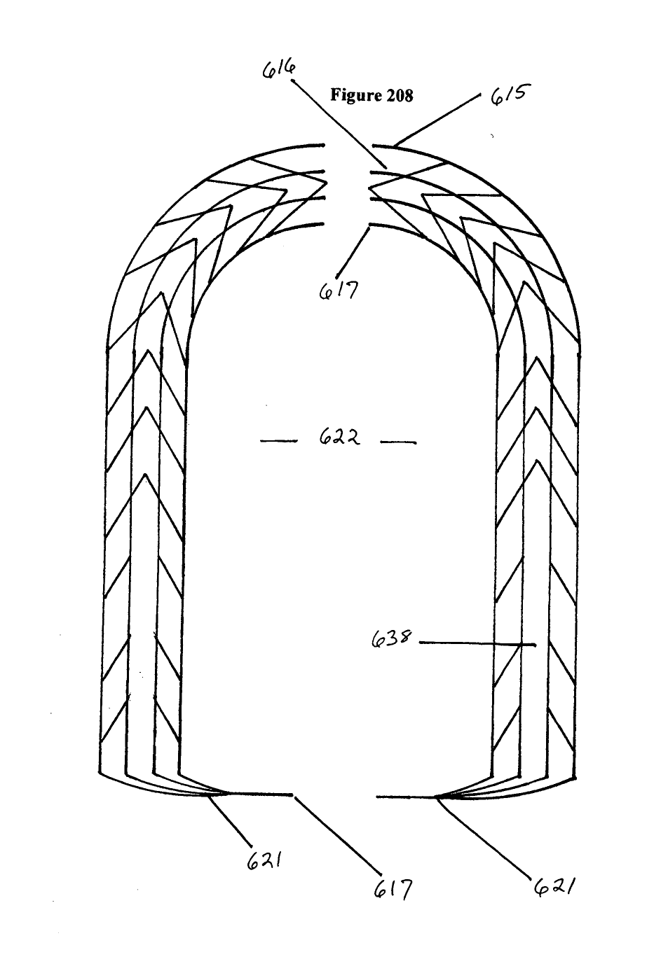

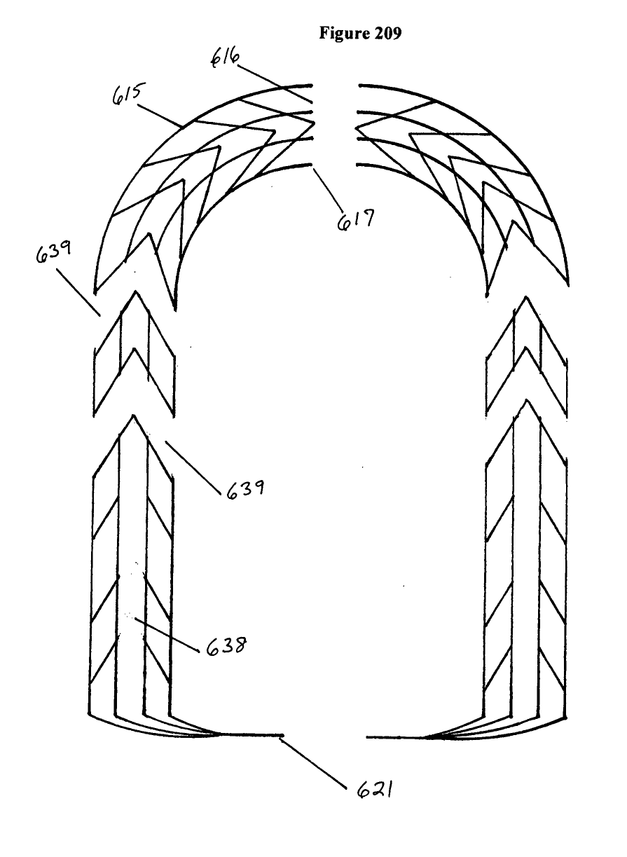

FIGS. 207, 208 and 209 illustrate the propellant containment that is located between the near exterior surface and the interior surface of the encasement covers only a portion of the encasement's length.

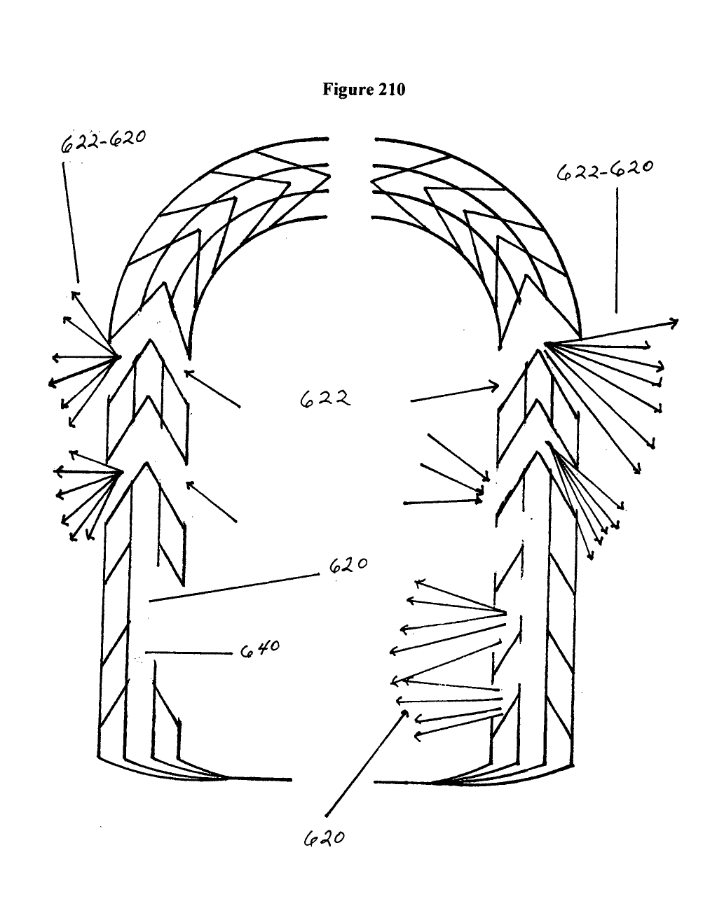

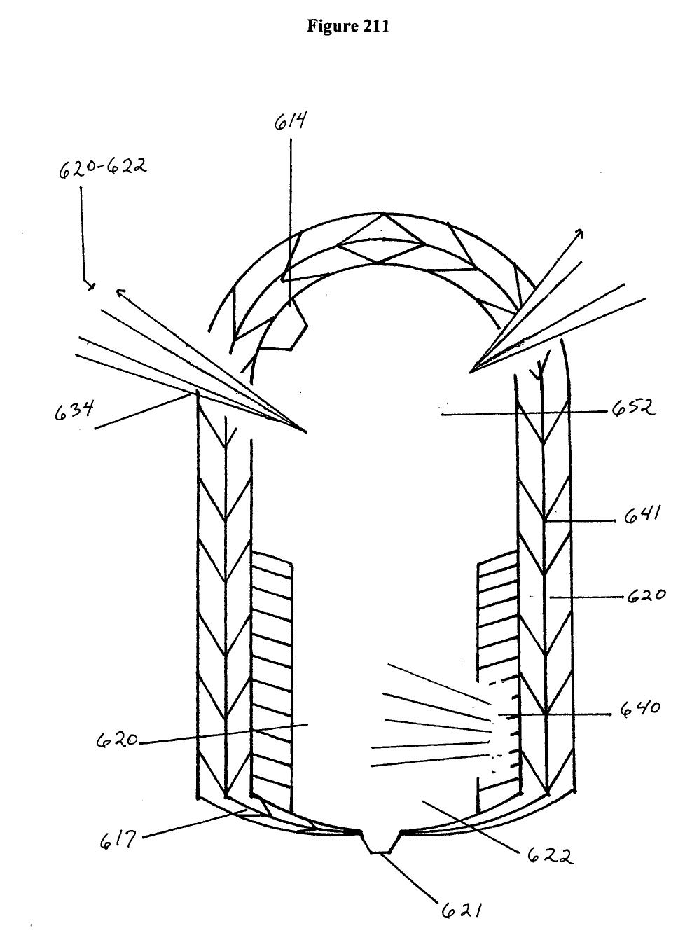

FIGS. 210 and 211 illustrates placement of the propellant core within the wall structure of the encasement.

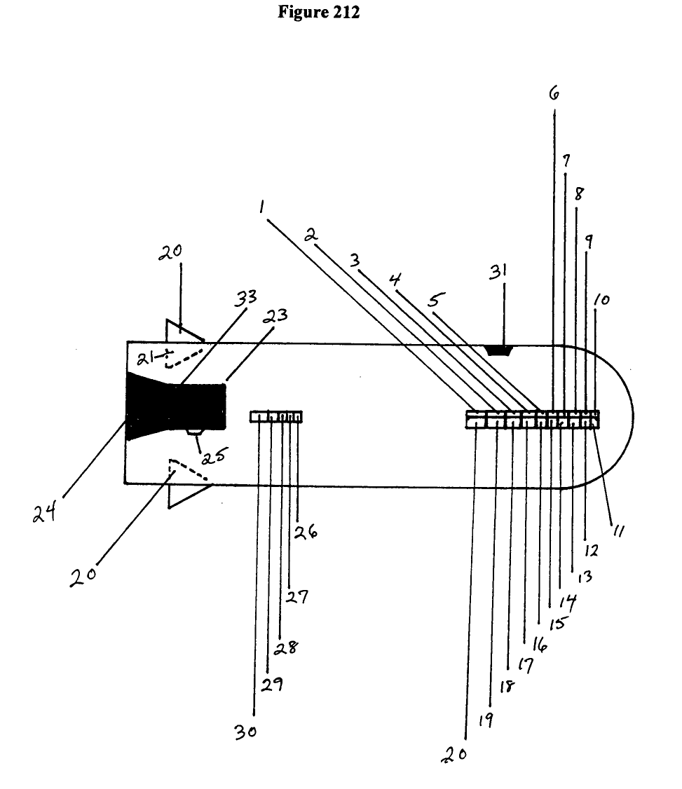

FIG. 212 illustrates a Third Generation Smart Fire Extinguishment Encasement.

### DETAILED DESCRIPTION OF THE INVENTION

As used herein, an activatable means shall mean a means, method, methodology, mechanism, procedure, mechanical provision, electronic provision, conveyance, technique, process, way, microprocessor controlled, microprocessor initiated, microprocessor aided or assisted, microchip controlled, microchip initiated, microchip aided or assisted, nanotechnology controlled, nanotechnology initiated, nanotechnology aided or assisted, that in some way, shape or manner when activated, turned on, charged, charged with, programmed to, manually set to, manually programmed to, mechanically set to, mechanically programmed to, will cause a shell or device to partially release, completely release, leak, or in combination thereof release its contents.

As used herein, a shell is defined as a form of encasement, encapsulation, capsule, containment device, device which may also be referred to but not all inclusive to mean a canister, device or something of similar designation or meaning, that may be constructed of metal, a non-metal substance, gelatin, cellulose, plastic, fire extinguishment material, fire suppressant material, fire retardant material, a particulate matter dissipating material or substance, an endothermic agent, composite material, other suitable medium or in combination thereof, with appropriate mechanical strength and disintegration rates and may be referred to interchangeably.

As used herein, a fire extinguishment encasement is defined as a form of encasement, encapsulation, capsule, containment device, device, shell, or similar means developed to house, contain, comprise, or similarly hold a fire extinguishment, retardant, suppressant, smoke dissipating agent, endothermic agent, or in combination thereof.

As defined herein, a fire extinguishment encasement is intended to house, accommodate, contain, have, include, hold, surround, enclose, a fire suppressant material, fire retardant material, particulate matter dissipating agent, an endothermic agent, or in combination thereof, for the purpose of delivering same to a fire situation.

As used herein, delivery shall mean the means, method, methodology, way, ways, or similar manner to present, present into, place, drop, aerially drop, project, propel, throw, or suspend a shell, capsule, device, canister into, within, above, discharge or suspend an encasement into, proximate to a fire environment.

As used herein, a fire environment, fire situation, or fire conflagration shall mean the place, environment, area or ecosystem where a fire exists, is active, is anticipated, or has existed but requires continued monitoring; and, may also be used interchangeably with fire, fire environment, fire zone, target, or target areas.

In an embodiment FIG. 1, the primary targets are, small and major (forest [101]), grassland fires [102], open debris field fires [103], bog fires [104], structural fires such as high-rise [105], deep set building fires [106], underground construction tunnels and shaft fires [107], tunnel fires [108], oil and gas field fires [109], marine vessel fires [110], and military vehicle fires [111]) through the use of an array of shell types. These shell types include: Heat/temperature Sensitive shells (FIG. 2); Shatter or Impact shells (FIG. 3); Time Activated shells (FIG. 5); Two-Stage (FIG. 19) and Single-Stage (FIG. 25) Pop-up Shells; Canisters (FIG. 35) with multiple Pop-up Shells (FIG. 35); Canisters (FIG. 39) with multiple non Pop-up Shells (FIG. 46); Concentric Capsule system: Primary Capsule (FIG. 30) with multiple, independent shells (FIG. 7); Primary Capsule with multiple, concentric shells (FIG. 27); Primary Capsule with multiple, concentric levels (FIG. 30); High speed Disintegrating Shells (FIG. 82); Pressure-Sensitive shells (FIG. 62), Ground-based Discharged Shells (FIG. 38); Smart-chip controlled shells (FIG. 82); Smart Chip controlled heat seeking shells (inter alia, FIG. 82); and, Smoke/Airborne Particulate Matter Dissipating shells.

As used herein, in this invention, a fire suppressant material shall be defined as a powder, granular, solid, aerosol material, in a compressed or non compressed state, or other suitable substance with fire suppressant characteristics.

As used herein, release shall mean but is not limited to, an action by which the contents of a shell, encasement, encapsulation, capsule, containment device, device will be or become discharged, ejected, ejected from, expulsed, forcibly expulsed, expelled, forcibly expelled, emptied from, projected from, propelled, propelled from, propelled by, removed, removed therefrom.

As used herein, discharge of an encasement, release of an encasement, shall mean but is not limited to, an action by which the contents of an encasement will be or become discharged, ejected, ejected from, expulsed, forcibly expulsed, expelled, forcibly expelled, emptied from, projected from, propelled, propelled by, propelled from an encasement, fixture, device, containment device, containment system, or containment means.

As used herein, discharge a fire extinguishment encasement from a launcher shall mean but is not limited to, an action by which an encasement will be or become discharged from, discharged by, ejected, ejected from, expulsed, expelled, projected from, propelled, propelled by, propelled from a means, device, mechanism, system, fixture, encasement containment device, encasement containment system, or similar entity; and, unless specified otherwise, to a fire environment.

This shall further mean but is not limited to, an action by which a shell, encasement, encapsulation, capsule, containment device, device may be discharged, ejected, ejected from, expulsed, forcibly expulsed, expelled, forcibly expelled, emptied from, projected from, propelled, propelled from, propelled by, removed, removed from another device, shell, encasement, fixture, device, containment device, containment system.

As used herein, a spent shell shall also mean a shell, capsule, encasement, canister, containment device, or similar device that has fully, completely expelled, released, emptied, expulsed, projected, propelled, removed or otherwise has emptied its contents so that the device itself is all that remains.

As used herein, in this invention, a fire retardant material shall be defined as a powder, granular, solid, aerosol material, in a compressed or non-compressed state, or other suitable substance with fire retardant characteristics.

As used herein, in this invention, a particulate matter dissipating agent shall be defined as a powder, granular, solid, aerosol material, in a compressed or non compressed state, liquid, or other suitable substance with particulate matter suppression and/or dispersal characteristics.

As used herein, in this invention, an endothermic agent shall be defined as a substance, composite, solution, material that can be used to reduce the temperature within a fire zone when delivered to and activated within a fire zone.

As used herein, in this invention, a smoke dissipating agent or smoke suppression material shall be defined as a powder, granular, solid, aerosol material, in a compressed or non compressed state, liquid, or other suitable substance with smoke suppression and/or dispersal characteristics.

As used herein in this invention, a fire extinguishment material, a fire suppressant material, a fire retardant material, a particulate matter dissipating agent, an endothermic agent, shall be defined as a powder, granular, solid, aerosol material, misting material, atomizing mist, inert gas, gaseous substance, gaseous material substance or material, in a compressed or non-compressed state, or other suitable substance, with suitable characteristics for fire extinguishment, fire suppressant, fire retardant, particulate matter suppression and/or dispersal, the capacity to reduce the temperature within a fire zone when delivered to and activated within a fire environment, and or to extinguish or suppress a fire in said environment, respectively.

As used herein, a single wall shell shall mean, but is not limited to, a shell, encapsulation, capsule, containment, device that is constructed in such a manner that it comprise one wall that separates its contents from the external environment, yet is strong enough to withstand the internal pressure exerted by its contents, incidental bumping, the pressure exerted with general transportation and storage, the force exerted when dropped from a two foot height to a solid structure, and, the force exerted when propelled.

As used herein, a thin-walled fire suppressant capsule shall mean, a shell, encapsulation, capsule, containment device, device that is constructed in such a manner that the containment wall that separates its contents from the external environment will be of the minimal thickness possible, yet is strong enough to withstand the internal pressure exerted by its contents, incidental bumping, the pressure exerted with general transportation and storage, the force exerted when dropped from a two foot height to a solid structure, and, the force exerted when propelled.

As used herein, a double thin-walled or multi thin-walled shell shall means, but is not limited to, a shell, encapsulation, capsule, containment device, device that is constructed in such a manner that one containment wall separates the external environment from the fire suppressant contents of the shell, and a second wall separates the fire suppressant contents of the shell from the first containment wall.

As used herein, a hybrid single or double wall shall mean, but is not limited to, a shell, encapsulation, capsule, containment device, device that is constructed in such a manner that the containment wall or walls that separate the contents of the device or within the device from the external environment, may contain a singe wall and a double wall within the same device. This shall further mean that such hybrid wall construction shall be strong enough to withstand the internal pressure exerted by its contents, incidental bumping, the pressure exerted with general transportation and storage, the force exerted when dropped from a two foot height to a solid structure, and, the force exerted when propelled.

As used herein, a tracer shall mean a chemical substance that is attached to, made a part of, incorporated into an encasement that when activated will serve as a visual cue, marker, or similar means to visually see, note, trace, the trajectory or pathway of a deployed encasement.

This shall also mean a non-chemical substance that is attached to, made a part of, incorporated into an encasement that when activated will serve as a visual cue, marker, or similar means to visually see, note, trace, the trajectory or pathway of a deployed encasement.

As used herein, an electronic beacon shall mean a mechanism, system, method or similar means incorporated into an encasement, that is linked to a transmission means to report the encasement's position within a fire situation, its position to predecessor or tandem encasements discharged to the fire environment, its trajectory, and where in the event of a failure to discharge it provides a method to monitor the encasement's failure to discharge its extinguishment and the to locate same.

As used herein, a solid structure shall mean the ground, floor, or surface, of such strength, integrity, mass, or combination thereof, that when impacted by an encasement will cause the encasement to shatter or break apart, break away, become punctured, rupture, compromise the integrity of same, so as to initiate the process of or effect release of its contents thereof, where designed to do so, may result in non-controlled degradation of or impact degradation of a fire extinguishment impact encasement.

As used herein, the phrase spherical capsule shall mean and be used descriptively, for illustrative purposes alone as a shell, encapsulation, capsule, containment means, device that is constructed in such a manner that it is spherical, round or of similar shape, for the purpose of containing a fire suppressant material, fire retardant material, an endothermic agent, composite material or other suitable medium or in combination thereof, with appropriate mechanical strength and disintegration rates.

As used herein, the phrase cylindrical capsule shall mean and be used descriptively, for illustrative purposes alone, as a shell, encapsulation, capsule, containment means, device that is constructed in such a manner that it is spherical, round or of similar shape, for the purpose of containing a fire suppressant material, fire retardant material, an endothermic agent, composite material or other suitable medium or in combination thereof, with appropriate mechanical strength and disintegration rates.

As used herein, a canister is defined as a larger form of encasement, encapsulation, capsule, containment, device which may also be referred to but not all inclusive to mean a shell, device or something of similar designation or meaning, that may be constructed of metal, a non-metal substance, gelatin, cellulose, plastic, fire suppressant material, fire retardant material, an endothermic agent, composite material or other suitable medium or in combination thereof, with appropriate mechanical strength.

As used in this invention, highly compressed fire suppressant materials shall mean a fire suppressant, fire retardant, endothermic agent, smoke dissipating material, particulate matter dissipating material that can be compressed for containment within a device.

As used herein, a heat/temperature sensitive device shall convey the means by which a device will activate the temperature sensitive activatable setting of a shell, capsule, canister or device, to initiate disintegration of the shell, actual disintegration of the shell, and release of its contents, when exposed to a minimum temperature threshold or heat above a specified minimum temperature.

As used herein, a temperature range activated shall mean, the point at which the device will release its contents to the environment or initiate disintegration of its shell for subsequent release of its material, is determined by the temperature of the fire zone the device encounters, where such is between X degrees centigrade or Fahrenheit and Y degrees centigrade or Fahrenheit. This shall further mean that X degrees is the minimum temperature and Y is the highest temperature within the defined temperature range, and the shell's activatable means is programmed mechanically, electronically programmed, or in combination thereof, to respond accordingly to the specified temperature range.

As used herein, the phrase deactivated prior to deployment shall mean, that any discharge feature that can be electronically, manually or mechanically programmed into a shell, capsule, device, canister that such as discharge in relationship to heat, time, impact, height, altitude, pressure, and any combination thereof, can be deactivated, deprogrammed or reprogrammed prior to deployment of the device.

As used herein, deployment shall mean the application, introduction of, introduction to, use of, intended use of, projection, propelling, throwing, or in any other manner to deliver the invention to the fire zone.

In an embodiment FIG. 2, a heat/temperature activated fire suppressant capsule (47) is projected into a fire zone (11). Entering above the flame (12) , the capsule descends (20) and disintegration of its thin-walled shell (21) initiates because of the heat, resulting in release (15) of the capsule's fire suppressant load (13).

Here, the capsule's containment wall (21) is designed to disintegrate at a minimum or pre-determined temperature threshold (e.g., 350° F.). Because its fire suppressant load (13) is packed under very high pressure (14), a plume (34) of the fire suppressant (13) is spread out across the fire (15) when the capsule disintegrates (21).

In another embodiment FIG. 3, a heat/temperature activated shatter fire suppressant capsule (48) (or, “shatter capsule”) is projected into a fire zone (11). When in contact with the flame (12) and upon impact with a second structure, e.g., the floor (16), ground (17), or any structure or surface (18) that will cause the capsule to shatter upon impact, the capsule shatters (19) (FIG. 3b), forcibly ejecting its fire suppressant load (13) to the fire zone (15) (FIG. 3b).

In a further embodiment FIG. 4, a structural fire zone (11) where the intensity of the fire's temperature various throughout the structure is depicted. For illustrative purposes here, the first twenty feet (400) of the structure is at 500° F. (305). While facing the rear of the structure (399), the temperature rises to 800° F. (308) between 45′ and 60′ into the structure (411). At the rear of the structure (399) the 100′ demarcation (410) the temperature is only 700° F. (307). By developing fire suppressant capsules that will disintegrate at different temperatures, especially where the fire cannot be attacked from more than one point of entry, capsules can be projected farther into a structure.

In still another embodiment FIG. 5, this principle is demonstrated where a fire suppressant capsule (1) that requires, e.g. 900° F. temperatures to initiate disintegration of the capsule, so as to release the suppressant, enters a 350° F. fire zone (300) and passes through a 800° F. zone (308), then comes to rest in a fire zone measuring only 600+ F. (306), the capsule disintegrates 30 seconds after projection (161, FIG. 82) or 30 seconds into the fire zone (11).

Where a capsule lands in a fire zone that is below the minimum temperature threshold (e.g., the capsule is specifically set to disintegrate at the 900° F.), time sensitive feature acts as a safety feature to release the fire suppressant load instead of waiting for the temperature to achieve 900° F. or greater (which would otherwise result in more damage before the suppressant is released).

When determining the temperature range throughout the course depth of the building is not feasible, using capsules that disintegrate based upon time out of the launcher (161, FIG. 82) (i.e., time activated), distance and/or striking a surface hard enough to shatter or compromise the capsule's integrity, the capsule is not prematurely triggered by heat.

Through another embodiment (See FIG. 6, which utilizes the same fire zone pattern discussed at FIG. 5), the intended mark is the 700° F. demarcation, using a time-activated capsule (49) to suppress the fire. While capsules are projected into the 350° F. fire zone (300) and the 900° F. fire zone (309), additional capsules (6/49) are projected beyond the 900° F. (309) zone to actively knock down the fire that is at 600° F. fire zone (306). Using a time sensitive fire suppressant capsule (49), the latter passes through the 350° F. fire zone (300) and the 900° F. fire zone (309), landing 100′ into the structure (100) in the 600° F. fire zone (306), where its shell begins to disintegrate (5) (e.g., for illustrative purposes only) 25 seconds after projection from the launcher (161, FIG. 76), releasing and forcibly ejecting its fire suppressant load (13), 30 seconds after launch. FIG. 7 further illustrates the intent of FIG. 6, where a heat/temperature activated (47) fire suppressant capsule designed to discharge its load at 900° F. comes to rest in a 600° F. fire zone. Point (320) shows the level of damage at 8 seconds. At FIG. 7b the capsule remains intact, the temperature of the fire zone is 700° F. (307) at 15 seconds, and the extent of damage is greater (321). At FIG. 7c, the fire does not reach 900° F. (309) until 90 seconds. At this time the extent of damage is greater (322). By only deploying a limited use capsule to the fire zone (i.e., a capsule that disintegrates only when the fire zone achieves an ambient temperature of 900° F. or greater) allows for greater damage to the structure (100) to occur with elapsed time (322). FIG. 8 continues to illustrate FIG. 5, FIG. 8's heat/temperature activated (47) fire suppressant capsule encounters a hard surface along its trajectory path (200). Striking the surface, the capsule (47) is diverted from its intended pathway; however, due to the impact the capsule shatters or begins to disintegrate, releasing its fire suppressant load (13) at ground or floor level (or earlier).

As used herein, the fire suppressant load shall mean the fire suppressant, fire retardant, endothermic agent, smoke dissipating material, particulate matter dissipating material contained within a device.

As used herein, the phrase level of damage shall mean, the amount, degree, reach, extent of damage, destruction, devastation, obliteration, wreckage, desolation, ruin, caused by, as a result of, or resulting from a fire.

As used herein, a shatter or impact capsule shall mean, a device that will release its contents to the environment or initiate disintegration of its shell for subsequent release of its material to the environment, upon impact with a structure or surface of such consistency that the impacting force will result in disintegration of or initiating the disintegration of the shell.

In an embodiment (See FIG. 4)and discussed above, the shatter feature of the heat/temperature activated fire suppressant capsule (47) serves a secondary purpose: where heat alone does not cause the thin-walled fire suppressant's capsule (1) to disintegrate, impact will (19), thereby releasing its contents (13). This serves as a safety feature to assure release of the fire suppressant (13).

Fire suppressant capsules can be developed as a shatter capsule (4), and/or where in combination with other features, e.g., temperature sensitive (4/47), where the latter feature (i.e., temperature sensitivity) is deactivated prior to deployment of the capsule to the fire zone (100-111), so that the capsule (4/47) will discharge its fire suppressant load (13) upon impact with any structure (16, 17, 18).

In another embodiment FIG. 8, continuing to illustrate FIG. 5, FIG. 8's heat/temperature activated (47) fire suppressant capsule encounters a hard surface along its trajectory path (200). Striking the surface, the capsule (47) is diverted from its intended pathway; however, due to the impact the capsule shatters or begins to disintegrate, releasing its fire suppressant load (13) at ground or floor level (or earlier). Here, the impact setting serves a dual function as a safety mechanism

As used herein, a time activated device shall mean, that period of time where a device will release its contents to the environment or initiate disintegration of its shell for subsequent release of its material, and as such may be mechanically set, electronically set, or in combination thereof.

In another embodiment FIG. 4 which utilizes the same fire zone pattern discussed at FIG. 5, the intended mark is the 700° F. demarcation, using a time-activated capsule (49) to suppress the fire. While capsules are projected into the 350° F. fire zone (300) and the 900° F. fire zone (309), additional capsules (6/49) are projected beyond the 900° F. (309) zone to actively knock down the fire that is at 600° F. fire zone (306). Using a time sensitive fire suppressant capsule (49), the latter passes through the 350° F. fire zone (300) and the 900° F. fire zone (309), landing 100′ into the structure (100) in the 600° F. fire zone (306), where its shell begins to disintegrate (5) (e.g., for illustrative purposes only) 25 seconds after projection from the launcher (161, FIG. 76), releasing and forcibly ejecting its fire suppressant load (13), 30 seconds after launch.

In an embodiment FIG. 6 utilizes the same fire zone pattern discussed at FIG. 5. Here, the intended mark is the 700° F. demarcation, using a time-activated capsule (49) to suppress the fire. While capsules are projected into the 350° F. fire zone (300) and the 900° F. fire zone (309), additional capsules (6/49) are projected beyond the 900° F. (309) zone to actively knock down the fire that is at 600° F. fire zone (306). Using a time sensitive fire suppressant capsule (49), the latter passes through the 350° F. fire zone (300) and the 900° F. fire zone (309), landing 100′ into the structure (100) in the 600° F. fire zone (306), where its shell begins to disintegrate (5) (e.g., for illustrative purposes only) 25 seconds after projection from the launcher (161, FIG. 76), releasing and forcibly ejecting its fire suppressant load (13), 30 seconds after launch.

In a further embodiment FIG. 7 further illustrates the intent of FIG. 6. Here, a heat/temperature activated (47) fire suppressant capsule designed to discharge its load at 900° F. comes to rest in a 600° F. fire zone. Point (320) shows the level of damage at 8 seconds. At FIG. 7b the capsule remains intact, the temperature of the fire zone is 700° F. (307) at 15 seconds, and the extent of damage is greater (321). At FIG. 7c, the fire does not reach 900° F. (309) until 90 seconds. At this time the extent of damage is greater (322). By only deploying a limited use capsule to the fire zone (i.e., a capsule that disintegrates only when the fire zone achieves an ambient temperature of 900° F. or greater) allows for greater damage to the structure (100) to occur with elapsed time (322).

As used herein, the impact safety feature of a temperature range activated shell, a time activated shell, altitude activated shell, height activated shell shall mean, a means, mechanism or device that will cause the release of the contents contained by an encasement, encapsulation, capsule, containment device, where a device's activatable means responsive to heat, temperature, time, altitude, height, pressure, or in combination thereof fails to respond or does not respond accordingly when activated. In an embodiment, (See FIG. 8), when the shell comes to rest on a surface, or impacts with a surface or structure strong enough to initiate disintegration of the shell upon or as a result of impact, but where its activatable means has not resulted in expulsion of the shell's contents, impact will serve as a secondary or safety activatable means, thereby releasing the contents to the environment.

In an embodiment (see FIG. 8), a heat/temperature activated (47) fire suppressant capsule encounters a hard surface along its trajectory path (200). Striking the surface, the capsule (47) is diverted from its intended pathway; however, due to the impact the capsule shatters or begins to disintegrate, releasing its fire suppressant load (13) at ground or floor level (or earlier).

As used herein, an altitude activated device shall mean, an encasement, encapsulation, capsule, containment device, device, with an activatable means that will respond to a specified altitude, based upon a means to determine the longitudinal and latitudinal setting, where the device will release its contents to the environment or initiate disintegration of its shell for subsequent release of its material, and as such may be mechanically set, electronically set, or in combination thereof.

As used herein, a variable programmed minimum altitude, preprogrammed maximum altitude, altitude range, or in combination thereof shall mean, an encasement, encapsulation, capsule, containment device, device, with an activatable means that will respond after the device achieves X altitude but before achieving Y altitude. This shall further mean that X altitude is the minimum altitude and Y is the maximum altitude within the defined altitudinal range, based upon a means to determine the longitudinal and latitudinal setting, where the device will release its contents to the environment or initiate disintegration of its shell for subsequent release of its material. This shall still further mean the shell's activatable means is programmed mechanically, electronically programmed, or in combination thereof, to respond accordingly to the specified altitude range.

As used herein, a height activated device shall mean, an encasement, encapsulation, capsule, containment device, device, with an activatable means that will respond to a specified height, based upon a means to determine the height or distance between the device and the ground or floor or similar surface area, during the ascent and/or descent of the device, where the device will release its contents to the environment or initiate disintegration of its shell for subsequent release of its material, and as such may be mechanically set, electronically set, or in combination thereof.

As used herein, a variable programmed minimum height, preprogrammed maximum height, height range, or in combination thereof shall mean, an encasement, encapsulation, capsule, containment device, device, with an activatable means that will respond after the device achieves X height but before achieving Y height. This shall further mean that X height is the minimum altitude and Y is the maximum height within the defined height range, based upon a means to determine the height or distance between the device and the ground or floor or similar surface area, during the ascent and/or descent of the device, where the device will release its contents to the environment or initiate disintegration of its shell for subsequent release of its material. This shall still further mean the shell's activatable means is programmed mechanically, electronically programmed, or in combination thereof, to respond accordingly to the specified altitude range.

As used herein, chafe-charge shall mean, a means, method, instrument, device, or similar indication to effect a controlled explosion, where the force of that explosion is directed to a specific direction.

As used herein, is shall also mean a means that when activated will pierce, shatter, compromise, penetrate, perforate, puncture a shell, encasement, encapsulation, capsule, containment device, device, at a specific point, point or origin, place in the body of that shell, while forcibly expelling the contents of the shell through the opening created, in the intended direction, or in combination thereof.

As used herein percussive shall mean the force exerted by a body, upon a body, as created by an explosion, controlled explosion, explosive force, detonation, detonated material or similar definition.

In an embodiment FIG. 69 a single walled fire suppressant capsule with a global position system and gyroscopic sensor microprocessor (86) and a microprocessor controlled altimeter (87), contains a single chafe-charge mechanism (142) that will penetrate the shell of the chafe-charge type capsule (141) at the point closest to the intended target fire area, directing the fire suppressant in a specified direction.

The chafe charge used by the military is an ordinance that that has the ability to control the direction of an explosive reaction, sending its force or charge in a specific direction: e.g., when placed against a door, the charge will blow against and through the door, yet the percussive force is not felt by anyone standing behind the explosive device itself.

The global positioning system and gyroscopic sensor microprocessors (86) and microprocessor controlled altimeter (87) determine the position and coordinates of the fire suppressant capsule relative to the intended fire zone and the specific area targeted within that zone. The target area may be based upon temperature (range), height of the flame or burning structure/obstruction, etc.

The purpose of the chafe-charge like mechanism (142) is to forcibly eject all or part of the fire suppressant load (13) to a specified area within the fire zone. When the fire suppressant capsule (13) is dropped or projected into the fire zone and the microprocessors (86, 87) determine the optimum position or range, the microprocessor (86 or 87) electronically discharges the chafe-charge (143) by emitting an electric impulse (if employing a physical contact/lead between the microprocessors [86, 87] and the chafe charge mechanism [142] or an electronic signal) to the chafe-charge mechanism (142) to trigger an explosion of the chafe charge (143). As at FIG. 59, composition of the chafe charge (143) should be a substance that will not ignite or cause an explosion when subject to heat or flames.

Here, the intent is to develop a capsule where its fire suppressant load can be projected with force in a specific direction, while the capsule is in motion. What is key here is the ability of the capsule to achieve the desired vertical or horizontal plane at the time of intended discharge. One method that may be applied to achieve the proper vertical/horizontal plane while the capsule is in mid-flight or mid-air is the self-righting mechanism mentioned at FIG. 19 or the stabilizing wings or fins (98) first mentioned at FIG. 56. The chafe charge surface (189), i.e., the surface that will blow out the capsule's shell should be attached to or facing the surface of the fire suppressant capsule (1)

FIG. 70 is a second embodiment of FIG. 69, showing multiple chafe-charge mechanisms (143) placed throughout the interior of the fire suppressant capsule (141).

In another embodiment FIG. 71 a double thin-walled fire suppressant capsule (113) containing a global positioning system and gyroscopic sensor microprocessors (86), microprocessor controlled altimeter (87), has a single free-floating chafe-charge mechanism (145) placed between the chamber walls (146). When using a free floating chafe-charge mechanism (145), instead of a fixed position chafe-charge mechanism, the chafe-charge mechanism (145) itself must be negative balanced, positive balanced or neutral balance, relative to the balance of the capsule (1), where the capsule will rotate into optimum position prior to discharge.

In still another embodiment FIG. 72, the chafe-charge mechanism (145) is illustrated penetrating (190) the double thin-walled fire suppressant capsule (113) of FIG. 57, expelling its fire suppressant load (13).

In a further embodiment FIG. 73 is a horizontal descending/vertical dispersal (147), horizontal-bifurcated fire suppressant capsule (148) containing a single chafe-charge mechanism (142) in each half (149, 150) of the capsule. When the guiding means rotates the capsule into position the chafe-charge (143) breaches the wall, ejecting one half, i.e., the dorsal portion (151) of its fire suppressant load (13). This may be particularly useful where the fire suppressants must be forcibly ejected upward (e.g., to a ceiling, canopy, etc.) but where firing a fire suppressant capsule directly into the ceiling is not possible. The second half of the capsule falls away and discharges the ventral portion (122) of its fire suppressant load (13). See, also, embodiment FIG. 69.

In a continuation of the previous embodiment, FIG. 74 is an illustration is an illustration of FIG. 73 after a dorsal rotation, for positioning to vertically discharge (152) the second half of its fire suppressant load (13), whereas FIG. 75 is a schematic of independent upward/downward vertical discharge pattern of FIG. 73.

In an embodiment FIG. 76 is a vertical descending/vertical dispersal (153), horizontal-bifurcated fire suppressant capsule (148) containing multiple chafe-charges (143), along with centrally located global positioning system and gyroscopic sensor microprocessor (86) and microprocessor controlled altimeter (87).

In another embodiment, FIG. 77 a vertical descending/horizontal dispersal, vertical bifurcated (155) fire suppressant capsule (156) containing multiple chafe-charges (143), along with centrally located global positioning system and gyroscopic sensor microprocessor (86) and microprocessor controlled altimeter (87) is illustrated.

In still another embodiment FIG. 78 is the vertical descending/horizontal dispersal patterns (154), of the vertical-bifurcated (155) version of FIG. 76's fire suppressant capsule (1). Sub-figure-a shows an upward/downward vertical dispersal, followed by Sub-figure-b with an upward vertical dispersal pattern, and Sub-figure-c with a downward vertical dispersal pattern. Sub-figure-d illustrates an upward vertical dispersal pattern along with two horizontal

In other embodiments (See FIGS. 79 and 80) the independent horizontal dispersal pattern of FIG. 77 is illustrated.

In a further embodiment FIG. 81 a single thin-walled fire suppressant capsule (1) is shown containing multiple, fixed chafe-charges (143), an adjustable stabilizing flange/wing (98), a global positioning system and gyroscopic sensor microprocessor (86), and an microprocessor controlled altimeter (87). The adjustable stabilizing flange/wing (98) controls the path, angle and positioning of the capsule to maximize the chafe-charge flow of the fire suppressant (13). The adjustable stabilizing flange/wing (98) can be applied to other fire suppressant capsules cited throughout this section.

The chafe-charge is further applied at FIG. 39, which is a lateral view of the Single-stage pop-up fire suppressant capsule (44), a Single-stage non pop-up fire suppressant capsule (83) or a ground-based discharge (139) capsule attached to a single strip structure (231). Each capsule (44/83/139) is attached consecutively. As at FIG. 38, this capsule can be used as a pop-up (44). As a Single-stage non pop-up fire suppressant capsule (83) or a ground-based discharge (139) capsule, when the weighted tag end will trigger discharge and release of its fire suppressant contents (13) at ground level. As a Single-stage pop-up Capsule (44) the propellant core (22) is flush with the base of the capsule (69). FIG. 24 illustrates a thin-walled fire suppressant capsule (1) containing a central propellant core (8), where the base of the core is flush (43) with the capsule's base (26). FIG. 26 is a partial cross-section view of a protruding soft-spot propellant core (22), of a Single-stage pop-up fire suppressant capsule (44).

The Single-stage pop-up fire suppressant capsule's posterior section (69) is heavier than the anterior (70) portion, so that the fire suppressant (pop-up) capsule (44) will always rotate into position (or, self rights) upon the strip structure (231) with its anterior (70) section pointing upward (71). As a ground-based discharge capsule (139), the propellant core (22) is replaced by a chafe-charge (143) that is attached by a retaining line (210) and a corresponding attachment pin (211) that is extended from the capsule (83/139), through the independent pivot (68), to the triggering mechanism (213) within the capsule. When the strip structure is taut, the retaining line (210) either pulls against or pulls free of the chafe-charges triggering mechanism (213), resulting in forcible ejection of the capsule's fire suppressant load 13). FIG. 40 provides a second horizontal view of FIG. 36 illustrating one capsule (44) of the multiple fire suppressant (pop-up) capsules (44) attached to a double stranded strip structure (231). As at FIG. 37, each fire suppressant (pop-up) capsule (44) is independently attached to the strip structure (231) by connecting pivots (68). This design can incorporate the same features discussed at FIG. 39.

As used herein, the time safety feature of a temperature range activated shell, an impact activated shell, altitude activated shell, height activated shell shall mean, a means, mechanism or device that will cause the release of the contents contained by an encasement, encapsulation, capsule, containment device, where a device's activatable means responsive to heat, temperature, impact, altitude, height, pressure, or in combination thereof fails to respond or does not respond accordingly when activated. In an embodiment, (See FIG. 5), when the shell's activatable means has not resulted in expulsion of the shell's contents, time or a delayed timing means, mechanism, device, method, methodology will serve as a secondary activatable means, thereby releasing the contents to the environment.

As used herein, an internal pressure activatable means shall means, an encasement, encapsulation, capsule, containment device, device that will respond the differences between the internal pressure exerted by the contents upon the shell of the device and the pressure of the external environment, where the difference in pressure between the internal and external environment is significant enough so that the internal pressure will cause the shell to disintegrate, thereby expelling its contents to the environment.

As used herein, the phrase internal pressure of the pressure sensitive center nodules incorporated with the wall of the device activatable means shall mean, an encasement, encapsulation, capsule, containment device, device that is constructed in such a manner that hollow bodies are incorporated into the wall of the shell. When the air pressure within the hollow bodies reaches or exceeds the breaking point of its surface area, the surface area will rupture, explode, disintegrate, or in similar manner erupt. This is in direct response to the internal pressure exerted by the hollow body upon its surface area. This shall further mean that the pressure exerted by the hollow body that will cause it to disintegrate shall be created by an increase of air pressure within the hollow body upon its surface area, relative to the corresponding decrease in air pressure as the shell ascends. This shall still further mean that upon disintegration of the hollow body, the latter will puncture the wall of the device, creating an opening between the internal and the external environment of the device, resulting in the release of the device's contents to the external environment. By using this method of content expulsion, as an alternative to shattering the shell in its entirety, the contents are forced outward at greater speed and distance.

As used herein, an internal pressure activatable means shall mean, an encasement, encapsulation, capsule, containment device, device that is constructed in such a manner that when the internal pressure of the device exceeds the strength of the shell's wall(s), the shell will rupture, expelling its contents to the environment. When the discharge means is activated the pressure exerted by the shell's contents will cause the wall(s) to rupture, explode, disintegrate, or in similar manner erupt in response to the internal pressure exerted by the contents upon the shell's surface area. This shall further mean that the pressure exerted by the contents of the shell that will cause it to disintegrate shall be created by an increase of content pressure upon the wall(s) of the shell, relative to the corresponding decrease in ambient air pressure, as the device ascends.

As used herein, the phrase negative pressure of the negative pressure sensitive center nodules incorporated with the wall of the device activatable means shall mean, an encasement, encapsulation, capsule, containment device, device that is constructed in such a manner that vacuum or negative air pressure hollow bodies are incorporated into the wall of the shell. When the negative air pressure within the hollow bodies increases or exceeds the breaking point of its surface area so as to create an implosion, the surface area will rupture, explode, disintegrate, or in similar manner erupt. This is in direct response to the negative air pressure within the hollow body upon its surface area. This shall further mean that the ambient air pressure exerted by the external environment upon the hollow body will cause it to disintegrate shall be created by an increase of ambient air pressure and a decrease in air pressure as the shell descends. This shall still further mean that upon disintegration of the hollow body it will collapse or implode, creating a hole, channel, groove, fissure, or opening, that will extend from the exterior of the device's wall(s) to its interior section containing its fire suppressant material. This opening between the internal and the external environment of the device will result in the release of the device's contents to the external environment.

In an embodiment FIG. 15 is a partial cross-sectional view of a thin walled fire suppressant capsule (1), illustrating low (vacuum) (28-L) or high-pressure nodules (28-H) is provided. Here, an increase or decrease in the nodules pressure influenced by a change in altitude on delivery results in the creation of a fissure or channel (30) between the exterior (31) and interior (32) of the thin-walled capsule (1), causing the capsule's wall to destabilize and release its fire suppressant load (13). If this is the sole method employed to disintegrate the capsule's (1) wall(s) it is a pressure-sensitive fire suppressant capsule (124).

The vacuum or negative pressure nodule (28-L) is designed so that when the external or environmental pressure is great enough to collapse the nodule during its decent, the greater pressure results in an implosion of the nodule, which in turn causes that region of the capsule (1) to disintegrate and release its contents (13). The design of the pressure-sensitive fire suppressant capsule (124) relies upon creating sufficient differences between the nodules' pressure and the external environment.

A second method to creating a pressure-sensitive fire suppressant capsule (124) is to load the fire suppressant (13) under high (14) or negative (vacuum) pressure.

In another embodiment FIG. 16 is a partial cross-sectional view of FIG. 15, where several low (vacuum) or high pressure nodules (28-L/H) have been breached or ruptured (29), forming a channel (30) between the exterior (31) and interior (32) of the thin-walled capsule (1), which will result in the releasing of its fire suppressant load to the fire environment.

In still another embodiment FIG. 17 is a partial cross-sectional view of FIGS. 15 and 16, where two of the low (vacuum) (28-L) that have been breached (29) and formed a channel (30) between the exterior (31) and interior (32) of the thin-walled capsule (1), forcibly ejecting its fire suppressant load (13).

In a further embodiment FIG. 18 is a partial cross-sectional view of FIGS. 10 and 11, where one-of-two low (vacuum) pressure nodules (28-L) that have breached the exterior (31) and interior (32) walls of the fire suppressant capsule (1) and formed a channel (30), forcibly emits a greater plume (36) of fire suppressant material (13) through the single opening (32). By designing a capsule (1) where the first nodule (28) that is breached (29) and forms a channel that prevents or retards the ability of the remaining nodules (28) to breach the interior (32) and exterior (31) walls of the capsule (1) the fire suppressant (13) plume (36) is ejected further, by virtue of the internal pressure exerted upon the fire suppressant (13) and the limitation of one small opening through which the fire suppressant passes (27).

As used herein, a negative pressure activatable means shall mean, an encasement, encapsulation, capsule, containment device, device that is constructed in such a manner that when the external pressure of the exerted upon the surface of the shell exceeds the strength of the shell's wall(s), the shell will rupture, implode, disintegrate, shatter, erupt or in similar manner destabilize, expelling its contents to the environment. This shall further mean that the contents of the shell or the internal or interior environment of the shell is vacuum packed so that air pressure within the shell will be less than the ambient air pressure at X feet at or above sea level. This shall further mean that when the discharge means is activated the pressure exerted upon the shell's surface causes the wall(s) to rupture, explode, disintegrate, or in similar manner erupt, the implosive force of air rushing in will expel the contents of the shell outward with an explosive like force. This shall still further mean that the pressure exerted by the contents of the shell that will cause it to disintegrate shall be created by an increase of pressure exerted externally, a decrease in internal or interior air pressure, as the device descends.

As used herein, a chemical activatable means shall mean, an encasement, encapsulation, capsule, containment device, device with an activatable means that will respond to the interaction of two of more chemicals, chemical substances, chemical substrates, chemical compositions, chemical materials, chemical compounds, chemical derivatives or similar definitions, which in turn when activated will cause a controlled micro explosion, microburst, micro implosion, that will result in the forcible expulsion, expelling of, emptying of, projection of, propelling of, removal of or similar action toward the release of its contents to the environment or initiate disintegration of its shell for subsequent release of its contents.

As used herein, an electrical activatable means shall mean, an encasement, encapsulation, capsule, containment device, device with an activatable means that will transmit an electrical signal, charge, impulse, stimuli, pulse to initiate, cause, promote, signal, result in the forcible expulsion, expelling of, emptying of, projection of, propelling of, removal of or similar action toward the release of its contents to the environment or initiate disintegration, disruption, destabilization, shattering, structural compromise of its shell for subsequent release of its contents.

As used herein, an electronic activatable means shall mean, an encasement, encapsulation, capsule, containment device, device with an activatable means comprising a microprocessor, microprocessor device, microchip, nanotechnology device, nanochip, nanoprocessor, nano device, computer, computer program, software, electronic program or similar technology will transmit an electronic signal to a receiving means within the device, to initiate, cause, promote, signal, result in the forcible expulsion, expelling of, emptying of, projection of, propelling of, removal of or similar action toward the release of its contents to the environment or initiate disintegration, disruption, destabilization, shattering, structural compromise of its shell for subsequent release of its contents.

As used herein, an incendiary activatable means shall mean, an encasement, encapsulation, capsule, containment device, device with an activatable means that is combustible, flammable, inflammable, which in turn when activated will cause a controlled micro explosion, microburst, micro implosion, that will result in the forcible expulsion, expelling of, emptying of, projection of, propelling of, removal of or similar action toward the release of its contents to the environment or initiate disintegration, disruption, destabilization, shattering, structural compromise of its shell for subsequent release of its contents.

As used herein, a non-incendiary activatable means shall mean, an encasement, encapsulation, capsule, containment device, device with an activatable means that when activated will cause a controlled micro explosion, microburst, micro implosion, that will result in the forcible expulsion, expelling of, emptying of, projection of, propelling of, removal of or similar action toward the release of its contents to the environment or initiate disintegration, disruption, destabilization, shattering, structural compromise of its shell for subsequent release of its contents.

As used herein, a flammable propellant shall mean, a shell, encasement, encapsulation, capsule, containment device, device, that in addition to its fire suppressant material contains a flammable substance, chemical, compound, fuel, energy source of propulsion, or something of similar nature that when activated will ignite, explode, implode, set into motion, convert to power, convert to usable energy, convert to expendable energy, combust the propellant so as to provide lift, movement, propulsion of the shell.

As used herein, an inflammable propellant shall mean, a shell, encasement, encapsulation, capsule, containment device, device, that in addition to its fire suppressant material contains an inflammable substance, chemical, compound, fuel, energy source of propulsion, or something of similar nature that when activated will set into motion, convert to power, convert to usable energy, convert to expendable energy, combust the propellant so as to provide lift, movement, propulsion of the shell.

As used herein, a second activatable means shall mean a method, means, methodology, mechanism, procedure, mechanical provision, electronic provision, conveyance, technique, process, way, microtechnology, nanotechnology controlled, initiated, aided or assisted, that in some way, shape or manner when activated, turned on, charged, charged with, programmed to, manually set to, manually programmed to, mechanically set to, mechanically programmed to activate the propellant.

In an embodiment FIG. 9 is a two dimensional view of FIG. 1 with a protruding posterior soft spot (22) containing a propellant (23) and two dispersal ports (24). When the soft spot (22) is ruptured, it will propel the fire suppressant capsule (1) by forcing the propellant (23) through a restricted aperture (27), while at the same time discharging the fire suppressant (13). When the fire suppressant capsule (1) reaches the pre-set or desired altitude, time, ambient temperature, temperature range, etc., the ports (24) rupture, forcibly ejecting the remainder of its fire suppressant load (13). The actual number of ports employed will be determined by design. Here, for illustrative purposes only, the number of ports displayed is not determinative of the actual design.

In another embodiment FIG. 10, the fire suppressant contents (13) are ejected through a thin-walled port (24) and the soft-spot region (22) during the shell's ascent. Here, fire suppressant materials (13) that are contained under high pressure (14), lifts the capsule (1) while also spreading fire suppressants (13) over the intended fire zone (100-111). FIG. 11 illustrates a fire suppressant capsule (1) with intact multiple thin-walled ports (24), and a separate propellant containment area (25) at the base of the capsule (26).

FIG. 11 illustrates a fire suppressant capsule (1) with intact multiple thin-walled ports (24), and a separate propellant containment area (25) at the base of the capsule (26).

FIG. 12 illustrates FIG. 11 where all four thin-wall ports (24) have been breached, by design, forcibly expelling its fire suppressant load (13) as the capsule continues its lift (120), powered by a separate propellant containment area (25) at the base of the capsule (26).

FIG. 13 illustrates a view of FIGS. 11 and 12, where the propellant core (23) occupies a central core region (10) of the capsule (1) providing greater lift. The core itself may contain fire suppressant contained under very high pressure (14) or vacuum pressure.

FIG. 14 illustrates FIGS. 11 and 12. Where, the fire suppressant capsule (1) is projected into a fire zone, self-rights (112), and the soft spot is superheated to 550° F. by the fire (119). The superheated/core gas or propellant (23) contained in the soft spot (22), along with the suppressant (119), propels the capsule upward (120), creating a greater vertical fire suppressant plume (35) as the capsule ascends (120). At e.g., 200′, the port (24) breaks; the suppressant discharges (13), creating an obtuse horizontal plume (34) and greater lift of the capsule (120). The capsule (1) remains intact while the vertical plume (121) increases. The capsule continues to ascend (120), powered by its suppressant (13) and/or the superheated core gas propellant (23) until it has completely expelled its contents (13).

FIG. 15 is a partial cross-sectional view of a thin walled fire suppressant capsule (1), illustrating low (vacuum) (28-L) or high-pressure nodules (28-H) . Here, an increase or decrease in the nodules pressure influenced by a change in altitude on delivery results in the creation of a fissure or channel (30) between the exterior (31) and interior (32) of the thin-walled capsule (1), causing the capsule's wall to destabilize and release its fire suppressant load (13). If this is the sole method employed to disintegrate the capsule's (1) wall(s) it is a pressure-sensitive fire suppressant capsule (124).

As used in this invention, a guiding means shall mean, the use of, application, incorporation, function of a system, method, application or similar means, that may include use of a global positioning system, gyroscopic control means, altimeter, stabilizing fins, or similar instrumentation, electronic means or devices that can be made a part of or incorporated into an encasement, that can be programmed by use of a microprocessor, nanotechnology, computer program, software, circuitry, interface, wireless interface, or similar means to set the range, target, target area, distance, altitude, height, depth, trajectory, trajectory pattern, path, pathway, for the device, to assist, guide, direct, steer, manage, orient an encasement, by providing a link between the systems, means, devices to receive, send and share information and to respond according to programming, for the purpose of guiding the encasement from Point A to Point C, while traveling through Point B, and discharge its contents to a specific or general target area.

As used in this invention it shall further mean that when linked to a microprocessor, nanotechnology, software or similar means, working in conjunction with the global positioning system, micro-impulse radar scan data, a three-dimensional structural and fire topography programming data, altimeter and others means, the adjustable stabilizing fins can perform corrective orientation of the encasement.

This shall also mean the use of ports, gas emitting ports, channels, openings, means, methods or similar descriptions that will allow for controlled release of gas from the propellant core and/or the fire extinguishment containment area to the exterior surface of the encasement, other than what is released through the propellant's release aperture, for the purpose of assisting in navigation of the encasement or the release of an extinguishment to the environment.

As used herein, electronic discharge is to control the time, place, and where appropriate the direction and amount of contents to be released from an encasement.

As used herein, electronic discharge of an encasement shall mean the use of microtechnology, nanotechnology, wireless technology, software or similar means, linked to a guiding means to receive and exchange information so as to deliver and discharge its contents to a specific or general target area, that when linked to a discharge mechanism and activated will cause its contents to be discharged, ejected, expelled from, expulsed, released, or similarly projected to the environment.

This shall further mean that electronic discharge may be linked to a guiding means to receive and exchange information shell can deliver and discharge its contents to a specific or general target area.

As used herein, a second discharge means shall be a method, mechanism, device, means or similar means, other than a launcher or launcher means that will project, propel, eject, or similarly disgorge an encasement from a fixture, attachment, containment means, to the environment.

In addition to or apart from the manual, static, hardwired programming methods, or mechanical means, to set the discharge mechanism of a shell, as discussed above, the purpose of electronic discharge is to control the time, place, and where appropriate the direction and amount of contents to be released from a shell.

In an embodiment FIG. 62 is a double thin-walled fire suppressant capsule (113) with microchips (114) embedded in the interior (115) and exterior walls (116), to effect electronic discharge of the fire suppressant load (13). The fire suppressant capsule can be a Single-stage pop-up (44), Two-stage pop-up (45), heat/temperature sensitive (47), pressure sensitive (123, 124), ground discharge (125), altitude/height controlled (126), or concentric configuration (51, 54), etc.

When triggered, the microchip itself will send an electric charge through the fire suppressant capsule's shell (1), causing the latter to destabilize and discharge its fire suppressant load (13). Where coupled with a microprocessor (123, 86, 87), the capsule may be pre-programmed to discharge at a given height/altitude/ temperature, distance, time, etc.

As an alternative design single and double thin-walled fire suppressant capsules can be designed as a hybrid, single/double thin-walled or multi thin-walled fire suppressant capsule.

In another embodiment FIG. 63 is a schematic representation of FIG. 62, a thin-walled fire suppressant capsule (1) containing a deep central propellant core (10) with a protruding soft spot (22). Microchips (114) have been placed at the capsule's wall (130), the interior wall (131) of the deep central propellant core (10), and within the capsule's interior wall (132). As at FIG. 62, this can be coupled with a microprocessor, and may be designed as a double thin-walled fire suppressant capsule.

In still another embodiment FIG. 64 is a schematic representation of heat/temperature specific discharging fire suppressant capsule (47), as at FIG. 62, demonstrating multiple physical leads (133, 134, 135) emanating from the microchip or microprocessor (128) to the capsule (47). Here, a double thin-walled fire suppressant capsule (113) is used as an illustration, with the physical leads (133, 134, 135) extending through the interior portion of the wall (132). Do note that a (single) thin-walled construction can be applied as well.

When the capsule (1) enters the targeted area, the microchip or microprocessor (128) will discharge an electric current through the leads (133, 134, 135) when the capsule is at its specific height/altitude, temperature zone, distance, etc. This will in turn result in disintegration of the capsule (47) and projection of its fire suppressant load (13). In this diagram the fire suppressant capsule (47) has a protruding propellant soft spot (21) at the capsule's base (26): the propellant core and its position within the capsule can be constructed in any manner described above.

In a continued embodiment FIG. 65 is a second schematic representation of FIGS. 62, 63 and FIG. 64. Instead of using multiple physical leads, as at FIG. 64, one (136) or two leads (137) emanate from the microchip or microprocessor (128), to a central chemical strip (138). When the chemical strip (13) receives an electrical charge from the microchip (114) or microprocessor (128), it creates a micro explosion that shatters the capsule and forcibly projects the fire suppressant load (13). The composition of the central chemical strip (138) should be a substance that will not ignite or cause an explosion when subject to heat or flames.

In yet another embodiment FIG. 66 as at FIGS. 62, 63 and 64, FIG. 66 is a microprocessor (128) controlled fire suppressant capsule (1) designed for expulsion of its load (13) at a designated height/altitude, temperature, time, etc. Instead of utilizing physical contact leads attached to the microprocessor (128), the latter emits an electronic signal that controls disintegration of the capsule.

Given the fact that no one fire fighting method is suitable to every fire situation, no one shell or discharge method is intended to fit every conceivable fire situation either. In an embodiment (see) where the intended target area within a building is set e.g., two hundred feet into the structure and immediate access by fire fighters may be limited to the front, a shell can be programmed to discharge its contents to the fire environment at a specific (or general range according to) time, temperature, distance, height, altitude or other requisite conditions. This will permit fire fighters to combat a wide range of area within the fire environment at the same time, as opposed to the limitation of concentrating efforts at one place, at one time, in the hope of reaching deeper into the structure afterwards.

As used in this invention, the phrase the latter emits an electronic signal that controls disintegration of the capsule shall mean, that the nanoprocessor, microprocessor, microprocessor device, microchip contained within the device, capsule, containment means, canister, encasement, shell or similar device that has been programmed to initiate or effect discharge or release of contents within the device, will transmit an electronic signal to a receiving means within the device, that in turn will activate the disintegration means of the device.

In another embodiment where the intensity of heat generated by the fire differs from one area to another, the discharge means can be set to release the fire suppressant load at varying points, even where it may not be possible for its user to predetermine the different temperature zones, positions, and areas. As such, an array of shells or an array of shells with different discharge modes can be delivered into a situation simultaneously or in close succession. Similarly, when combating an environmental fire situation, particularly where a fire is not limited to a small, ground level, manageable area, the ability to discharge an array of shells at varying heights, distances or positions within the fire situation itself is advantageous.

In an embodiment FIG. 67 is a schematic representation of a mixed array of multiple independent ground-based discharging capsules (223/140), and high and mid-altitude pop-up fire suppressant capsules (140) deployed for simultaneous controlled discharge of the fire suppressant.

In another embodiment FIG. 68 is a schematic representation of FIGS. 66 and 67 illustrating the release pattern of multiple independent ground-based discharging capsules (139), and high and mid-altitude pop-up fire suppressant capsules (223/140) deployed for (simultaneous) controlled discharge of the fire suppressant.

As used herein, electronic programming shall mean but is not limited to, the use or application of microtechnology, nanotechnology, a device, program, software, circuitry, wireless system, electronic program, transceiver or similar technology, that will permit an electronic signal to be transmitted to and received by the encasement's programming means or module, so as to program the discharge, navigation, guidance, propulsion, targeting, security, sensor, transceiver, electronic beacon, search functions or other systems of the encasement.

As used herein, the phrase surface electronic contact, surface electronic contact interface, embedded electronic contact, embedded electronic contact interface, submerged electronic contact, submerged electronic contact interface shall mean, a platform, means, structure, mechanism, physical contact, contact area, physical contact point, physical contact area, electronic contact point, electronic contact area, or similarly structure that can be placed on, placed within, placed in, made a part of, incorporated within, embedded within a shell, canister, device that will permit the electronic programming means to send and/or receive a programming signal and data to, from a shell, encasement, fixture, device, containment device, containment system, for the purpose of effecting electronic programming therein.

In an embodiment FIG. 94 is a lateral and partially exploded view of the Personal Carrier's Launcher (161), with an exploded view of the Launcher's capsule programming module (174). Each capsule (1), whether it is a non-programmed capsule, pre-programmed capsule, or a capsule programmed after being loaded into the launcher from the Personal Carrier or drop loaded (224) into the launcher (161), each can be programmed or reprogrammed once loaded into the launcher. The launcher's interior section (175) is lined with redundant electronic contact strips (176, see, FIG. 95), through which the programming signal is relayed to the microprocessor (86, 87) embedded in each capsule (1). Here, the transfer of the programming signal is physically performed between the electronic contact strips of the Launcher and the corresponding electronic contact strips of a fire suppressant capsule (1). However, where the re/programming signal is transmitted from the programming module of the Launcher to a receiver (467), transceiver (467) within the capsule (1) or other means of receiving a signal, then the electronic contact strips may not be necessary. From an operational viewpoint, a capsule can be designed with a combined electronic contact strip features and a receiver (467), transceiver (467) within the capsule (1) or other means of receiving a signal for programming, reprogramming, deprogramming purposes.

In another embodiment FIGS. 94-A AND 94-B are a lateral view of a generic fire suppressant capsule for use in the operation of the Personal Carrier's Launcher (161) (see, FIG. 94), where surface or subsurface electronic contact strips (176) are constructed as part of the capsule (1). The fire suppressant capsule's electronic contact strips correspond with the electronic contact strips of the Launcher for the purpose of electronically re/programming a capsule contained within its barrel: where programming of capsules is effected through the use of both sources, i.e., electronic contact strips and electronic transmission to a capsule embedded receiver, for subsequent deployment of the capsule by the Launcher. Here, the capsule is shown with multiple electronic contact strips. The actual number and placement of electronic contact strips within a capsule, including surface, subsurface mounted, or in combination thereof, will be determined by design parameters.

In still another embodiment FIG. 95 is a cross-sectional view from FIG. 94, showing the interior of the Launcher's barrel (175) and its redundant electronic contact points (176) used to program each fire suppressant capsule (1). The redundant electronic contact points (176) are intended to insure proper programming of each fire suppressant capsule (1) loaded into the Launcher (161).

As used herein, self-righting of an encasement shall mean, method, action, mechanism or similar means that will cause an encasement to roll, rotate, pitch, pivot, angle, redirect, stand or similarly change or correct its position after coming to rest on a surface, so as to achieve its intended or near intended position, angle, or orientation for secondary projection, discharge, or in combination thereof: to promote effective usage where the angle, height, time, orientation of discharge is significant for fire extinguishment; where operators cannot physically reach or enter to determine whether the encasement has achieved its intended position, angle, or orientation for effective discharge.

As used in this invention, a self-righting means may be linked to a gyroscopic sensor and control, a global positioning system, or other means to orient the encasement prior to discharge of its fire extinguishment, thereby reducing fire combat associated risk, loss of time, and the threat of more fire damage.

Although ground discharge of a shell can be effected where its contents are dispersed laterally, directly at ground or floor level, there may be instances where discharging the shell above or just above ground level, to allow the fire suppressant material to spread and settle over the fire and burning surface, may be advantageous. In an embodiment using a system to combat a grass or forest fire where the intended area of shell deployment is at ground level, where the device is projected from its containment system but lands on its side or in an upside down position, or twisted where a number of shells are face down or on their side, the shells self-right to their correct or intended position prior to activation of the propellant that will lift the shell above ground level.

In another embodiment FIG. 21a, when the shell comes to rest on a surface, the shell is on its side, which is the unintended angle or position for operation. The purpose of this particular shell includes the ability to be projected upward, so as to release its contents at a given point or time above ground or floor. Here, the shell self-rights to orient itself in a vertical or vertical firing position.

By providing a self-righting means, which may also be linked to a global positioning system, fire fighters will not be required to manually orient the shells prior to use or discharge, thereby reducing their risk, loss of time, and the threat of more damage.

A shell that comes to rest upside down on a surface, subsequently failing to discharge its contents because of the an inability to achieve a better angle or initiate the next sequence of events because of same, or subsequently discharges its contents at ground or floor level, may have little to no favorable impact upon a fire where the intended discharge position is, e.g., ten or fifteen feet above ground.

In an embodiment FIG. 19 a lateral view is provided of a Two-stage pop-up thin-walled fire suppressant capsule (37) that can be thrown, projected or dropped into a fire zone. Stage-two (38) contains a protruding soft spot core (22) that, when the capsule self-rights the soft-spot will rupture, resulting in vertical lift of the fire suppressant capsule.

In another embodiment FIG. 20 is a lateral view of a Two-stage pop-up thin-walled fire suppressant capsule (37) where the wall of Stage-one (40) has disintegrated (41) and discharged its fire suppressant load (13).

In still another embodiment FIG. 21 is an illustration of a Two-stage pop-up thin-walled fire suppressant capsule (37) landing within a structural fire zone (100), where Stage-one (40) disintegrates (41), discharges its fire suppressant load (13). At FIG. 21a, Stage-two (38) self rights (FIG. 21a points [b], [c], [d], and [e]), putting pressure on the soft spot (22), causing it to rupture (39), sending the capsules Stage-two component (the pop-up) (40) upward, discharging its fire suppressant load (13) along the way (41) or disintegrating at a pre-determined height/altitude (42).

In a continued embodiment (See FIG. 22), a Two-stage pop-up thin-walled fire suppressant capsule (37) is projected or (aerial) dropped into a forest fire zone (101). Stage-one (40) and Stage-two (38) are intact at (a), and remain intact as the capsule (37) continues its descent (b). Whether Stage-one (40) is designed to disintegrate at a specific temperature or temperature range (47), time activated (49), altitude/height activated (50) or in any combination thereof, it disintegrates and ejects its fire suppressant load (13) before hitting the ground (c-1). Stage-one (40) remains intact and continues its descent (c-2) & (d). When Stage-one (40) comes to rest on the ground (e), it self-rights (f) the protruding (22) or flush mount (43) ruptures (g), vertically propelling Stage-one (40) to a set height (42), dispersing its fire suppressant load (13) along the way/beginning at a set height/or shatters and disperses at a pre-determined height/time. FIG. 23 illustrates a thin-walled fire suppressant capsule (1) containing an internal flush mount (43) soft-spot propellant core (22) at its base (26).

The system can be developed where Stage-one (40) is horizontally propelled (k) along the ground or at a low height. If the capsule (37) is developed with a smart chip (FIG. 82) and/or heat seeking (FIG. 82) technology, Stage-one (40) can be programmed to target structural, ground, canopy or tree-top level areas based upon heat detection.

Furthermore, self-righting should promote effective usage of fire suppression systems remotely deployed into a fire environment where the angle, height, time, orientation of discharge is significant for fire suppression, and where operators cannot physically reach or enter to determine whether it has achieved its intended position, angle, or orientation for effective discharge.

As used herein, the term concentric levels of fire suppressant material shall mean an encasement, encapsulation, capsule, containment, device, shell comprising at least one additional, independent encasement, encapsulation, capsule, containment device, device, within its interior or internal structure.

This shall further mean, an encasement, encapsulation, capsule, containment device, device, shell comprising at least one additional, successive, concentric, contiguous level or layers of an encasement, encapsulation, capsule, containment, device, where each successive level requires the activation of the predecessor level and expulsion of its fire suppressant material prior to the activation of the next successive level.

As further used herein, a primary capsule with multiple independent capsules shall mean a primary encasement, encapsulation, capsule, containment device, device, shell comprising at least three or more encasements, encapsulations, capsules, containment devices, devices, shells within its interior or internal structure, that when released from the primary shell each device will discharge its contents independent of the primary capsule and other shells so released.

As used herein, a primary capsule with multiple concentric levels shall mean an encasement, encapsulation, capsule, containment device, device, shell comprising at least three or more independent encasements, encapsulations, capsules, containment devices, devices, shells, where each successor level is contiguous to its predecessor and successor level, and where each successive level requires the activation of the predecessor level before its own activation.

In an embodiment FIG. 27 the shell or primary shell is used to house additional shells, encasements, capsules, encapsulations, containment devices, devices, all of which contain a fire suppressant material, including the primary shell. This system allows the delivery of a payload of smaller shells encased in one. Here, when the primary shell discharges its fire suppressant material and releases its enclosed shells, the primary shell's fire suppressant material spreads out, in a canopy, while the released shells will continue to descend, subsequently discharging their contents. Depending upon the distance between discharge of the primary shell and the secondary shells, and developing the secondary shell with the capacity to maintain a vertical descent of or close to 90 degrees, the contents released from both sources can form a fire suppressant material canopy that will settle over the release area.

In still another embodiment, FIG. 28 illustrates the descent and dispersal pattern of a primary concentric shell (51) and the secondary fire suppressant shells (52), at FIG. 27. The secondary shells (52) are released from the primary shell (51) when the wall of the latter ruptures (a) (9), forcibly ejecting its fire suppressant load (13). The secondary fire suppressant shells (52) continue their descent (b), discharging their fire suppressant load (13) point during descent (c) and/or upon impact and shattering (d). Here, the secondary shells have been programmed to discharge their contents at different heights, levels or altitude settings. FIG. 29 is a second diagram of FIG. 28, containing larger Secondary concentric fire suppressant capsules (52).

The secondary shells can be programmed to discharge in clusters, at an alternating rate, or simultaneously.

By using a mixed array of secondary fire suppressant shells the latter can spread a canopy or overlap of fire suppressants at different levels or heights within the fire column (e, f, g, h, i, j, k).

This method of delivery and discharge allows for wider coverage of an area, overlapping of the discharged contents, and the ability to cover a greater vertical area.

As used herein, a pop-up capsule, pop-up encasement shall mean a canister, shell, containment device, device, a single-stage, two-stage pop-up encasement or multi-stage pop-up encasement, that may or may not have any additional attaching encasements, that subsequent to being introduced to the fire environment and coming to rest on a surface, the shell will spring upward, become vertically propelled, or otherwise become elevated from the surface that it is resting upon, subsequently discharging its contents.

As used herein, a single-stage fire suppression device, shall mean a pop-up shell, capsule, canister, containment device, device, that does not have any additional attaching capsules, canisters, shells, device, that subsequent to being introduced to the fire environment, coming to rest on a surface, the device will spring upward, become vertically propelled, or otherwise become elevated from the surface that it is resting upon, subsequently discharging its contents.

As used herein, a two-stage pop-up encasement or multi-stage pop-up encasement shall mean, at least two encasements connected in such a manner that when the first encasement is activated it will release its contents, and release the second encasement. When the second encasement is released from the first encasement, comes to rest upon a surface, it will self-right, project upward, then release its contents to the environment upon ascent, descent or in combination, as programmed.

As used herein, self-righting of an encasement shall mean, method, action, mechanism or similar means that will cause an encasement to roll, rotate, pitch, pivot, angle, redirect, stand or similarly change or correct its position after coming to rest on a surface, so as to achieve its intended or near intended position, angle, or orientation for secondary projection, discharge, or in combination thereof: to promote effective usage where the angle, height, time, orientation of discharge is significant for fire extinguishment; where operators cannot physically reach or enter to determine whether the encasement has achieved its intended position, angle, or orientation for effective discharge.

As used in this invention, a self-righting means may be linked to a gyroscopic sensor and control, a global positioning system, or other means to orient the encasement prior to discharge of its fire extinguishment, thereby reducing fire combat associated risk, loss of time, and the threat of more fire damage.

As used herein, descent and dispersal pattern shall mean, the pattern of the contents expelled from a capsule, canister, shell, containment device, device, during the time in which said device, that has been dropped, released, thrown, projected, propelled or in similar manner is descending to the ground or floor, and the pattern the contents released from the device during that period of descent.

In a different embodiment FIG. 30), each secondary level of fire suppressant material is contiguous to its predecessor level. When the primary shell (54) shatters, releasing its fire suppressant content (13), it drops the remainder of the shell (55). This process repeats itself until the final concentric shell (58) shatters, discharging its fire suppressant load (13): analogous to peeling an onion to reach successive layers.

This embodiment differs from the design of FIG. 28, as the primary shell only release one concentric shell at a time (see, FIG. 31).

In another embodiment FIG. 27-A the primary shell houses additional shells (44, 83), encasements, capsules, encapsulations, containment devices, devices attached to its external surface. The primary shell (54) and secondary shells (44, 83) contain their own fire suppressant load (13).

The primary shell may be developed as a platform to support the attachment of additional shells on its surface (see FIG. 27-B). The primary shell is developed and programmed to discharge the secondary shells attached to its surface, or to release the secondary shells for subsequent discharge, prior to, or simultaneous to the primary shell discharging its own fire suppressant contents. Alternatively, developing the surface attached shells with an activatable propellant, the shells can be projected out from and away from the primary shell for subsequent discharge. This is analogous to a rocket comprising multiple, smaller, independent missiles that when released from the rocket are programmed to seek different targets or different points along the same target. Here, again, a greater area can be covered through the use of one device that serves as a delivery means for smaller devices (see, FIGS. 27-B).

In still another embodiment FIG. 27-C the primary shell houses its own fire suppressant material, with additional shells, encasements, capsules, encapsulations, containment devices, devices, internally and attached to its external surface. The release and discharge patterns discussed above are applicable here. As the shell descends, ascends, discharging a number of the shells attached to its surface, surface attaching pins (85), as well as the shells and fire suppressant material contained within, it its gyroscopic sensor and global positioning system (86) rotates the remaining portion of the primary shell (54) into position, for subsequent release and discharge of the secondary capsules (44, 83) attached to its surface.

In a further embodiment FIG. 32 the shell comprises several, contiguous levels of fire suppressant materials and a propellant occupying the shell's core region. This particular shell with a propellant means is classified as a pop-up shell, meaning that when the propellant is activated it will propel the shell upward. However, this shell can be modified so that the propellant, when activated, will propel the shell at a different angle other than vertically upwards (see, FIG. 22[k]). As well, by linking the secondary shells with a guiding means, the shells can be projected to different targets, areas, or upwards (as pop-ups) (see FIGS. 21a and 22).

FIG. 32 diagrams a primary concentric fire suppressant shell (1) that is a general cylindrical shaped concentric pop-up shell (59)—containing its own fire suppressant load (13) and multiple secondary cylindrical fire suppressant shells (60 through and including 64). The primary cylindrical concentric pop-up shell (59) contains a flush mount surface (43) with a centralized core propellant region (10).

As used herein, the soft-spot shall mean, the area at the base of a shell that separates the propellant from the external environment. Designed in a number of ways, i.e., flush mount to the surface of the shell or protruding outward from the base of the shell, its structural integrity should withstand the internal pressure exerted by its contents, incidental bumping, the pressure exerted with general transportation and storage, the force exerted when dropped from a two foot height to a solid structure, yet perhaps not as strong as the remaining area of the shell, and not strong enough to impede an effluent flow from that area when the propellant is activated. If flow is impeded when the propellant is activated, the shell could explode or otherwise prematurely discharge its contents, while failing to achieve vertical lift.

This capsule type can be designed as a non pop-up for projection and aerial drop deployment. As a non pop-up cylindrical primary concentric shell the deep central core propellant region (10) of FIG. 32 would be replaced with fire suppressant materials (13) and perform as the primary concentric shell (51), FIGS. 30 and 31.

Continuing from the former embodiment, FIG. 33 and FIG. 34 are intended to show the successive level of content dispersal as the shell performs a vertical climb or pop-up.

FIG. 33 illustrates the flow pattern issuing from FIG. 32 and the discharge pattern of each successive concentric fire suppressant shell while descending into and through a fire zone (11). Here, the primary concentric pop-up shell (59) is deployed, where disintegration of the shell (21) does not begin until the shell enters the fire zone, the propellant is spent, or at a designated point. When the fire propellant is spent and the capsule (58) begins its descent. Upon descent, the primary pop-up shell (59) ruptures, forcibly ejecting its contents (13), and releasing the pop-up's second fire suppressant shell (60). Here, Point-a illustrates the dispersal field of the pop-up's primary concentric shell (59) and the dispersal field of its fire suppressant loads (13). Point-b illustrates discharge of the pop-up's second fire shell (60) and the dispersal field of its fire suppressant load (13).

By increasing the contents of the second fire suppressant pop-up shell's (60) or packing same (13) under greater pressure, discharge of the second shell's contents should create greater content dispersal field (b) than that of its predecessor's—the primary cylindrical concentric pop-up shell (59).

FIG. 34 is a second schematic representation of the flow pattern issuing from FIG. 32 and discharge of each successive concentric fire suppressant capsule while ascending into and through a fire zone (11).

When the primary cylindrical concentric pop-up shell (59) ruptures (39) during ascent its contents create a plume (34) that forms a canopy. While the second fire suppressant pop-up shell's (60) continue a vertical lift path, the release of its contents (13) will form a canopy that overlaps the fire suppressant canopy of the previously discharged primary concentric pop-up shell (59).

Point-a illustrates a field array of primary concentric pop-up shells (59) fired simultaneously or in close sequence, where the contents (13) released form an overlapping canopy (b).

As used herein, a two-stage shell shall mean, two or more canisters, shells, containment devices, devices, capsule, shells connected in such a way that when the first shell is activated, the first shell will release its contents and the second shell. When the second shell is released from the first shell it will self-right, project, and release the contents upon ascent, descent, or in combination thereof.

In an embodiment (see FIGS. 21 and 21a), the shell will release its contents at two separate stages, milestones, occurrences, where the first stage of this two-stage component will perform its designated task first, subsequently triggering performance of the second stage component.

As used herein, a smart chip or heat seeking smart chip shall mean a means, mechanism, electronic provision, microprocessor controlled, microprocessor initiated, microprocessor aided or assisted, microchip controlled, microchip initiated, microchip aided or assisted, nanotechnology controlled, nanotechnology initiated, nanotechnology aided or assisted device that has the capacity to, when linked with a guiding means, seek out, search for, target a given temperature, temperature range, heat associated with a structural or environmental fire, fire source, fire, burning area, burning material or similar notation.

As used herein, a smart chip or heat seeking smart chip shall also mean a means that has the capability to determine the distance, size, height, depth, width, rate of approach to an obstruction within its pathway, and rate of approach to its target or target area.

As used herein, a smart chip or heat seeking smart chip shall further mean a means that has the capability to determine the position of obstructions in its pathway so as to avoid the obstruction, while continuing to search for and respond as programmed to its target or target area.

As used herein, the pathway, pathway of a shell with an activated smart chip or heat seeking smart chip shall further mean the trajectory, path, route, course, track or similar definition, that a shell shall take when activated to use the smart chip to ascertain, seek, search for its target.

As used herein, the prescribed pathway of a shell with a shell with an activated smart chip or heat seeking smart chip shall further mean a specified trajectory, trajectory path, path, route, course, track or similar definition, that a shell's guiding means has been programmed to follow, take, travel upon, travel within, to ascertain, seek, search for its target.

As used herein, an obstruction in the pathway of a shell with an activated smart chip or heat seeking smart chip shall further mean any encumbrance, material substance, blockage, structure or similar finding that exists between the shell and its target or target area, that can be mounted, surmounted, evade or otherwise circumnavigated but will not prevent the shell from accessing its target or target area if it can be circumnavigated, yet would otherwise hinder, block or prevent the shell from achieving its target if a straight line of sight course were maintained by the shell.

As used herein, a shell with a shell with an activated smart chip or heat seeking smart chip shall further mean a means that can perform collision avoidance with an unintended obstruction within the shell's a specified trajectory, trajectory path, path, route, course, track or similar definition, as programmed into a shell's guiding means.

As used in this invention, a target or target area shall mean, a fire zone, fire environment, fire, position of the fire, position within a fire or fire situation that has become, is or will be identified as the point, location, pathway, path or position that fire extinguishing action will directed to.

As used in this invention, a primary target shall mean a specific fire zone, specific fire environment, specific fire, specific position of the fire, specific position within a fire or specific fire situation that has become, is or will be identified as the point, location, pathway, path or position that fire suppression action will directed to.

As used herein, a smart chip or heat seeking smart chip shall also mean a means that has the computer programming, software programming, when receiving data when its heat seeking means is activated has the capacity to differentiate the heat generated within a fire environment from the heat of an individual that is, e.g., smoking a cigarette or similar instrument, the heat generated from an aircraft, vehicle or vessel operating proximate to, within, above, or near the fire environment.

As used herein, a smart chip or heat seeking smart chip shall also mean a means that has the computer programming, software programming, when receiving data when its heat seeking means is activated has the capacity to differentiate the temperature, temperature ranges generated within a fire environment, as a shell encounters within or proximate to its trajectory.

As used herein, a smart chip or heat seeking smart chip shall also mean but a means that can be programmed to receive, analyze, transmit data pertaining to its trajectory and the fire environment encountered within its pathway to a remote monitor, to other shells with a heat seeking smart chip that has been projected into the same fire environment.

As used herein, a high-speed disintegrating shell shall mean a shell, encasement, encapsulation, capsule, containment device, device with a guiding means and a heat seeking smart chip, concentric levels of activatable fire suppressant material, that can be programmed to target a heat source and programmed to discharge its contents at a specified point, area, in range of its target or target area, or on approach to same. The disintegrating aspect is the controlled discharge of its fire suppressant contents.

In an embodiment FIG. 82, a high-speed disintegrating fire suppressant shell (157), with a smart chip (158), guiding means (86), and an adjustable stabilizing flange/wing (98), where the smart chip acts as a low-grade heat seeker is programmed to seek out and target a fire's source. Its thermal detection range, here, is between 350° F. (the point at which paper and similar materials will burn) and e.g., 1,000° F.

The high-speed disintegrating fire suppressant shell (157) begins to disintegrate and propel part of its fire suppressant load (13) after achieving a specified distance within the fire zone or a minimum heat threshold (e.g., at or above 350° F.). As the high-speed disintegrating fire suppressant shell (157) continues toward its final target destination, it continues to project its fire suppressant load (13) along the shell's (157) trajectory.

The high-speed disintegrating fire suppressant shell (157) can be fitted with a visual and/or electronic marker for tagging its target area, and developed to identify pre-ignition (temperature) areas for simultaneous or subsequent targeting of a fire suppressant agent, fire retardant agent, or an endothermic agent.

Here, two different scenarios will be used for illustrative purposes: 1) a burning structure, such as a building or tunnel, with temperatures varying between 350° F. and 900° F., 80′ front to rear depth with no intervening areas for entry; and, 2) a forest fire:
1. A burning structure such as a building or tunnel with temperatures varying between 350° F. and 900° F., 80′ front to rear depth with no intervening areas for entry. The shell is programmed to completely release its fire suppressant load before reaching the 80′ demarcation:
   A. When the high-speed disintegrating fire suppressant shell (157) is fired into the building, the smart chip tracks and determines its trajectory and position at all times relative to the intended target area (temperature and/or depth of the building) and the physical structure that it is approaching. When the high-speed disintegrating fire suppressant shell (157) enters its targeted thermal range, e.g., 350° F. and 900° F., 50′ to 80′, the shell (157) will begin to release its load at 50′. The high-speed disintegrating fire suppressant shell (157) will continue to release its fire suppressant load (13) along its pathway, completely expending its load within one foot of the 80′ demarcation (See FIG. 84). This will be referred to as pathway targeting dispersal.
   B. The amount of fire suppressants (13) released along the targeting path will be determined and controlled by its microprocessor (33): in accord with the temperature encountered along its pathway, the amount of suppressant contained within the shell (157) and the shell's remaining distance to its target demarcation.
   C. Where propulsion of the high-speed disintegrating fire suppressant shell (157) relies solely upon its projection e.g., the high-speed hand-held shell launcher (161, see FIG. 92, et al.) and not a propellant core, disintegration of the shell (157) and projection of its fire suppressant load (13) can take place beginning at the rear of the shell (157), working forward, or laterally, moving inward to the core of the shell or in combination.
   D. Where its thermal target does not exist within a straightforward pathway but is detected elsewhere within the structure, the high-speed disintegrating fire suppressant shell (157) will correct its trajectory in search of its target zone, by the positioning GPS microprocessor (86) and altimeter microprocessor (87) controlling the adjustable stabilizing flange/wing (98).
   E. If it is projected at a structure, with the intent to hit the target, the shell remains intact on approach, disintegrating at a rapid speed and projecting the fire suppressant load forward (immediately) within less than one foot of the structure (for a concentrated dispersal pattern) or within e.g., four feet of the structure (for wider dispersal). This will be referred to as forward targeting.
2) A major forest fire:
   A. When projected above the fire, in search of the fire's source, the high-speed disintegrating fire suppressant shell (157) will target the base of the fire and burning materials. It can be programmed to seek out and target the hottest point within its thermal search range, and to disintegrate on approach (as above).
   B. As above, the high-speed disintegrating fire suppressant shell (157) deployed against a forest fire can be programmed for pathway targeting dispersal, forward targeting, or corrective trajectory targeting, and can be fired to or above the tree level, where targeting takes place upon its descent.

Where the intended path is partially obstructed the smart chip will determine the path of least resistance, correct its trajectory/path, while at all times targeting the source of the fire/flames.

Each high-speed disintegrating fire suppressant shell (157) can be programmed to release its fire suppressant load (13) over a short, intermediate or long distance pathway. While in flight, the high-speed disintegrating fire suppressant shell (157) projects to a portable monitor its path, and the temperature patterns along that path. From here, successive high-speed disintegrating fire suppressant shells (157) can be programmed to seek out specified (or general) patterns: e.g., a temperature-range between 400° F. and 460° F. at 37′ to 45′; 455° F. and 710° F. at 35′ to 65′; 650° F. and 710° F. at 35′ to 65′, etc. When multiple high-speed disintegrating fire suppressant shells (157) are projected simultaneously, each shell (157) tracks the trajectory of its companion shell (157), while searching for its thermal target. The intent here is to prevent successive shells from seeking the same thermal target, at the expense of allowing other areas within its thermal targeted pathway to burn. At the very least, two or more shells tracking the same thermal pattern will disintegrate several feet apart. This will be referred to as trajectory differentiation. An exception to trajectory differentiation is override the trajectory differentiation mechanism of the microprocessor, allowing shells to concentrate on a given target area.

The smart chip technology cited here can be applied to the shell types discussed above. The heat seeking mechanics of the smart chip (158) may also prove useful in situations where entry is hampered by intense heat and/or smoke, and the ability to determine the position of the fire or the source of its flames is not possible without the aid of thermal imaging. Blind firing into a structure, such as a building or tunnel, allows the high-speed disintegrating fire suppressant shell (157) to serve as the initial (electronic) eyes to knocking down the fire. When combined with Smoke/Airborne Particulate Matter Dissipating shells, safety and the ability to knock down a structural fire is significantly enhanced.

If a fire retardant shell (412) is deployed to a fire situation the smart chip (158) employed would target a thermal range between 275° F. to 325° F.

In another embodiment FIG. 83, as each successive fire suppressant material level (146, 147 and 198) of a high-speed shell disintegrates, it frees the next level of adjustable wings (159). See, also, FIG. 84, which illustrates the release pattern of a high-speed disintegrating fire suppressant shell (157) cited at FIGS. 82 and 83. Here, the shell (157) begins to disintegrate and propel part of its fire suppressant load after e.g., 12′ from the launcher FIGS. 87 (or, a laser determines distance to or within the fire zone, sets the initial point of disintegration). Where the high-speed disintegrating fire suppressant shell (157) is designed for, e.g., an 80′ disintegration path, reaches its 80′ point in e.g., 2-4 seconds, laying out a wide suppressant path (13) in its wake.

In still another embodiment FIG. 85, the shell (157) is projected into a fire zone (or, upward), but does not begin to disintegrate until it reaches a (pre-set) altitude of, e.g., 300′; whereas at FIG. 86, which illustrates the release pattern of a high-speed disintegrating fire suppressant shell (157) cited at FIG. 85, the shell (157) remains intact during its ascent then, disintegrates and projects its fire suppressant load (13) on descent (with a specified time of release, altitude/height).

In still another embodiment FIG. 87 which is an overhead view of the trajectory release pattern (293) for a high-speed disintegrating fire suppressant shell (157) projected into a building from an outside position, the targeted fire zone is a 1,200° C./F. wall of fire at the rear of the structure (319). The structure contains a barrier wall (291) that does not traverse the entire with of the structure, an obstruction (292) and a closed room (290). Viable access to the structure is limited to the front of the structure (318). A high-speed disintegrating fire suppressant shell (157) is projected into the structure (318). Its smart chip determines the presence of the barrier wall (291) and a viable pathway leading to the target area (312/319). Its trajectory (293) navigates the barrier (291), the closed room (290) and the obstruction (292) while encountering fire and temperatures of 600° C./F., 800° C./F., 900° C./F., and a 1,100° C./F. However, the high-speed disintegrating fire suppressant shell (157), programmed to target a temperature range of 1,200° C./F. at :50° C./F. (or 1,200° C./F. at e.g., 100′) does not discharge its fire suppressant load (313) until achieving its target (312/319). The trajectory of the high-speed disintegrating fire suppressant shell (157) is transmitted in real time to a control unit, which will permit programming of successive high-speed disintegrating fire suppressant shell (157) projected into the structure.

As above, if the high-speed disintegrating fire suppressant shell (157) lands short of its target, the time sensitive safety feature, as at FIG. 5, will discharge its fire suppressant load (13) to the fire environment. Alternatively, if the high-speed disintegrating fire suppressant shell (157) is unable to locate its target within the trajectory period, it will alternatively seek a lower temperature range (i.e., temperatures associated with fires) and discharge its fire suppressant load therein.

In a separate embodiment FIG. 88 is another view of the trajectory pathways of three successive high-speed disintegrating fire suppressant shells projected into a structure (318), subsequent to entry of a predecessor high-speed disintegrating fire suppressant shell (157). Here, each successive high-speed disintegrating fire suppressant shell (157) is programmed based upon the target and trajectory information of its predecessor high-speed disintegrating fire suppressant shell. Here, the target is the 1,200° C./F. (at 100′), where each shell striking the target does so at a different point. Here, two of the three shells projected into the structure (318) follow the same trajectory as in FIG. 87 (294, 295), with the third shell tacking a second pathway (296). Whereas these high-speed disintegrating fire suppressant shells (157) traverse the same barriers and obstructions as at FIG. 87: however, each high-speed disintegrating fire suppressant shell (157) actively tracts the signal of its companion high-speed disintegrating fire suppressant shell (157) to prevent targeting the same 1,200° C./F. (at 100′) demarcation: instead, each shell strikes at an equidistant point (314, 315 and 315) within the target area (312).

In another embodiment FIG. 89, there is a second illustration of FIG. 88, with the exception that each of the Smart Fire Extinguishment Encasements (157) is programmed to strike the same target (317) as its predecessor Smart Fire Extinguishment Encasement (157). FIG. 90 is a horizontal illustration of FIG. 87.

As used herein, an electronic marker for tagging purposes shall mean the means, method, methodology, way, ways, or similar manner in which a shell shall contain along with its contents or as part of the forward section of the shell 5 that does not shatter, an electronic chip or beacon. This electronic chip, beacon or similar means will actively relay to a remote monitor and/or other such devices programmed to receive, intercept, monitor that beacon signal, a distinct, identifying signal, electronic signal, electronic signature, that can be used to determine where in the fire zone the shell's point of impact or final position is, temperature, and for programming other devices that may be deployed to or proximate to the beacon.

As used herein, a visual marker for tagging purposes shall mean the means, method, methodology, way, ways, or similar manner in which a shell shall contain along with its contents a substance, compound, element or similar material, when exposed to intense heat, will provide a visual characteristic that can be observed electronically, visually, or through the application of imaging systems with the capacity to discern the marker from the fire's thermal patterns, that can be used to determine where in the fire zone the shell's point of impact or final position is, and for programming other devices that may be deployed to or proximate to that area.

In an embodiment FIG. 82, the high-speed disintegrating fire suppressant shell (157) is fitted with a visual marker, electronic marker, for tagging its target area. By developing a high-speed disintegrating fire suppressant shell (157) for the purpose of targeting pre-ignition (temperature) areas for simultaneous or subsequent targeting of a fire suppressant agent, fire retardant agent, or an endothermic agent, an electronic or visual marker will aid fire fighters to monitor such areas, and for the deployment of other shells to or proximate to that area.

As used herein, a two-part housing unit shall mean a means, shell, canister, device, containment device or similar means to form an external, exterior formed, outer casement, casing, shell, containment device, containment structure or similar means, that can be constructed in such a manner to hold, carry, transport, house a shell or similar device within.

This shall further mean, a means that is microprocessor controlled, microprocessor initiated, microprocessor aided or assisted, microchip controlled, microchip initiated, microchip aided or assisted, nanotechnology controlled, nanotechnology initiated, nanotechnology aided or assisted device that can be propelled or delivered by self propulsion, when linked with a guiding means has the capacity to approach, attach to, bore through or similarly penetrate a glass structure without causing that structure to shatter.

This shall still further mean, a means that upon bore through or similarly penetrating a glass structure, will secure itself to the surface of the glass structure in such a manner that its weight nor other factors will cause it to break, break through, or similarly compromise the integrity of the glass structure.

This shall also mean, a means that upon bore through or similarly penetrating a glass structure, will form a seal between the device and the glass structure so as to reduce or prevent the entry of air where the means has attached and penetrated the glass, so as to prevent a backdraft, a condition that is known to persons of ordinarily skill in the art of fire fighting.

As used herein, the second part of the two-part housing unit with an activatable means, shall mean the containment, housing, transport or similar result, where the housing contains at least one a shell, encapsulation, capsule, containment device, device, with its own activatable device, that when the housing units activatable means is activated it will release, discharge or similarly eject the device it contains to the fire environment.

In an embodiment FIG. 91, the Glass Penetrating Capsule is intended for areas where the only or most viable point of entry to combat a fire is through a window, particularly the upper floors of high rise structures where one's ability to reach to and access the area may be limited to a ground level approach. To address the concern that creating a substantial breach in a window will result in sufficient fresh air so as to create a back flash within the structure, the object here includes the ability to create as small an opening as possible for subsequent entry of the fire suppressant capsule, and a fire suppressant capsule that will travel faster than the intake of fresh air that would otherwise result in a back flash. A secondary consideration is to develop a carrier/breaching module that will travel fast enough to breach the type and thickness of glass associated with high-rise buildings, yet at the same time not cause the glass to shatter.

This is a two-part system where the outer capsule or Glass Penetrating Capsule (409) serves as the carrier module containing a fire suppressant capsule (1, 418) that will eventually enter the structure and target the fire. This system is one method of reaching the upper levels of a structure from or near a ground level position

The penetrating tip (413) located at the anterior of the Glass Penetrating Unit (409) also houses its own guiding system microprocessors (86, 87) used to guide the Glass Penetrating Unit to the target. After breaching the glass, the penetrating tip (413) falls away; at the same time, the impact of the Glass Penetrating Unit with the glass activates the firing mechanism (417) of the fire suppressant capsule (418) contained within, that has its own deep propellant core (10). The Glass Penetrating Unit has a primary propellant core (23) and a secondary propellant core (415). The purpose of the secondary propellant core (415) is to serve as a booster, to accelerate the speed of the Glass Penetrating Unit as it nears the target and to provide increased force for penetration of the glass. The Glass Penetrating Unit's microprocessor increases the secondary propellant core's output the closer the GPC is to the target.

The fire suppressant capsule (418) is Positioning GPS, altimeter and heat seeker microprocessor controlled. When ejected from the Glass Penetrating Unit into the structure, its microprocessor controls target the fire, as the Smart Fire Extinguishment Encasement (157) cited at FIGS. 82, 83, 84, 85, 86, 87, 88, 89 and 90, releasing its fire suppressant load (13) accordingly.

As used herein, a ground-based delivery structure shall mean a canister, cylinder, containment device, device, or similar structure that can contain a chord, ribbon, strip, strip structure that is single stranded, double stranded, helical-stranded, or in combination thereof, comprising multiple shells, encasements, encapsulations, capsules, containment devices, devices, a guiding means, an ejection means, a programmable means, so that when the structure is placed, delivered to or similarly found within a fire zone, it can eject its strip structures or shells outward, away from the structure, for discharge of the shells at or about ground level.

As used herein, a ground-based delivery structure shall also mean a means, method, methodology, strategy, mechanism or similar notation for arranging, aligning, effecting discharge of fire extinguishing shells, encasements, encapsulations, capsules, containment devices, devices at or about ground level.

As used herein, an aerial, ground-based delivery structure shall mean a canister, cylinder, containment device, device, or similar structure that can contain a chord, ribbon, strip, strip structure that is single stranded, double stranded, helical-stranded, or in combination thereof, comprising multiple shells, encasements, encapsulations, capsules, containment devices, devices, a guiding means, an ejection means, a programmable means, that can be dropped, aerially drop, aerially dropped, delivered or otherwise conveyed from an aircraft or other suitable platform or structure to the environment, that along with the guiding means and the guiding means' gyroscopic sensor that is linked to the ejection means will orient the structure before achieving its intended position, ground, so as to effect ejection of the strip structure, contents, at a predetermined point prior to impact of the structure with the ground, upon impact with the ground, or in suitable combination thereof, for subsequent discharge of the shells at or about ground level.

As used herein, an aerial, ground-based delivery structure shall also mean a chord, ribbon, strip, strip structure that is single stranded, double stranded, helical-stranded, or in combination thereof, comprising multiple shells, encasements, encapsulations, capsules, containment devices, devices, that can be dropped, aerially drop, aerially dropped, delivered or otherwise conveyed from an aircraft or other suitable platform or structure to the environment a guiding means, with an ejection means, an attachment securing the strip to an ejection means, an end piece that when the strip is ejected, will be ejected furthest from the ejection means, a segment of the end piece that is weighted, non-weighted, partially weighted, for the purpose of adding balance when the strip is ejected.

As used herein, an aerial, ground-based delivery structure shall still also mean a securing means within the strip, that will connect, hold multiple shells, encasements, encapsulations, capsules, containment devices, devices to the strip structure in a positive oriented position, an release means that when activated will release the attached devices from the strip structure for subsequent discharge, a device activation means to effect discharge of the devices while attached to the strip structure, detached from the strip structure, or in combination thereof.

As used herein, an aerial, ground-based delivery structure further mean when the device is linked to its guiding means, released to the environment by way of aerial drop, ejection, or similar manner, with the distal end serving as a ballast, balance, the device can deliver successively attached multiple fire suppression devices for discharge at ground level, in a vertical column, horizontal column, or in combination thereof.

As used herein, a strip structure shall mean, a chord, ribbon, strip, strip structure that is single stranded, double stranded, helical-stranded, or in combination thereof, with a connecting means to connect a shell, encasement, encapsulation, capsule, containment device, device in each cut out section of the strip structure so constructed to hold shells, an attachment for securing the strip to an ejection means, a weighted end segment, partially weighted end segment, for the purpose of adding balance when the strip is ejected, deployed, projected, thrown, released or in similar manner introduced to the fire environment, a shell release means, a shell activatable means.

As used herein, a single-stranded, flexible, strip structure shall mean a strip structure comprising one continuous piece of material.

In an embodiment FIG. 37 is a lateral view diagram of an individual Single-stage pop-up fire suppressant capsule (44) on a ribbon (231) from FIG. 35. Each fire suppressant (pop-up) capsule (44) is independently attached to the ribbon (231) by connecting pivots (68). The Single-stage pop-up fire suppressant capsule (44) used here are designed so that its posterior section (69) is heavier than the anterior (70) portion, so that the fire suppressant (pop-up) capsule (44) will always rotate into position (or, self-rights) upon the ribbon (231) with its anterior (70) section pointing upward (71).

In another embodiment FIG. 39 which is a lateral view of the Single-stage pop-up fire suppressant capsule (44), a Single-stage non pop-up fire suppressant capsule (83) or a ground-based discharge (139) capsule attached to a single ribbon (231). Each capsule (44/83/139) is attached consecutively. As at FIG. 38, this capsule can be used as a pop-up (44). As a Single-stage non pop-up fire suppressant capsule (83) or a ground-based discharge (139) capsule, when the weighted tag end will trigger discharge and release of its fire suppressant contents (13) at ground level. As a Single-stage pop-up Capsule (44) the propellant core (22) is flush with the base of the capsule (69).

The Single-stage pop-up fire suppressant capsule's posterior section (69) is heavier than the anterior (70) portion, so that the fire suppressant (pop-up) capsule (44) will always rotate into position (or, self rights) upon the ribbon (231) with its anterior (70) section pointing upward (71). As a ground-based discharge capsule (139), the propellant core (22) is replaced by a chafe-charge (143) that is attached by a retaining line (210) and a corresponding attachment pin (211) that is extended from the capsule (83/139), through the independent pivot (68), to the triggering mechanism (213) within the capsule. When the ribbon is taut, the retaining line (210) either pulls against or pulls free of the chafe-charges triggering mechanism (213), resulting in forcible ejection of the capsule's fire suppressant load 13).

As used herein, a parallel-stranded, flexible, strip structure shall mean a strip structure comprising two continuous, corresponding pieces of material constructed in such manner as to form one connected structure.

In an embodiment FIG. 36 is a horizontal view of multiple fire suppressant (pop-up) capsules (44) attached to a double stranded ribbon (231).

In another embodiment FIG. 40 is a second horizontal view of FIG. 36 illustrating one capsule (44) of the multiple fire suppressant (pop-up) capsules (44) attached to a double stranded ribbon (231). As at FIG. 37, each fire suppressant (pop-up) capsule (44) is independently attached to the ribbon (231) by connecting pivots (68). This design can incorporate the same features discussed at FIG. 39.

As used herein, a parallel-stranded, flexible, strip structure shall also mean a strip structure comprising two continuous, corresponding pieces of material constructed and arranged in such manner as to form one connected helical structure.

As used herein, strip structure securing means shall mean, a means, method, methodology, structure, attachment, securing mechanism, to secure the strip to an ejection means, that will remain with the ejection means upon ejection, separate from the ejection means after the strip structure is completely, fully, ejected, extended, extended from the ejection means, or in combination thereof.

As used herein, a weighted, non-weighted, partially weighted end segment of a strip structure shall mean, a means, structure, application, construction forming, attaching to the distal end of the strip structure serving as a ballast, balance, so that when ejected, projected, dropped, thrown, aerially dropped to the fire environment the strip structure will descend in a vertical pattern.

As used herein, a shell securing means within the strip structure shall mean a means, structure, device, pivot, connecting pivot, pin, connecting pin, rod, connecting rod, connecting shaft, connecting dowel or similar arrangement that will secure a shell to the cut out segment of the strip structure.

As used herein, a shell securing means within the strip structure shall also mean a structure or means that will support the shell attached to the strip structure, with a gyroscopic balance means to maintain the shell in a positive, upright position.

As used herein, a shell securing means within the strip structure shall further mean a structure, means, device, enclosure, encasement, partial encasement that is attached to the strip structure with a supporting means, a gyroscopic balance means to maintain the structure in a positive, upright position orientation, that will hold, contain, secure a shell without impeding discharge, release of the shell.

In an embodiment (See FIG. 38) is a lateral view of an alternate design of FIG. 37 of an individual Single-stage pop-up fire suppressant capsule (44) on a ribbon (231), originating from FIG. 35. Here, the base or posterior section of the capsule (69) is held by a partial, rhomboid shaped, enclosure (214), that performs the self righting task when the capsule is projected from its canister (see, FIG. 35). Several additional design options will be discussed here.

This capsule can be used as a pop-up (44) or a ground-based discharge (139) capsule. The latter, when the weighted tag end triggers discharge, will release its fire suppressant contents (13) at ground level. As a Single-stage pop-up Capsule (44) the propellant core (22) is flush with the base of the capsule (69), and its initial propulsion will take place against the inside of the partial, rhomboid shaped, enclosure (214). Therefore, the thin-walled structure this capsule type must be strong enough to withstand pressure exerted by the propellant (23) against the interior of the enclosure (214).

As a ground-based discharge capsule (139), the propellant core (22) is replaced by a chafe-charge (143), or a chemical strip (138) that is ignited by an electrical impulse provided by a microprocessor (123), which is the discharge mechanism. Here, as at FIG. 35, the capsule (44) is attached to the ribbon (231) by independent pivots (68).

The ribbon (231) is secured to the interior of the canister's base (209) by a retaining line (210) (see, FIG. 37) that runs through the ribbon (231) and is attached to each Single-stage pop-up fire suppressant Capsule (44). A corresponding attachment pin (211) is extended from the capsule (212), through the pivot (68), to the triggering mechanism (213) within the capsule.

When the weighted tag end (205) is fully projected, it creates a tension against and between the retaining line (210) and its corresponding capsule attachment (212), which sets off the capsule's triggering mechanism (213), chafe-charge mechanism (142) or chemical strip (138), resulting in disintegration of the thin-walled capsule or expulsion of its propellant (22), forcibly ejecting its fire suppressant load (13), or its propellant core (22) (if it's a pop-up capsule [44]).

As used herein, a shell release means within the strip structure shall mean an activatable means that when activated will disconnect the attaching pin(s) from the shell, will disconnect the attaching pin(s) from the strip structure, or in combination thereof.

As used herein, a shell discharge means within the strip structure shall mean an activatable means that when activated will discharge the contents of the shell while attached to the strip structure, while linked to the release means will effect discharge of the shell after its release from the strip structure, or in combination there.

As used herein, discharge at ground level shall mean the discharge, release, activation of a shell, encasement, encapsulation, capsule, containment device, device, at, upon, proximate to, within proximity of within close proximity of the ground, floor or in combination thereof.

As used herein, a cylinder shall mean a device, encasement, casing, shape, containment device, device that can be placed, dropped, aerially dropped, projected, ejected or in similar fashion delivered to a fire environment, with the capacity to contain one or more strip structures, multiple shells, encasements, encapsulations, capsules, containment devices, devices, or in combination thereof, a guiding means, an ejection means, a programmable mean.

As used herein, a guiding means shall further mean a guiding means comprising a microprocessor controlled interior mounted retractable parabolic flanges, exterior mounted retractable parabolic flanges, mini parachute, or in combination thereof to control the cylinder's descent.

As used herein, a sealable posterior lid, sealable anterior lid, sealable breakaway side panel shall mean, a top, bottom, closure, cap, cover, platform, side structure, door, removable door that can be sealed to the cylinder to form a closed structure with a hollow interior environment.

As used herein, a microprocessor controlled electronic release pins shall mean, a means, device, structure, mechanism linked to an activatable means, guiding means, that when activated will release, remove, unscrew, loosen, detach, unbolt the pins that secure the sealable posterior lid, sealable anterior lid, sealable breakaway side panel to the cylinder that formed a closed structure.

As used herein, the interior of the cylinder shall mean, that part of a device or means that is not exposed to the environment, that may be the delivery vehicle, containment means, that is hollowed, fitted with and shall comprise at least one or more devices for the purpose of effecting fire suppression, as discussed in this invention.

As used herein, deployment of the mini-parachute shall mean, when the cylinder's guiding means is activated the parachute while attached to the cylinder's lid, will be released from its cover, allowing it to unravel and deploy its canopy.

This shall also mean that based on computer program and data received from the global positioning system, gyroscopic sensors and altimeter, the guiding means will extend, retract the mini-parachute accordingly to slow the cylinder's descent and guide-the cylinder to its intended destination.

As used herein, deployment of the cylinder shall mean when the cylinder is dropped, aerially dropped, projected for use in the fire environment, and directed by its guiding means reaches its targeted area, activation of the electronic release pins will detach the anterior lid, posterior lid or breakaway panel, permitting its shell, strip structure contents to fall free from or be ejected from the cylinder to the environment.

As used herein, strip structures that by design remain attached to the cylinder by its securing means will release its shells for subsequent discharge, activate discharge of its shells while attached, or in combination thereof.

This shall still further mean that when the cylinder, directed by its guiding means reaches its target area, activation of the electronic release pins will detach the lid from the cylinder, whereby the remainder of the cylinder will fall away, releasing the strip structure and shells to the environment for subsequent discharge.

As used here in this invention, a rocker arm shall mean, a means, device, method, that is attached to the parabolic flanges, hood of the canister and the armature rotor, that when activated by the guiding means will extend, retract the parabolic flanges, hood accordingly.

As used here in this invention, a hood shall mean, a means, structure, device that can be extended outward from a canister or similar device, when attached to a motor, mechanical means that is computer linked to the guiding means.

As used here in this invention, a hood shall also mean a means, that when extended outward from the canister, its purpose is to flow the descent of the canister, and as part of the guiding means, to assist with guidance of the device.

As used herein, a weighted tag end shall mean a means, structure, device or similar definition that can be attached, attached to, made a part of a strip structure, fixture or other device, for the purpose of providing ballast, balance, guidance to a strip structure, fixture when projected, dropped, aerially dropped, aerially delivered, released to, placed within, delivered to or in similar manner introduced to, above, proximate to a fire environment.

As used herein, a retainer ribbon shall mean a strip structure.

In an embodiment FIG. 42 represents a vertical canister (74) containing multiple pop-up fire suppressant capsules (44) attached consecutively (230) to a ribbon (231) with a weighted tag end (232) and extended from the canister (94). This design can utilize Non Pop-up fire suppressant capsules (83).

In another embodiment FIG. 43, the fire suppressant release pattern of pop-up fire suppressant capsules (44) projected from the vertical canister (74) of FIG. 42 is shown. Here, the ribbon (231) can remain attached to the canister (74) or be completely projected from the vertical canister.

In still another embodiment (See FIG. 44), the vertical canister (89/61) is used for aerial deployment with the intent that its ribbon (231) and fire suppressant load (13) will project well in advance of the canister (89/61) striking the ground. This vertical canister (89/61) contains Single-stage non pop-up fire suppressant capsules (83/240), with a weighted tag end (232) attached to the most posterior capsule (214) on a ribbon (231) placed in the vertical canister (89/61). The breakaway panel (233) or the lid (77) of the canister (89/61) is fitted with four electronic release pins (85). The interior of the canister is fitted with positioning microprocessor controlled geographic position system, gyroscopic sensor and altimeter (86 and 87). The weightless tag end (78) extends out from the vertical canister's interior and is attached to externally (91) to side of the breakaway panel or the lid of the canister (89/61), and to the most anterior capsule on a ribbon (231).

As used herein, the interior of the canister shall mean, that part of a device or means that is not exposed to the environment, that may be the delivery vehicle, containment means, that is hollowed to, fitted to, and shall comprise at least one other device that may be used for the purpose of effecting fire suppression, as discussed in this invention.

In a further embodiment FIG. 45 is a partial exploded view of the vertical canister (89/61) being aerially deployed. The microprocessor controlled geographic position system, gyroscopic sensor and altimeter (86 and 87) installed in the vertical canister (89/61) would trigger a release mechanism (76) of the electronic release pins (85) to detach the breakaway panel (233) or lid (77). As the breakaway panel (233) or lid (77) detaches from the vertical canister (89/61) it rotates and deploys the mini-parachute (80) or an inflated plastic dome (80) attached to the underside of the breakaway panel (233) or lid (77), aiding to pull the non pop-up capsules on a ribbon (231), slowing their descent as the vertical canister (89/61) falls away. When the weighted tag end (232) is fully stretched (81), it causes a pulling action on the ribbon (231) and the weightless tag end/lid/panel (78/77/65). The tension created acts like a rip-chord, triggering the disintegration of the thin walled non pop-up capsules and dispersal of the fire suppressant load.

In still a further embodiment FIG. 46 is a schematic representation of the vertical canister (89/61) with multiple Non Pop-up fire suppressant capsules during aerial deployment (a). When it reaches the pre-set height/altitude the breakaway lid (77) detaches (c), pulling the Non Pop-up fire suppressant capsules (83) on a ribbon (231) free from the vertical canister (89/61) (d). The weighted tag end (232) straightens out the ribbon (231), creating a rip-chord effect, which initiates disintegration of the capsules, forcibly ejecting the fire suppressant load (13) (e): the spent vertical canister (89/61) lands on the ground (f).

In an embodiment FIG. 47 is a schematic representation of the inverted vertical canister (61) with multiple Non Pop-up fire suppressant capsules during aerial deployment (a). As at FIG. 46 when the canister (89/61) reaches the pre-set height/altitude the breakaway lid (77) separates, and its base (201) detaches to fall free. Unlike FIG. 44, where the weighted tag end (232) is attached to the most posterior capsule (214) and secured to the interior of the canister's base, the weighted tag end (232) is only attached to the most posterior capsule and falls free when the base detaches (b & c), pulling the capsules on the ribbon (231) free from the canister (89/61). When the lid (77) separates from the canister from the canister (61), it remains attached to the latter by a series of guide wires (206), with one guide wire attached to the mini parachute's release mechanism (227). When the lid is fully extended from the canister the designated guide wire (225) acts as a rip chord, triggering the mini parachute's release mechanism (227), deploying the parachute (b & c): this slows the descent of the inverted vertical canister (89/61), allowing the capsules (47) on a ribbon (231) to fall free (d, e & f), resulting in the capsules (47) disintegrating and discharging their fire suppressant load (13) at the pre-set height/altitude (g). As above, the inverted vertical canister (61) contains the microprocessor controlled geographic position system, gyroscopic sensor and altimeter (86 and 87) that will trigger the release mechanism (76) of the electronic release pins (85) to detach the lid (77) and the base (201).

In a continued embodiment FIG. 48 is an alternative schematic representation of the inverted vertical canister (89) of FIG. 47, with multiple Non Pop-up fire suppressant capsules during aerial deployment. In this design, instead of using a mini-parachute to slow the canisters descent, a series of internal hoods (280) connected to an armature rotor (282) by a rocker arm (281) are partially extended to the external environment through openings (283) at the anterior section of the canister's side walls. When aerially deployed, the armature arm can be pre-set to extend the hoods outward based upon such factors as altitude, time, descent plane, etc., or in conjunction with the microprocessor controlled geographic position system, gyroscopic sensor and altimeter (86 and 87). As at FIG. 47 when the canister (89/61) reaches the pre-set height/altitude the electronic release pins (85) detaches the base breakaway lid (77) from the canister (89/61), and the base detaches to fall free (288), (See FIG. 50).

FIG. 50 is a schematic representation of FIGS. 48 and 49, where the electronic release pins have separated the base lid (77) from the canister, allowing the base lid to fall free and clear (288). The weighted tag end (232), located at the posterior end of the retainer ribbon (231) falls from the canister (89/61), pulling the ribbon (231) and its capsule load (83) from the canister, as both continue a vertical descent. The anterior segment (78) of the retainer ribbon (231) is secured to the underside of the anterior lid (231/78). The anterior length of the retainer ribbon (289/231), which does not contain any fire suppressant capsules, is sufficient in length to clear the base of the capsule so that its capsule load will not be discharged while within the canister.

In another embodiment FIG. 49 is a schematic representation of FIG. 48, where the armature motor (282) has moved the rocker arm (281) attached to each hood (280), extending the hood through the canister's anterior openings (283) for deployment of each hood (285) to the external environment, to slow the canister's vertical descent.

In still another embodiment FIG. 50 which is a schematic representation of FIGS. 48 and 49, the electronic release pins have separated the base lid (77) from the canister, allowing the base lid to fall free and clear (288). The weighted tag end (232), located at the posterior end of the retainer ribbon (231), falls from the canister (89/61), pulling the ribbon (231) and its capsule load (83) from the canister, as both continue a vertical descent. The anterior segment (78) of the retainer ribbon (231) is secured to the underside of the anterior lid (231/78). The anterior length of the retainer ribbon (289/231), which does not contain any fire suppressant capsules, is sufficient in length to clear the base of the capsule so that its capsule load will not be discharged while within the canister.

In a further embodiment FIG. 51 is an isolated schematic representation of FIG. 48, illustrating the sections of the hood (281) extended through the canister's openings (283), with (b) representing an overhead view. The hood, when extended, forms a bell-like structure.

In other embodiments FIGS. 52 and 53 represent an alternative design to FIG. 48, where the armature motor (282), rocker arm (281) and the hood (286) are housed at the exterior of the inverted vertical descending canister (89/61). When initially deployed, the hood is in a downward position. To deploy the hood, to slow descent of the canister, the armature motor rotates the hood upward in a 90° arc, locking it into position (421) (see, FIG. 53).

As used herein, a fire extinguishing carrier unit shall mean a containment structure capable of carrying one or more attached, unattached strip structures, multiple shells, or in combination thereof, for the delivery and deployment of shells to a fire environment.

As used herein, a fire extinguishing carrier unit shall also mean a case, casing, encasement, containment device, containment unit, containment structure, device, with along with an ejection means, a means to secure the contents to the ejection means, a programmable means, activatable electronic release pins, sealable breakaway side panels, sealable breakaway top panel, sealable breakaway bottom panel.

As used herein, a fire extinguishing carrier unit shall further mean when the structure is placed or otherwise delivered to a fire environment, the programmable means that is linked to the activatable means will cause the electronic release pins to detach the sealable lid, sealable panels, allowing activation of the ejection means that will forcibly eject the strip structures, multiple shells from the carrier unit to the environment. Upon ejection of the strip structure its weighted distal end will assist to draw the strip structure out to its full length, whereupon the gyroscopic sensor will positively orient the shells upon the strip structure for subsequent release, discharge.

As used herein, a drop, aerial drop fire extinguishing carrier unit shall mean a fire extinguishing carrier unit containing a guiding means.

As used herein, a drop, aerial drop fire extinguishing carrier unit shall also mean a containment structure constructed in such a manner that on impact it sides, top, bottom will collapse, breakaway, shatter, or in similar fashion fall apart, but in doing so will not impede the projection, ejection, release, escape of its contents, a means to effect such collapse, or in combination thereof.

As used herein, a drop, aerial drop fire extinguishing carrier unit shall further mean a containment structure with a self-righting means connected to the ejection means, so that upon impact of the carrier unit the ejection means will maintain a positive orientation for effective operation.

In an embodiment FIG. 35 which represents a large canister (202) containing multiple pop-up fire suppressant capsules (44) attached consecutively (230) to a ribbon (231) that has a weighted tag end (231), the weighted tag end (232) is attached or placed to a breakaway panel (233). When this large square or rectangular canister (202) is deployed for aerial drops into a fire zone (100-103, 109) hits the ground, the breakaway panel (233) falls from the canister (202), allowing for the weighted tag end (232) to be projected outward (66). When the weighted tag end (232) is projected or launched outward (66) and away from the canister (202), the weighted tag end (232) pulls the capsules on the ribbon (231) from the canister (202). FIG. 35 can utilize Non Pop-up fire suppressant capsules (83).

In another embodiment FIG. 36 a horizontal view is provided whereby multiple fire suppressant (pop-up) capsules (44) attached to a double stranded ribbon (231). FIG. 37 is a lateral view diagram of an individual Single-stage pop-up fire suppressant capsule (44) on a ribbon (231) from FIG. 35. Each fire suppressant (pop-up) capsule (44) is independently attached to the ribbon (231) by connecting pivots (68). The Single-stage pop-up fire suppressant capsule (44) used here are designed so that its posterior section (69) is heavier than the anterior (70) portion, so that the fire suppressant (pop-up) capsule (44) will always rotate into position (or, self rights) upon the ribbon (231) with its anterior (70) section pointing upward (71).

In still another embodiment FIG. 38 is a lateral view of an alternate design of FIG. 37 of an individual Single-stage pop-up fire suppressant capsule (44) on a ribbon (231), originating from FIG. 35. Here, the base or posterior section of the capsule (69) is held by a partial, rhomboid shaped, enclosure (214), that performs the self righting task when the capsule is projected from its canister (see, FIG. 35). Several additional design options will be discussed here.

This capsule can be used as a pop-up (44) or a ground-based discharge (139) capsule. The latter, when the weighted tag end triggers discharge, will release its fire suppressant contents (13) at ground level. As a Single-stage pop-up Capsule (44) the propellant core (22) is flush with the base of the capsule (69), and its initial propulsion will take place against the inside of the partial, rhomboid shaped, enclosure (214). Therefore, the thin-walled structure this capsule type must be strong enough to withstand pressure exerted by the propellant (23) against the interior of the enclosure (214).

As a ground-based discharge capsule (139), the propellant core (22) is replaced by a chafe-charge (143), or a chemical strip (138) that is ignited by an electrical impulse provided by a microprocessor (123), which is the discharge mechanism. Here, as at FIG. 35, the capsule (44) is attached to the ribbon (231) by independent pivots (68).

As used herein, a ground-based discharge capsule shall mean, a capsule, canister, shell, device, that has been designed, developed and/or programmed to release, discharge, expel its contents while the device is positioned upon, found upon, rests upon or similarly placed upon the ground (floor).

The ribbon (231) is secured to the interior of the canister's base (209) by a retaining line (210) (see, FIG. 37) that runs through the ribbon (231) and is attached to each Single-stage pop-up fire suppressant Capsule (44). A corresponding attachment pin (211) is extended from the capsule (212), through the pivot (68), to the triggering mechanism (213) within the capsule.

When the weighted tag end (205) is fully projected, it creates a tension against and between the retaining line (210) and its corresponding capsule attachment (212), which sets off the capsule's triggering mechanism (213), chafe-charge mechanism (142) or chemical strip (138), resulting in disintegration of the thin-walled capsule or expulsion of its propellant (22), forcibly ejecting its fire suppressant load (13), or its propellant core (22) (if it's a pop-up capsule [44]).

As used herein, a fire extinguishing carrier unit shall mean a containment structure capable of carrying one or more attached, unattached strip structures, multiple shells, or in combination thereof, for the delivery and deployment of shells to a fire environment.

As used herein, a fire extinguishing carrier unit shall also mean a case, casing, encasement, containment device, containment unit, containment structure, device, with along with an ejection means, a means to secure the contents to the ejection means, a programmable means, activatable electronic release pins, sealable breakaway side panels, sealable breakaway top panel, sealable breakaway bottom panel.

As used herein, a fire extinguishing carrier unit shall further mean when the structure is placed or otherwise delivered to a fire environment, the programmable means that is linked to the activatable means will cause the electronic release pins to detach the sealable lid, sealable panels, allowing activation of the ejection means that will forcibly eject the strip structures, multiple shells from the carrier unit to the environment. Upon ejection of the strip structure its weighted distal end will assist to draw the strip structure out to its full length, whereupon the gyroscopic sensor will positively orient the shells upon the strip structure for subsequent release, discharge.

As used herein, a drop, aerial drop fire extinguishing carrier unit shall mean a fire extinguishing carrier unit containing a guiding means.

As used herein, a drop, aerial drop fire extinguishing carrier unit shall also mean a containment structure constructed in such a manner that on impact it sides, top, bottom will collapse, breakaway, shatter, or in similar fashion fall apart, but in doing so will not impede the projection, ejection, release, escape of its contents, a means to effect such collapse, or in combination thereof.

As used herein, a drop, aerial drop fire extinguishing carrier unit shall further mean a containment structure with a self-righting means connected to the ejection means, so that upon impact of the carrier unit the ejection means will maintain a positive orientation for effective operation.

In a continued embodiment FIG. 39 is a lateral view of the Single-stage pop-up fire suppressant capsule (44), a Single-stage non pop-up fire suppressant capsule (83) or a ground-based discharge (139) capsule attached to a single ribbon (231). Each capsule (44/83/139) is attached consecutively. As at FIG. 38, this capsule can be used as a pop-up (44). As a Single-stage non pop-up fire suppressant capsule (83) or a ground-based discharge (139) capsule, when the weighted tag end will trigger discharge and release of its fire suppressant contents (13) at ground level. As a Single-stage pop-up Capsule (44) the propellant core (22) is flush with the base of the capsule (69).

The Single-stage pop-up fire suppressant capsule's posterior section (69) is heavier than the anterior (70) portion, so that the fire suppressant (pop-up) capsule (44) will always rotate into position (or, self rights) upon the ribbon (231) with its anterior (70) section pointing upward (71). As a ground-based discharge capsule (139), the propellant core (22) is replaced by a chafe-charge (143) that is attached by a retaining line (210) and a corresponding attachment pin (211) that is extended from the capsule (83/139), through the independent pivot (68), to the triggering mechanism (213) within the capsule. When the ribbon is taut, the retaining line (210) either pulls against or pulls free of the chafe-charges triggering mechanism (213), resulting in forcible ejection of the capsule's fire suppressant load 13).

In another continued embodiment (See FIG. 40) there is a second horizontal view of FIG. 36 illustrating one capsule (44) of the multiple fire suppressant (pop-up) capsules (44) attached to a double stranded ribbon (231). As at FIG. 37, each fire suppressant (pop-up) capsule (44) is independently attached to the ribbon (231) by connecting pivots (68). This design can incorporate the same features discussed at FIG. 39.

In still another embodiment FIG. 41, is a schematic representation of the release pattern (72 and 73) of the Single-stage pop-up fire suppressant capsule (44) projected from the canister of FIG. 35. When the weighted tag end (205) pulls the capsules (44) free from the canister (202) and the capsules pivot into position, the pop-up sequence is triggered, simultaneously or sequentially jettisoning the Single-stage pop-up fire suppressant capsules (44) vertically.

In a continued embodiment FIG. 42 a vertical canister (74) is represented containing multiple pop-up fire suppressant capsules (44) attached consecutively (230) to a ribbon (231) with a weighted tag end (232) and extended from the canister (94). This design can utilize Non Pop-up fire suppressant capsules (83).

In still another continued embodiment FIG. 43 is the fire suppressant release pattern of pop-up fire suppressant capsules (44) projected from the vertical canister (74) of FIG. 42. Here, the ribbon (231) can remain attached to the canister (74) or be completely projected from the vertical canister.

In still yet another continued embodiment (See FIG. 44) is an illustration of the vertical canister (89/61) used for aerial deployment with the intent that its ribbon (231) and fire suppressant load (13) will project well in advance of the canister (89/61) striking the ground. This vertical canister (89/61) contains Single-stage non pop-up fire suppressant capsules (83/240), with a weighted tag end (232) attached to the most posterior capsule (214) on a ribbon (231) placed in the vertical canister (89/61). The breakaway panel (233) or the lid (77) of the canister (89/61) is fitted with four electronic release pins (85). The interior of the canister is fitted with positioning microprocessor controlled geographic position system, gyroscopic sensor and altimeter (86 and 87). The weightless tag end (78) extends out from the vertical canister's interior and is attached to externally (91) to side of the breakaway panel or the lid of the canister (89/61), and to the most anterior capsule on a ribbon (231).

Continuing from the previous embodiment FIG. 45 is a partial exploded view of the vertical canister (89/61) being aerially deployed. The microprocessor controlled geographic position system, gyroscopic sensor and altimeter (86 and 87) installed in the vertical canister (89/61) would trigger a release mechanism (76) of the electronic release pins (85) to detach the breakaway panel (233) or lid (77). As the breakaway panel (233) or lid (77) detaches from the vertical canister (89/61) it rotates and deploys the mini-parachute (80) or an inflated plastic dome (80) attached to the underside of the breakaway panel (233) or lid (77), aiding to pull the non pop-up capsules on a ribbon (231), slowing their descent as the vertical canister (89/61) falls away. When the weighted tag end (232) is fully stretched (81), it causes a pulling action on the ribbon (231) and the weightless tag end/lid/panel (78/77/65). The tension created acts like a rip-chord, triggering the disintegration of the thin walled non pop-up capsules and dispersal of the fire suppressant load.

In a separate embodiment FIG. 46 is a schematic representation of the vertical canister (89/61) with multiple Non Pop-up fire suppressant capsules during aerial deployment (a). When it reaches the pre-set height/altitude the breakaway lid (77) detaches (c), pulling the Non Pop-up fire suppressant capsules (83) on a ribbon (231) free from the vertical canister (89/61) (d). The weighted tag end (232) straightens out the ribbon (231), creating a rip-chord effect, which initiates disintegration of the capsules, forcibly ejecting the fire suppressant load (13) (e): the spent vertical canister (89/61) lands on the ground (f).

In a further embodiment FIG. 47 is a schematic representation of the inverted vertical canister (61) with multiple Non Pop-up fire suppressant capsules during aerial deployment (a). As at FIG. 46 when the canister (89/61) reaches the pre-set height/altitude the breakaway lid (77) separates, and its base (201) detaches to fall free. Unlike FIG. 44, where the weighted tag end (232) is attached to the most posterior capsule (214) and secured to the interior of the canister's base, the weighted tag end (232) is only attached to the most posterior capsule and falls free when the base detaches (b & c), pulling the capsules on the ribbon (231) free from the canister (89/61). When the lid (77) separates from the canister from the canister (61), it remains attached to the latter by a series of guide wires (206), with one guide wire attached to the mini parachute's release mechanism (227). When the lid is fully extended from the canister the designated guide wire (225) acts as a rip chord, triggering the mini parachute's release mechanism (227), deploying the parachute (b & c): this slows the descent of the inverted vertical canister (89/61), allowing the capsules (47) on a ribbon (231) to fall free (d, e & f), resulting in the capsules (47) disintegrating and discharging their fire suppressant load (13) at the pre-set height/altitude (g). As above, the inverted vertical canister (61) contains the microprocessor controlled geographic position system, gyroscopic sensor and altimeter (86 and 87) that will trigger the release mechanism (76) of the electronic release pins (85) to detach the lid (77) and the base (201).

At another embodiment FIG. 48 is an alternative schematic representation of the inverted vertical canister (89) of FIG. 47, with multiple Non Pop-up fire suppressant capsules during aerial deployment. In this design, instead of using a mini-parachute to slow the canisters descent, a series of internal hoods (280) connected to an armature rotor (282) by a rocker arm (281) are partially extended to the external environment through openings (283) at the anterior section of the canister's side walls. When aerially deployed, the armature arm can be pre-set to extend the hoods outward based upon such factors as altitude, time, descent plane, etc., or in conjunction with the microprocessor controlled geographic position system, gyroscopic sensor and altimeter (86, 87). As at FIG. 47 when the canister (89/61) reaches the pre-set height/altitude the electronic release pins (85) detaches the base breakaway lid (77) from the canister (89/61), and the base detaches to fall free (288), (See, FIG. 50).

In still another embodiment FIG. 49 is a schematic representation of FIG. 48, where the armature motor (282) has moved the rocker arm (281) attached to each hood (280), extending the hood through the canister's anterior openings (283) for deployment of each hood (285) to the external environment, to slow the canister's vertical descent.

In a continued embodiment FIG. 50 is a schematic representation of FIGS. 48 and 49, where the electronic release pins have separated the base lid (77) from the canister, allowing the base lid to fall free and clear (288). The weighted tag end (232), located at the posterior end of the retainer ribbon (231), falls from the canister (89/61), pulling the ribbon (231) and its capsule load (83) from the canister, as both continue a vertical descent. The anterior segment (78) of the retainer ribbon (231) is secured to the underside of the anterior lid (231/78). The anterior length of the retainer ribbon (289/231), which does not contain any fire suppressant capsules, is sufficient in length to clear the base of the capsule so that its capsule load will not be discharged while within the canister.

In a still another continued embodiment FIG. 52 is an isolated schematic representation of FIG. 48, illustrating the sections of the hood (281) extended through the canister's openings (283), with (b) representing an overhead view. The hood, when extended, forms a bell-like structure.

In two additional embodiments FIGS. 52 and 53 illustrate an alternative design to FIG. 48 is represented, where the armature motor (282), rocker arm (281) and the hood (286) are housed at the exterior of the inverted vertical descending canister (89/61). When initially deployed, the hood is in a downward position. To deploy the hood, to slow descent of the canister, the armature motor rotates the hood upward in a 90° arc, locking it into position (421) (see, FIG. 53).

Thereafter, the following embodiment FIG. 54 illustrates a large breakaway square or rectangular canister (90) or other suitable structures containing multiple pop-up fire suppressant capsules (44) on a ribbon (231) with a weighted tag end (232), similar to that of FIG. 35. Here, however, instead of attaching the pop-up fire suppressant capsules (44) to one ribbon (231), as at FIG. 35, capsules are attached to several independent ribbons (231), with each ribbon (231) containing a weighted tag end (232). The weighted tag ends (232) are attached to a central ring (92) within the canister (90). When the canister (90) strikes the ground (or other hard surface) it collapses outward and away from its capsule load (95). The ring's firing mechanism (92) ejects each weighted tag end (232) vertically, at an acute angle, thereby pulling each ribbon (231) out of, away from, and clear of the canister (90). The amount of force applied by the firing mechanism (92) will determine the height and distance to which the ribbon (63) and the Non Pop-up fire suppressant capsules (83) or Single-stage pop-up fire suppressant capsules (44) will be projected.

In another embodiment FIG. 55 is an illustration of Non Pop-up fire suppressant capsules (83) with a weighted tag end (232) attached to a vertical ribbon (99), for aerial deployment to a fire zone. Whether released from a helicopter, aerial tanker or drone, the weighted tag end (232) is used to achieve vertical descent during a vertical free fall.

If the capsules are dropped in a ball-like manner, end-capsule-first or tag-end-first, the weighted tag end (232) should be sufficiently weighted to prevent long-distance drifts (away from the intended fire zone), horizontal drop, or a vertical drop where one or more capsules attached to the ribbon (231) drop at a rate faster than its weighted tag end (232). The weighted tag end (232) itself can be a fire suppressant capsule (1). Here, the capsules on a ribbon are not packaged within a container or containment system during deployment.

As above, a variety of capsule types can be deployed in this fashion: heat/temperature activated, time activated, height/altitude activated, pop-up, concentric, two-stage, etc., and the discharge pattern can be varied.

As used herein, a fixture shall mean a means, structure, device, rod, rod-like structure, elongated cylinder, bar, shaft or similar arrangement that can hold, retain, maintain multiple shells, encasements, encapsulations, capsules, containment devices, devices.

As further used herein a fixture shall mean a device, with the aid of a retaining means, can have attached to same shells, encasements, encapsulations, capsules, containment devices, devices.

As used herein, a fixture shall mean a structure that has a guiding means, shell, encasement, encapsulation, capsule, containment device, device programmable means, release means, discharge means.

As used herein, a retaining pin shall mean a device, means, system, method or similar arrangement that is part of the fixture upon which a shell, encasement, encapsulation, capsule, containment device, device can be attached at the end opposite its attachment to the fixture.

As used herein, a weighted end region shall mean a weight, counterweight, weighted matter, weighted core, counter balance or similar structure affixed to one end of the fixture opposite the end containing the guiding means' stabilizing wings.

As used herein, the shell release means of the fixture shall mean an activatable means linked to the guiding means and the retaining pin, so that when the fixture is within its objective, aided by the guiding means, it will cause the shells attached to the fixture by the retaining pins to dislodge, fall free or otherwise become released from the fixture for subsequent discharge.

As used herein, the shell discharge means of the fixture shall mean an activatable means linked to the guiding means and the retaining pin, so that when the fixture is within its objective, aided by the guiding means, it will cause the shells attached to the fixture by the retaining pins to discharge their contents to the environment while attached to the fixture.

As used here in this invention, a retractable arm shall mean a means to extend a structure out from within, out from a containment structure, fixture, or in combination thereof.

As used here in this invention, independent flexing or flexible arms shall mean the arms of the fixture used to hold, support, retain, or in similar manner attach shells to the fixture, with, without, or in combination thereof the use of retaining pins, that are flexible, semi-flexible, or in combination thereof.

As used here in this invention, an umbrella rig of a fixture shall mean the permanent, flexible arms of the fixture used to hold, support, retain, or in similar manner attach shells to the fixture, with, without, or in combination thereof the use of retaining pins.

As used here in this invention, an umbrella rig of a fixture shall also mean the permanent, flexible arms of the fixture that when opened, displayed outward from the fixture, may imitate the arms of an umbrella when opened.

As used here in this invention, a unidirectional umbrella rig of a fixture shall mean that where two or more umbrella rigs are affixed to the same fixture, the arms and distal ends of the umbrella rig face the same direction.

As used here in this invention, a bi-directional umbrella rig of a fixture shall mean an umbrella rig, where two such umbrella rigs are positioned in such a manner upon the fixture where the distal ends of one umbrella rig faces but does not touch or impede the distal ends of a second umbrella rig.

As also used here in this invention, a bi-directional umbrella rig of a fixture shall mean an umbrella rig, where two such rigs are positioned in such a manner upon the fixture where the arms and distal ends of one rig faces away from the arms and distal ends of a second rig.

As used here in this invention, a ring shall mean a device, structure, means, instrumentation or similar meaning that is affixed to the fixture in such a manner that it encircles the fixture, perpendicular to the fixture's horizontal, longitudinal axis.

As used here in this invention, a ring shall also mean a device with the capacity to hold multiple shells, encasements, encapsulations, capsules, containment devices, devices attached to fixed position, moveable position, rotatable position retention pins, or in combination thereof.

As used here in this invention, a ring shall further mean a device with an activatable shell release means, computer linked to the fixture's guiding means to discharge the shells while affixed to the ring, to release the shells for subsequent discharge, or in combination thereof.

As used here in this invention, central post shall mean the structure that forms the horizontal, longitudinal axis of the fixture, serving as a platform for attachment of the guiding means, release means, weighted tag end, rings, umbrella rigs, bi-directional umbrella rigs, discharge means, release means, and other attachments.

As used here in this invention, a weighted tag end shall mean a weighted end segment of the fixture that is at the opposite end, furthest distance from the fixture's guiding means, constructed in such a manner that it will provide ballast, balance and assist the guiding means during descent of the fixture when ejected, projected, dropped, thrown, aerially dropped to the fire environment.

As used herein, independent tubular fire suppressant capsules vertically attached shall mean, the attachment of shells, encasements, encapsulations, capsules, containment devices, devices to a fixture's ring, flexible arms, umbrella rigs, or in combination thereof.

In an embodiment FIG. 56 is an illustration of multiple independent fire suppressant capsules (1) attached to independent flexing arms (94) of an umbrella rig (95) connected to a central post (96), for aerial deployment to a fire zone (101-104). The central post (96) has a weighted tag end (232) at its base (97) for balance, and fixed anterior stabilizing wings/flanges or fins (98).

This is a variation of the vertical ribbon capsule system (99) noted at FIG. 55. Instead of arranging the capsules in linear fashion along the ribbon (231), a center post (96) or ring (118) (See, FIG. 59) holds several flexion arms (94) with a capsule (1) attached to the end of each arm (94). This version employs a bi-directional umbrella rig (79). Dispersal of the fire suppressant capsules (1) can be achieved by any of the methods discussed above.

In another embodiment FIG. 57 is a second version of FIG. 56, with unidirectional umbrella rig attachments (127).

In still another embodiment FIG. 58 is a schematic representation of the release pattern of the multiple independent fire suppressant capsules of FIGS. 56 and 57. As noted at FIG. 55, above, this system is developed for free fall deployment and is not housed within a container or containment system during such times. However, this does not prevent containment for storage and transport purposes. By using a microprocessor controlled geographic position system, gyroscopic sensor and altimeter (86 and 87), and a capsule release microprocessor (127) as part of the central post (96) or ring, release of the capsule (1) can be electronically pre-programmed or controlled during descent. This does not, however, supplant a decision to fit each capsule (1) with its own microprocessors (67, 68, and 127). As illustrated here, the capsules (1) may be dispersed (82) while attached to its independent flexing arms (94), or during its continued descent (218), when released from the umbrella rig (95).

In a further embodiment FIG. 59 is an arrangement whereby multiple independent tubular (216) or canister-type (217) fire suppressant capsules vertically attached (129) to a circular ring (219), for aerial deployment to a fire zone (101-104). As at FIGS. 56 and 57, FIG. 59 contains a weighted tag end (232) for balance, and fixed anterior stabilizing wings or fins (98). Any one of the fire suppressant capsules (1) cited above may be utilized with this design.

Each canister/capsule is independently attached to the circular ring (219) with a retractable arm (193) (See, FIG. 60) that will extend the canister/capsule outward (220), to an acute angle or right angle to the circular ring (219), for projected deployment (221) into the fire zone (100-104) (See, FIG. 60 for 219, 220, 221 and 193). Extension of the retractable arm (193) and deployment of the canisters/capsules can be effectuated electronically by remote control, through the use of microprocessors (123) or pre-set, using a microprocessor controlled geographic position system, gyroscopic sensor and altimeter (86 and 87).

In a continued embodiment (See FIG. 60) the firing pattern of canister/capsules of FIG. 59 is shown, when the retractable arms (193) of the circular ring (219) extend to a horizontal or acute angle for projection of the canister/capsules (1).

In a separate embodiment (See FIG. 61) multiple (independent) spherical fire suppressant capsules or canisters (1) are attached to a central post (96), for aerial deployment into a fire zone. The fire suppressant capsules or canisters (1) are attached directly to the central post (96), which has a weighted tag end (232) for balance, and fixed anterior stabilizing wings or fins (98). Any one of the fire suppressant capsules (1) cited above may be utilized with this design. FIG. 61 contains a microprocessor controlled geographic position system, gyroscopic sensor and altimeter (86 and 87), and a microprocessor (127) to control release and descent of the capsules/canisters.

As used herein, a fire extinguishing carrying unit shall mean, a means, structure, containment structure, encasement, encased structure, encasement structure, system, device, with shells, encasements, devices or similar fire extinguishing entities that can be carried or otherwise brought to, into a fire environment by a firefighter, that is insulated to withstand the extreme temperatures of a fire zone.

As used herein, a fire extinguishing carrying unit shall also mean a light weight carrying unit, carrying structure, transportable structure that has discernible compartments, cells, chambers or similar structural features that can be filled with an inflammable gas with a buoyancy composition, so as to give buoyancy to the device when in use.

As used herein, a fire extinguishing carrying unit shall further mean a device that can be used to contain, house, transport, store, protect, multiple fire extinguishing devices for use by firefighters.

As used herein, a fire extinguishing carrying unit shall also mean a device constructed in such a manner that electronic signals emitting from the external environment, other than the electronic signal produced by the carrying unit's shell programming means, will be prevented from entering, penetrating the exterior of the carrying unit, interfering with the programming, programmed signal of the shells contained therein.

As used here in this invention a shell's programming means shall mean a device, means, method, structure that linked with a method of transmitting its electronic program signal used to program shells equipped with the means to receive such signal for the purpose of programming its activatable means, guiding means, or in combination thereof.

As used here in this invention a transducer shall mean a means, method, system capable of receiving electronic programming signals from the fire extinguishing carrying unit's programming means, to broadcast such programming signal to the receiving means of the shells contained within the fire extinguishing carrying unit.

As used here in this invention a transducer shall mean a means, method, system capable of receiving, detecting the electronic program signal of each individual device contained within the fire extinguishing carrying unit, that when linked to a computer program and a visual display monitor will identify and provide the electronic program status of each device contained therein.

As used herein, programming a fire extinguishing device shall mean but not all inclusive of, a means by which a shell's microprocessor, nanoprocessor, computer program, activatable means, guiding means, discharge means, can be programmed to function in combination, independently, separately, to perform in the manner stated throughout this invention.

As used herein, a fire extinguishing carrying unit shall also mean a device that can be connected to, appended to, affixed to, or in similar manner attached to an external device, means, structure, that can be used to deploy shells to the fire environment.

As used here in this invention, a programming module shall mean, a means, device, instrument or similar method, that when linked with a method of transmitting its electronic program signal to the fire extinguishing carrying unit and eventually to the shells contained there.

As used here in this invention, an external, recessed, programming module shall mean a programming module that is incorporated into the structure of the fire extinguishing carrying unit while remaining accessible to the user.

As used here in this invention, a hand-held electronic programming keypad shall mean a programming module that can be detached from, separated from, manually connected to, attached to the fire extinguishing carrying unit, where when linked with a method of transmitting its electronic program signal to the fire extinguishing carrying unit the user can electronically program the shells contained there.

As used here in this invention, a flame resistant, externally recessed electronic docking port shall mean a means, method, system, device that the hand-held electronic programming keypad can be attached to, coupled to, connected to, or in similar manner joined to a receiving means that when linked with a method of transmitting its electronic program signal to the fire extinguishing carrying unit the user can electronically program the shells contained there.

As used herein, a device counter shall mean a device, structure, system, method or similar means that will individually identify each device contained within the fire extinguishing carrying unit, its programming status, the number and specific device exited from the carrying unit, that when linked to a computer program and a visual display monitor will provide the user with an active display of the fire extinguishing carrying unit's contents.

In an embodiment FIG. 92 is the lightweight, insulated, Personal Carrier a backpack type system (160) that is fitted with a Smart Fire Extinguishment Encasement launcher (161).

The purpose of the Personal Carrier (160) and its a Smart Fire Extinguishment Encasement launcher (161), is to give fire fighters and fire jumpers the ability to walk directly into a fire situation with a high concentration of encapsulated fire suppressants (1) at hand, for immediate pinpoint or line of sight deployment. The Smart Fire Extinguishment Encasement launcher (161) can project fire suppressant capsules (1) into or deeper within a fire zone, from within and from without the fire zone/structure, can propel a capsule to a specific target or point, and should allow fire fighters to take fire suppressants into an area or interior structure that may not be as readily accessible to an external fire hose.

In another embodiment FIG. 93 is an illustration of the Personal Carrier (160) with sequentially (electronic) numbered capsules (1) that can be electronically programmed en masse or individually, after being loaded into the Personal Carrier (160), through the use of an external programming module (162) or a removable hand-held programming module (163, see, FIG. 94) that plugs into an external docking port (164). The interior of the Personal Carrier (160) is insulated (165); shielded (166) to prevent extraneous signal interference; and, contains a transducer (167) that is used to program the capsules (1). The exterior of the Personal Carrier (160), its straps (168), and its molded harness (169) should be constructed of heat dissipating materials. The base compartment (170) of the Personal Carrier (160) is pressurized (171) for loading of fire suppressant capsules (1) to the Smart Fire Extinguishment Encasement launcher (161) via a connecting insulated flex tube (172). Fire suppressant capsules (1) contained within the Personal Carrier (160) drop into the base compartment (170) for flex tube (172) loading to the Smart Fire Extinguishment Encasement launcher (161), or can be individually dropped to the floor/ground through a double insulated chambered dispenser (173), for ground/floor based dispersal (139). As an option, the top of the Personal Carrier (160) can be fitted with an inflammable gas (199) to create buoyancy. The flex tube (172) can be uncoupled from the Personal Carrier (160) and the Smart Fire Extinguishment Encasement launcher (161). When detachment of the flex tube is accomplished, insulated caps that can be screwed onto the attaching ports (241, 242) seal the openings, to prevent heat from entering the Personal Carrier and the launcher.

In a further embodiment (See FIG. 94) is a lateral and partially exploded view of an external device attached to the Personal Carrier for deployment of its shells—the Launcher (161). Each capsule (1), whether it is a non-programmed capsule, pre-programmed capsule, or a capsule programmed after being loaded into the launcher from the Personal Carrier or drop loaded (224) into the launcher (161), each can be programmed or reprogrammed once loaded into the launcher.

As used herein, a containment structure constructed in such a manner that on impact it sides, top, bottom will collapse, breakaway, shatter, or in similar fashion fall apart, but in doing so will not impede the projection, ejection, release, escape of its contents, a means to effect such collapse, or in combination thereof shall mean,

As used in this invention a light weight, insulated, fire extinguishing device carrying unit shall mean a portable containment structure, system, device, temporary encasement, temporary enclosure or similar definitions, with a capacity to house, carry, transport a fixture containing multiple fire extinguishing shells, devices, encasements, encapsulations, capsules, containment devices.

As used in this invention a light weight, insulated, fire extinguishing device carrying unit shall also mean a portable containment structure with a guiding means, discharge mean a portable containment structure with an electronic device programmable means that linked by a computer program to a transducer can program its devices, guiding means, discharge means.

As used in this invention a light weight, insulated, fire extinguishing device carrying unit shall further mean a portable containment structure that can be utilized by firefighters to carry an array of fire extinguishing devices into a fire environment, where it can to deposited to, proximate to or in a fire zone, or blindly tossed into same as a front line advance against a fire.

As used in this invention a Drop Satchel shall mean a portable, light weight, insulated, fire extinguishing device carrying unit that can be utilized by firefighters to carry an array of fire extinguishing devices into a fire environment.

As used in this invention a central post shall mean a fixture with multiple sections.

As used in this invention a fixture with interlocking, interconnections sections shall mean a fixture that can be separated into two or more smaller sections with each section complete with

In an embodiment FIG. 125 is a partial cross-sectional frontal view of the Drop Satchel (186). The Drop Satchel (186) is a lightweight portable bag containing a multiple array of up fire suppressant capsules or canisters with a smart chip (189). The multiple array of Single-stage pop-up fire suppressant capsule with a smart chip, Two-stage pop-up with a smart chip (190) and/or a Smart Fire Extinguishment Encasement (157), with a smart chip (158) are connected to a central post (96), with a fixed (187) or retractable arm (193).

The intended purpose of the Drop Satchel (186) is to allow a fire fighter to carry the bag containing an array of fire suppressant capsules (1) to be placed, thrown or dropped into a burning structure (229). Combined with Smoke/Airborne Particulate Matter Dissipating capsules, the Drop Satchel (186) can become a front line defense tool where searching under conditions where visibility is limited, particularly in high-rise building fire.

The central post is fitted with a microprocessor (191) that can be programmed through the use of an external programming module (192) or a removable hand-held programming module (193) that plugs into an external docking port (194). The fixed arm (187) and the retractable arm (194) can be set at a 30° to 45° angle. The retractable arm (193) would also be set at a 30° to 45° angle. However, where the Drop Satchel (186) rests at less than a 90° vertical angle, the microprocessor (191) will rotate the arm (193) to a 90° vertical angle for discharge of the attached capsules (1). The Drop Satchel (186) can be set to discharge its capsules (1) while in mid air or from a stationary position.

In another embodiment FIG. 126 is a freestanding illustration of the Drop Satchel's central post (96) with fire suppressant capsules (1) attached by a fixed arm (187) or retractable arm (193). Here, the central (96) has six vertical levels (246, 247, 248, 249, 250 and 251), each level containing four horizontally attached fixed (187) or retractable (193) arms. The actual number of vertical levels and horizontal attachment can be increased or decreased by design, or as needed. The Drop Satchel's central post (96) is attached by a handle (244) and a pedestal base (245).

In situations where deployment of a six level unit is excessive, the central post (96) can be separated by detaching each or any level of the post (96). This can be accomplished by turning a lower unit in a counter-clockwise direction, starting from the base of the unit. The six-level unit can be reduced to multiple or individual levels, to be placed, thrown or dropped into a burning structure. The top of level six threads into the base of level five; the top of level five threads into the base of level four; the top of level four threads into the base of level three; the top of level three threads into the base of level two; and the top of level two threads into the base of level one. Each level can be programmed individually or en masse through microprocessor programming.

In still another embodiment FIG. 127 is an overhead view of the Drop Satchel's (186) central post (96) with fire suppressant capsules (1) attached by a fixed arm (187) or retractable arm (193).

In a continued embodiment FIG. 128 is an illustration of an unfolded Drop Satchel (186), where the central post has been removed. For unobstructed deployment of the capsules the sides (188) of the Drop Satchel (186) can be folded back or removed. The central post with capsules attached can be removed from the Drop Satchel (186) in its entirety: exposing the capsules to the burning environment. The vertical sides (191) of the Drop Satchel (186) are connected to the base (192) as one contiguous piece of material on all four sides of the Drop Satchel's base; with one of the vertical sides (196) attached to the top (197) of the Drop Satchel (186). Each side can be closed, by using snap closures, Velcro attachment or zippers. As used here in this invention a Smart Fire Extinguishment Encasement Launcher shall mean but is not limited to, a portable, hand-held device, structure, system, means or similar definition, with the capacity to fire, project, propel, shoot, launch fire extinguishing devices discussed herein, and carried, used in a related manner as a firearm, rifle, pistol, flare gun, grenade launcher, rocket propelled grenade launcher, or comparable device.

As used here in this invention a Smart Fire Extinguishment Encasement Launcher shall also mean but is not limited to, a firing, firearm type device for launching, firing fire extinguishing devices.

As used here in this invention a Smart Fire Extinguishment Encasement Launcher shall further mean but is not limited to, a fire extinguishing device with a shell programming means, a computer programming means linking the shell programming means to the electronic contact strips lining the interior section of the barrel, a transmission or transducer means for transmitting the electronic programming signal to shells contained within the launcher's barrel prior to deployment.

As used here in this invention a flash prevent/suppressor shall mean but is not limited to a means, method, containment device or similar device that will prevent the muzzle flash associated with firing an incendiary from a firearm, from igniting or otherwise creating combustion of a flammable substance when a shell is projected from the Smart Fire Extinguishment Encasement Launcher by use of an incendiary means.

As used here in this invention a blank cartridge barrel shall mean but is not limited to that part of a device, means associated with a firearm, flare gun, grenade launcher or similar device from which a projectile, bullet, shell can be fired from.

As used here in this invention a microprocessor controlled trigger shall mean but is not limited to a touch sensitive device, pressure sensitive device, system, means or similar structure that is linked by a computer program to a microprocessor and shell programming means, arming means, that as a single operating unit can program, reprogram, deprogram shells contained within the launcher's barrel.

As used here in this invention, dual triggers shall mean a pressure sensitive electronic means to program fire extinguishing devices contained within the launcher, and a second means to fire the fire extinguishing devices from the launcher.

As used here in this invention a trigger guard shall mean a structure, means, device associated with the use of a firearm to prevent, reduce the opportunity of unintended, incidental, accidental discharge of a firearm, or as in this invention the unintended, incidental, accidental reprogramming programming, reprogramming of fire extinguishing devices within the launcher by a finger or other object striking either or both triggers.

As used herein, a, microprocessor or computer assisted laser, thermal, night vision or enhanced starlight or stargazer vision, techniques, or other suitable imaging systems, including computer programming to differentiate thermal patterns and to prevent “white out” associated with intense light shall means those systems, devices, means known to those who are skilled in the area of military and civilian imaging systems.

As used here in this invention a safety means shall mean a device, means, method, as used in the operation of a firearm, that when engaged will prevent accidental operation of the trigger used to fire, launch, shoot, propel the shell from the Smart Fire Extinguishment Encasement Launcher.

As used here in this invention, a breach of the Smart Fire Extinguishment Encasement Launcher shall mean a structure, means, device, construction of the launcher that will permit its operator to open, unseal, close, seal, operate so as to allow a shell to be placed within, placed into, dropped into, loaded into, loaded within, or similarly introduced to the interior of the launcher, the launcher's barrel for subsequent deployment.

As used here in this invention, a breach of the Smart Fire Extinguishment Encasement Launcher shall also mean a device similar to that of a firearm to enter a bullet, round, munitions into the chamber, barrel of a firearm

As used here in this invention a fire suppressant shell magazine of the Smart Fire Extinguishment Encasement Launcher shall mean an encasement, containment device, containment structure or similar definition with the same, similar uses as a munitions clip, bullet magazine, magazine clip of a firearm, but herein housing multiple shells that will be loaded into the carrel of the Smart Fire Extinguishment Encasement Launcher for electronic programming and subsequent deployment.

As used here in this invention a rear loading fire suppressant shell magazine of the Smart Fire Extinguishment Encasement Launcher shall mean a magazine housing multiple shells for loading into the launcher's barrel that is designed to fit to the posterior section of the launcher.

As used here in this invention an elliptical fire suppressant shell magazine of the Smart Fire Extinguishment Encasement Launcher shall mean a magazine housing multiple shells for loading into the launcher's barrel that is designed to fit to the posterior, midsection of the launcher.

As used here in this invention a circular clip, circular magazine fire suppressant shell magazine of the Smart Fire Extinguishment Encasement Launcher shall mean a magazine housing multiple shells for loading into the launcher's barrel that is designed to fit to the posterior, midsection of the launcher.

As used here in this invention an electronic monitoring display shall mean a device, means, system that is linked by computer program to the dual trigger system, the electronic programming means, the sighting systems, shell counter to provide the operator with a visual means to monitor all functions, operations of the Smart Fire Extinguishment Encasement Launcher.

As used herein, the connecting tube of the light weight fire extinguishing device carrying unit attaching to the Smart Fire Extinguishment Encasement Launcher shall mean a device, means, system, structure that can be temporarily, permanently attached to or in similar manner made a part of the launcher, that is utilized to pass shells contained within the carrying unit for loading to the launcher's barrel.

As used herein, the connecting tube of the light weight fire extinguishing device carrying unit attaching to the Smart Fire Extinguishment Encasement Launcher shall also mean a device, means, system, structure that can be pressurized, gas powered, mechanically powered, or by another suitable manner powered to move shells contained within the light weight fire extinguishing device carrying unit into the connecting tube, through the connecting tube, into the Smart Fire Extinguishment Encasement Launcher for loading into the latter's barrel.

As used here in this invention, direct feed from the connecting unit to the Smart Fire Extinguishment Encasement Launcher shall mean the means, method, system, structure utilizing the connecting unit of the fire extinguishing device carrying unit or similar means, attached directly to the launcher to permit passage of shells from the carrying unit directly to the launcher, to the launcher's barrel, or in combination thereof.

As used here in this invention, the Smart Fire Extinguishment Encasement Launcher magazine loader shall mean a device, means, system, structure with the capacity to receive a magazine clip, to receive shells for loading to the magazine clip, loading the magazine clip with shells for subsequent deployment by the launcher and/or similar device.

In an embodiment (See FIG. 94), as discussed above is a lateral and partially exploded view of the Personal Carrier's Launcher (161), with an exploded view of the Launcher's capsule programming module (174). The launcher's interior section (175) is lined with redundant electronic contact strips (176, see, FIG. 95), through which the programming signal is relayed to the microprocessor (86, 87) embedded in each capsule (1). The Launcher's electronic contact strips correspond with the electronic contact strips of the fire suppressant capsule's for the purpose of electronically re/programming a capsule contained within its barrel: where programming of capsules is effected through the use of both sources, i.e., electronic contact strips and electronic transmission to a capsule embedded receiver, for subsequent deployment of the capsule by the Launcher. Here, the transfer of the programming signal is physically performed between the electronic contract strips of the Launcher and the corresponding electronic contract strips of a fire suppressant capsule (1). However, where the re/programming signal is transmitted from the programming module of the Launcher to a receiver (467), transceiver (467) within the capsule (1) or other means of receiving a signal, then the electronic contract strips may not be necessary. From an operational viewpoint, a capsule can be designed with a combined electronic contract strip features and a receiver (467), transceiver (467) within the capsule (1) or other means of receiving a signal for programming, reprogramming, deprogramming purposes.

If the Launcher is gas powered, gas ports (177) for connecting an external compressed gas container or cartridge can be placed behind or in front of the pistol grip (226).

If the Launcher is not gas powered but relies upon conventional (incendiary) methods to propel the capsule the flash suppressor/preventer is intended to eliminate the risk of igniting inflammatory materials present in the immediate deployment environment.

When the breach of the drop loading section of the launcher (224) is opened and loaded a seal (228) closes the area between the drop load section of the barrel (243) and rear of the launcher to prevent a loss of pressure within the barrel when the capsule is ejected.

In another embodiment (See FIG. 95) is a cross-sectional view from FIG. 94, showing the interior of the Launcher's barrel (175) and its redundant electronic contact points (176) used to program each fire suppressant capsule (1).

The redundant electronic contact points (176) are intended to insure proper programming of each fire suppressant capsule (1) loaded into the Launcher (161). As illustrated in FIG. 94, the launcher's barrel (175) is shown with multiple electronic contact strips. The actual number and placement of electronic contact strips within the barrel will be determined by design parameters.

The Launcher (161) is equipped with a semi-enclosed flash suppressor/preventer (195) to prevent ignition of any flammable materials proximate to the Launcher (175) and the fire fighter, as a result of barrel flash.

In an continued embodiment FIG. 96 is a partial rear-view of the Fire Extinguishment Encasement Launcher (161), showing the programmable module (174) and gas canister port (177) and gas canister (178).

In still another embodiment FIG. 97 is an illustration of the projection pattern (179) of fire suppressant capsules (1) fired from the Launcher (161) of FIG. 94, into a forest fire zone.

In a further embodiment FIG. 98 is an illustration of the limited reach of a fire hose (181) when entering from the stairwell of a burning structure or high-rise building (105), contrasted to a fire fighter using the light weight, insulated, Personal Carrier system (160) loaded with programmable fire suppressant capsules (1), and fitted with a Smart Fire Extinguishment Encasement launcher (161). Here, the ability of a fire fighter to walk into a structural fire (11), projecting fire suppressant capsules (1) fired from the Launcher (161) of FIG. 94, overcoming limitations imposed by the reach of a fire hose, particularly within a high rise or deep structure. The use fire suppressant capsules (1) with smart chips allows for blind projection of capsules into a structure or tunnel, allowing the capsule to seek out the target area.

Continuing from the embodiment of FIG. 98, FIG. 99 illustrates what can be the limited reach of water (180) projected from a fire hose (181) by a fire fighter restricted to standing outside a burning structure (182). This illustration, along with FIG. 100, represents one of several limiting aspects faced by fire fighters using conventional methods to put down a fire.

Continuing from the embodiment of FIG. 98, FIG. 100 illustrates the arcing pattern (183) and limited reach of water (180) projected (182) from a fire hose (181) by fire fighters standing outside a burning two-story structure (64), and the use of a aerial fire hose (184) to reach a second or higher floor of a structure (64).

In further embodiments (See FIGS. 101, 102 and 103) are illustrations the trajectory pattern (185) of fire suppressant capsules (1) projected into a ground floor structure 65) and to the second floor (or higher) of a structure (64), by fire fighter using a Launcher (161) while standing outside the burning structure (182).

In still further embodiments (See FIGS. 104, 105 and 106) are illustrations the dispersal pattern (283) of fire suppressants (13) discharged from the capsules (1) projected into a structure (64/65) from the Launcher (161).

In another embodiment FIG. 107 is an illustration of a Launcher (474), as in FIG. 94, modified to accept a rear-loading fire suppressant capsule magazine (434). Here, a magazine (434) containing multiple, forward (barrel) facing fire suppressant capsules, is fitted to the posterior of the Launcher (475), and functions in the same manner as a bullet magazine fitted to a firearm. The magazine would feed a fire suppressant capsule into the launcher's chamber, when the launcher is activated. As a safety mechanism, if a fire suppressant capsule remains in the chamber of the Launcher after the launcher is deactivated a visual and audible sensor warns the user that the chamber is loaded. Part (b) of FIG. 107 illustrates a lateral view of the fire suppressant capsule magazine (434): detached from the Launcher.

This model of the Launcher is further modified, where the flex tube (172), anterior programming module and the anterior drop load door have been removed. In place of the anterior mounted programming keypad in FIG. 94, the pistol grip (395) contains a dual trigger mechanism (396, 397): the first trigger is microprocessor (401) controlled. The first or upper trigger is an electronic pressure sensitive button (403) that controls electronic re/programming of capsules and operation of the internal rapid high-pressure pump. The second or lower trigger (397), a conventional trigger, is used to propel the fire suppressant capsule from the launcher.

An electronic fire suppressant capsule counter (507) provides the user with a real time count of the capsules projected, in the magazine, and in the Personal carrier: displayed on a split screen monitor (see, FIG. 110).

Other embodiments FIGS. 108 and 109 illustrate a modification to the Personal Carrier of FIGS. 94 and 95, to accommodate use of the Fire Suppressant Capsule Magazine of FIG. 107. Here, instead of connecting the flex tube (172) to the rear or underside of the Launcher, as in FIG. 92, it would attach to a belt or side worn fire suppressant capsules magazine loader (436) Point 440 is the Fire Suppressant Capsule Magazine Loader's belt clip.

The Fire Suppressant Capsule Magazine (434) removed from the posterior section FIG. 107's would be placed face down (435) into the body of the capsule loader (434), and seated in the top of or open face (438) of the loading mechanism (437). Fire suppressant capsule's loaded (439) from the flex tube (172) of the Personal Carrier to the Capsule Magazine Loader (436) would then be mechanically loaded into the magazine. When needed, the user would pull the magazine from the loader, inserting it into the Launcher of FIG. 107.

Although the Personal Carrier can be modified to house fire suppressant capsules magazines, this may: increase the weight of the Carrier; decrease efficiency by having to reach backwards or to remove the Carrier so as to retrieve a magazine; and, the re-loader should reduce the weight associated with carrying a mass of magazines.

As used here in this invention, a shoulder-mount device for the launching, firing, shooting, propelling of fire extinguishing devices shall mean, a portable, shoulder supported device, structure, system, means with the capacity to fire, project, propel, shoot, launch fire extinguishing devices discussed herein, with two to four independent launch barrels, that can be carried, used in a related manner as a Smart Fire Extinguishment Encasement Launcher.

As used here in this invention, a shoulder-mount device for the launching, firing, shooting, propelling of fire extinguishing devices shall also mean a high-speed capsule launcher with two to four independent, adjustable launch barrels also capable of accommodating fire extinguishing devices that cannot be accommodated by the Smart Fire Extinguishment Encasement Launcher.

In an embodiment FIG. 110 is an illustration of a Shoulder-mount Multiple-tube High-speed Capsule Launcher (393), a multiple, reusable, re-loadable, short barrel system similar in design and function as FIGS. 94 and 95, comprising two-to-four barrels or launch tubes (394) and the same features as in FIGS. 94 and 95: except for the absence of the flex tube, the front or top drop loader and the fire suppressant capsule magazine.

The split screen laser sighting (407) that is side mounted, with a 220° arcing traverse tract (406) will allow the user to reposition the sight from one side of the launcher to the other: then, locked into position. This split screen system also serves as a display for the operator to actively monitor the microprocessor and all other functions of the Shoulder-mount Multiple-tube High-speed Capsule Launcher.

In addition to the anterior mounted (404) and posterior mounted (408) programming touch pad, or in place of the latter, the pistol grip (395) contains a dual trigger mechanism (396, 397) and the latter's microprocessor (401). The first trigger (396) is used to electronically re/program capsules via the barrel's redundant electronic contacts and to operate the internal rapid high-pressure pump. The second trigger (397) is used to propel the fire suppressant capsule from the launcher. Alternatively, sub-figure (b) illustrates the dual trigger system where an electronic button (403) performs the electronic re/programming and internal rapid high-pressure pump functions. The anterior mount programming keypad (see, sub-figure [c]) is a backup to the dual trigger mechanism. Point 402 is the trigger guard.

The Shoulder-mount High-speed Capsule Launcher can propel the same size fire suppressant capsule used by the Smart Fire Extinguishment Encasement Launcher FIGS. 94, 95 and 107, or accommodate a larger fire suppressant capsule by adjusting the barrel's interior.

A comparative view is the shoulder mount bazooka or rocket launcher used by the U.S. Military. A comparative view is the shoulder-mount multiple-rocket launcher used by the United States Military.

As used here in this invention a Stationary Anchored Fire Suppressant Capsule Launcher shall mean a freestanding, upright, pedestaled single, multi barreled launcher system, with a fire extinguishing device containment unit, programmable means, that can be temporarily secured to the ground or other surface area, with the capacity to lift fire extinguishing devices that cannot be accommodated by the High-speed High-speed Capsule Launchers, Shoulder-mount High-speed Capsule Launchers.

As used here in this invention a rotating arm, rotating flywheels shall mean an attached pair of arms extending from the upright vertical column of the Stationary Anchored Fire Suppressant Capsule Launcher, fitted with a securing face plate for attachment of fire extinguishing devices that cannot be accommodated by the High-speed High-speed Capsule Launchers, Shoulder-mount High-speed Capsule Launchers.

As used here in this invention a securing face plate shall mean a device positioned at the most distal point of the rotating arms for the purpose of attaching fire extinguishing devices that cannot be accommodated by the High-speed High-speed Capsule Launchers, Shoulder-mount High-speed Capsule Launchers, with an electronic contact surface means to permit electronic programming of attached devices.

In an embodiment FIG. 111 is an upright, vertical, lightweight pillar with a rotating arm (367), and a microprocessor controlled capsule firing mechanism (388) that forms the Stationary Anchored Fire Suppressant Capsule Launcher (364). The intended purpose of the Stationary Anchored Fire Suppressant Capsule Launcher is to lift into firing position fire suppressant capsules/canisters that are too large for use by hand, shoulder mount or other launchers, that will be projected from a ground position into (or above) a fire zone, such as a major forest fire.

The Stationary Anchored Fire Suppressant Capsule Launcher (364) comprising a vertical stanchion (420) affixed to a square base (379). Two, round, clockwise/counterclockwise, rotating flywheels (366) are vertically mounted to the sides of the stanchion, that in turn support two equally positioned arms (367) that extend outward and away from the flywheel and the stanchion. These arms are then connected at their distal end to form a unitary structure and can be pivoted from the ground, upward, in a 160° vertical arc.

The base of the stanchion comprising four independent tubes (380) that each house one fourteen inch long steel spike (381); fitted to the posterior of a plunger (384) or driver type cylinder that fits tightly within the tube to form an airtight seal when depressed (into the tube); an optional impact hammer (389) capable of driving the spike twelve inches into the ground or through a concrete/tarmac surface (386), so as to anchor the Stationary Anchored Fire Suppressant Capsule Launcher for use. Alternatively, the stanchion can be fitted with a high-pressure pump (372), attached by a braided tube (373) to an air intake valve (416) at each of the four independent airtight pressure tubes that surround the spikes, which also comprises a automatic pressure relief valve (383) and an air release valve (419). This is an alternative to the use of an impact hammer to drive the spikes (381) into the ground or concrete/tarmac surface (386).

The anterior of each spike is fitted with a lip (384) that will prevent the spike from being driven into the ground more than twelve inches. Each spike is surrounded by a high-tension collapsible spring (382) that attaches to the posterior of the cylinder to aid in retraction of the spike when the air pressure valve (419) is relieved. When the high-pressure pump is used to drive the spikes, a retention latch (387) within the tube locks the (now compressed) collapsible spring (382) in place. To release the spike, the pressure valve (419) is opened to release air from the tube; the spring retention latch (387) is released, allowing the compressed spring to push upward, lifting the spike.

The interior of the stanchion comprising an internal air tight (376) chamber (375) housing a push rod (371) that when pressurized, forces the twenty (20″) inch push rod (371) downward against the ground, causing the stanchion to lift and the spikes (381) to break free from the ground/tarmac (386). To distribute the load exerted by the push rod (371) the latter has its own pedestal base (377). The chamber is fitted with an automatic pressure relief valve (369) as a safety feature. Once the stanchion is lifted from its anchored position and the four spikes retract into their containment tubes, by releasing the chamber's pressure release valve (374) the chamber can then retract into the stanchion and the Stationary Anchored Fire Suppressant Capsule Launcher can be moved.

The pivoting arm or flywheel (366), which acts as a fulcrum, is rotated downward so that its face plate (368) is aligned with the face plate of the fire suppressant capsule/canister, and secured by fastening both face plates together or by pressure sealing the two. Rotating the pivoting arm upward with the fire suppressant capsule/canister attached, the trajectory can then be set through use of the Stationary Anchored Fire Suppressant Capsule Launcher's electronic keypad (electronic programming module and targeting system) (365), or by its microprocessor working in conjunction with the side or internal mounted laser sighting system/thermal imaging system/optical sighting system (370), as at FIG. 84. In another embodiment FIG. 112 further illustrates the retractable anchoring mechanism of FIG. 111, where the steel spikes (381) have been driven through the ground (386). Here, once the spike (381) is compressed to its fullest extent (390) the high-tension collapsible spring (382) is locked into place by the retention latch (387).

In still another embodiment FIG. 113 illustrates the use of the push rod (371) to free the Stationary Anchored Fire Suppressant Capsule Launcher (364) from its anchored position. Here, air from the high-pressure pump (372) that is attached by a braided tube (373) to an air intake valve within the stanchion (420) forces the push rod (371) downward (392), through the interior of the of the air tight chamber (375) and against the anchored surface (386). The push rod's pedestal base (377) supports the weight of the Stationary Anchored Fire Suppressant Capsule Launcher (364) forcing the latter upward, while breaking the hold of the spikes. Simultaneous to filling the airtight chamber (375) the system's microprocessor (388) releases the high-tension collapsible spring (382) that surrounds each spike (381) and the air contained within each of the four independent tubes (380). When the Stationary Anchored Fire Suppressant Capsule Launcher (364) is lifted from its anchored position, the chamber's pressure release valve (374) is opened and the push rod (371) retracts into its airtight chamber (375).

As used here in this invention a Vehicle Mounted Multi-tube Fire Suppressant Capsule Launcher shall mean a vehicle-based fire extinguishing device launcher.

As used here in this invention a Vehicle Mounted Multi-tube Fire Suppressant Capsule Launcher shall also mean device with a fire extinguishing device containment system capable of holding, shuttling fire extinguishing devices on a controlled roller system to the device launcher.

As used here in this invention a Vehicle Mounted Multi-tube Fire Suppressant Capsule Launcher shall further mean a device with a means to electronically program, enter, load, introduce fire extinguishing devices from the containment device to the launching device for subsequent deployment to the fire environment.

In two embodiments FIG. 114 and FIG. 115 illustrate a rotating, Vehicle Mounted Multi-tube Fire Suppressant Capsule Launcher (446).

Here, this launcher (446) is mounted atop a bifurcated pedestal (447, 448) that is connected by a mechanical or motorized swivel (449). This mechanical or motorized swivel (449) connects the two halves and can rotate the launcher 360° horizontally.

The base (450) of the bottom half of the pedestal (448) is secured to the vehicle. The upper half of the pedestal (447) contains two synchronized pneumatic power rollers (451) capable of tilting and holding the launcher in position, on its horizontal axis, and an optional motorized pedestal seat (452, 453) for use by the operator of the launcher. The seat can be removed, or recessed alongside, or into the upper half of the pedestal base or replaced by an elevated pedestal housed within or alongside the bottom half of the pedestal base.

The launcher has four primary sections:
1. The electronic control housing (454), including microprocessor or computer assisted laser, thermal, night vision or enhanced starlight or stargazer vision, or other suitable imaging systems, including computer programming to differentiate thermal patterns and to prevent “white out” associated with intense light; capsule arming/programming and fire control mechanism, recessed programming keypad (455), capsule counter, microprocessor, split screen monitor (456), and a remote operations electronic package;
2. Multiple, independent, vertical fire suppressant capsule containment racks that holds numerous fire suppressant capsules (457), with a recessed, free floating roller system and roller brake system;
3. The horizontal (458) or vertical (459) fire suppressant capsule loader; and,
4. The launcher tubes (460).

Here, the first (or last) vertical rack (457) is lowered into and seated within the horizontal loading track, where fire suppressant capsules can be lowered from the rack into the launcher's fire suppressant capsule loader mechanism. In turn, the fire suppressant capsule loader mechanism can electronically re/program each fire suppressant capsule, then load same into a into a capsule launcher tube. If tube loading is set on automatic, the launcher's fire suppressant capsule loading mechanism will alternately reload the first empty launch tube available. This process will continue unless terminated by the operator. When a vertical rack is expended, the horizontal fire suppressant capsule loader (458) mechanically raises the emptied vertical rack upward and seats the next vertical rack to continue with the process: unless terminated or the entire fire suppressant capsule load is expended.

Each rack can be set in place and removed from the side or (as an option) from the top of the rack containment area.

The Launcher (460) comprising two-to-four or more independent stationary barrels or tubes (460, 461).

In an embodiment FIG. 115 illustrates the same system at FIG. 114, but with a dual level launcher (barrel) housing (460, 461): subparts (b) and (c), illustrate a two- and four-barrel configurations (462, 463). The actual number of launcher barrels, and barrel placement (i.e., lateral and/or stacked) within each level, will be determined by design protocols and is shown here for illustrative purposes, not as a limitation.

In another embodiment FIG. 116 is a partially exploded view of the FIG. 114's and 115's Launcher platform.

In a continued embodiment FIG. 117 illustrates three additional options for the loading of fire suppressant capsules to FIGS. 114 and 115.
1. Instead of capsules dropping into the horizontal fire suppressant capsule loader, a vertical rack is moved forward into an upright or vertical loader that is contiguous to the launcher assembly. Upon expending the last fire suppressant capsule from the vertical rack the latter is lifted out of and away from the launcher assembly by a mechanical arm and the remaining vertical racks are moved forward; the expended vertical rack is moved to and placed at the rear of the vertical rack assembly and the process continues; or,
2. A series of telescoping push rods (467) housed at the posterior section of the vertical rack assembly will push the capsules forward, into the an upright loader that is contiguous to the launcher assembly; or,
3. When the vertical racks are loaded into the launcher's rack assembly, horizontal leveling tracks (463) at the base of the rack assembly (464) align the vertical racks to one another and the loader assembly (459). Each level (465) within the vertical rack contains an assembly (469) of miniature rollers (466) that when activated will move a row of fire suppressant capsules forward, into the loader assembly (459).

In still another embodiment FIG. 118 illustrates a third representation of FIGS. 114 and 115. Here, however, the multiple, independent, vertical fire suppressant capsule containment racks have been replaced with horizontal fire suppressant capsule containment racks or tubes (470); the interior of which contain the miniature roller assembly of FIG. 117. This design can use the dual level launcher (barrel) housing cited at FIG. 114 and FIG. 115; the upright or vertical capsule loader assembly (459), and the horizontal leveling tract assembly (458).

In a further embodiment FIG. 119 illustrates FIG. 118 with a single rotating launcher assembly (471), resembling the operational function of a Gatling Gun, Machine Gun (471), or Phalanx Gun (473), or similar system.

Continuing from the previous embodiment FIG. 120 illustrates FIG. 118 with a moveable single or dual level launcher housing (460, 461). The moveable launcher housing assembly (472) is moved vertically along a track aligned with the capsule loader (459).

As used here in this invention a vehicle enclosed, vessel enclosed fire extinguishing device containment unit shall mean a fire extinguishing device containment unit containment unit with the capacity to hold multiple fire extinguishing devices, further comprising a moveable rail system with semi-recessed free floating rollers, a mechanical drive to move the semi-recessed free floating rollers, a brake system to control the speed and movement of each track of free floating rollers, safety control systems to assure safe operation of the system.

In two embodiments FIGS. 121 and 122 illustrate a rear view of a horizontal and tubular rack system (487) adapted for use in modified fire fighting, military, utility or other suitably modified vehicles that may or may not incorporate the use of capsule launchers though utilized for housing and transporting purposes, fire suppressant capsules for use in place of or in conjunction with standard fire suppressant mediums. The discussion here will only reflect the application of containment systems and the fire suppressant capsule loading mechanism where the use of capsule launchers is incorporated.

If a permanent or temporary containment rack system is used then, the use of recessed rollers, motorized motor track, winch and similar systems mentioned above, may be unnecessary. However, in place of same, external capsule loading and offloading system (or doors) will be necessary to fill the containment system as required.

The methods of containment and launcher loading expressed in FIGS. 121, 122, 123 and 124 may also be applied to FIGS. 129 through and including FIG. 141.

In an embodiment FIG. 121, Point 485 represents the interior (containment area) of the modified vehicle that will house the suppressant capsule containment rack system (441) comprising multiple containment racks (486). The interior of the vehicle's containment area (484) should be shielded to prevent extraneous signal interference with the capsules' electronic programming and insulated (see, FIGS. 93, 129 and 131). Partially recessed motorized tracks or rollers contained at the top and base of the containment area (442, 443) assist to load the containment rack (441) into the vehicle, as well as the rack's mechanical rollers (445). The motorized drive assembly of the vehicle's partially recessed tracks can be disengaged, allowing manual movement of the racks. As at FIG. 118, levelizing tracks inside the containment area align the horizontal racks with the capsule loading mechanism: the latter being located at the front of the containment section (see, FIG. 123). As at FIG. 118, levelizing tracks inside the containment area align the containment racks with the capsule loading mechanism. Here, as in FIGS. 117 and 118, the horizontal fire suppressant capsule containment racks (486) contain a free floating roller assembly (444) (see also, FIG. 117) and braking system, and are adjustable to accommodate different fire suppressant capsules. Each rack contains its own electronic capsule counter, as does the capsule loading mechanism.

The containment rack's roller assembly and capsule loading mechanism discussed at FIGS. 117(3) and 118 are applied here as well.

In another embodiment FIG. 122 illustrates a tubular fire suppressant capsule containment rack system (441, 487) that contains the same elements of FIG. 121. As an option, each tube (487) can be individually replaced.

In still another embodiment FIG. 123 illustrates a cross sectional view of the vehicle containment area to provide a loading view of the fire suppressant capsule containment rack system (441). Here, in addition to or as an alternative to the partially recessed motorized tracks or rollers (498) mentioned at FIG. 121 to assist with containment rack assembly (441) loading into the vehicle, one or more winches placed at the anterior of the containment area (489), with attaching lines (496) secured to the rack (490, 441), can be used to achieve the same purpose. For illustrative purposes only, the rear of the vehicle (495) has been modified to fold downward (494), serving as a ramp or caribou to facilitate loading the containment rack (441) to the interior (497) of the vehicle. Once loaded into the containment area (497) the containment rack assembly (441) is brought forward (493) to the vertical capsule loading system (492) and aligned (500) with the capsule loader. Levelizing tracts (499) recessed into the base of the vehicle (501) stabilize and assist to align the rack assembly (441) with the capsule loader (492).

In a continued embodiment FIG. 124 illustrates a cross sectional view, where the fire suppressant capsule containment rack system (441) is loaded into the vehicle and aligned (503) with the fire suppressant capsule loader (492). This illustration is limited to showing one horizontal capsule rack (486), with its roller assembly 444) and fire suppressant capsule load (505, 1, et al.). In this design the fire suppressant capsule loader (492) moves vertically from one containment rack (486), where the capsules a later brought into contact with the electronic programming module (505) and capsule counter (504) prior to being loaded to the capsule launcher.

As used here in this invention a Sikorsky S-64 shall mean a Sikorsky Aircraft Corporation S-64 model helicopter modified for fire fighting purposes.

As used herein, insulating ceramic tiles shall mean the ceramic tiles utilized to shield the Space Shuttle fleet of aircraft from the extreme temperatures associated with reentering the earth's atmosphere.

As used here in this a built out hull of the Sikorsky S-64 shall mean to extend outwardly the fuselage, the central part of an aircraft that contains passengers or cargo.

As used here in this compartmentalization of the hull's interior shall mean to physically subdivide the fuselage of the aircraft into two or more discrete compartments.

As used herein, drops doors shall mean independently operable doors positioned to the underside of the fuselage, that when opened will allow fire extinguishing devices to be released from the aircraft.

As used herein, a permanent or temporary suppressant device containment racks shall means vehicle enclosed, vessel enclosed fire extinguishing containment device fitted for use in an aircraft.

As used herein, a non-load bearing partial outer hull or secondary skin fitted to or recessed into the fuselage shall mean a partial, false hull, situated to the exterior of the aircraft's fuselage, that when extended outward from the aircraft's hull creates a channel through which air is funneled through and away from the aircraft.

As used herein, a non-load bearing partial outer hull or secondary skin fitted to or recessed into the fuselage shall mean a partial, false hull, situated to the exterior of the aircraft's fuselage, that when retracted will fold again, into the aircraft's fuselage.

In an embodiment FIG. 129 is a illustrates a lateral view of a Sikorsky S-64's hull, built out (279) and adapted to deliver suppressant capsules and canisters in place of water, foam, and loose pack fire suppressants. The build out (279) includes the placement of capsule/canister drop doors (253); side 270° (254), forward 360° (255) and underside mounted 540° rotating fire suppressant capsule launchers with an integrated cooling system and flash suppressor/preventer; shielded by insulating ceramic tiles (257) similar to or the same as those used for the shuttle aircraft. It should be equipped with thermal and infrared imaging, night vision cameras, starlight or stargazer systems and monitors, computer programming to differentiate thermal patterns and to prevent “white out” associated with intense light, and lasers to target and track capsule trajectory.

In another embodiment FIG. 130 is a frontal view of FIG. 129, showing compartmentalization of the hull's interior (258). Compartment 258-c can be opened into compartment 258-b; compartment 258-b can be opened into compartment-a; and, compartment 258-a opens to the outer environment. Each compartment must be insulated to prevent the intense heat of the environment from damaging the interior of the hull or compromising its fire suppressant load.

As an alternative to the hull's compartmentalization and use of drop doors, the hull can be fitted with FIGS. 121's-124's permanent or temporary suppressant capsule containment racks.

In an embodiment FIG. 131 is a schematic drawing of non-load bearing partial outer hull or secondary skin (259) fitted to or recessed into the fuselage (260) of a helicopter or an unmanned aerial fire drone, to reduce the impact of thermal updrafts created by intense fires. The intent here is to channel away from and around the helicopter/aerial drone the high altitude winds and thermal updrafts (271) associated with combating high-rise and forest fires.

The outer hull (259) should be recessed into the hull (272) of the helicopter/aerial drone, providing a normal, flat surface profile during normal flight operations.

When recessed, the baffles (273) lining the outer hull, the interior of the outer hull (274), and the exterior of the helicopter/aerial drone's hull (275), and the retractable, downward extending baffles or planes (276) occupying the underside of the fuselage (277), all of which are mechanically controlled, retract into the skin of the hull (272), again providing a normal, flat surface profile during normal flight operations. An analogy here is the operation of a sea anchor or “birds” deployed to stabilize a boat during operations upon rough waters or high seas.

The underside baffles (276) can be extended and retracted vertically or in the same manner as retractable landing gear of a plane.

The baffles (273) lining the outer hull (259), the interior of the outer hull (274), and the exterior of the helicopter/aerial drone's hull (275) can be:
A. Extended and retracted similar to that of the underside baffles (276); or,
B. Extended and retracted in vertical or horizontal manner; or,
C. Opened in the same manner as a door or bi-door panel by attaching several baffles to a motorized retaining rod that will open each baffle in the.

By channeling thermal updrafts and high winds away from the body of the aircraft, its engines and rotors, and combining same with the use of insulated ceramic tiles (207) to reduce or eliminate the impact of intense heat that would otherwise cause fatigue and affect pilots and instruments, aerial vehicles used to combat such fires should be able to operate closer to or within a fire zone itself.

In a continued embodiment FIG. 132 is a cross-sectional view of FIG. 131, showing air as it is baffled through an opening in the outer hull (278), and channeled by the baffles (275) lining the interior of the outer hull (274): around and away from the hull and fuselage of the helicopter/aerial fire drone, reducing buffeting and allowing for increased stabilization of the vehicle.

As used herein, an unmanned aerial fire suppression drone shall mean, a pilotless, unmanned, remote controlled or software controlled aerial vehicle, that can operate at low altitudes, at or above tree top level, nap of the earth flight formation, at or above the height of a fire, within a fire's vertical column, within a fire; and, that is fitted with ceramic insulating tile, such as or similar to the insulated ceramic tiles applied to the external surface of the space shuttle or similar material capable of withstanding sustained extreme heat of at least 3,000⁺° F. for a minimum of 24 hours of continuous operation.

This shall also mean an aerial vehicle comprising an avionics package associated with unmanned aerial vehicles, encasement programming means, with a capacity to contain and discharge powder, granular, liquid or gaseous fire extinguishment materials, Smart Fire Extinguishment Encasements and Standard Launcher Discharged Fire Extinguishment Encasements.

The unmanned aerial fire suppression drone shall further mean an aerial vehicle with a propulsion means with the capacity to switch between operating with external air intakes and the use of internally stored compressed air or oxygen, or other fuel sources.

As used here in this invention, the drone is fitted with thermal and infrared imaging systems will make it possible to determine the position and height of a firewall, the thermocline of a fire, to identify areas that are approaching flashpoint, to detect the presence and position of life in or near to the fire zone to prevent further risk of injury, loss of life, and any potential injury resulting from a direct strike of a fire suppressant capsule projected into the site.

As also used here in this invention, the drone is equipped with infra-red, thermal, night vision or a stargazer system with computer programming to differentiate thermal patterns and to prevent white out, for operations in heavy smoke, low light/night, intense heat and from within the fire situation itself, with direct or real-time transmission to its remote base; is fitted with one or more rotating launchers and launcher loading mechanisms; is fitted with sensors to detect the presence and size of falling debris and its proximity to the drone.

As used herein, an electrical bus shall mean a means, collection of electric wires, conduits used to collect, carry, distribute electrical current, impulses from one device to another.

As used herein, a docking collar shall mean, a means, structure, device deployed for the purpose of attaching a pod to an Aerial Fire Suppression Drone, an aircraft modified for fire fighting purposes.

As used here this invention a Pod shall mean, a means, vehicle, vessel, fitted with fire extinguishing containment units, launchers, multiple fire extinguishing, to be connected to an Aerial Fire Suppression Drone via a docking collar, electrical bus.

In an embodiment FIG. 133 illustrates the intent to develop an Aerial Fire Suppression Drone (325), i.e., a low altitude, unmanned, remote controlled/computer guided aerial vehicle that can deliver a large payload of fire suppressant capsules/canisters to the exterior of a high rise, off shore structure, and to operate within grassland, forest fire and similar fire situations.

Here, the Aerial Fire Suppression Drone is shown as compartmentalized (326, 327 and 328) with its landing gear (332) retracted. Drop doors to the underside of the Aerial Fire Suppression Drone (329) can release individual fire suppressant capsules or a load of fire suppressant canisters. As first noted at FIG. 129, the Aerial Fire Suppression Drone is also fitted with multiple independent rotating capsule launchers (338, 339, 340 and 341) with an integrated cooling system and flash suppressor/preventer, to direct fire suppressant capsules with greater precision. The firing mechanism for the launchers can be computer aided, or preprogrammed, electronically overridden for manual remote operations, and the communications antennae (330) can be positioned above and/or below the Aerial Fire Suppression Drone. Insulating ceramic tiles (356) are applied to the entire fuselage, the retractable wheel wells, and to the nose cone area (333) that contains the Aerial Fire Suppression Drone's avionic and other electrical packages. Point (362) is a cross sectional illustration of the Aerial Fire Suppression Drone's receiving receptacle for connecting the Pod's electrical bus (to be discussed at FIGS. 134 and 136): the receiving receptacle (362) is recessed into the underside of the Aerial Fire Suppression Drone. The external ram air propulsion intake (334) to provide air to the engine is housed within the rudder assembly (335) that stabilizes the Aerial Fire Suppression Drone while in flight. The wings (336) can be a fixed or variable positioning assembly. This particular illustration does not contain the docking collar cited at FIGS. 134, 135, 136, 137, 138 and 140.

When using programmable fire suppressant capsules and capsules with heat seeking smart chip technology (see, FIG. 82, et al), each capsule contains an individual electronic identification number for programming and counter purposes. The Aerial Fire Suppression Drone contains an internal counter that tracks each capsule loaded into the Aerial Fire Suppression Drone; monitors the load at all times and the number of, specific capsule/canister, and the specific capsule/canister type released through the launcher/drop door. Capsules loaded to the rotating launchers can be hopper fed to the launcher's loading breach or sequentially tethered for belt driven loading to the launchers.

Current applications of military predator drones allow remote access to a given area, as well as the capacity to hover and for reverse flight operations. By developing a drone for civil applications that can fly low, into, or immediately over a fire zone, at low speeds, with a low turning radius or even the knap of the fire's surface, fire jumpers and fire fighters will gain greater control over major fires. As well, drones have a better profile for forest fire operations, significantly less prop wash than what can be expected from helicopter rotors, jet and turboprop engines.

The Aerial Fire Suppression Drone is intended to safely bring the fight directly to and closer to the fire, with greater impact. When combating a major forest fire a fire fighter or fire jumper is limited in his or her ability to propel a steady stream of water or other fire suppressant materials to a fire raging several hundred feet overhead or enter a fire situation because of the intensity of the fire and heat. The impact of water dropped overhead by airplanes and helicopters employed for aerial combat of fires can be attenuated as a result of evaporation caused by intense heat, wind speeds, thermal updrafts, etc. Where the fires' vertical column reaches e.g., 100′ or more, making it difficult to handle by the amount of water that can be delivered at one time by e.g., a Sikorsky S-64 helicopter such as the Erickson Air Crane, the Aerial Fire Suppression Drone should prove superior in its ability to deliver a payload of fire suppressant capsules directly to or within the fire zone itself. The Aerial Fire Suppression Drone should significantly reduce pilot error resulting from fatigue and extreme heat and reduces the risk to human life—e.g., pilots having to operate close to the zone as permitted by the limitation of the aircraft currently used.

The power plant can be fueled by aviation fuel, hydrogen or compressed natural gas. Here, the use of hydrogen or compressed natural gas will be the choice and the point from which the following descriptions and discussion will follow.

The power plant of the Aerial Fire Suppression Drone should consist of three possible operating modes:
1. The standard engine operations where the Aerial Fire Suppression Drone utilizes ram propulsion to force-feed a high volume of air to the engine.
2. In response to the sensors detecting compromising levels of particulate mater, the microprocessor close off the external ram and feed air to the engine in one of two methods:
A. Simultaneously feeding air to the engine onboard tanks holding a compressed mixture of hydrogen and air or compressed natural gas and air; or,
B. Using a high speed, high volume air filtration system capable of removing particulate matter while internally feeding sufficient quantities of air to the engine from within the Aerial Fire Suppression Drone's fuselage.

The Aerial Fire Suppression Drone should be fitted with onboard sensors that continually monitor the amount of particulate matter (e.g., soot) in its flight path, as it approaches (and later exits from) the fire zone.

During operations outside of but on approach to the fire zone the engine can rely upon standard ram propulsion of air through its external port (334) to feed the fuel/air mixture required for combustion or the high volume air filtration system. When sensors detect that the level of particulate matter on approach to the fire zone is nearing stage that will compromise safe operations of the engine, the onboard computer or microprocessor begins to feed compressed air from its tanks to the engine, while closing off the external port of the ram. At this point the Aerial Fire Suppression Drone operates on its secondary system: i.e., the amount of air required for a proper fuel burn is internally supplied from highly compressed air cells or air bladders within the fuselage. When the Aerial Fire Suppression Drone exits the fire zone and enters an air space sufficient to safely operate under external ram propulsion, the Aerial Fire Suppression Drone can continue to function on its internal drive system or return to the use of ram propulsion.

As an alternative, the Aerial Fire Suppression Drone can be designed to operate using its internal high volume air filtration system at all times. Here, the hydrogen or compressed natural gas powered Aerial Fire Suppression Drone used for in close operations is not affected by small particulate matter and soot associated with fires that will otherwise clog the engines and air intake filters.

Alternatively, by using a high speed, high volume air filtration system capable of withstanding the force exerted by the air intake pumps acting as a surrogate ram air intake, while clearing airborne particulate matter/soot without clogging or otherwise compromising the flow of air required for optimum engine operations, and able to remove particulate matter while internally feeding sufficient quantities of air to the engine during the entire period of operation, eliminating the need to switch operating modes.

The exterior of the power plant, i.e., areas that are exposed to the fire environment, should be shielded by insulated ceramic tiles, aluminate or other substances capable of withstanding, dissipating or transferring extreme heat over prolonged periods. The insulated ceramic tiles applied to the space shuttle are suitably rated for this purpose. The lines, fuel lines, internal pars, etc., should be constructed or a material that will withstand extreme internal operating temperatures, and the external environment.

As first noted above at FIG. 129, for the deployment of modified helicopters and aerial tankers, the proposed Aerial Fire Suppression Drone model rivals its counterpart in several areas, as follows:
1. By shielding the exterior of the Aerial Fire Suppression Drone with heat resistant ceramic tiles, as used for the space shuttle, the Aerial Fire Suppression Drone can be flown directly into grassland or forest fire situation for direct deployment of fire suppressant capsules.
2. By fitting the Aerial Fire Suppression Drone with thermal and infrared imaging systems will make it possible to determine the position and height of a firewall, the thermocline of a fire, and identify areas that are approaching flashpoint. With this information the Aerial Fire Suppression Drone's onboard targeting computer (system) can re/program its capsule load en masse through a transducer(s) within its capsule containment area, or at the launcher's loading breach. As a reference point, see the discussion for the High-speed Hand-held fire suppressant capsule launcher (161) beginning at FIG. 94. Application of the transducer for re/programming purposes is first discussed at FIG. 92.
3. Fire suppressant capsules (1) loaded into the Aerial Fire Suppression Drone can be programmed prior to loading, programmed subsequent to loading, or re/programmed after loading.
4. Equipped with infrared, thermal, night vision or stargazer system with computer programming to differentiate thermal patterns and to prevent “white out” associated with intense light, for operations in heavy smoke, low light/night, intense heat and from within the fire situation itself, with direct or real-time transmission to its remote base. Sensitivity should be sufficient to determine the distance of the Aerial Fire Suppression Drone is from the hot spot and other target points, for laser targeting of fire suppressant capsules.
5. Equipped with infrared, thermal and night vision systems with computer programming to differentiate thermal patterns and to prevent “white out” associated with intense light, to detect the presence and position of life in or near to the fire zone to prevent further risk of injury, loss of life, and any potential injury resulting from a direct strike of a fire suppressant capsule projected into the site.
6. Fitted with one or more rotating launchers, the Aerial Fire Suppression Drone can propel capsules directly, fore, aft, above and below, and/or pinpoint fire suppressant delivery. Comparatively, current methods rely on flyovers and drops.
7. Fitted with sensors to detect the presence and size of falling debris and its proximity to the Aerial Fire Suppression Drone. Combined with an onboard computer system, the best path of avoidance or escape is plotted and taken.
8. The interior of the Aerial Fire Suppression Drone is insulated and shielded to reduce or prevent heat damage and interference from extraneous electronic signals. To prevent premature fire suppression capsule ignition, the number of heat-activated capsules deployed by the Aerial Fire Suppression Drone should be kept to a minimum or eliminated entirely. The rotating launchers should be cooled to prevent jamming and backwashing of heat from the external environment.
9. Reduced impact of fatigue or the impact of extreme heat upon the human element, through the use of a remote controlled system.
10. As well, consideration may be given to develop an Aerial Fire Suppression Drone capable of serving as a rescue vehicle for operations within intense heat zones that would make the operation of current vehicles such as helicopters impractical or untenable.

As an alternative to the Aerial Fire Suppression Drone compartmentalization and use of drop doors, the interior can be fitted with FIGS. 121's-124's permanent or temporary suppressant capsule containment racks.

For extended operations the Aerial Fire Suppression Drone can be fitted to a detachable Pod (337), via docking collars (see, 335 and 336, FIG. 134), carrying a higher volume of fire suppressant capsules or canisters. See, FIG. 134. When a docking collar is attached to an Aerial Fire Suppression Drone, the collar circumnavigates the drop doors. When attached to the Pod (FIGS. 136, 137, 138 and 139) the Aerial Fire Suppression Drone's drop doors are closed and inoperable.

In another embodiment FIG. 134 illustrates the detachable Pod (337), a bulbous, bulk, fire suppressant capsule containment structure that can be attached to the underside of the Aerial Fire Suppression Drone (325) via a docking collar (335 and 336), with the Aerial Fire Suppression Drone serving as the lift and control vehicle. The electronic package of the Pod, i.e., its front (338), rear, side (339) and underside (340) mounted fire suppressant capsule launchers with an integrated cooling system and flash suppressor/preventer, capsule loaders, braking system, steering system, and its drop doors (341), are controlled by the Aerial Fire Suppression Drone via an attached electrical bus (342) that extends from the Pod (343) to the Aerial Fire Suppression Drone: while the Aerial Fire Suppression Drone and the Pod are attached. The Pod is equipped with its own set of compartments (349, 350, 351 and 352) and drop doors (353 and 354). Compartments 1 and 2 (349 and 350) can drop their fire suppressant capsule load into compartment 3 (351). Compartment 3 (351) can drop its fire suppressant capsule load into compartment 4 (352). The exterior of the Pod, and the interior and exterior of the wheel wells (355) for its retractable landing gear (358) are shielded by insulated ceramic tiles (356). When the Pod (337) is attached to the Aerial Fire Suppression Drone (325), skirts (361) from the Pod can be raised and locked into the underside of the Aerial Fire Suppression Drone to create one continuous Aerial Fire Suppression Drone/Pod profile. Here, the landing gear and wheel assembly (362) is fully extended. When airborne, the landing gear and wheel assembly is retracted (363).

As an alternative to the Pod's compartmentalization and use of drop doors, the interior of the Pod can be fitted with FIGS. 121's-124's permanent or temporary suppressant capsule containment racks.

The interior of the Pod is insulated and shielded to prevent heat damage and interference from extraneous electronic signals. To prevent premature fire suppression capsule ignition, the number of heat-activated capsules deployed by the Pod should be kept to a minimum or eliminated entirely.

The Aerial Fire Suppression Drone contains an internal counter that tracks each capsule within the Pod; monitors the load at all times: and, release of capsules from the launcher/drop door, into the fire zone. Capsules loaded to the rotating launchers are hopper fed to the launcher's loading breach and its drop doors, or the capsules can be sequentially tethered for belt driven loading to the launchers. As an alternative to the use of drop doors the Pod can be fitted with a series of strategically placed drop cylinder gateways.

With the Aerial Fire Suppression Drone's capacity for pinpoint targeting of capsules fired from its rotating launchers, it also controls the Pod's launchers. Transducers within the Pod (359) will allow the Aerial Fire Suppression Drone to re/program its fire suppressant capsule load as it enters the launcher or the launcher's loading breach. As a reference point, see the discussion for the High-speed Hand-held fire suppressant capsule launcher, beginning at FIG. 94. Application of the transducer for re/programming purposes is the same as discussed first at FIG. 92, pertaining to the Personal Carrier (160).

Attaching the Aerial Fire Suppression Drone to a Pod can be facilitated by use of a mobile gantry or sling. During landing the Pod (337) can be electronically released from the Aerial Fire Suppression Drone upon touch down, with the Aerial Fire Suppression Drone continuing its flight or landing separately; or, the Pods and the Aerial Fire Suppression Drone can be landed as one unit. If the Pod is released from the Aerial Fire Suppression Drone during landing but prior to the Aerial Fire Suppression Drone coming to a full stop, the Pod's electric bus (342) that is attached to the Aerial Fire Suppression Drone separates from the Aerial Fire Suppression Drone, permitting remote control of the Pod's steering and braking systems.

In still another embodiment FIG. 135 is a lateral view of FIG. 134.

In a continued embodiment FIG. 136 illustrates the Aerial Fire Suppression Drone (325) of FIG. 133, attached to the Pod (337) of FIG. 133, connected by its docking collars (360). The Pod's electrical bus connected to the receiving receptacle (362) of the Aerial Fire Suppression Drone; and, the skirts raised (361). The Aerial Fire Suppression Drone's launchers and compartments have been omitted from this figure, only for the purpose of providing a clearer diagram of the two systems when attached.

In a further embodiment FIG. 137 is a second lateral view of FIG. 136 illustrating the Aerial Fire Suppression Drone (325) attached to the Pod (337).

In a continued embodiment FIG. 138 is a frontal view of FIG. 136, where the Aerial Fire Suppression Drone (325) is attached to the Pod (337). Here, the landing gear and wheel assembly is extended (362) and the skirts (361) are raised and locked into place.

In an embodiment FIG. 139 illustrates FIG. 138, with the Pod's landing gear retracted (332).

In another embodiment FIG. 140 illustrates the Aerial Fire Suppression Drone with its docking collar (325).

In a further embodiment FIG. 141 illustrates an underside view of FIGS. 133 and 136: the Aerial Fire Suppression Drone (325) with its docking collar (335) retracted; and, its (double) drop doors (329). When a docking collar is attached to an Aerial Fire Suppression Drone, the collar circumnavigates the drop doors to allow use of the drop doors when the Aerial Fire Suppression Drone is in operation but not attached to the Pod (see, FIG. 133 and comparatively, FIG. 137). As illustrated here, a partial length docking collar may be employed, or a full-length collar, as indicated by the continuing hash lines.

As used herein, the use of micro-impulse radar scanning system, RF, an ultra-wide band system, shall mean a modification of such systems and linked with an appropriate software program to produce a non-invasive detection and three-dimensional mapping of a structure.

This shall also mean a system that is further linked to a memory device comprising a processing device which includes a library of known characteristics of high-rise, commercial, residential, industrial, underground transportation infrastructures, its voids, barriers, barrier walls, walls, multiple walls, open spaces, openings such as doorways, halls, chases, shafts, and other spaces common to obstructions, location and identification of human subjects within the scanned area of the structure and its fire zones.

This shall further mean a system comprising a means from which its scan data will be used to produce a three-dimensional mapping of the fire's thermal patterns within the scanned area. The data gathered to produce the three-dimensional map of the scanned structure and the fire zone(s) will then be used to program the encasement's smart system to seek out, target and extinguish a fire, with the capacity to direct fire extinguishing material loads to different points of the fire, its navigation means, discharge control means, and other encasement components.

As used herein, the micro-impulse radar scan data, ultra-wide band scan data, optical scanning data, side-band radar scanning data, laser scanning data, infra-red scanning data, or similar scanning means data, shall mean the data used to produce the structural and fire topography three-dimensional mapping applied to programming an encasement and for training purposes.

As used herein, a second generation and a third generation launcher shall mean a device, mechanism, means, instrument from which an encasement can be propelled, ejected, discharged, expelled or released from.

This shall also mean a device, mechanism, instrument, or similar means comprising a micro-impulse radar means, ultra-wide band radar means, laser, acoustical, infra-red, optical or similar device or means that is made a part of or incorporated into the launcher, with the capacity to scan a structure and fire, or provide target sighting, that is further linked to a software program or means to produce a three-dimension layout of the scanned structure, including its dimensions, openings, barriers, walls, a three-dimension topography map of the fire, the presence and position of a human subject within or near to the scanned area, that can be used to determine the optimal and alternative patterns to combat a fire; that may then be linked to a transmission means to program an encasement held within the launcher, as well as to receive and transmit such data to and from a remote monitoring and encasement programming means.

This shall further mean a programmable, software linked system linked to a memory device or means comprising digitized fingerprint segments of all authorized operators, with the capacity to encrypt and insert same into the encasement programming sequence and the launcher's encasement security verification means, so that an encasement cannot be programmed, or discharged from a launcher unless the launcher's encasement security verification means recognizes the operator's fingerprint and the encrypted digitized fingerprint segment uploaded to and embedded within the encasement's programming sequence.

This shall still further mean a system comprising programming and operations means capable of scanning an operator's fingerprint, that will be transmitted to a means linked to the launcher's memory means, so that further operation of the launcher, programming and discharge of an encasement cannot proceed without fingerprint recognition; that when a scanned fingerprint is not recognized by the software means comparing fingerprints against those stored in memory, it will disable the launcher, its discharge means, and its programming means, activate the launcher's alarm means, transmit an alarm signal and the recorded unauthorized user's fingerprint to a remote monitoring means, which shall include the time and location of the attempted intrusion.

As used herein in this invention, the chassis of the launcher shall means a launcher comprising a material capable of withstanding prolonged exposure to extreme heat and cold; capable of dissipating extremes of heat and cold from its operating systems, components, encasements loaded therein, and from the interior of the launcher's barrel from which an encasement will be discharged.

The launcher and encasement's security means shall mean a system, device, method, mechanism, or means using smart technology that can scan, record, and digitize an operator's/technicians' fingerprint upon attempting to operate the system, upload and compare same against current fingerprint data in memory, and that will digitize and encrypt an authorized operator's or technicians, fingerprints, upload and store same within the memory means of each launcher, monitoring means, and a central memory storage means,

This shall further mean, that when an authorized operator's fingerprint is recognized, a means, system, method that will select discrete portions of that fingerprint, encrypt same, upload and incorporate same within the launcher's programming means, for incorporation within the encasement loaded therein, its programming sequence, the transceiver, and the encasement security verification means.

As used herein, the launcher's encasement security verification means, shall mean a system, device, method, mechanism, or means, that linked to a launcher's programming means and firing mechanism which must recognize a digitized fingerprint scan embedded within an encasement's programming sequence and reconcile same with the fingerprint of the operator before discharge of the encasement from the launcher can take place.

In an embodiment FIG. 145 illustrates use of the MIR-gun to scan a structure and fire zone. Based upon this data a software program produces a three-dimensional map of the layout of the structure and the fire's thermal topography. The software is then used to determine the number of encasements and the fire-extinguishing load required to extinguish the fire.

As used in this invention, the launcher's programming software comprises a means to determine the number of encasements/load required per area or quadrant of the fire environment; the discharge timing sequence, height/altitude of discharge; the distance between discharging encasements; the angle(s)/trajectory of attack; the required angle of the launcher for each encasement to be launched; and the security codes. The launcher's programming module then loads this information to the program module of the encasement. Unless manually overwritten and reprogrammed, the encasement and the launcher's programming module will comprise a three-dimensional layout of the fire zone and the information necessary for the encasement to navigate the fire zone, target and identify the target area, and discharge the fire extinguishing load accordingly.

As used herein, each of the above programming features can be manually or remotely (electronically) overridden, allowing the operator to reprogram the encasement to meet the demands of a given fire situation.

In this invention the launcher's memory will record the encasement identifier number, type of extinguishment, load date, amount, weight of encasement and internal psi; propellant type and load date, psi and weight; the order in which each encasement is discharged from the launcher, trajectory, and discharge instructions; fire extinguishment manufacturer, date of purchase from manufacturer; and, the three-dimension structural layout and fire thermal topography. This data can then be uploaded to a remote monitoring, for real-time monitoring and subsequent use in the study and training of firefighting tactics.

In an embodiment FIG. 146 illustrates use of the MIR-gun feature incorporated within the launcher, where the latter is aimed at the intended structure (600) while the operator is located outside the structure or scanning from within a stairwell or similar area. The launcher's software program translates data from the returning MIR-beam (602) to produce the three-dimensional software image of the structure (604), showing the showing floor, ceiling, walls, door, barrier walls, and structures commonly associated with e.g., an office tower, and obstructions.

In another embodiment FIG. 147 illustrates use of the MIR-gun feature incorporated within the launcher, where the operator is standing within the intended structure or scan area at Point X (605), scanning further within same. The three-dimensional software image produced here is of MIR scan data showing a partial layout of the structure: i.e., the floor, ceiling, walls, door, barrier walls, obstructions limited to the area scanned by a fire firefighter standing within the structure and aiming the MIR-Gun or Launcher w/MIR functions to an area within the structure itself (606).

In a continuing embodiment FIG. 148 illustrates how the MIR-scan data provides a three-dimensional overlay of the fire's thermal topography, with each (color) area representing a different temperature or thermal range (608). The structure layout is provided, including barrier walls and obstructions. As at FIG. 147, the firefighter is standing within area of the structure (607) that will be targeted for MIR scanning or inside the structure itself. The image produced from the scan data will be limited to the area scanned by a fire firefighter standing within the structure and aiming the MIR-gun or Launcher w/MIR functions to an area within the structure itself. Where the firefighter is standing within a stairwell, as at FIG. 148, the MIR-scan produced will be of the forward interior of the structure.

As used in this invention, the Third Generation launcher is designed to reduce the guesswork of the angle in which the launcher should be held, to be fired, particularly in a blind firing situation. Blind firing refers to situations where because of obstructions, smoke, intense heat preventing access to the fire environment, or other factors a firefighter would discharge the fire extinguishing encasement into the fire zone, based upon MIR scan or thermal targeting data. Once the target area is selected the position of the target area and best route of entry/trajectory is entered into a motion-level sensor. Here, a motion-level sensor is a device or means that will display the position and angle of the launcher's barrel to the fire zone and the target area. The motion-level sensor is positioned at or near the distal end of the launcher's barrel (or the launcher's sighting system). Based upon the MIR-scan data, input as to the selected target/area, the operator then sweeps the barrel of the launcher upward, downward, left, or right, until its sensor indicates the operator has achieved the required or proximate level at which to discharge the fire extinguishing encasement from the launcher.

As further used in this invention encasements can be programmed within the launcher, in an independent programmable containment means, or in an independent, remote programming means capable of uploading program data to the launcher. Where the launcher is the initial encasement programmer the encasement is programmed by the launcher's wireless system or microprocessor according to the selected area of attack. Similarly, where an encasement is pre-programmed prior to loading to the launcher, the launcher will read each individual encasement loaded into its barrel: the position of the target area, and best route of entry/trajectory will be transmitted to the launcher's discharge control sensor. Where the position of the launcher/operator changes between the time the programming MIR scan is produced, programming of the encasement based upon the MIR-scan data, and actual discharge of the encasement from the launcher, the programming module corrects the trajectory and discharge code when the launcher is swept into position to discharge the encasement.

As used in the invention, when more than one launcher is activated for operation within the same fire situation, programming data, i.e., the number of required encasements and fire extinguishing load to be launched to a given quadrant, structural layout and fire topography, etc., as determined from the MIR-scan, the programming data produced is downloaded to a centralized, on site, remote monitor. Similarly, the programming data from each launcher is transmitted to the centralized on site remote monitor, which in turn is shared with each launcher. The intent here is to prevent two situations:
1. Unintentional over-pressurization, by flooding a given target area with quantities of fire extinguishing encasements and materials well above the amount required to extinguish a fire; and,
2. Unintentional discharge of encasements to the same area by one launcher operator unaware that another launcher operator is targeting the same position or area, multiple operators positioned at different points within or near the fire zone, but who are otherwise uninformed as to the attack approach of fellow firefighters who will discharge encasements to the fire environment,
   wherein, the option here should be to provide shared information and an alerting mechanism, as opposed to an automatic prevention of one launcher operator from discharging a encasement to a targeted fire zone, where a second launcher operator has targeted the area and possibly discharged a smart/fire extinguishing encasement to same. The program should allow for intentional discharge of encasements from different launchers to the same or proximate target/area, via a deliberate programming command or manual override.

As used in this invention the second and third generation encasement or second generation and a third generation Smart Fire Extinguishment Encasement (“S/FEE”), shall means a fire extinguishment system comprising a means that operates in conjunction with the MIR-scan data, contains a structural layout of the fire zone, from which The structural dimensions and coordinates are determined from the MIR-scan data. Obstruction avoidance is then preprogrammed into the navigation program of the encasement. Here, given the fact that obstructions are identified by the software program prior to discharge of the encasement from the launcher, as is the avoidance pathway, the need of a distinct or separate on-board obstruction detection and avoidance means may not be necessary for the third generation encasement system. When using the third generation encasement a MIR-gun or a launcher with MIR-functions would perform intermittent or continuous MIR-scans of the fire environment, and interpret the data in the same manner used for programming encasements. Here, however, the software compares the intermittent or continuous MIR-scan data with that of the initial or programming MIR-scan data, looking for changes within the fire environment that would affect the encasement's trajectory, obstruction avoidance, targeting, or discharge.

In this invention where using the second generation encasement system, when the encasement is in flight to the target area, a software program would compare the layout created by data from the MIR-scan with that of continuous real-time scanning of the structure. To achieve this end the second generation encasement would comprise a laser, acoustic, look forward radar, on-board micro-impulse-radar or similar means (herein, referred to collectively as an on-board real-time scanning system) to produce an active scan of the structure immediate to the pathway of the encasement, while the encasement is in flight to the target area. However, in the third generation encasement system, the data gathered as a result of the real-time on-board scanning system would be actively compared with the MIR-programming data. This will allow the Smart Encasement to make in flight trajectory adjustments upon detection of structural changes or the presence of new obstructions. Therefore, instead of using an on-board obstruction detection and avoidance system, the real-time scanning system working, in conjunction with the navigation software program to perform the same obstruction detection and avoidance functions.

As further used in this invention the third generation encasement comprises a means that works in conjunction with the MIR-scan data that produced a structural layout of the fire zone. Obstruction avoidance is programmed prior to a third generation encasements discharge from the launcher. Whereas the second generation encasement uses an on-board real-time scanning system, the third generation encasement does not. Instead of embedding a look forward on-board real-time scanning system into each generation encasement the MIR-gun or MIR function of the launcher, as used to program the generation Smart Encasement, would continue to scan the structure. The data from the MIR scan would then be transmitted, in real-time, to the third generation Smart Encasement, post encasement discharge from the launcher. Adjustment to the third generation encasement's trajectory would occur internally based upon structural changes or new obstructions noted by software (performed) comparison of the original data applied to program the encasement. Alternatively, the pre- and post-launcher discharge MIR scans would be compared at the launcher or at a remote system, with navigation changes transmitted in real-time to the encasement.

As used herein, the second and third generation Smart Fire Extinguishment Encasement shall mean an encasement system utilizing smart technology comprising the capacity to be electronically or manually programmed, to search for, target, and deliver to and discharge a fire extinguishment to the fire.

This shall also mean, an encasement comprising a means using smart technology, is electronically or manually programmed with a software program where its guidance and fire extinguishment discharge means utilizes scan data from micro-impulse radar laser, acoustical, infra-red, optical, or similar means, singularly or in combination thereof, to produce a three-dimension layout, map, grid of the structural area and the fire's topography, with the ability to identify and avoid obstructions and barriers, identify and locate the target fire area. Where taking down an outdoor/environmental fire the system can utilize global positioning system settings based upon global positioning system linked to a laser, infra-red, acoustical, optical, thermal differentiation detection means or other sighting means, in place of micro impulse radar scan data.

This shall also mean a system comprising a heat seeking capacity that can be programmed to detect and target a specific temperature or temperature range in an open or discretely defined area; that can differentiate incremental temperature differences as well as distinguish a higher or lower thermal target while within or passing through a conflagration; that can differentiate the thermal pattern of a human subject in or near a conflagration from the thermal pattern of the conflagration itself.

As used herein, thermal differentiation shall mean the capacity, ability, means to differentiate incremental temperature differences as well as distinguish a higher or lower thermal target upon approach, while within or passing through a conflagration; that can differentiate the thermal pattern of a human subject in or near a conflagration from the thermal pattern of the conflagration itself.

As used herein, the second and third generation Smart Fire Extinguishment Encasement guidance means shall mean a system where micro-impulse radar scan data is used by the appropriate software to determine the number of fire extinguishing encasements and the fire extinguishing load required to extinguish the fire; the optimal and alternative routes of access; trajectory; and, discharge parameters, as uploaded from the launcher's programming means to the encasement's programming means, or a manual override to program thermal target and target area selection; that is uploaded from the launcher's programming means to the encasement's programming means to navigate the area of the structural fire and its fire topography.

This shall further mean a system, means, method or similar definition, comprising a means capable of receiving programming data from a programming means of the structural and fire topography data from the micro-impulse radar scan data (or similar means described above) that can be uploaded and can interface with the encasement's programming means, its navigation means that guides the encasement to the targeted fire zone, propulsion means, sensors, warning sensors, transceiver, security means, discharge means, and electronic beacon.

As used in this invention when MIR scan data is downloaded to or transmitted to a remote monitoring and programming system (see, FIGS. 153 and 154), the remote programming system would perform the same programming functions cited herein with use of the launcher. The encasement's programming information developed by the remote programming software system could be uploaded to a launcher's programming module, or directly to Smart Encasements requiring in flight trajectory corrections. When the MIR system is incorporated within the chassis of a launcher (see, FIG. 155), data produced from the MIR scan is directly downloaded to the launcher's monitor and programming software; downloaded or transmitted to a remote Smart Encasement launcher programming system; or, downloaded or transmitted to a remote monitoring and programming system. See, also, FIG. 156, “Alternate programming sequences where the MIR functions incorporated into the launcher” and FIG. 157, “Intermittent or continuous MIR-scanning with data transmitted to and from a remote MIR monitoring system.”

As used in this invention when MIR-scan data is utilized to program the structural and fire topography, the microprocessor receiving and interpreting the MIR-structural and fire topography scan data splits MIR structural data into a predetermined number of quadrants and regions, respectively. For illustrative purposes the structural layout will be divided into four quadrants. Quadrants are determined by the square footage of the structural area scanned by MIR, divided into (here, four) equal, discrete areas. A Smart Encasement can be programmed to search a target area based upon priority settings. For example: Sections 2, 4, then Sections 3, 1; or, by priority, Section 2, if not found then Section 4, then if not found, etc. The intent here is to prevent unintentional over-pressurization or bunching of Smart Encasements in one or more Sections, at the expense of unintentionally missing other Sections. Similarly, where the microprocessor splits MIR structural data into a predetermined number of sections, the interpretative software program divides the MIR thermal pattern data into a discrete number of regions. For illustrative purposes the thermal layout within a structure will be divided into four regions, as follows: Region 1 represents the upper one-third of the fire's vertical column; Region 2 represents the middle one-third of the fire's vertical column; Region 3 represents the lower one-third of the fire's vertical column; and, Region 4 represents is for blanket coverage of the regions. When the temperature target region is on e.g., Section 5 and the same thermal pattern or a greater thermal pattern exists in Sections 1 through 4 and Section 6, programming of the Smart Encasement can be specific to Section 5 or e.g., Section 5 at 150′ post launch.

As used in this invention Regions are determined by the square footage of the structural area scanned by MIR, divided into (here, three) equal, discrete areas. However, where the Smart Encasement is programmed to seek and target a temperature/range, to prevent unintentional over-pressurization or bunching of Smart Encasement in one or more quadrants, at the expense of unintentionally missing other quadrants, the Smart Encasement can be set to target a specific region or by priority. For example: 600° F.-650° F. at (region) Y2. In recognition of the fact that thermal patterns change with time, the presence of fuel, heat and oxygen, the initial thermal patterns detected by the MIR may differ from the thermal patterns present at the time of discharging the Smart Encasement from the launcher or arrival at the intended target area. Therefore, where the target is a specific thermal range/point, e.g., 850° F. in S5, R3 (and to the left side of the marker that subdivides the section), the Smart Encasement is programmed to discharge it's fire extinguishment load at S5, R3, Area left, but not 850° F. If the Smart Encasement is programmed specifically to 850° F. in S5, R3, Area L alone, and the thermal range at S5 Area left changes above or below±one or two standard deviations (e.g., a standard deviation representing ±40° F.), the discharge parameters would not be met and the intended impact of the Smart Encasement could become attenuated, by failing to achieve optimal discharge (where optimal discharge is described as the best point, region, area, etc., for discharge of the fire extinguishment load). Instead, the programmer uses the MIR data to identify the target area as 850° F. in S5, R3, Area L but, programs the Smart Encasement to discharge its fire extinguishment load at S5, R3, Area L.

The advantage of using real-time continual MIR scanning with the ability to transmit new instructions to a Smart Encasement is that the targeted temperature range for e.g., S5-AL could be adjusted as the S5-AL thermocline changes. By maintaining continuous MIR scanning of the structural and fire zone, after (initial) programming Smart Encasements, firefighters are given the opportunity to monitor changes within the fire zone and to plan their attack strategy accordingly. Where there is a significant increase or decrease in thermal activity between the time of programming/discharge of the Smart Encasement from the launcher to the target area, and additional Smart Encasements are needed, the MIR-linked program can be exploited to determine the number of additional Smart Encasement required, consequently programming and launching the additional Smart Encasements. A continual MIR scan will also alert a firefighter to new outbreaks as well as extinguishment in the targeted area (and the fire zone as a whole).

As used herein, the Second Generation Smart Fire Extinguishing Encasement shall mean a smart fire extinguishment encasement system comprising an external program to navigate the area of the structural fire and its fire topography, with real-time obstruction avoidance guidance by pulse or continuous Micro-power Impulse Radar scanning, an on-board structural scanning system, linked to a software program and memory that contains the three-dimensional structural layout and fire topography data, so as to perform a real-time comparison of the look forward scan to that of the structural scan data in its memory, by comparing the real-time look forward data and the pre-launch trajectory program, where trajectory corrections would be performed internally by the encasement's navigation system.

As used in this invention the second-generation encasement uses an external program based upon scan data to navigate the floor plan, with real-time obstruction avoidance guidance by pulse, intermittent, or continuous MIR. Here, the navigation program that utilized a global positioning system to combat outdoor or environmental fires is replaced by MIR-scan data, for operations within an enclosed or semi-enclosed structure. As stated above, the MIR is used to scan the fire zone, a three-dimensional map of the structural grid or layout of the structure and the fire's topography is produced. The software then determines the number of fire extinguishing encasements and the fire-extinguishing load required to extinguish the fire; the optimal and alternative routes of access; trajectory; and, discharge parameters (i.e., horizontal, vertical, height within/above the fire, etc.). Subsequently, this data would be uploaded from the launcher to the fire extinguishing encasement's programming module. When discharged from the launcher the encasement's trajectory is monitored by a remote, on site or off site control center. To this end, tracking an encasement is accomplished by outfitting the encasement with a transponder that will transmit a signal to an on site control center, allowing the control center to compare the encasement's trajectory in real-time to the structural map produced by from the MIR and the resulting programming route. A self destruct or kill system should be built into the encasement's system(s) as a safety feature, in case the encasement runs an errant pattern or other changes within the fire environment necessitate pre-target discharge (or, where possible, re-routing).

As further used in this invention, this encasement's navigation system would include an on-board structural scanning system. This will allow the smart encasement's navigation system to maneuver the encasement through the fire interior of the structure and the fire environment, using the three-dimensional structural layout and fire topography data for guidance. The on-board scanning system, linked to a software program within the encasement and the encasement's memory that comprises the three-dimensional structural layout and fire topography data, to perform a real-time comparison of the look forward scan to that of the structural scan data in its memory. By comparing the real-time look forward data and the pre-launch trajectory program, trajectory corrections would be performed internally by the fire extinguishing encasement navigation system.

As used herein, the encasement's exterior surface or near exterior surface of the Second Generation Smart Fire Extinguishment Encasement can be fitted with forward looking radar systems, thermal detection, flame detection, warning sensors, transceiver, and other wireless components, unless such systems and sensors are capable of functioning as intended from within the interior of the encasement, broadcasting its signal through the encasement's wall.

As used herein, the Third Generation Fire Extinguishing Encasement and the Smart Fire Extinguishing Encasement Heat Seeker Fire Extinguishing Encasement shall mean a smart encasement system with heat seeking and heat differentiation capacity; the optimal and alternative routes of access; trajectory; and, discharge parameters.

As used herein, the Third Generation Fire Extinguishing Encasement and the Smart Fire Extinguishing Encasement Heat Seeker Fire Extinguishing Encasement shall also mean a smart encasement system comprising an external or launcher means based real-time Micro-power Impulse Radar scan and the capacity to transmit new, corrective programming instructions while the encasement is in flight that will permit navigational adjustment of the fire extinguishing encasement in the pathway of new obstructions caused by debris, explosion, or fire. The third generation system navigates by virtue of the structural layout data and fire data created by the Micro-power Impulse Radar scan.

As used herein the third generation encasement shall also mean an encasement comprising heat-seeking functions with the capacity to differentiate thermal patterns and temperatures, a MIR-scan system would be used to scan a structure and the fire. The data from that MIR scan, combined with a properly developed software program, would then be used to provide a three-dimensional map of the structure/floor space, including barrier walls, obstructions and openings, and a map of the fire itself (see, FIGS. 145 and 146). This data will in turn be used to program the heat seeker function of the Smart Encasement system. Here, the Global Positioning System or “GPS” is replaced by use of the navigation program utilizing MIR-scan data: for operations within an enclosed or semi-enclosed structure. The third generation's navigational controls would still use altimeter/height sensors, gyroscopic sensors, near object detection, speed and trajectory sensors, and MIR data programmed into the encasement's navigational system to then allow the encasement to navigate the structure to the target area (see, third generation, single function component system schematic, FIG. 149). By maintaining a real-time MIR scan and the capacity to transmit new, corrective programming instructions while the encasement is in flight will permit navigational adjustment of the fire extinguishing encasement in the pathway of new obstructions caused by debris, explosion, or fire. The third generation system navigates by virtue of the layout data and fire data created by the MIR scan.

As used herein, the Standard Launcher Discharged Fire Extinguishment Encasement shall mean an encasement system comprising limited smart technology with the capacity to be electronically or manually programmed to search for, target, and extinguish a fire. This encasement, using limited smart technology, that is electronically or manually programmed from a software program that can utilize scan data from micro-impulse radar laser, acoustical, infra-red, optical, or similar mean, or in combination thereof, to produce a three-dimension grid, map layout of the structural area and the fire's topography: where it will deliver to and discharge its fire extinguishment payload based upon such factors as height, spatial relationship, altitude, temperature, thermal range, time, time out of the launcher, distance, global positioning system coordinates, or flame detection settings, or impact.

This shall also mean an encasement system that does not comprise heat seeking technology but can be linked with thermal sensors or similar means, and programmed to detect and target a specific temperature or temperature range in an open or discretely defined area; that can differentiate incremental temperature differences as well as distinguish a higher or lower thermal target while within or passing through a conflagration, or otherwise high temperature area normally associated with a conflagration.

This shall further mean an encasement utilizing impact as the primary or secondary cause of fire extinguishment material discharge, designed to discharge upon impact with a surface at X psi: where X psi is the amount of pressure exerted per square inch when the encasement impacts with or is struck by a surface force greater than that encountered when an encasement is discharged from a launching means, the pressure exerted when loading the fire extinguishment and/or propellant, incidental bumping, and storage exerted pressure.

In an embodiment FIG. 149 is a block diagram of a Third Generation, Single Function Component System schematic, each component is individually detailed and linked within the Smart Encasement system. The primary difference between FIG. 149, the Third Generation, Single Function Component System schematic, to that of FIG. 150, the Second Generation, Single Function Component System schematic and the Third Generation, Multifunction Batched Component System schematic (see, FIG. 151), is the obstruction sensor/avoidance and clearance systems, and the look forward radar, the on-board MIR, or acoustic tracking features are not included or necessary for the former.

In an embodiment FIG. 150 is a block diagram illustrating the second generation, single function component system schematic format.

In an embodiment FIG. 151 is a block diagram illustrating the 3rd generation, multifunction batched component system schematic format.

In an embodiment FIG. 152 illustrates a block diagram of the MIR gun system utilized to scan a structure, where the MIR function is used as a stand alone, independently operated system, separate from the launcher.

In an embodiment FIG. 153 illustrates a block diagram of the MIR gun system utilized to scan a structure, where the MIR function is used as a stand alone, independently operated system, separate from the launcher. Here, the data produced by the MIR scan function is downloaded or transmitted to a near or on site remote monitoring and control system. Where MIR scan data is downloaded to or transmitted to a remote monitoring and programming system (see, FIGS. 153 and 154), the remote programming system would perform the same programming functions cited herein with use of the launcher. The Smart Encasements programming information developed by the remote programming software system could be uploaded to a launcher's programming module, or directly to Smart Encasements requiring in flight trajectory corrections.

In an embodiment FIG. 154 is a block diagram illustrating the interchange scan data between the remote monitoring and programming means and the launcher. Where MIR-scan data is downloaded to or transmitted to a remote monitoring and programming system, the remote programming system would perform the same programming functions cited herein with use of the launcher. The Smart Encasements programming information developed by the remote programming software system could be uploaded to a launcher's programming module, or directly to Smart Encasements requiring in flight trajectory corrections.

In an embodiment FIG. 155 illustrates a block diagram where the MIR system is incorporated within a hand-held launcher. Here, the MIR scan data produced is directly downloaded to the launcher's monitor and programming software; downloaded or transmitted to a remote encasement launcher programming system; or, downloaded or transmitted to a remote monitoring and programming system.

In an embodiment FIG. 156 is a block diagram illustrating an alternate programming sequence where the MIR functions are incorporated into the launcher.

In an embodiment FIG. 157 is a block diagram illustrating intermittent or continuous MIR-scanning with data transmitted to and from a remote MIR monitoring system.

As used herein, the security means of the fire suppression delivery system shall mean the use of smart technology to prevent unauthorized use of a launcher, the programming or program interference with an encasement, and discharge of an encasement from a launcher means. Whereas smart technology in firearms prevents use by an unauthorized user, this proposed system goes further by incorporating the fingerprint sequences into the encasement's programming sequences and security system. Thereby providing a battery of user sequences recognizable by the launcher, the fire extinguishing encasement, and respective programming modules, so that deprogramming/reprogramming by each successive user before operation of the launcher is not required.

As used in this invention, smart technology security means comprises a scanning and imprinting means to produce a digitized print of each authorized user, electronically store same, and contain such data within the launcher's memory system. Thus, if a launcher is operated by a system authorized user, the launcher's memory means recognizes the new user then allows the latter to operate the system. An unauthorized user would be prevented from operating the system, while at the same time making a digitized print of the unauthorized user. The digitized print from the unauthorized would be immediately relayed to a remote monitoring and alert system. Having a digitized print of the unauthorized user would allow for tracking, identification, and where necessary prosecution.

In an embodiment FIG. 158, the launcher's smart technology security means first recognizes the authorized user when the latter takes hold of the pistol grip, thereafter creating three distinct fingerprint patterns.

As used in this invention the first part of the smart technology security mean's recognition sequences comprises a digitized print that is then entered to the launcher's encasement programming module. This serves as an authorization code for the user to operate and program the launcher, program and discharge the encasement.

As further used in this invention a software program randomly selects a portion of the authorized user's print.

This randomly selected portion of the authorized user's print is then loaded into the programming sequence of the launcher's programming module, where it will become part of the encasement's programming sequence. This becomes part of the security sequence or code.

As used here in this invention, before an encasement can actually be discharged from the launcher, the latter's security sensor must recognize the security sequence. Failure to recognize the security sequence will result in non-operation of the launcher and an automatic security reporting of a breach by automatic transmission to a remote security and monitoring system, and inoperability of the system. If either the launcher's programming means, the encasement's programming means or its transceiver's recognition program fails to recognize the launcher user's encrypted digitized fingerprint segment, such failure to recognize this security sequence will result in non-operation of the launcher and the encasement, and an automatic electronic security reporting of the breach and inoperability of the system. Reactivation of the launcher will take place when an authorized operator's fingerprint is recognized, or the system is reset, but not bypassed, by an authorized technician.

As also used in this invention a third portion of the sequence is uploaded to a means comprising the digitized fingerprints or portions of the digitized fingerprints corresponding to all authorized users.

As used in this invention each successive encasement loaded into that particular launcher will contain the above security sequences. Before the encasement can be discharged from the launcher, the launcher's discharge security system must reconcile its randomly selected portion of the authorized user's print with the randomly selected portion of the authorized user's print embedded within the encasement's program sequence. To reduce the number of authorized operators that a particular launcher will recognize, the information loaded to the launcher's memory could be categorized for authorized operators in a given region, state, country, etc.

In an embodiment FIG. 158 is a block diagram illustrating the process by which an operator's fingerprint is scanned, digitized, confirmed where authorized, then uploaded to the appropriate programming features of the launcher and the encasement.

In another embodiment FIG. 159 illustrates the construction and use of an electronic glove for use in operation of the launcher.

As used in this invention, wearing a glove or other covering over the hand used to operate the launcher may prevent the latter's ability to produce a digitized identification of the users hand, as discussed above. However, it is also recognized that conditions such as extreme heat, cold, the risk of injury, etc., may prevent a firefighter's ability to enter a fire zone and operate the launcher bare-handedly, as well as finding that removal of a protective glove in such an environment may not be feasible or dangerous. To overcome this problem sensors are integrated to the interior of the glove and electronically communicate with the launcher's sensory system. In an embodiment FIG. 159 illustrates an electronic glove where a linear (609/610) or circular (611) digitized fingerprint sensor is located within the same glove finger corresponding with the finger (614) that would be used by the launcher to identify the operator. The area between the sensor and the outer environment would be shield by Kevlar (for safety) or other synthetic fiber (613), and a lightweight material capable of preventing electromagnetic interference or unauthorized interception of the signal.

As further illustrated in this embodiment, FIG. 159, Point 610 of the represents a linear or circular (614) sensor that measure capillary density of the operator's sensor. This corresponds with the security feature cited above. Points 609, 610 and 612 may occupy the same glove finger. Transmission of the glove's sensor signal to the launcher may be accomplished in one of several ways. One method is to use a wireless, shortwave transmitter (641) that can project the signal to the launcher's transceiver. The transmitter would be limited in distance of several inches. A second option is to use a hardwire system: i.e., the sensor signals are routed to a transmitter (641) in the glove that is attached to a hardwire (642) system, that extends from the glove (643) to the launcher. To prevent unauthorized use after the authorized operator has digitized fingerprint is recognized while wearing the glove, when the authorized operator's hand is removed from the glove or the hardwire attachment is separated from the launcher the system will not function until the verification process is once again completed.

As used in this invention the electronic or wireless programming sequence of an encasement comprising a means that can be divided into several discrete segments: e.g., user identification, trajectory, and discharge parameters such as temperature, temperature range, time, time out of launch, height, altitude. To prevent interference with a encasement's programming by an unauthorized user the encasement's program module and transceiver must first recognize an imbedded security sequence. Before the encasement can be programmed by the launcher's programming module it must first identify and recognize the digitized print of the operator. Once recognized, two or more portions of the recognized print are then embedded into what will become the encasement's programming sequence. In the event that an unauthorized individual attempts to interfere with the encasement's programming by use of an extraneous signal source, the latter must contain a digitized portion of an authorized users print, otherwise the encasement programming module will not accept the new signal. In the absence of a recognizable authorized digitized print the fire extinguishing encasement's programming module will not accept the new transmission but continue as previously programmed. However, when a new transmission contains a recognizable authorized digitized print, the fire extinguishing encasement's programming module will accept the newly transmitted sequence and reprogram the fire extinguishing encasement accordingly. This is the second level of security. If a change is made by an authorized operator using the same launcher, or by an authorized user operating from a remote system, the new set of operating instructions transmitted to the fire extinguishing encasement will contain a randomly digitized print that will be recognized by the fire extinguishing encasement's programming module.

In an embodiment FIG. 160 provides a block diagram of the security verification system.

In am embodiment FIGS. 161 and 162 provide block diagrams to illustrate the progression of the security verification process to effect changes to the encasement's programming sequence, post discharge from a launcher, where the transceiver must first recognize an authorized digitized print. Once recognized, the transmitted signal passes to the fire extinguishing encasement's programming module, where the appropriate changes will be made. In the event that an unauthorized individual attempts to interfere with the fire extinguishing encasement's programming by use of an extraneous signal source, the latter must contain a digitized portion of an authorized users print, otherwise the fire extinguishing encasement programming module will not accept the new signal (see, FIG. 161). In the absence of a recognizable authorized digitized print the fire extinguishing encasement's programming module will not accept the new transmission but continue as previously programmed. Where an unauthorized user takes command of a launcher after an authorized user has programmed a fire extinguishing encasement but prior to the discharge of same from the launcher, the launcher's discharge security system will not recognize the interlopers print, thereby shutting down the launcher.

As used herein, the structural wall surface of a fire extinguishment encasement is defined as the interior, near exterior, exterior surfaces of an encasement.

As used herein, the exterior wall of a fire extinguishment encasement shall mean the exterior, outer surface area exposed to the environment. The exterior surface should not destabilize, disintegrate, or otherwise become compromised where exposed to an electrical charge emanating from the external environment, exposure to toxic gases or fluids from the fire environment.

As used herein, the interior wall of an encasement shall mean the internal surface area of the encasement that is exposed to and contains the fire extinguishment, but is not exposed to the external environment.

As used herein, the near exterior wall of an encasement shall mean a third wall structure or the area between the exterior wall and the interior wall of the encasement that is not exposed to the external environment nor exposed to the interior area comprising the fire extinguishment material containment area.

As used in this invention the interior surface of the encasement should be designed to harden with an increase of internal pressure created by loading fire extinguishment material to the containment area: the greater the internal pressure the greater the hardening capacity of the encasement's interior surface. To increase tensile strength of the encasement's exterior surface, consider interweaving the material with Kevlar or a similar material. Kevlar or other fibers incorporated into the encasement's material composition should be oriented in such a manner such as using micro chambers, interlocking sections, or a similar construction, that will increase hardening of the exterior to prevent premature discharge of the fire extinguishment load due to impact, environmental exposure, or exposure to an external electrical charge: without adverse impact upon controlled degradation of the encasement.

As used herein an additional concept in control degradation is to embed within the material comprising the exterior, near exterior, and interior surfaces of the encasement microfilaments that will respond to a specific pitch emitted by a tuning fork or tuning fork-like device. Placement of the microfilaments is to augment stabilization of the encasement and the controlled degradation process.

In an embodiment FIG. 163, which is a partial cross-section view of an encasement illustrating the exterior wall structure (615), the interior wall structure (617) and the near interior wall structure (616). Here, the interior surface of the encasement is designed to harden with an increase of internal pressure created by loading fire extinguishment material to containment area: the greater the internal pressure the greater the hardening capacity of the encasement's interior surface. To increase tensile strength of the encasement's exterior surface, Kevlar or a similar material is interwoven into the wall structure (618). Kevlar (or other) fibers incorporated into the encasement's material composition should be oriented in such a manner that will increase hardening of the exterior to prevent premature discharge of the fire extinguishment load due to impact, environmental exposure or exposure to an external electrical charge. However, this design should not effect controlled degradation of the encasement's interior.

In another embodiment FIGS. 164 and 165 illustrate the encasement's exterior (615), near exterior (616), and interior wall (617), prior to being filed with the fire extinguishment material. The wall is constructed so that when the containment area is compression filled with the fire extinguishment the tensile strength of the exterior surface area increases. The Kevlar lacing (618) is aligned so as to help the exterior surface area withstand a hard surface impact—e.g., impact with the floor, ceiling, wall or similar area. The exterior surface is designed to deflect an electrical charge that strikes the surface from the external environment, and without allowing such an electrical charge to destabilize the encasement: such as when an interior generated electrical charge electrifies the interior, near exterior, and exterior surface for controlled degradation of the encasement. The near exterior area is made up of micro chambers, interlocking sections, or a similar construction, so that when compressed by increasing the internal pressure exerted from within the containment area of the encasement it either expands or contracts to harden the exterior surface area. When this area receives an electrical charge to the interior surface area, that electrical charge causes each chamber to rapidly collapse away from or expand against the adjoining chamber: generating a (material) pulverizing action. This pulverizing action is the disintegration of the encasement. For non-impact discharge encasements rapid expulsion of the propellant should not result in collapse of the containment means or the containment means' walls. Where (compressed) gas is used as an incendiary or non-incendiary propellant, its containment means must withstand the pressure exerted by the propellant and (compressed) fire extinguishment material: including the pressure exerted by the fire extinguishment material when expelled from the containment area.

In an embodiment FIG. 166 illustrates a cut-away section of an encasement comprising two levels of micro capstone-like sections (623, 624) are built into the encasement walls. The intent of these structures is to increase the tensile strength of the encasement, with increased pressure exerted internally (pushing outwardly) and impact pressure exerted from the exterior environment. The first level (623) extends from the exterior surface to the near exterior surface with its pinnacle resting upon the broad surface of the second level capstone. The second level capstone-like feature extends from the interior surface to the near interior surface. Pressure exerted to and upon the exterior is then focused back upon the capstone, which exerts pressure outwardly to against the encasement. Ideally, when an electrical charge is passed internally to the encasement's wall structure rapid disintegration of the encasement's wall occurs, resulting in collapse and pulverization of the encasement into a fine particulate while forcibly expelling its contents to the environment.

As used herein, controlled degradation of a fire extinguishment encasement shall mean the intentional, purposeful, deliberate discharge, release, destabilization, disintegration, degradation, rapid degradation of a fire extinguishment encasement resulting in the forceful expulsion, release, discharge, projection, propelling of fire extinguishment from the encasement to the environment, where such degradation is the result of an intentional, discrete, or complete disruption of the encasement's wall structure based upon pre-set, programmed controlled degradation and discharge parameters such as time, temperature, specified thermal range, thermal differentiation, distance, height, altitude, Global Positioning System settings, target acquisition, thermal target acquisition, target proximity, the use of scan data from micro-impulse radar, thermal imaging, laser, infrared, and/or acoustic imaging to produce a three-dimensional structural and fire topography map of the target structure area, or in any combination thereof, as programmed into the encasement's programming, navigation, security, and discharge means, but not by impact of the encasement.

As used herein, controlled degradation of a fire extinguishment encasement shall also mean the discharge, disintegration, collapse, rapid collapse, intentional destruction of the entire fire extinguishment encasement, or discrete segment(s) of the fire extinguishment encasement, so as to effect immediate, rapid, destabilization, disintegration, destruction, by the use of an electrical, electronic, chemical, acoustical means generated from and emanating from within the encasement

As used herein, non-controlled degradation, impact degradation, secondary discharge degradation, and degradation of a fire extinguishment encasement based upon impact shall mean, the intentional, purposeful, deliberate discharge, release, destabilization, disintegration, degradation, rapid degradation of a fire extinguishment encasement fire extinguishment resulting in the forceful expulsion, release, discharge, projection, propelling of fire extinguishment from the fire encasement to the environment, where such degradation is the result of an intentional, discrete, or complete disruption of the encasement's wall structure based upon pre-set discharge parameters such as time, specified temperature, specified thermal range, thermal differentiation, distance, height, altitude, Global Positioning System settings, target acquisition, thermal target acquisition, target proximity, or in any combination thereof, as programmed into the encasement's programming, navigation, security, and discharge means, or by impact of the fire extinguishment encasement with second surface area at X psi, where X psi is the amount of pressure exerted per square inch when the encasement impacts with or is struck by a surface force greater than that encountered when an encasement is discharged from a launching means, or the pressure exerted when loading the fire extinguishment and/or propellant, incidental bumping, and storage exerted pressure.

As used here in this invention, a solid structure shall mean the ground, floor, or surface, of such strength, integrity, mass, or combination thereof, that when impacted by an encasement will cause the encasement to shatter or break apart, break away, become punctured, rupture, compromise the integrity of same, so as to initiate the process of or effect release of its contents thereof, where designed to do so, may result in non-controlled degradation of or impact degradation of a fire extinguishment impact encasement.

As used here in this invention, the impact safety feature, secondary impact discharge, safety discharge of a smart fire extinguishment encasement shall mean where a controlled degradation encasement has failed to discharge it's load based upon programmed, discharge settings but impacts with a surface at X psi, where X psi is the amount of pressure exerted per square inch when the encasement impacts with or is struck by a surface force greater than that encountered when an encasement is discharged from a launching means, or the pressure exerted when loading the fire extinguishment and/or propellant, incidental bumping, and storage exerted pressure, impact will serve as a secondary or safety activatable means, thereby releasing its contents to the environment.

As used herein, the impact safety feature, secondary impact discharge, safety discharge of a standard launcher discharged fire extinguishment encasement or standard fire extinguishment encasement shall mean where the encasement has failed to discharge it's load based upon programmed, discharge settings including impact discharge at X psi, the sensor will initiate the discharge control mechanism.

In an embodiment FIG. 167 illustrates a cut-away section of the Smart Encasement showing the Kevlar lacing (618) as part of the composite material comprising the encasement with the electronically controlled electrical charge generator (625) hardwired (626) to the near exterior (616) surface. At Subpart B, on command by the discharge means the generator (625) sends an electrical charge to contacts strategically placed at limited points within the encasement's walls, where discrete controlled degradation of the encasement's walls will occur: resulting in forcible expulsion of extinguishment (622) through the limited openings created. At Subpart C, electrically charged hardwire contacts have caused rapid controlled degradation of the entire encasement, resulting in forcible expulsion of the entire extinguishment load to the environment.

In another embodiment FIG. 168 illustrates the intent of developing the encasement to strengthen with an increased internal load and orientation of the wall structure to resist degradation by impact with an external source. Here, even though debris (652) impacts the exterior surface of the encasement but does not cause the encasement to shatter or otherwise release its extinguishment load, when an internally generated electrical charge (625) is sent to the strategically placed contacts within the encasement's near exterior surface and its exterior surface, such causes the encasement to rapidly disintegrate (653): forcibly expelling the extinguishment to the environment (654).

As used herein, a fire extinguishment discharge control means shall mean a system comprising an electronic, micro-technology, wireless, nanotechnology, electrical, manual set, static means, method or similar means that can be programmed, reprogrammed, deprogrammed, and is designed to effect the disintegration of a fire extinguishment encasement's walls and the release, discharge, expulsion, ejection or fire extinguishment material contained therein to the environment, based upon such factors as time, specified temperature, specified thermal range, thermal differentiation, distance, height, altitude, impact, Global Positioning System settings, target acquisition, thermal target acquisition, target proximity, the use of programming using micro-impulse radar, radar, thermal imaging laser, infra-red, and/or acoustic imaging scan-data, individually or in any combination thereof.

As used herein, an electronic controlled electrical charge generator shall mean a method, system, conveyance, means, or similar means comprising the capacity to receive an electronic signal, conveyance that can be programmed, reprogrammed to generate and distribute an electrical charge of X magnitude to contact points within the wall of the encasement, where X magnitude is the amperage and/or voltage required to effect rapid degradation of the encasement.

As used in this invention hardwired leads are conductive surface areas strategically placed within, imbedded within, adjacent to the wall structure of the encasement that can be charged by the electronic controlled electrical charge generator, on command from the discharge program.

As used herein, a sonic or acoustic generator shall mean a method, system, conveyance, means, or similar means comprising the capacity to receive an electronic signal, conveyance that can be programmed, reprogrammed to generate a sonic frequency of X magnitude, where X magnitude is the amplitude required to effect rapid degradation of the encasement.

As used in this invention the exterior or near exterior area of the encasement are fitted with contact surfaces attached to electrical leads emanating from the electronically controlled electrical charge generator, that when an electrical charge or electronic signal from the charge generator is transmitted will cause the encasement's material composition to rapidly disintegrate.

In still another embodiment FIG. 169, comprises an electronically controlled electrical charge generator (628), that when activated, will generate an electrical charge that will travel through strategically hardwired (644) to various points within the encasement's wall structure (645), or generate an electronic signal that will cause strategically placed capacitor or contact surfaces (629) to vibrate or produce a charge of such magnitude as to cause the material of the encasement's wall to rapidly disintegrate (646). Here, controlled degradation of the encasement is to it's entire wall structure at one time, resulting in forcible expulsion of the fire extinguishment to the environment (647).

In yet another embodiment FIG. 170, comprising an encasement (here) that is divided into four discrete segments (647, 648, 649, and 650), each containing as an option an independent gas generated propellant core (628), further illustrating the wireless programming means, discharge means, transceiver, and an electronically controlled electrical charge generator. This encasement can be programmed to discharge its entire fire extinguishment load simultaneously, or released consecutively by quadrant. At FIG. 170, each section of the encasement is strategically fitted with electrical or electronic contact points or capacitors. Beginning with Section One, when an electrical charge is passed to the contact points within the encasement Section One (650) of the encasement disintegrates, releasing its fire extinguishment material to the fire environment. When Section One is completely disintegrated it triggers the electrical generator to pass an electrical charge to the contact points in Section Two (649). This process continues until the last section is charged and disintegrated, and the entire fire extinguishment material load of is expelled to the fire environment (see, FIG. 171). By incorporating this feature to the Standard Launcher Discharged Fire Extinguishment Encasement the extinguishment can be released over an area, creating a canopy effect.

As used in this invention the use of microfilaments (631) shall mean surfaces, substances, material, or similar means that will respond to a specific pitch emitted by a tuning fork or tuning fork-like device like a sonic or acoustic generator, and that are strategically placed within, imbedded within, adjacent to the wall structure of the encasement, that when charged by the sonic or acoustic generator on command from the discharge program, the encasement will rapidly disintegrate. Placement of the microfilaments is to augment stabilization of the encasement, as well as a function of the controlled degradation process. Such filaments should be oriented within the encasement's wall structure in such a manner that it will not respond to external electrical, electronic, acoustical, laser, thermal, chemical or similar means, but where such orientation may strengthen the encasement to such external exposure.

In a separate embodiment FIG. 172 illustrates the placement of microfilaments (613) to the exterior (615), near exterior (616), and interior surfaces (617) of the encasement that will respond to a specific pitch emitted by a tuning fork or tuning fork-like device. Placement of the microfilaments is to augment stabilization of the encasement and the controlled degradation process. By absorbing vibrations caused by incidental bumping, unintended impact with an obstruction, debris or other surfaces the chance of premature discharge or unintended rupture of the encasement is further reduced. A tuning fork-like device or shock absorption structure can absorb vibrations. However, the use of a tuning fork-like device can absorb vibrations and absorb such as well. The intent here is to produce an internal vibration that will cause the encasement's material structure to rapidly disintegrate, on command. At FIG. 172, the specific vibration is produced the embedded microfilaments will vibrate so rapidly and violently as to cause complete disintegration of the encasement's material structure (or, specified controlled degradation points.

In an independent embodiment FIG. 175 illustrates the use of controlled degradation to disintegrate discrete areas of an encasement for release of its contents to the environment. Here, the encasement is divided into four chambers (647-650), with each chamber containing its own fire extinguishment load (622) and a (gas generated) propellant that will cause sequential discharge of the extinguishment load on command, during the encasement's (programmed) trajectory into and through the fire zone. The fire extinguishment material can be expelled one chamber at a time, two or more chambers at the same time, or all at once: this is controlled degradation-controlled by the discharge program.

In an embodiment FIG. 176 illustrates FIG. 175 where the encasement is compartmentalized to discrete sections, where release of the fire extinguishment material contained therein begins at the base segment (650), progressing forward, with the extinguishment is released through control degradation ports (651). Here, for illustrative purposes the encasement is divided into four discrete segments—Sections One through Section Four. When the fire extinguishment material is expended from Section 1 (650), it triggers the degradation of the exit ports located in Section 2 (649), and the release of the fire extinguishment material from Section 2. Each section is contiguous to the next section. This process continues during the Smart Fire Extinguishment Encasement's trajectory, until the fire extinguishment material from all four sections is fully expended from the encasement.

In a continuing embodiment FIG. 177 each chamber is filled with nitrogen (637) or other inert gas as the fire extinguishment. The propellant core is segregated from the internal chamber that contains the fire extinguishment. Each contiguously attached chamber is independently control. In this particular illustration, controlled degradation is limited to specific, strategic points of the chamber, i.e., ports or exit apertures. On command from the discharge program the electronically controlled electrical charge generator will initiate rapid degradation of a designated gas port. Chambers can be emptied of their fire extinguishment loads sequentially, in groupings, simultaneous, etc. An inert gas filled Smart Fire Extinguishment Encasement that releases each chamber sequentially or in an overlapping manner, can provide canopy coverage of a fire along its trajectory. This encasement can be developed without placement of gas ports in each chamber. Instead, as at FIG. 171, each chamber undergoes complete controlled degradation.

As used herein, the physical construction of the impact controlled encasement is similar to its non-impact controlled counterpart, i.e., the controlled degradation encasement, with the following exceptions: controlled degradation is absent or is not used as the primary means of discharge or, rapid disintegration of the encasement's surfaces is not initiated by controlled degradation though by impact with a surface at X psi.

As further used herein the impact release encasements is divided into three categories: Category One impact release encasements that where the encasement shatters upon impact with a surface at X psi, resulting in the expulsive release of its fire extinguishment material to the environment; Category Two impact encasements where impact with a surface at Y psi initiates the controlled degradation response mechanism; and, Category Three impact release encasements where impact with a surface at Z psi initiates the controlled degradation response mechanism.

As used here in this invention, X psi for Category One impact release encasements pertains to the pressure per square inch exerted upon the exterior surface of the encasement when the encasement impacts with or is struck by a surface force greater than what is encountered when an encasement is discharged from a launching means; pressure is exerted by loading the fire extinguishment material to the encasement's containment area; pressure is exerted by loading the propellant to the propellant containment means of the encasement; pressure is exerted by the fire extinguishment material and/or the propellant, as contained within the encasement; the encasement is stored, handled, or loaded to a launching means; and, the propellant is released under force from the encasement, except where the propellant is harnessed as a means to expel the fire extinguishment from the encasement with greater force, thereby causing the encasement's material to rapidly disintegrate or pulverize, forcibly releasing its fire extinguishment to the environment.

As used here in this invention, Y psi for Category Two impact release encasements pertains to the pressure per square inch exerted upon the exterior surface of the encasement when the encasement impacts with or is struck by a surface force greater than what is encountered so that it will initiate the controlled degradation means of the encasement. Here, Category Two encasement impact itself does not cause disintegration of the encasement. However, it may work in conjunction with other targeting and discharge settings, e.g., thermal range of A° C./F.-B° C./F. and impact or thermal range of A° C./F.-B° C./F. but if thermal range of A° C./F.-B° C./F. is not achieved then on impact at Y psi.

As used here in this invention, the application of Z psi is for non-impact release encasements and Category Two impact release encasements alike. Here, the impact discharge feature is a safety feature whereupon failure of a encasements to achieve its discharge settings when the encasement comes to rest after impact with a surface force of X psi magnitude or greater, where the ambient temperature of the immediate area is or later achieves C° C./F. or greater. Where the ambient temperature of the immediate area is not or fails to achieve C° C./F. or greater, where C° C./F. is determined as the minimum temperature necessary to indicate an evolved fire is within the discharge radius of the encasement, impact as a safety feature will not initiate disintegration of the encasement by controlled degradation or any other means.

A defined herein, the propellant core, propellant region, propellant containment area, propellant containment means, centralized propellant containment core, shall mean a means comprising a compartmentalized, contained, containment, distinct containment area, region, segment, or section, that is contained, found within an encasement that is distinct from the area containing the fire extinguishment, and shall house, contain a propellant used, to be used by the encasement for the purpose of propelling, projecting, delivering the encasement from Point A to Point C, and should be distinct from the fire extinguishment material containment area that may also be linked to a propellant discharge control means, navigation means, programming means, propellant monitoring sensor(s), and/or propellant leaching sensor(s).

The propellant core of the encasement houses the propellant masse used to propel the fire extinguishment encasement upon discharge from the launcher. The propellant core occupies a distinct, isolated portion of the fire extinguishment encasement's interior (see, FIGS. 198, 199 and 200) with an exhaust or release aperture centrally located to the base of the encasement.

This shall also mean that where compressed gas used as an incendiary or non-incendiary propellant is contained within the encasement its containment means must comprise a means that will withstand the pressure exerted by the propellant and compressed fire extinguishment material: including the pressure exerted by the fire extinguishment material when expelled from the containment area. Unless intentionally designed to do so, rapid expulsion of the propellant should not result in collapse of the containment means, nor should the result of rapid propellant loss result in disruption of function or integrity of the encasement.

This shall further mean an area of the encasement that may be attached adjacent to, contiguous to, contiguous with, contain between the exterior and interior wall surface of the encasement; incorporated into, made a part of, constructed in such a manner as to be one with or a part of the fire extinguishment encasement's wall structure.

As used herein, a propellant shall mean a substance, chemical, compound, fuel, energy source, gas, compressed fire extinguishment or an entity of similar nature, independently or in combination, that when activated will ignite, explode, implode, set into motion, convert to power, convert to usable energy, convert to expendable energy, combust so as to provide lift, movement, propulsion of the encasement.

As used herein, construction of the propellant core and aperture(s) must be strong enough to contain the propellant in its resting, storage, handling state, and when the encasement is loaded to and discharged from a launcher. The propellant core, its exhaust/release aperture, and control means of the exhaust aperture(s) (see, FIG. 163, pt. 621) must be suitable to withstand the same pressure and any corrosive properties of the propellant contained therein.

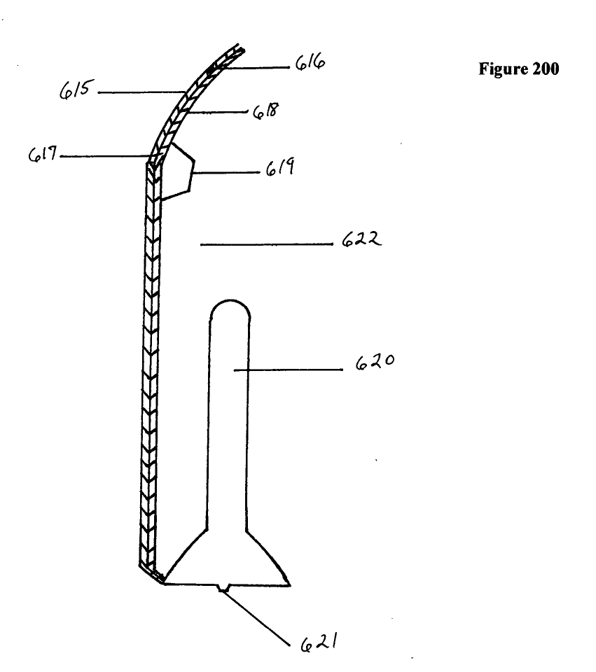

In an embodiment FIG. 200 illustrates a cut-away cross section of an encasement, where the propellant core (620) is centrally placed within the encasement.

As used herein, the material and construction of the encasement's propellant core must be able to withstand the pressure exerted by the compressed fire extinguishment material loaded therein must rapidly disintegrate when exposed to an interior emanating electrical charge of X magnitude/frequency/duration. However, the propellant core must withstand disintegration until directly charged by the electronically controlled electric charge generator. As further used herein, when possible, where pressure from the propellant core will be harnessed to expel the fire extinguishment with greater force, the discharge program should initiate the electronically controlled electric charge generator to disintegrate the propellant core immediately prior to initiating controlled degradation of the encasement.

In an embodiment FIG. 202 illustrates that when the wall of the propellant core is exposed to an electrical charge emanating from within the encasement's interior or fire extinguishment containment area, such as by the electronically controlled electrical charge generator (621), the electrical charge should cause the propellant core's material to pulverize, resulting in the expulsive release of the encased propellant material to the interior of the encasement.

In a further embodiment FIG. 203, as a continuation from FIG. 202, with controlled degradation of the encasement, the propellant (620) will forcibly project the fire extinguishing material (622) to the fire environment (619).

As used herein, whether using a fixed position exhaust aperture (see, FIG. 206, pt. 652), or a maneuverable exhaust aperture, the rate of propellant release is controlled by the encasement's guidance means. A movable, controlled rotation exhaust aperture provides greater control and maneuverability of the encasement by providing thrust vectoring: i.e., directional control of the exhaust, a method common to those skilled in the art of aircraft engine and missile design.

As used herein, where compressed nitrogen gas (or another, suitable, inert gas) is used as a propellant and as a fire extinguishment, ports or apertures contained within the propellant core's wall provide controlled release of compressed gaseous nitrogen from the fire extinguishment material containment area to the propellant core area, where the nitrogen would then be expelled to the fire environment through the exhaust aperture of the propellant core as the encasement traverses the fire zone. Here, the release of nitrogen or other inert gases as a total flooding means to extinguish a fire, works by displacing free oxygen in the fire zone. The use of compressed nitrogen gas as a propellant and/or as a fire extinguishment agent comes with the advantage of being noncombustible and oxygen depleting. Therefore, as a propellant its usage will not promote a fire, and ultimately duly functions as an extinguishment.

As used herein, the propellant containment area may be located contiguous to the interior surface area of the encasement, or in a cavity between the near exterior surface and the interior surface.

As used herein, an encasement's warning sensors shall mean a system, mechanism, method or similar means to electronically, chemically, monitor and report by electronic transmission to a monitoring system, the leaching of fire extinguishment materials, propellant, tampering, unauthorized access attempts, discharge failure, errant trajectory, and by option to measure the oxygen, nitrogen or other inert gas levels, common toxic substances associated with a fire, as found within or proximate to an encasement's trajectory: therefore, the sensor memory software must be able to conform the scan data.

In an embodiment FIG. 206 illustrates a cut away section, comprising an encasement where the propellant containment is sandwiched between the near exterior surface (616) and the interior surface (617) of the encasement, spanning the majority of the encasement with the exception of the base and nose area. Release of the propellant, for drive purposes, is through a base located propellant exhaust aperture (652). Release of the propellant may be achieved through a signal exhaust aperture, where depletion of the propellant is regulated and uniform. Multiple base located exhaust apertures may be utilized, which will again require that propellant release is performed in a regulated, uniform manner, to maintain proper orientation of the encasement's trajectory.

In another embodiment FIGS. 207, 208 and 209, the propellant containment that is located between the near exterior surface and the interior surface of the encasement covers only a portion of the encasement's length. Whether the propellant containment core spans the majority of the near exterior surface or the interior surface or a smaller portion of the encasement (see, FIG. 206, pt. 620), Kevlar lacing or a similar material is still employed to protect the encasement from incidental bumping, the force exerted upon discharge from a launcher, storage pressure, and fire extinguishment material and propellant loading. Where the propellant containment area is contiguous to or incorporated within the encasement's surface structure, the propellant should be utilized to expel the fire extinguishment contents where release of same is through designated ports of the encasement.

As used in this invention when the interior or fire extinguishment containment facing side of the propellant containment core is ruptured, sending propellant into the extinguishment containment area and working in conjunction with controlled degradation means to clear the strategically placed fire extinguishment ports, the force of the propellant accelerates the rate and distance of the extinguishment expelled through the ports.

In an embodiment FIGS. 210 and 211 illustrates placement of the propellant core within the wall structure of the encasement (620).

In a separate embodiment FIG. 211 illustrates placement of the propellant core (641) contiguous to the interior wall (617) of the encasement. When the interior facing portion of the propellant containment area is pulverized through controlled degradation (640), releasing the propellant (620) into the extinguishment containment area of the encasement (652), while at the same time discrete ports of the encasement (634) are blown out, the force of the propellant expelled into the extinguishment area forcibly expels the latter through the ports to the environment.

In an embodiment FIG. 212 illustrates a Third Generation Smart Fire Extinguishment Encasement comprising its gyroscopic sensor (1), spatial sensor (2), navigation control means (3), discharge control means (4), thermal detection means (5), thermal differentiation means (6), altimeter (7), heat seeking targeting means (8), secondary discharge—impact safety discharge control means (9), programming means (10), scanning means (11), motion sensor (12), global positioning system (13), guidance control means (14), speed monitor (15), distance monitor (16), timing means (17), targeting proximity (18), propulsion control means (19), deployed navigation wing (20<navigation wing in the pre-deployed state (21), propellant core (23), propellant exhaust aperture (24), propellant leaching sensor (25), obstruction detection sensor (26), tampering/extinguishment leaching sensor (27), electronic beacon (28), security verification means (29), transceiver (30), electronically controlled electrical charge generator (31), and the fire extinguishment.

| | | |
|---|---|---|
| 4,090,567 | Tomlinson | May 23, 1978; |
| 4,172,499 | Richardson | Oct. 30, 1979 |
| 4,195,572 | Knapp | Apr. 1, 1980 |
| 4,195,693 | Busch | Apr. 1, 1980 |
| 4,285,403 | Poland | Aug. 25, 1981 |
| 4,328,868 | Monte | May 11, 1982 |
| 4,474,350 | Hawkshaw | Oct. 2, 1984 |
| 4,488,603 | Schittmann | Dec. 12, 1984 |
| 4,550,931 | Ziaylek, Jr., | Nov. 5, 1985 |
| 4,576,237 | Arney | Mar. 18, 1986 |
| 4,601,345 | Makrt | Jul. 22, 1986 |
| 4,627,354 | Diamond | Dec. 8, 1986 |
| 4,671,472 | Hawkshaw | Jun. 9, 1987 |
| 4,691,783 | Stern | Sep. 8, 1987 |
| 4,881,601 | Smith | Nov. 11, 1989 |
| 4,930,826 | Perren | Jun. 5, 1990 |
| 4,936,389 | MacDonald | Jun. 26, 1990 |
| 4,964,469 | Smith | Oct. 23, 1990 |
| 4,993,665 | Sparling | Feb. 19, 1991 |
| 5,018,586 | Cawley | May 28, 1991 |
| 5,135,055 | Bisson | Aug. 4, 1992 |
| 5,188,184 | Northill | Feb. 23, 1993 |
| 5,211,246 | Miller | May 18, 1993 |
| 5,232,053 | Gillis | Aug. 3, 1993 |
| 5,549,259 | Herlik | Feb. 17, 1994 |
| 5,320,185 | Foy | Jun. 14, 1994 |
| 5,377,934 | Hill | Jan. 3, 1995 |
| 5,385,208 | Baker | Jan. 31, 1995 |
| 5,507,350 | Primlani | Apr. 16, 1996 |
| 5,641,024 | Lopez | Jun. 24, 1997 |
| 5,794,889 | Rey | Dec. 23, 1997 |
| 5,771,977 | Schmidt | Jun. 30, 1998 |
| 5,778,984 | Suma | Jul. 14, 1998 |
| 5,878,819 | Denoize | Mar. 9, 1999 |
| 6,029,751 | Ford | Feb. 29, 2000 |
| 6,125,942 | Kaufman | Oct. 3, 2000 |
| 6,134,423 | Fitzpatrick | Oct. 24, 2000 |
| 6,244,353 | Greer | Jun. 12, 2001 |
| 6,340,058 | Dominick | Jan. 22, 2002 |
| 6,364,026 | Doshay | Apr. 2, 2002 |
| 6,474,564 | Doshay | Nov. 5, 2002 |
| 6,502,421 | Kotlian | Jan. 7, 2003 |
| 6,523,616 | Wallace | Feb. 25, 2003 |
| 6,533,041 | Jensen | Mar. 18, 2003 |
| 6,548,753 | Blackmon, Jr. | Apr. 15, 2003 |
| 6,549,422, | Mendoza | Apr. 15, 2003 |
| 6,557,374 | Kotliar | May 6, 2003 |
| 6,725,941 | Edwards | Apr. 27, 2004 |
| 6,732,725 | Doud | May 11, 2004 |

1. A fire extinguishing device comprising:
a. An activatable means; and
b. A shell comprising at least a single wall further comprising compressed powdered fire suppressant material;
wherein when the means is activated, the contents of the shell will be released.

2. The fire extinguishing device of claim 1, as set forth in FIG. 1.

3. The fire extinguishing device of claim 1, wherein the wall is a double wall, a hybrid single or double wall or a combination thereof, as set forth in FIG. 62.

4. The fire extinguishing device of claim 1 comprising a non-phosphate tracer.

5. The fire extinguishing device of claims 1-4, comprising a fire retardant material, particulate matter dispersal material, or an endothermic agent.

6. The fire extinguishing device of claims 1-5, comprising a material that will withstand the internal pressure of its compressed fire suppressant material contents, the external pressure asserted by incidental bumping, storage, transport, or change in atmospheric pressure asserted during transport above or below sea level.

7. The fire extinguishing device of claims 1-6, comprising an activatable means of temperature, temperature range, impact, temperature and impact, temperature range, with impact as a safety feature; time, temperature and time, temperature range and time, time and impact, time and temperature with impact as a safety feature, time, temperature range with impact as a safety feature; altitude, altitude and temperature, altitude and temperature range, altitude and impact, altitude, temperature with impact as a safety feature, altitude, temperature range with impact as a safety feature; height, height and temperature, height and temperature range, height and impact, height, at a variable preprogrammed minimum height; maximum altitude, a maximum height, minimum altitude, or a combination thereof, temperature, with impact as a safety feature, height, temperature range, with impact as a safety feature, internal pressure, internal pressure of the device or internal pressure of the pressure sensitive center nodules incorporated within the wall of the device, internal pressure of the device or internal pressure of the pressure sensitive center nodules incorporated within the wall of the device and altitude, internal pressure of the device or internal pressure of the pressure sensitive center nodules incorporated within the wall of the device and temperature, negative pressure of the device or negative pressure of the negative pressure sensitive center nodules incorporated within the wall of the device, negative pressure of the device or negative pressure of the negative pressure sensitive center nodules incorporated within the wall of the device and altitude, negative pressure of the device or negative pressure of the negative pressure sensitive center nodules incorporated within the wall of the device and temperature; chemical, electrical, electronic, incendiary, non-incendiary, chafe-charge mechanism, or percussive as.

8. The fire extinguishing device of claims 1-7 comprising:
a. A second activatable means,
b. A propellant containment means,
c. A propellant comprising an inflammable material, a flammable material, or in combination there,
wherein when the second activatable means is activated the propellant will be released, propelling the device to a determined height, a determined distance, or in combination thereof.

9. The fire extinguishing device of claims 1-8 further comprising a guiding means.

10. A guiding means of claim 9 further comprising:
a. A microprocessor capable of providing the functions of a global positioning system, altimeter, gyroscopic sensor or in combination thereof,
b. A second guiding means comprising an adjustable stabilizing surface wings, embedded adjustable stabilizing wings, or in combination thereof,
wherein when working through the microprocessor, with information provided by the global position system, altimeter or in combination thereof, the guiding means can guide the device, and the stabilizing wings will assist the device to achieve its target area, as set forth in FIG. 44.

11. The fire extinguishing device of claim 10 further comprising an electronic discharge means.

12. An electronic discharge means of claim 11 further comprising:
a. A microprocessor comprising or linked to a global positioning system and altimeter control, that is capable of orienting the device to discharge its content at a latitudinal coordinate, longitudinal coordinate, height, altitude, or in combination thereof,
wherein when working through the microprocessor, with information provided by the guiding means, the discharge means, which is the activatable means, will cause the device to discharge its contents at a desired point, place, time or in combination thereof.

13. The fire extinguishing device of claim 1-9 further comprising an electronic programming means.
a. A hardwired interface capable of receiving and transmitting input from an external means to program the claim 10 guiding means, claim 12 discharge means, further comprising a surface electronic contact interface, an embedded electronic contact interface, a submerged electronic contact interface, or in combination thereof, hardwired to the claim 9-12 microprocessor,
b. A wireless interface capable of receiving and transmitting input to program the claim 10 guiding means, claim 12 discharge means, further comprising a surface electronic contact interface, an embedded electronic contact interface, a submerged electronic contact interface, or in combination thereof, hardwired to the claim 9-12 microprocessor; or
c. In combination thereof,
wherein when the interface receives an electronic programming data signal from a source without the device, it will transmit that data signal to the claim 9-13 microprocessor.

14. The fire extinguishing device of claim 1-8 comprising a self-righting means,
wherein when the device comes to rest on a surface but has not achieved its intended position, angle, orientation for projection, discharge, or in combination thereof, the self-righting means will perform a corrective action to adjust the angle, pitch, direction of the device to or proximate to its intended position.

15. A fire extinguishing device of claim 1-8 further comprising three or more distinct concentric levels of fire suppressant materials, or three or more distinct concentric spherical levels of fire suppressant materials.

16. A fire extinguishing device carrier medium comprising:
a. Multiple fire extinguishing devices; and
b. Fire suppressant material or no fire suppressant material.

17. Two fire extinguishing devices connected in such a way that when the first device is activated, the first device will release the contents of its shell and release the second device, wherein when the second device is released from the first device it will self-right, project, release the contents of its shell upon ascent of the device, descent of the device, or in combination thereof, as set forth in FIG. 22.

18. A fire extinguishing device of claims 1-17, with a guiding means further comprising:
a. A fire extinguishing device with a heat seeking smart chip for guidance capable of obstruction avoidance, programmable heat detection, real time trajectory data relay to a remote monitor, real time targeting data relay to a remote monitor, collision avoidance with other fire extinguishing devices, interactive exchange of electronic data with other fire extinguishing devices, or in combination thereof, as set forth in FIG. 82.

19. A fire extinguishing device of claim 18's heat seeking means comprising:
a Visual marker,
b. Electronic marker, or in combination thereof,
wherein when acting as a single device will search for, locate, deliver its fire suppression contents to the fire, and mark the target or area with a visual marker that responds with greater intensity with the heat, for observation, and detection purposes, and an electronic marker that will relay its position to a remote monitor, while acting as a homing beacon for other devices so constructed.

20. A two-part fire extinguishing unit comprising:
a. A housing unit, first part, comprising:
i An external, exterior formed, outer casement, casing, shell, containment device, containment structure or similar means,
ii A means for assisted low-speed propulsion, self propulsion, or in combination thereof,
iii A guiding means,
iv A attaching means to hold the device to a glass surface,
iv A means to penetrate, bore, bore through, displace a portion of the glass surface attached to without shattering the glass,
v A means to remove the displaced glass from the device,
vi A means that will form a seal between the housing of the device and the glass structure upon penetrating the glass structure,
vii A means to separate the boring or penetrating means from the two-part housing after completion of its function,

21. A second part of the two-part fire extinguishing unit of claim 20, further comprising:
a. claims 1-19 devices,
b. A means to secure the claims 1-19 devices within the housing but away from the means that will penetrate, bore, bore through, displace a portion of the glass surface,
c. An activatable means,
wherein when the device, guided by its guiding means, approaches, attaches to, penetrates a glass surface, removes the displaced portion of glass, its activatable device when activated will release, propel, discharge its claims 1-7 contents, claim 19(a)(b) markers held within the housing device to the fire environment.

22. An aerial, ground based delivery device comprising:
a. A single-stranded flexible strip structure, a parallel-stranded flexible strip structure, or in combination thereof, that can be dropped, aerially dropped, propelled, projected, or in any other suitable fashion placed within or delivered to the fire zone,
b. A guiding means for orienting the device,
c. An ejection means.

23. The aerial, ground-based delivery device of claim 22, further comprising:
a. An attachment securing the strip to an ejection means,
b. An end piece that when the strip is ejected, will be ejected furthest from the ejection means,
c. A segment of the end piece that is weighted, non-weighted, partially weighted, for the purpose of adding balance when the strip is ejected,
d. Cut out segments within the strip, for the purpose of holding claim 1-19 devices,
e. A securing means within the strip, that will connect, hold the claim 1-19 devices to the strip structure in a positive oriented position,
f. An release means that when activated will release the attached claim 1-19 devices from the strip structure for subsequent discharge, a device activation means to effect discharge of the claim 1-19 devices while attached to the strip structure, or in combination thereof,
g. Multiple claim 1-19 devices attached to the strip structure,
wherein when the device is linked to its guiding means, released to the environment by way of aerial drop, ejection, or similar manner, with the distal end serving as a ballast, balance, the device can deliver successively attached multiple fire suppression devices for discharge at ground level, in a vertical column, horizontal column, or in combination thereof.

24. A fire extinguishing unit comprising:
a. A cylinder,
b. A guiding means further comprising a microprocessor controlled interior mounted retractable parabolic flanges, exterior mounted retractable parabolic flanges, mini parachute, or in combination thereof to control the cylinder's descent,
c. A sealable posterior lid, sealable anterior lid, sealable breakaway side panel, held in place by microprocessor controlled electronic release pins,
d. An activatable means linked to the electronic release pins and the guiding means, wherein when activated the electronic release pins will open, releasing the anterior lid, posterior lid, breakaway panel, or in combination thereof,
e. One or more anchored, unanchored claim 23 strip structures, claim 1-19 devices, or in combination thereof, held within the cylinder's,
wherein when the cylinder is projected, aerially dropped, the guiding means will direct the cylinder to its destination, where the activatable means will release the lid, breakaway panel, thereafter dropping the contents for subsequent discharge.

25. A fire extinguishing carrier unit comprising a containment structure capable of carrying one or more claim 1-19, 24 fire extinguishing devices.

26. The fire extinguishing carrier unit of claim 24, further comprising:
a. A guiding means,
b. A self-righting means to orient the structure, if dropped, projected or in similar manner delivered to the fire environment,
c. A sealable lid, sealable breakaway side panel, held in place by microprocessor controlled electronic release pins,
d. An activatable means linked to the electronic release pins and the guiding means, so that when activated the electronic release pins will open, releasing the anterior lid, posterior lid, breakaway panel, or in combination thereof,
e. An ejection means,
f. An activatable means to effect ejection,
g. One or more anchored, unanchored strip structure of claim 24, multiple claim 1-19 devices, or in combination thereof, secured to the ejection means,
wherein when the claim 25 device has reached its intended destination, the self-righting means which is linked to the guiding means and activatable means will correct the carrier units position, where necessary, so that the activatable means will release the lid, breakaway side panel, thereby activating the ejection means to eject the strip structure, claim 1-19, 24 devices, for subsequent discharge of these fire extinguishing devices.

27. A fire extinguishing carrier unit of claim 25 comprising a breakaway containment structure capable of carrying one or more claim 1-19, 22 devices.

28. The fire extinguishing carrier unit of claim 27, further comprising:
a. A containment structure constructed in such a manner that on impact it sides, top, bottom will collapse, breakaway, shatter, or in similar fashion fall apart, but in doing so will not impede the projection, ejection, release, escape of its contents, a means to effect such collapse, or in combination thereof,
b. A self-righting means to orient the structure, if dropped, projected or in similar manner delivered to the fire environment,
c. An ejection means,
d. An activatable means to effect ejection,
e. One or more anchored, unanchored strip structure of claim 23, multiple claim 1-19, 22 devices, or in combination thereof, secured to the ejection means,
wherein when the claim 25 device has reached its intended position, impact and/or an activatable means will cause the device to fall away from its contents that will be ejected further into the fire environment for discharge of the fire extinguishing shells.

29. The fire extinguishing carrier unit of claim 28 comprising a guiding means.

30. A unit comprising a fixture for the linkage of:
a. A guiding means,
b. A weighted end region position distally opposite the guiding means' stabilizing wings,
c. An attachment means for securing shells, encasements, containment devices, encapsulations, capsules, devices, or in combination thereof,
d. A shell, encasement, encapsulation, capsule, containment device, device programmable means,
e. An activatable means to release or discharge the shells, discharge the shells, or in combination thereof,
wherein when the fixture is projected, propelled, dropped or aerially dropped, the guiding means guides the fixture that has been to its destination, the activatable means linked by a computer program to the guiding means will release the shells from the retaining pins of the fixture for subsequent activation, or discharge the shells while attached to the fixture, or in combination thereof19Because I want to know all there is about you. 56.

31. A fire extinguishing device carrying unit comprising:
a. Material that is insulated, lightweight, flame resistant, fire resistant, can withstand extreme heat for an extended period of time, shielding to prevent entry of external, extraneous electronic signals that could interfere with the programming of the devices held within the carrying unit,
b. A primary internal chamber that will contain the fire extinguishing devices, with a connecting tube to external devices,
c. A secondary internal chamber that can be filled with an inflammable gas with a composition and capacity to provide buoyancy to the carrying unit, with a connecting line to a pump, gas containment structure,
d. A pump to independently pressurize, depressurize the primary chamber, the secondary internal chamber or in combination thereof,
e. A gas containment structure from which the inflammable gas will be pumped inert to, from the secondary internal chamber, receiving inflammable gas from the secondary internal chamber or in combination thereof,
f. Automatic pressure relief valve, pressure release valve, pressure monitor or in combination thereof,
g. Multiple devices.

32. A fire extinguishing device carrying unit of claim 31 further comprising:
a. An electronic programming means to program devices contained within the carrying unit comprising an external, recessed, programming module, a hand-held electronic programming keypad, a flame resistant externally recessed electronic docking port for use of the hand-held electronic programming keypad, transducer, for the purpose of electronically programming, reprogramming, deprogramming fire extinguishing devices contained with the fire extinguishing device carrying unit,
b. A microprocessor controlled device counter computer linked to a display monitor, display monitor, for the purpose of providing a visual monitoring the number of devices contained within, programming status of, number of devices released from the fire extinguishing carrying unit.

33. A fire extinguishing device carrying unit of claim 31 further comprising a connecting means for passage of devices from the fire extinguishing carrying unit to external devices for deployment to the fire environment,
wherein when the carrying unit containing fire extinguishing devices that can be electronically programmed through the programming means that is computer program linked to the transducer, and is closed, sealed, pressurized to assist with pushing the devices through the connecting tube to external devices for subsequent fire zone deployment, firefighters have the ability to bring a replenishable quantity of such devices to, into the fire environment to combat a fire.

34. A light weight, portable, insulated, fire extinguishing device carrying unit comprising:
a. Electronic programming module, recessed hand-held electronic programming module, or in combination thereof,
b. External docking port for the electronic programming module.

35. A fire extinguishing carrying unit of claim 34 comprising:
a. A fixture further comprising a handle, one or more interlocking, interconnecting sections with one or more angled connecting pins per section for device attachment,
b. A guiding means, discharge means, electronic programming means, computer programming means connecting the electronic programming module to the programming means, transducer,
c. Multiple fire extinguishing devices, device counter,
wherein as a unit, it will permit its user to program, transport a quantity of fire extinguishing devices to a fire environment, as one unit or as separate units, so that when the fixture with its attached devices is placed, thrown, presented to the fire environment, and has reached its intended position, as determined by its guiding means, the activatable means will be discharge the devices.

36. A hand-held device for the launching, firing, shooting, propelling of fire extinguishing devices comprising:
a. Blank cartridge barrel further comprising redundant electronic programming contacts lining the interior of the barrel, connected to an electronic programming module, microprocessor controlled electronic programming trigger for electronic programming, reprogramming, deprogramming of devices loaded therein,
b. Flash suppressor, flash preventer, or a combination thereof, to prevent ignition of flammable material when the device is operated proximate to, within a fire environment, or in combination thereof,
c. Pistol grip,
d. Dual triggers comprising a primary microprocessor controlled trigger connected to the redundant electronic programming contacts within the fire extinguishing launching unit's barrel for the purpose of effecting electronic programming devices, and a second trigger to launch, fire, propel, shoot, or in similar action to release the devices from the launching device,
e. Trigger guard,
f. Safety means to prevent premature, unintended firing of devices loaded to the device's barrel,
g. Shell loading method further comprising a device breach section, circular or elliptical magazine, rear-mounted magazine, direct feed from the connecting unit of claim 28, magazine loader connected to a claim 28 device,
h. Microprocessor controlled laser sighting imaging system, thermal imaging sighting system, programming module, targeting system,
that when put together as a single unit will permit its user to electronically program and propel devices, wherein activating the activatable means to effect discharge of the fire extinguishing devices.

37. A shoulder mount device for launching claim 36 devices comprising a two- to- four adjustable launch barrels to accommodate fire extinguishing devices that as a result of size or configuration cannot be accommodated by a claim 36 fire extinguishing launching unit.

38. A manually controlled, microprocessor controlled, lightweight, freestanding, transportable fire extinguishing device launching unit, as set forth on FIG. 111, comprising:
a. A base,
b. Piston driven, compressed air driven, compressor driven retractable anchoring means,
c. Piston driven, compressed air driven, compressor driven means to free the anchoring means from an anchored position,
d. Bi-level swivel pedestal base supporting a shell lifting means,
wherein when this transportable device launching unit is moved into place the retractable anchoring means is driven through the base into the ground or similar area, stabilizing the bi-level base to allow the lifting means to raise a fire extinguishing device into its firing position.

39. A fire extinguishing device launching unit of claim 38, further comprising:
a. Two parallel, connected, pivotal arms attached to the pedestal base, with the latter dividing the two arms, that can be rotated in an upward, downward arc perpendicular to the pedestal base,
b. A securing face plate at the distal end of the pivotal arms capable of attaching, securing devices to be lifted by the fulcrum action of the pivotal arms,
wherein as a single unit the pivotal arms when rotated into position to secure a fire extinguishing device to the face plate, so as to allow the device to be lifted into a firing position.

40. A fire extinguishing device launching unit of claim 39 further comprising:
a. An electronic transmission means, electronic programming contact surface, manual programming means, or in combination thereof, for the purpose of programming, reprogramming, deprogramming devices secured to the face plate,
b. Microprocessor controlled laser sighting imaging system, thermal imaging sighting system, programming module, optical sighting system, electronic programming, targeting system,
wherein as a single unit permitting its user to attach, secure, lift fire extinguishing devices into firing position, the programming means linked by a computer program to a transmission, electronic contact source, can activate the device's activatable means, for subsequent discharge to the fire environment, after the device is fired from this launching unit.

41. A vehicle mounted fire extinguishing device launching unit as set forth in FIGS. 114 comprising:
a. A means serving as a base for attachment, securing the device to a vehicle,
b. A two-part, upright, end-to-end, vertically positioned vertical column, with each of the two columns capable of independent, unison movement,
c. The two-part vertical column housing a mechanized swivel at its base, midsection, or where the two columns join at the top of the upper column, or in combination thereof,
d. A means by which a platform is affixed to the upper vertical column
e. A means by which the platform that is affixed to the upper vertical column can be mechanically, electronically tilted along the horizontal axis of the vertical column,
f. A platform horizontally affixed atop the upper vertical column further comprising a moveable rail system with semi-recessed free floating rollers, a mechanical drive to move the semi-recessed free floating rollers, a brake system to control the speed and movement of each track of free floating rollers, safety control systems to assure safe operation of the system,
g. A mechanical leveling means, microprocessor controlled leveling means, or in combination thereof, to stabilize movement, align the platform, align the components of the platform to features of the device that acting together will result in movement of, programming of, launching fire extinguishing devices from this system,
h. A containment unit with the capacity to hold multiple fire extinguishing devices, further comprising a moveable rail system with semi-recessed free floating rollers, a mechanical drive to move the semi-recessed free floating rollers, a brake system to control the speed and movement of each track of free floating rollers, safety control systems to assure safe operation of the system,
i. A containment unit further comprising a mechanical leveling means, microprocessor controlled leveling means, or in combination thereof, to stabilize movement, align the containment unit, align the components of the platform to features of the device that acting together will result in movement of, programming of, launching fire extinguishing devices from this system,
j. A computer program, computer programs linking operations of the vertical column, the platform, leveling means, tilting means, alignment means, movement of the semi-recessed free floating rollers, braking system, safety control system,
wherein, as a stable platform that can be transported by and when affixed to a vehicle, the vehicle mounted fire extinguishing device launching unit can be rotated, tilted, into position for operation, while maintained in a level and aligned position, with the capacity to freely move its fire extinguishing devices along the roller tract system for subsequent launching.

42. A vehicle mounted fire extinguishing device launching unit of claim 41, further comprising:
a. Single, multiple fire extinguishing device launcher barrels located at the anterior section of the horizontal platform,
b. A means to move the fire extinguishing devices along the moveable rail system with the semi-recessed free floating rollers, to a means with the capacity to load, enter, introduce the fire extinguishing devices into the launcher barrels,
c. Multiple fire extinguishing devices,
wherein, when the fire extinguishing devices are moved from the containment device to the loading means, the loading means will receive and transfer the devices to the fire extinguishing device launcher.

43. A vehicle mounted fire extinguishing device launching unit of claim 42 further comprising an electronic control housing located at the posterior section of the horizontal platform.

44. A vehicle mounted fire extinguishing device launching unit of claim 43 further comprising a computer program linked electronic fire extinguishing device programming module, device fire control means, recessed programming keypad, device counter, microprocessor, split screen monitor, remote operations electronic package,
wherein the activatable means of each fire extinguishing devices can be electronically programmed for deployment by the device launcher.

45. A vehicle mounted fire extinguishing device launching unit of claim 44 further comprising thermal imaging, laser imaging, infra red, stargazer vision imaging system, night vision imaging systems with real time monitors, and computer programming to differentiate thermal patterns and to prevent “white out” associated with the exposure of such systems to intense light,
wherein as a single unit, the vehicle mounted fire extinguishing device launching unit can program, load, propel a fire extinguishing devices into the fire environment.

46. A vehicle enclosed, vessel enclosed, fire extinguishing device containment unit comprising:
a. A claim 41 fire extinguishing device containment unit containment unit with the capacity to hold multiple fire extinguishing devices, further comprising a moveable rail system with semi-recessed free floating rollers, a mechanical drive to move the semi-recessed free floating rollers, a brake system to control the speed and movement of each track of free floating rollers, safety control systems to assure safe operation of the system,
b. A containment unit further comprising a mechanical leveling means, microprocessor controlled leveling means, or in combination thereof, to stabilize movement, align the containment unit, align the components of the platform to features of the device that acting together will result in movement of, programming of, launching fire extinguishing devices from this system,
c. Shielding to prevent entry of external, extraneous electronic signals that could interfere with the programming of the fire extinguishing devices held within the containment unit,
d. Exterior accessible access doors for the purpose of moving fire extinguishing device to and from the containment unit,
e. Electronic control housing, further comprising a computer program linked electronic fire extinguishing device programming module, device fire control means, recessed programming keypad, device counter, microprocessor, split screen monitor, remote operations electronic package, thermal imaging, laser imaging, infra red, stargazer vision imaging system, night vision imaging systems with real time monitors, and computer programming to differentiate thermal patterns and to prevent “white out” associated with the exposure of such systems to intense light,
f. Multiple fire extinguishing devices,
wherein, the fire extinguishing device containment unit, when accessed from the exterior access doors can receive and offload such devices, whereby they will be moved along the moveable rail system of each rack, for the purpose of housing such devices for electronic, programming, reprogramming, deprogramming, transport, for external use.

47. A vehicle enclosed, vessel enclosed, claim 46 fire extinguishing device containment unit further comprising:
a. A remote, electronic device programming module, device fire control means, device counter, microprocessor, monitor, operations electronic package, as used in claim 46,
b. Braking system, moveable rail system with semi-recessed free floating rollers, mechanical drive to move the semi-recessed free floating rollers, which in turn will move fire extinguishing devices along the containment system launcher loading device,
wherein when incorporated with the features of claim 46, claim 47 will permit its operators to move, contain fire extinguishing devices from the containment system, to be electronically program, loaded to a fire extinguishing device launcher for delivery to the external environment.

48. A fixed wing aircraft, rotary wing aircraft, aircraft modified for fire fighting duty comprising:
a. Externally fitted, internally fitted, insulated ceramic tiles, or similar insulating material, to reduce, eliminate exposure of the heat associated with a fire environment, to the internal environment of the aircraft, aircraft operating systems, aircraft operators, whatever is contained within the aircraft, for operations above, proximate to, within, or in combination thereof, to the fire environment,
b. A second, non-load bearing, mechanical, collapsible hull, with a hull cavity comprising a collapsible interior hull section, collapsible exterior baffling, collapsible interior baffling, collapsible interior channels between the hulls, a means to extend the secondary hull outward from the hull, a means to retract the secondary hull to the hull,
wherein when the secondary hull is extended outward, from the hull, for the purpose of opening its channel and baffles to direct wind, updrafts, thermal updrafts away from the aircraft, to increase operating stability of an aircraft above, within a fire environment, high turbulence, thermal updraft turbulence, reducing shielding effect as understood by those skilled in the art of aerial fire fighting that affects the dispersal of fire suppressant materials from an aircraft.

49. A claim 48 fixed wing aircraft, rotary wing aircraft, aircraft modified for fire fighting duty further comprising:
a. An extending, retractable wind deflectors,
b. A means to extend the wind deflectors outward, downward from the hull,
c. A means to retract the wind deflectors to the hull,
wherein when the secondary hull is extended outward, from the hull, for the purpose of opening its channel and baffles to direct wind, updrafts, thermal updrafts away from the aircraft, to increase operating stability of an aircraft above, within a fire environment, high turbulence, thermal updraft turbulence, the retractable wind deflectors may be extended to increase wind, turbulence deflection.

50. A claim 49 fixed wing aircraft, rotary wing aircraft, aircraft modified for fire fighting duty further comprising:
a. Electronic signal shielding to prevent interference of fire extinguishing device programming, function, or in combination thereof, by extraneous signals,
b. Compartmentalized hull comprising:
i In dependently operated underside doors to allow aerial drop, delivery of fire extinguishing devices from the aircraft to the fire environment,
ii Multiple fire extinguishing device launchers, multiple fire extinguishing device launcher loading means, for loading extinguishing devices to independent, computer operated, computer assisted the device launchers, for the purpose of projecting extinguishing devices from within the hull of the aircraft to the fire environment or,
iii Multiple, exterior, exterior mounted, interior, interior mounted, interior recessed, rotating, claim 1-18 fire extinguishing device launchers, launcher loading means,
iv Fire extinguishing device launcher cooling system to prevent overheating, jamming, loss of operation of the of the device launcher,
v Flash suppressor, flash preventer, or in combination thereof, to prevent the ignition of flammable material when the fire extinguishing device launchers are operated,
c. A claim 46 device containment system,
d. Multiple fire extinguishing devices, device counter,
e. Electronic programming module, transducer, electronic programming transmission means to electronically program, reprogram, deprogram fire extinguishing devices contained therein,
f. Thermal imaging, laser imaging, infra red, stargazer vision imaging system, night vision imaging systems with real time monitors, and computer programming to differentiate thermal patterns and to prevent “white out” associated with the exposure of such systems to intense light,
wherein as a single, integrate system, it will allow the operator of fixed wing aircraft, rotary wing aircraft, aircraft modified for fire fighting duty to work closer to the fire environment, for the purpose of delivery fire suppressant devices, with less impact upon the operator, aircraft and load normally associated with these extreme temperatures, as well as the fatigue impact of turbulence, erratic thermal updrafts and other environmental factors associated with major fires.

51. An unmanned, remote controlled, computer operated aerial fire fighting unit, as set forth in FIG. 133 comprising:
a. Externally fitted, internally fitted, insulated ceramic tile, or similar insulating material, to reduce, eliminate exposure of the heat associated with a fire environment, to the internal environment of the aircraft, aircraft operating systems, aircraft operators, whatever is contained within the aircraft, for operations above, proximate to, within, or in combination thereof, to the fire environment,
b. A second, non-load bearing, mechanical, collapsible hull, with a hull cavity comprising a collapsible interior hull section, collapsible exterior baffling, collapsible interior baffling, collapsible interior channels between the hulls, a means to extend the secondary hull outward from the hull, a means to retract the secondary hull to the hull,
c. A claim 46 device containment system,
d. Multiple fire extinguishing devices, device counter,
e. Electronic programming module, transducer, electronic programming transmission means to electronically program, reprogram, deprogram fire extinguishing devices contained therein,
f. Thermal imaging, laser imaging, infra red, stargazer vision imaging system, night vision imaging systems with real time monitors, and computer programming to differentiate thermal patterns and to prevent “white out” associated with the exposure of such systems to intense light,
g. A power plant with an external air ram propulsion system comprising a high compression air ram propulsion system with an anti-clogging particulate matter air filtration system; an internal, high volume, compressed air/O₂ power plant air feed system; computer assisted particulate matter monitoring system; computer assisted switching system to properly switch from the external-internal-external ram propulsion system,
h. Docking collar,
i. Electrical bus,
that when operated as a single, integrated unit, the unmanned aircraft can approach a fire situation, switching to an internal air feed system when particulate matter levels would other comprise operation of an aircraft, the secondary hull and wind deflectors are extended to increase stability of the unmanned aircraft while near, above, in the fire environment, wherein the unmanned aircraft can operate closer or directly within the fire situation to deliver fire suppression devices, fire suppression units to the fire environment.

52. A unit for attachment to the underside of a claim 51 aerial fire fighting unit comprising:
a. Compartmentalized hull with underside doors to allow aerial delivery fire extinguishing devices; or
b. claim 46 containment system,
c. Non-load bearing, mechanical, collapsible secondary hull, collapsible interior and exterior baffling and channels, undercarriage extending retractable wind deflectors,
d. Launchers, launcher cooling system, launcher loading means, launcher targeting system,
e. Flash suppressor, flash preventer, or in combination thereof,
f. Externally fitted insulated ceramic tile or similar insulating material, electronic signal shielding to prevent electronic signal interference of the fire extinguishing devices contained therein,
g. Fire extinguishing device electronic programming module, transducer, transmission means,
f. Electrical bus, docking collar, for connection to the claim 50 unmanned, remote controlled, computer operated aerial fire fighting unit,
g. Retractable landing gear,
that when operated as a single unit in conjunction with claim 51, will provide the claim 51 unit with additional fire extinguishing devices.

53. The fire extinguishing device of claim 19, comprising an exterior surface, i.e., the surface exposed to the environment, should not destabilize, disintegrate, or otherwise become compromised where exposed to an electrical charge emanating from the external environment, exposure to toxic gases or fluids from a fire environment; further comprising:
a. A manner of construction where to increase tensile strength of the exterior surface, such as by interweaving its material with Kevlar or a similar material; where the incorporation of same into the encasement's material composition should be oriented in such a manner that will increase hardening of the exterior to prevent premature discharge of it contents due to impact, environmental exposure, or exposure to an external electrical charge; but, where such design should not effect controlled degradation of the encasement's interior, as set forth in FIGS. 164, 165 and 166;
b. An interior surface of the encasement that should be designed to harden with an increase of internal pressure created by loading fire extinguishment material to containment area, where the greater the internal pressure the greater the hardening capacity of the encasement's interior surface; still further comprising a material and construction of the encasement's interior wall and near exterior area, so that it must rapidly disintegrate when exposed to an interior emanating electrical charge of X magnitude, frequency, or duration, but, where the propellant core must withstand disintegration until directly charged by the same or an alternating internally emanating source. When the interior and near exterior walls of the encasement are exposed to an interior emanating electrical charge, the electrical charge should cause the encasement's material to pulverize, resulting in the expulsive release of the encased fire extinguishment material to the fire environment. The electrical charge is primarily directed to disrupt the structural integrity of the encasement's material composition, as set forth in FIG. 168;
c. A surface area between the exterior surface and the interior surface, as set forth in FIG. 163,
still further comprising:
d. Strategically placed electrical or electronic contact points, surfaces, material, or capacitors where discrete portions, points, or areas of the encasement can be charged and disintegrated on command to effect controlled degradation of the discrete area and forcible expulsion of its contents through same to the fire environment, as set forth in FIG. 210;
e. Strategically placed electrical or electronic contact points, surfaces, material, or capacitors where discrete portions, points, or areas of the encasement can be charged and disintegrated on command to effect controlled degradation of the discrete area and forcible expulsion of the entire encasement and forcible expulsion of its contents through same to the fire environment, as set forth in FIG. 167;

54. The fire extinguishing device of claim 53, as set forth in FIG. 169.

55. The fire extinguishing device of claim 53, as set forth in FIG. 170.

56. The fire extinguishing device of claim 53, as set forth in FIG. 171.

57. The fire extinguishing device of claim 53, comprising:
a. Comprising a material and construction in such a manner that it will withstand pressure exerted when discharged from a launcher, incidental bumping associated with storage, transport, handling, loading into a launcher, compression loading of the fire extinguishment material, when the extinguishment is expelled from the containment area, pressure exerted when the propellant is expelled from the propellant containment area; change in atmospheric pressure asserted during transport above or below sea level; capable of withstanding at least several hours of prolonged exposure to the upper range of extreme heat that a firefighter can work near or within; and where such is designed to discharge its fire extinguishment to the environment through controlled degradation of the encasement, but not by impact alone, as set forth in FIG. 212;
b. Comprising a material and construction in such a manner that it will withstand pressure exerted when discharged from a launcher, incidental bumping associated with storage, transport, handling, loading into a launcher, compression loading of the fire extinguishment material, when the extinguishment is expelled from the containment area, pressure exerted when the propellant is expelled from the propellant containment area; change in atmospheric pressure asserted during transport above or below sea level; capable of withstanding at least several hours of prolonged exposure to the upper range of extreme heat that a firefighter can work near or within; and where such is designed to discharge its fire extinguishment to the environment through impact with a hard surface subsequent to discharge from a launcher, where impact comprises X psi, which is the amount of pressure exerted per square inch when the encasement impacts with or is struck with a surface force greater than what encountered when an encasement is discharged from a launching means, the pressure exerted when loading the fire extinguishment and/or propellant, incidental bumping, and storage exerted pressure.
Unless intentionally designed to do so, rapid expulsion of the propellant should not result in collapse of the containment means or the containment means' walls, nor should the result of rapid propellant loss result in disruption of function or integrity of the encasement where a vacuum or semi-vacuum state is created by (rapid) propellant expulsion

58. The fire extinguishing device of claim 57, as set forth in FIG. 212.

59. A security means comprising smart technology to scan and digitize the finger of an authorized operator, that is linked to a software means where its memory comprises the fingerprints of all authorized operators, where that software will compare the scanned fingerprint against its data bank, as set forth in FIG. 158; so that:
a. Where failing to recognize the fingerprint the system will record the time and place of the intrusion and transmit that along with the scanned fingerprint to its memory means and to a remote monitoring means, while disabling operation of the launching means, programming, and discharge of the encasement, and activate an alarm, until such time that it is operationally reset by an authorized operator, as set forth in FIG. 160;
b. Upon recognition of the scanned fingerprint the appropriate software program will randomly segment at least three discrete portions of the operator's scanned fingerprint data, encrypt same, then cause such to be uploaded and incorporated into the programming sequence of an encasement and the launcher's security verification means, that further comprises a security verification means that must authenticate the presence and accuracy of authorized fingerprint within the programming sequence before the encasement can be discharged from the launcher, as set forth in FIG. 160;
wherein upon recognition of the scanned fingerprint and working in conjunction the appropriate software program and a transmission means, will record the identification of the authorized operator, time, place, and duration of operation; and cause such to be transmitted to a remote monitoring and programming means;

60. The fire extinguishing device of claim 59, as set forth in FIG. 212.

61. A scanning means comprising radar, micro-impulse radar, ultra-wide band radar, side-scan radar, acoustical, infra-red, laser, optical, thermal imaging or similar means that is independent of or incorporated into a launching or programming means, that can be directed to or within a structure to scan same, as set forth in FIGS. 145, 146, 147, and 148,
wherein, when linked with the appropriate software, the data from such scan will be used to produce a three-dimensional map of the scanned area, providing a to-scale layout of the area including walls, doors, windows, halls, areas and structures associated with e.g., an office tower, along with a three-dimensional grid of the thermal pattern within the scanned area, as set forth in FIG. 146.

62. The scanning device of claim 61, as set forth in FIG. 145.

63. A second encasement targeting means comprising the device of claim 61, where working in conjunction with the scan data produced resulting in the three-dimensional map of the scanned area and its thermal topography grid, and with the appropriate software program will determine the attack area or accept manual selection of the attack area, thereafter to determine the optimal and alternate attack route; the number of required encasements, based upon the thermal range, its conflagration and size of the area targeted; trajectory, obstruction position and avoidance route, further comprising a means to search for and target a thermal target or thermal range, with a means to identify and differentiate the thermal patterns within a conflagration, and to differentiate the thermal pattern of a human subject from that of the conflagration itself, while passing through same from Point A to Point C, as set forth in FIG. 149,
wherein being linked to the navigation and discharge means and using thermal detection, the search can be based upon a setting to detect the heat at or above XO C/F, heat and flame detection, or thermal range, where the expectancy of flame activity is safely presumed based upon the magnitude and intensity of the heat generated, so as to program the encasement to search for and deliver its fire extinguishment load as desired.

64. The fire extinguishing device of claim 53, also referred to as the Second Generation Fire Suppression Delivery System encasement or Second Generation Encasement, comprising an onboard obstruction detection and obstruction avoidance means, further comprising a real-time scanning means such as look forward radar, side-scan radar, motion detector, acoustical scanning, thermal detector, laser, or similar means, individually or in combination thereof, wherein when linked with the navigation and guidance means, its trajectory programming, and the scan data contained within the encasement's memory, that upon detecting an obstruction within its trajectory that was not present or in its present position within the trajectory when the encasement was programmed, will determine the size, position, and distance to the encasement, its position within the trajectory pattern, and through its onboard system determine the optimal and alternate route to avoid the obstruction, where possible, and whether to take such evasive action or discharge its extinguishment beforehand.

65. The fire extinguishing device of claim 53, also referred to as the Third Generation Fire Suppression Delivery System encasement or Third Generation Encasement comprising a transceiver that is linked to the programming, navigation, security verification, and discharge control means of the encasement, further comprising the means to receive a real-time transmission with corrective navigation and trajectory programming data upon detection of an obstruction by an external, remote scanning source, as set forth in FIG. 212,
wherein, when using intermittent or continuous micro-impulse radar scanning side-scan radar, motion detector, acoustical scanning, thermal detector, laser, or similar means, individually or in combination thereof, subsequent to programming of the encasement and where an obstruction is detected or anticipated to come within the trajectory of the encasement, the appropriate trajectory software determines the optimal and alternate route to avoid the obstruction, where possible, and whether to take such evasive action or discharge its extinguishment beforehand, whereupon such corrective instructions are then transmitted to the encasement's transceiver.
